(19) United States
(12) Patent Application Publication
(10) Pub. No.: US 2026/0078699 A1
(43) Pub. Date: Mar. 19, 2026

(54) TURBOFAN ENGINE INCLUDING A FAN ACTUATION SYSTEM

(71) Applicant: General Electric Company, Evendale, OH (US)

(72) Inventors: Randy M. Vondrell, Newport, KY (US); Keith A. Miedema, Fairfield, OH (US)

(21) Appl. No.: 19/397,386

(22) Filed: Nov. 21, 2025

Related U.S. Application Data
(63) Continuation-in-part of application No. 19/357,928, filed on Oct. 14, 2025.
Application No. 19/357,928 is a continuation-in-part of application No. 19/097,493, filed on Apr. 1, 2025, now Pat. No. 12,480,415.
Application No. 19/097,493 is a continuation-in-part of application No. 18/400,746, filed on Dec. 29, 2023, now Pat. No. 12,345,178.

(51) Int. Cl. F02C 7/141; B64D 27/10

(52) U.S. Cl. CPC F02C 7/141; B64D 27/10; F05D 2220/36; F05D 2260/213

(57) ABSTRACT

A turbofan engine for an aircraft includes a fan and a fan actuation system. The fan has a plurality of fan blades coupled to a fan shaft having one or more fan bearings. The fan blades are rotatable about a pitch axis. The fan actuation system is disposed within a fan hub and includes one or more actuators for rotating the fan blades about the pitch axis and one or more radial thrust bearings. The fan actuation system is characterized by a fan actuation system length envelope in a range from 8.5 to 24 and given by

$$\frac{{N}_{FB} \times {D}_{FT}}{{L}_{AXIAL} \times ( \frac{{R}_{TB}}{{N}_{FB}} )} .$$

N_{FB} is a number of the fan blades, D_{FT} is a fan tip diameter of the fan blades, R_{TB} is a thrust bearing radius of the radial thrust bearings, and L_{AXIAL} is an axial length from a fan hub tip to the fan bearings.

### CROSS REFERENCE TO RELATED APPLICATIONS

This application is a continuation-in-part of U.S. patent application Ser. No. 19/357,928, filed Oct. 14, 2025, which is a continuation-in-part of U.S. patent application Ser. No. 19/097,493, filed Apr. 1, 2025, which is a continuation-in-part of U.S. patent application Ser. No. 18/400,746, filed on Dec. 29, 2023, and issued as U.S. Pat. No. 12,345,178 on Jul. 1, 2025, the contents of all of which are hereby incorporated by reference herein in their entireties.

### TECHNICAL FIELD

The present disclosure relates generally to fan actuation systems for turbofan engines.

### BACKGROUND

Turbofan engines, for example, for an aircraft, generally include a fan having fan blades, a compressor section, a combustion section, and a turbine section arranged in flow communication with one another. Some turbofan engines include a fan actuation system for actuating the fan blades of the fan.

### BRIEF DESCRIPTION OF THE DRAWINGS

The foregoing and other features and advantages will be apparent from the following, more particular, description of various exemplary aspects, as illustrated in the accompanying drawings, wherein like reference numbers generally indicate identical, functionally similar, or structurally similar elements.

FIG. 1 is a schematic cross-sectional diagram of a turbofan engine, taken along a longitudinal centerline axis of the turbofan engine, according to the present disclosure.

FIG. 2 shows a schematic view of a turbofan engine, according to the present disclosure.

FIG. 3 shows a fan having a fan actuation system, according to the present disclosure.

FIG. 4 is a schematic cross-sectional diagram of a fan actuation system for a turbofan engine, taken along a longitudinal centerline axis of the turbofan engine, according to the present disclosure.

FIG. 5 is a schematic cross-sectional view of a fan actuation system for a turbofan engine, according to another aspect.

FIG. 6 is a schematic cross-sectional view of a fan actuation system for the turbofan engine, taken along the longitudinal centerline axis of the turbofan engine, according to the present disclosure.

FIG. 7 is a schematic cross-sectional view of a fan actuation system for the turbofan engine, taken along the longitudinal centerline axis of the turbofan engine, according to another aspect.

FIG. 8 is a schematic cross-sectional view of a fan actuation system for the turbofan engine, taken along the longitudinal centerline axis of the turbofan engine, according to another aspect.

FIG. 9 is a schematic cross-sectional view of a fan actuation system for the turbofan engine, taken along the longitudinal centerline axis of the turbofan engine, according to another aspect.

FIG. 10 is a schematic cross-sectional view of a fan actuation system for the turbofan engine, taken along the longitudinal centerline axis of the turbofan engine, according to another aspect.

FIG. 11 represents, in graph form, a fan actuation system envelope as a function of a loading envelope, according to the present disclosure.

FIG. 12 represents, in graph form, the fan actuation system envelope as a function of a spacing envelope, according to the present disclosure.

FIG. 13 represents, in graph form, a fan actuation system length envelope as a function of a loading envelope, according to the present disclosure.

FIG. 14 represents, in graph form, the fan actuation system length envelope as a function of a spacing envelope, according to the present disclosure.

FIG. 15 is a schematic view of a forward end of a fan of the turbofan engine of FIG. 2, according to the present disclosure.

FIG. 16 is an enlarged, schematic, cross-sectional diagram of the turbofan engine of FIG. 1 and having one or more fan bearings, taken at detail 16 in FIG. 1, according to the present disclosure.

FIG. 17 is an enlarged, schematic, cross-sectional diagram of the turbofan engine of FIG. 1 and having one or more fan bearings, taken along the longitudinal centerline axis, according to another aspect.

FIG. 18 is a schematic cross-sectional view of a fan bearing for the turbofan engine of FIG. 1, according to another aspect.

FIG. 19 represents, in graph form, a fan bearing envelope as a function of a takeoff thrust of the turbofan engine, according to the present disclosure.

FIG. 20 represents, in graph form, the fan bearing envelope as a function of the takeoff thrust, according to another aspect.

FIG. 21 is an enlarged schematic, cross-sectional view of a segment of a fan of having a fan actuation system, according to another aspect.

FIG. 22 is a close-up, schematic view of the turbofan engine of FIG. 2 with a cooled cooling air system, according to the present disclosure.

FIG. 23 is a close-up view of an aft-most stage of high-pressure compressor rotor blades within the turbofan engine of FIG. 2, according to the present disclosure.

FIG. 24 is a close-up, schematic view of the turbofan engine of FIG. 2 showing the cooled cooling air system of FIG. 22, according to the present disclosure.

FIG. 25 is a schematic view of a thermal transport bus, according to the present disclosure.

FIG. 26 is a table depicting numerical values showing the relationships between various parameters in accordance with various example embodiments of the present disclosure.

FIG. 27 is a graph depicting a range of corrected specific thrust values and redline exhaust gas temperature values of turbofan engines, according to the present disclosure.

FIG. 28 is a schematic, cross-sectional view of a turbofan engine, according to another embodiment.

FIG. 29 is a schematic, close-up view of a turbofan engine having a cooled cooling air system, according to another embodiment.

FIG. 30 is a schematic, close-up view of a turbofan engine having a cooled cooling air system, according to another embodiment.

FIG. 31 is a schematic, close-up view of a turbofan engine having a cooled cooling air system, according to another embodiment.

FIG. 32 is a schematic view of a turbofan engine, according to another embodiment.

FIG. 33 shows a schematic, cross-sectional view of a turbofan engine, taken along a longitudinal centerline axis of the turbofan engine, according to another embodiment.

FIG. 34 shows an enlarged, cross-sectional view of a portion of the cross-sectional view of FIG. 33.

FIG. 35A shows a cross-sectional view of a steel shaft.

FIG. 35B shows a cross-sectional view of a composite shaft.

FIG. 36A shows a cross-sectional view of a uniform shaft with a constant diameter and thickness, taken along a longitudinal centerline axis of the shaft.

FIG. 36B shows a cross-sectional view of a concave shaft with a constant diameter and a variable thickness, taken along a longitudinal centerline axis of the shaft.

FIG. 36C shows a cross-sectional view of a convex shaft with a variable diameter and a variable thickness, taken along a longitudinal centerline axis of the shaft.

FIG. 37A shows a schematic view of a shaft using a four-bearing straddle configuration.

FIG. 37B shows a schematic view of a shaft using a four-bearing outbound configuration.

FIG. 37C shows a schematic view of a shaft using an inbound duplex configuration.

FIG. 37D shows a schematic view of a shaft using an outbound duplex configuration.

FIG. 37E shows a schematic view of a shaft using a two-bearing configuration.

FIG. 38 shows a schematic, cross-sectional view, taken along a longitudinal centerline axis, of a turbofan engine, according to another embodiment.

FIG. 39 shows a schematic, cross-sectional view, taken along a longitudinal centerline axis, of a turbofan engine, according to another embodiment.

FIG. 40 shows a schematic, cross-sectional view, taken along a longitudinal centerline axis, of a turbofan engine, according to another embodiment.

FIG. 41 shows a schematic, cross-sectional view, taken along a longitudinal centerline axis, of a turbofan engine, according to another embodiment.

FIG. 42 shows a schematic view, taken along a longitudinal centerline axis, of turbofan engine, according to another embodiment.

FIG. 43 shows a schematic, partial cross-sectional view, taken along a longitudinal centerline axis, of a turbofan engine, according to another embodiment.

FIG. 44 shows an enlarged cross-sectional view of a portion of the turbofan engine of FIG. 43, according to the present disclosure.

FIG. 45 shows an exemplary blade for a turbofan engine, according to the present disclosure.

FIG. 46 shows a table of material properties.

FIG. 47 shows a plot depicting disk bore radius change as a factor of airfoil weight change.

FIG. 48 shows a plot depicting disk bore width change as a factor of airfoil weight change.

FIG. 49 shows a schematic, partial cross-sectional view, taken along a centerline axis, of a gearbox for a turbofan engine, according to the present disclosure.

FIG. 50A shows a first order bending mode of a shaft.

FIG. 50B shows a second order bending mode of a shaft.

FIG. 50C shows a third order bending mode of a shaft.

FIG. 51 shows a schematic view of a turbofan engine, according to another embodiment.

FIG. 52 is a schematic view of an exemplary bearing damper assembly of a turbofan engine, taken along a longitudinal centerline axis of the turbofan engine, according to the present disclosure.

FIGS. 53A to 53I show a table of embodiments, according to the present disclosure.

FIG. 54A shows a plot depicting a range of a midshaft rating relative to a range of outer diameter redline speeds.

FIG. 54B shows a plot depicting a range of a midshaft rating relative to a range of length-diameter ratios.

FIG. 54C shows a plot depicting a range of a midshaft rating relative to a range of length-diameter ratios.

FIG. 55 represents, in graph form, a Midshaft Effective Flexural Rigidity (MEFR) as a function of a midshaft thickness of a low-pressure shaft of the turbofan engine, according to the present disclosure.

### DETAILED DESCRIPTION

Features, advantages, and aspects of the present disclosure are set forth or apparent from a consideration of the following detailed description, drawings, and claims. Moreover, the following detailed description is exemplary and intended to provide further explanation without limiting the scope of the disclosure as claimed.

Various aspects of the present disclosure are discussed in detail below. While specific aspects are discussed, this is done for illustration purposes only. A person skilled in the relevant art will recognize that other components and configurations may be used without departing from the present disclosure.

As used herein, the terms “first,” “second,” “third,” “fourth,” “fifth,” and “sixth” may be used interchangeably to distinguish one component from another and are not intended to signify location or importance of the individual components.

The terms “upstream” and “downstream” refer to the relative direction with respect to fluid flow in a fluid pathway. For example, “upstream” refers to the direction from which the fluid flows, and “downstream” refers to the direction to which the fluid flows.

The terms “forward” and “aft” refer to relative positions within a turbofan engine or vehicle and refer to the normal operational attitude of the turbofan engine or vehicle. More particularly, forward and aft are used herein with reference to a direction of travel of the vehicle and a direction of propulsive thrust of the turbofan engine.

As used herein, the terms “low,” “mid” (or “mid-level”), and “high,” or their respective comparative degrees (e.g., “lower” and “higher”, where applicable), when used with compressor, combustor, turbine, shaft, fan, or turbofan engine components, each refers to relative pressures, relative speeds, relative temperatures, or relative power outputs within an engine unless otherwise specified. For example, a “low-power” setting defines the engine or the combustor configured to operate at a power output lower than a “high-power” setting of the engine or the combustor, and a “mid-level power” setting defines the engine or the combustor configured to operate at a power output higher than a “low-power” setting and lower than a “high-power” setting. The terms “low,” “mid” (or “mid-level”) or “high” in such aforementioned terms may additionally, or alternatively, be understood as relative to minimum allowable speeds, pressures, or temperatures, or minimum or maximum allowable speeds, pressures, or temperatures relative to normal, desired, steady state, etc., operation of the engine. A mission cycle for a turbofan engine includes, for example, a low-power operation, a mid-level power operation, and a high-power operation. Low-power operation includes, for example, engine start, idle, taxiing, and approach. Mid-level power operation includes, for example, cruise. High-power operation includes, for example, takeoff and climb.

The various power levels of the turbofan engine are defined as a percentage of a sea level static (SLS) maximum engine rated thrust. Low power operation includes, for example, less than thirty percent (30%) of the SLS maximum engine rated thrust of the turbofan engine. Mid-level power operation includes, for example, thirty percent (30%) to eighty-five percent (85%) of the SLS maximum engine rated thrust of the turbofan engine. High power operation includes, for example, greater than eighty-five percent (85%) of the SLS maximum engine rated thrust of the turbofan engine. The values of the thrust for each of the low power operation, the mid-level power operation, and the high power operation of the turbofan engine are exemplary only, and other values of the thrust can be used to define the low power operation, the mid-level power operation, and the high power operation.

The terms “coupled,” “fixed,” “attached,” “connected,” and the like, refer to both direct coupling, fixing, attaching, or connecting, as well as indirect coupling, fixing, attaching, or connecting through one or more intermediate components or features, unless otherwise specified herein.

The singular forms “a,” “an,” and “the” include plural references unless the context clearly dictates otherwise.

As used herein, the terms “axial” and “axially” refer to directions and orientations that extend substantially parallel to a centerline of the turbofan engine. Moreover, the terms “radial” and “radially” refer to directions and orientations that extend substantially perpendicular to the centerline of the turbofan engine. In addition, as used herein, the terms “circumferential” and “circumferentially” refer to directions and orientations that extend arcuately about the centerline of the turbofan engine.

As used herein, a “turbofan engine” includes a core flowpath defined by a compressor section, a combustion section, and a turbine section, and a fan that directs air into the core flowpath, and rated for use in a regional aircraft, a narrow body aircraft, or a wide body aircraft. A turbofan engine rated for use on a regional aircraft will have a maximum takeoff thrust in a range from ten thousand pound-force to twenty thousand pound-force (10,000 lbf to 20,000 lbf). A turbofan engine rated for use on a narrow body aircraft will have a maximum takeoff thrust in a range from fifteen thousand pound-force to thirty thousand pound-force (15,000 lbf to 30,000 lbf). A turbofan engine rated for use on a wide body aircraft will have a maximum takeoff thrust in a range from forty thousand pound-force to one hundred ten thousand pound-force (40,000 lbf to 110,000 lbf).

As used herein, the term “cruise” or “cruising speed” refers to operation of a turbofan engine utilized to power an aircraft that may operate at a cruising speed when the aircraft levels after climbing to a specified altitude. A turbofan engine may operate at a cruising speed that is from 50% to 90% of a rated speed, such as from 70% to 80% of the rated speed. In some aspects, a cruising speed may be achieved at about 80% of full throttle, such as from about 50% to about 90% of full throttle, such as from about 70% to about 80% full throttle. As used herein, the term “cruise flight” refers to a phase of flight in which an aircraft levels in altitude after a climb phase and prior to descending to an approach phase. In various examples, cruise flight may take place at a cruise altitude up to approximately 65,000 ft. In certain examples, cruise altitude is in a range from approximately 28,000 ft. to approximately 45,000 ft. In yet other examples, cruise altitude is expressed in flight levels (FL) based on a standard air pressure at sea level, in which cruise flight is between FL280 and FL650. In another example, cruise flight is between FL280 and FL450. In still certain examples, cruise altitude is defined based at least on a barometric pressure, in which cruise altitude is in a range from approximately 4.85 psia to approximately 0.82 psia based on a sea-level pressure of approximately 14.70 psia and sea-level temperature at approximately 59 degrees Fahrenheit. In another example, cruise altitude is in a range from approximately 4.85 psia to approximately 2.14 psia. In certain examples, the ranges of cruise altitude defined by pressure may be adjusted based on a different reference sea-level pressure and/or sea-level temperature.

As used herein, the term “ducted engine” means a turbofan engine with a fan casing or nacelle that circumferentially surrounds the fan.

As used herein, an “unducted fan engine” or an “open fan engine” means a turbofan engine without a fan casing or a nacelle surrounding the fan.

Hereafter, the term “turbofan engine” will refer to either a “ducted engine” or an “open fan engine.”

As used herein, a “fan tip diameter” is defined as a diameter of a fan blade and is measured through the longitudinal centerline axis of the turbofan engine to a fan tip of the fan blade at an axial location of the blade where the diameter is a maximum.

As used herein, a Mach number is a ratio of the speed of the aircraft to the speed of sound in the surrounding airflow. The Mach number at cruise as defined herein is a maximum operating Mach number as provided by a Type Certificate Data Sheet (TCDS) for the turbofan engine.

An aircraft's quoted cruise Mach number is generally known in the industry to be applied during a “standard day” temperature day. Therefore, the temperature is a fixed value based on altitude according to the established International Standard Atmosphere (ISA) tables. High speed civil gas turbine powered transport aircraft quote their speed by Mach number and have set cruising altitudes based on their size and mission profile (e.g., smaller aircraft fly at lower altitudes). Turboprops and smaller aircraft may have their cruising speed quoted in knots such as VTAS (velocity true airspeed) or KCAS (knots calibrated air speed), where ambient temperature is considered. Engine performance can be modeled for “hot days” or “cold days” where the ambient temperature is hotter or cooler than standard day by a prescribed amount, but this is part of off-design performance. Further, between 36,000 and 80,000 feet, where most commercial aircraft cruise, the ambient temperature is actually constant.

As used herein, a “thrust bearing radius” of a radial thrust bearing is defined in the radial direction from the longitudinal centerline axis to a radial center of the radial thrust bearing. Particularly, the radial center of the radial thrust bearing is a radial center of the rolling elements of the radial thrust bearing.

As used herein, a “fan hub axial length” is an axial length, in the axial direction (e.g., parallel with the longitudinal centerline axis 112) from a fan hub tip of the fan hub to a pitch axis P of the fan blades of the fan.

As used herein, a “fan actuation system axial length” is an axial length, in the axial direction (e.g., parallel with the longitudinal centerline axis 112), from an axially forward-most surface of the fan actuation system to the pitch axis P of the fan blades of the fan.

As used herein, a “fan bearing axial length” is an axial length, in the axial direction (e.g., parallel with the longitudinal centerline axis 112) from the pitch axis P of the fan blades of the fan to an axial center of one or more fan bearings that support rotation of the fan shaft.

The term “leading edge” refers to components and/or surfaces which are oriented predominately upstream relative to the fluid flow of the system, and the term “trailing edge” refers to components and/or surfaces which are oriented predominately downstream relative to the fluid flow of the system.

As used herein, a “rolling element diameter” of a rolling element of the fan bearing is a distance of a straight line passing from side to side through a center of the rolling element.

As used herein, a “fan hub trailing edge radius” or “R_{FHTE}” of a fan hub is defined in the radial direction from the longitudinal centerline axis to the fan hub at a trailing edge of the fan blades.

As used herein, a “fan tip radius” of a fan blade is defined in the radial direction from the longitudinal centerline axis to the fan tip at the trailing edge of the fan blade.

As used herein, a “fan hub radius ratio” is defined as a ratio of the fan hub trailing edge radius R_{FHTE} to the fan tip radius of the fan blades.

As used herein, a “fan hub leading edge radius” or “R_{FHLE}” of a fan hub is defined in the radial direction from the longitudinal centerline axis to the fan hub at a leading edge of the fan blades.

As used herein, a “fan bearing radius” or “R_{FBRG}” of a fan bearing is defined as a distance along the radial direction from the longitudinal centerline axis of the turbofan engine to a central axis or a center point of the fan bearing.

As used herein, a “fan bearing radius ratio” or “R_{FHLE}:R_{FBRG}” is a ratio of the fan hub leading edge radius R_{FHLE} to the fan bearing radius R_{FBRG}.

The term “cooled cooling air system” is used herein to mean a system configured to provide a cooling airflow to one or more components exposed to a working gas flowpath of a turbofan engine at a location downstream of a combustor of the turbofan engine and upstream of an exhaust nozzle of the turbofan engine, the cooling airflow being in thermal communication with a heat exchanger for reducing a temperature of the cooling airflow at a location upstream of the one or more components.

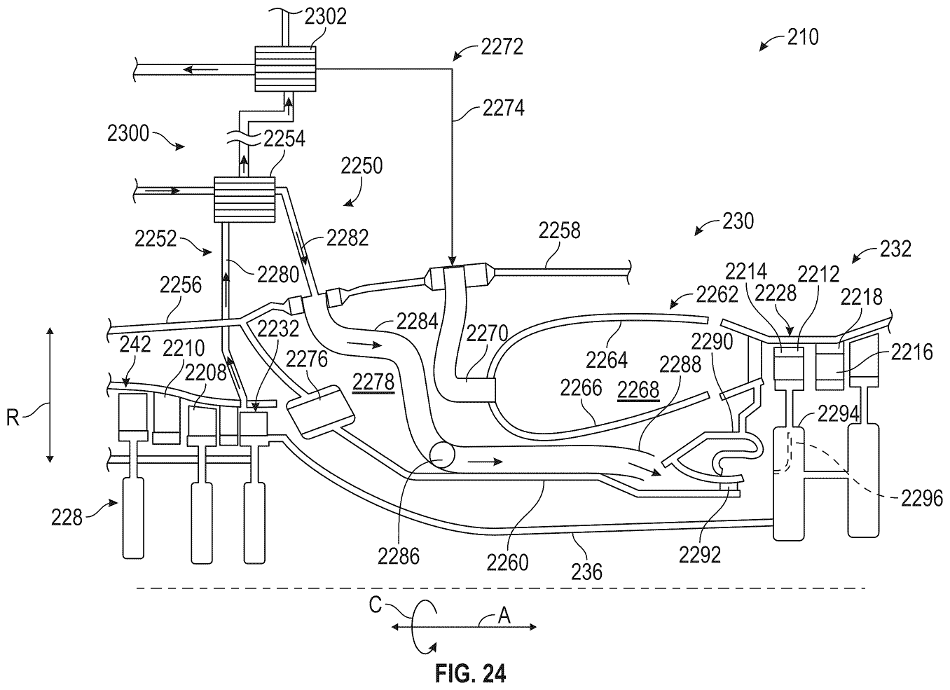

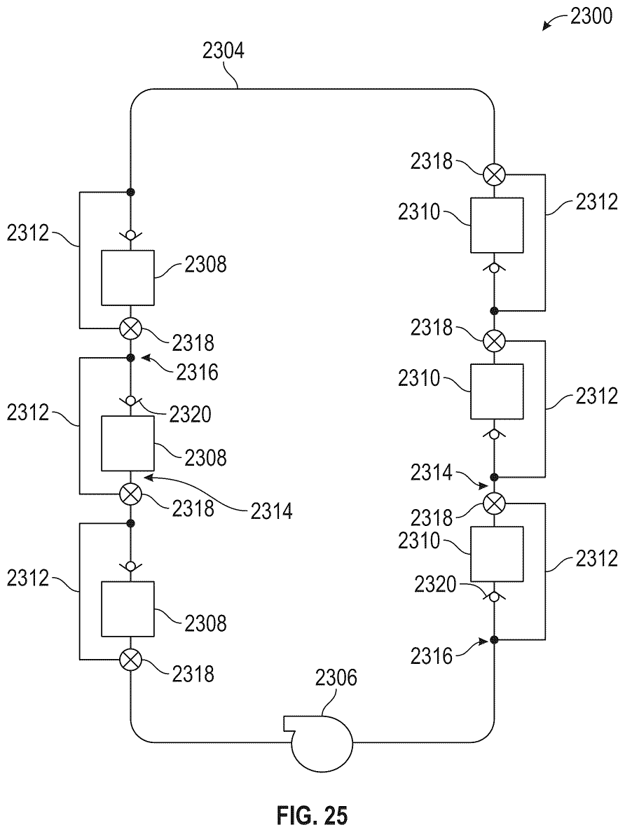

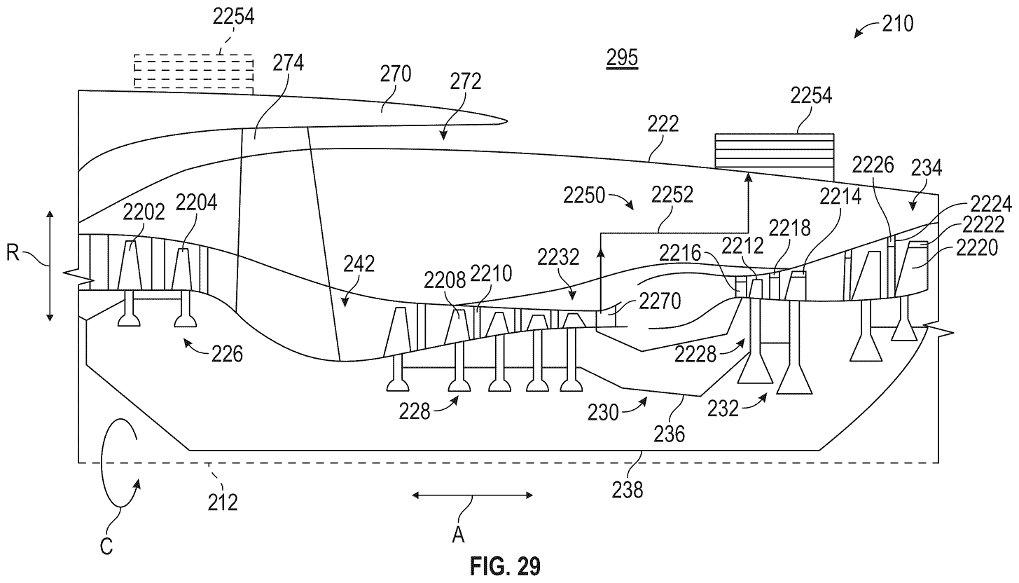

The cooled cooling air systems contemplated by the present disclosure may include a thermal bus cooled cooling air system (see, e.g., FIGS. 24 and 25) or a dedicated heat exchanger cooled cooling air system (i.e., a cooled cooling air system including a heat sink heat exchanger dedicated to the cooled cooling air system); a bypass heat exchanger cooled cooling air system having a heat sink heat exchanger thermally coupled to an airflow through a bypass passage (see, e.g., FIG. 29); an air-to-air cooled cooling air system (i.e., a cooled cooling air system having a heat sink heat exchanger configured to transfer heat to an airflow; see, e.g., FIG. 29); an oil-to-air cooled cooling air system (i.e., a cooled cooling air system having a heat sink heat exchanger configured to transfer heat to an oil flow); a fuel-to-air cooled cooling air system (i.e., a cooled cooling air system having a heat sink heat exchanger configured to transfer heat to a fuel flow, such as a Jet A fuel flow, a liquid hydrogen or hydrogen gas fuel flow, etc.; see, e.g., FIG. 24); or a combination thereof.

In one or more of the exemplary cooled cooling air systems described herein, the cooled cooling air system may receive the cooling air from a downstream end of a high-pressure compressor (i.e., a location closer to a last stage of the high-pressure compressor), an upstream end of the high-pressure compressor (i.e., a location closer to a first stage of the high-pressure compressor), a downstream end of a low-pressure compressor (i.e., a location closer to a last stage of the low-pressure compressor), an upstream end of the low-pressure compressor (i.e., a location closer to a first stage of the low-pressure compressor), a location between compressors, a bypass passage, a combination thereof, or any other suitable airflow source.

A “third stream” as used herein means a non-primary air stream capable of increasing fluid energy to produce a minority of total propulsion system thrust. A pressure ratio of the third stream may be higher than that of the primary propulsion stream (e.g., a bypass or a propeller driven propulsion stream). The thrust may be produced through a dedicated nozzle or through mixing of an airflow through the third stream with a primary propulsion stream or a core air stream, e.g., into a common nozzle.

In certain exemplary embodiments, an operating temperature of the airflow through the third stream may be less than a maximum compressor discharge temperature for the engine, and more specifically may be less than 350 degrees Fahrenheit (such as less than 300 degrees Fahrenheit, such as less than 250 degrees Fahrenheit, such as less than 200 degrees Fahrenheit, and at least as great as an ambient temperature). In certain exemplary embodiments, these operating temperatures may facilitate heat transfer to or from the airflow through the third stream and a separate fluid stream. Further, in certain exemplary embodiments, the airflow through the third stream may contribute less than 50% of the total engine thrust (and at least, e.g., 2% of the total engine thrust) at a takeoff condition, or, more particularly, while operating at a rated takeoff power at sea level, static flight speed, 86 degrees Fahrenheit ambient temperature operating conditions.

Furthermore, in certain exemplary embodiments, aspects of the airflow through the third stream (e.g., airstream, mixing, or exhaust properties), and thereby the aforementioned exemplary percent contribution to total thrust, may passively adjust during engine operation or be modified purposefully through use of engine control features (such as fuel flow, electric machine power, variable stators, variable inlet guide vanes, valves, variable exhaust geometry, or fluidic features) to adjust or optimize overall system performance across a broad range of potential operating conditions.

The term “takeoff power level” refers to a power level of a turbofan engine used during a takeoff operating mode of the turbofan engine during a standard day operating condition.

The term “standard day operating condition” refers to ambient conditions of sea level altitude, 59 degrees Fahrenheit, and 60 percent relative humidity.

The term “propulsive efficiency” refers to an efficiency with which the energy contained in an engine's fuel is converted into kinetic energy for the vehicle incorporating the engine, to accelerate the engine, or to replace losses due to aerodynamic drag or gravity.

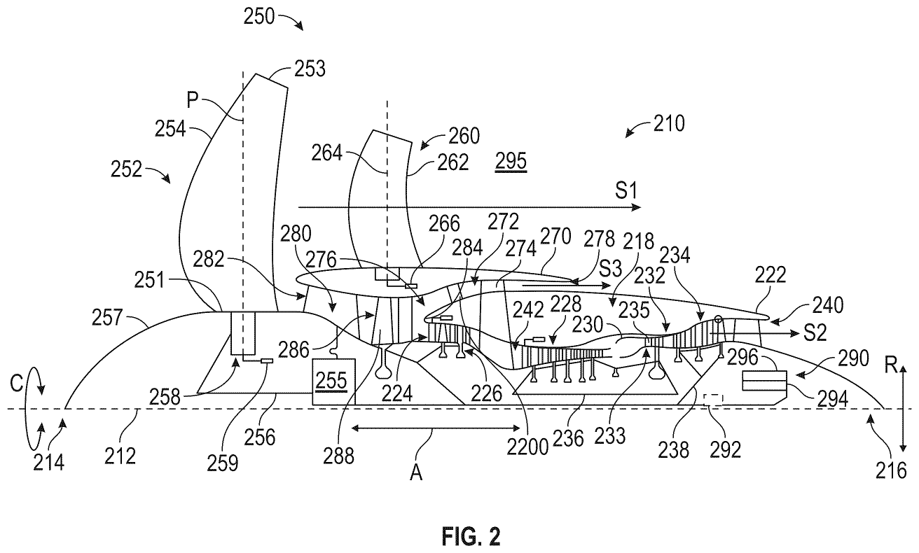

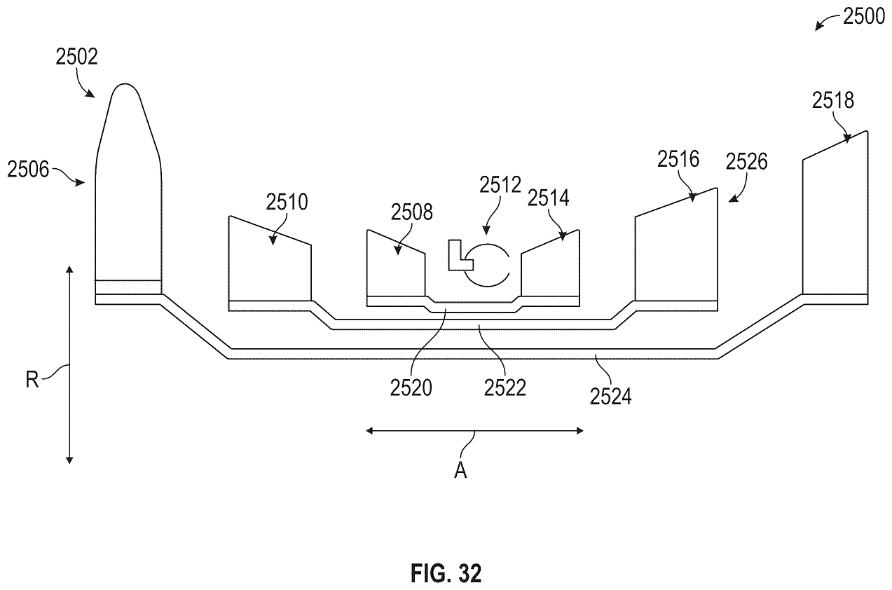

The term redline exhaust gas temperature (referred to herein as “redline EGT”) refers to a maximum permitted takeoff temperature documented in a Federal Aviation Administration (“FAA”)-type certificate data sheet. For example, in certain exemplary embodiments, the term redline EGT may refer to a maximum permitted takeoff temperature of an airflow after a first stage stator downstream of an HP turbine of an engine that the engine is rated to withstand. For example, with reference to the exemplary turbofan engine 210 discussed below with reference to FIG. 2, the term redline EGT refers to a maximum permitted takeoff temperature of an airflow after the first HP turbine stator vane 2216 downstream of the last stage of rotor blades 2212 of the HP turbine 232 (at location 2230 into the first of the plurality of LP turbine rotor blades 2220). In embodiments wherein the engine is configured as a three-spool engine (as compared to the two-spool engine of FIG. 2; see FIG. 32), the term redline EGT refers to a maximum permitted takeoff temperature of an airflow after the first stator downstream of the last stage of rotor blades of the intermediate speed turbine (see the second turbine 2516 of the turbofan engine 2500 of FIG. 32). The term redline EGT is sometimes also referred to as an indicated turbine exhaust gas temperature or indicated turbine temperature.

The term “propulsive system” refers generally to a thrust-producing system, which thrust is produced by a propulsor, and the propulsor provides the thrust using an electrically-powered motor(s), a heat engine such as a compressor, a combustor, and a turbine, or a combination of electrical motor(s) and a compressor, a combustor, or a turbine.

As used herein, “redline speed” means the maximum expected rotational speed of a shaft during normal operation of an engine. The redline speed may be expressed in terms of rotations per second in Hertz (Hz), rotations per minute (RPM), or as a linear velocity of the outer diameter of the shaft in terms of feet per second. For a turbofan engine that has a high-pressure shaft and a low-pressure shaft, both the high-pressure shaft and the low-pressure shaft have redline speeds.

As used herein, “maximum operating speed” is minimum rotational speed of the shaft to achieve a maximum thrust of the turbofan engine and is less than the redline speed for the turbofan engine. In one embodiment, the maximum operating speed of the shaft is 1% to 5% less than the redline speed. For example, the redline speed of the shaft can be 10,000 RPM and the maximum operating speed is 9,500 RPM to achieve the maximum thrust (e.g., during takeoff of the aircraft). In some embodiments, the maximum operating speed of the shaft is 1.5% to 2% less than the redline speed.

As used herein, “critical speed” means a rotational speed of the shaft that is about the same as the fundamental, or natural frequency of a first order bending mode of the shaft (e.g., the shaft rotates at eighty Hz and the first-order modal frequency is eighty Hertz). When the shaft rotates at the critical speed, the shaft is expected to have a maximum amount of deflection, hence instability, due to excitation of the first order bending mode of the shaft. The critical speed may be expressed in terms of rotations per second in Hertz (Hz), rotations per minute (RPM), or as a linear velocity of the outer diameter of the shaft in terms of feet per second.

As used herein, “critical frequency” and “fundamental frequency” are referred to interchangeably and refer to the fundamental, or natural frequency, of the first order bending mode of a low-pressure or high pressure shaft supported at their ends by bearings.

The term “subcritical speed” refers to a shaft redline speed that is less than the fundamental, or natural frequency of the first order bending mode of the shaft (e.g., the shaft rotates at a redline speed of 70 Hz while the first-order modal frequency is about 80 Hertz). When the rotational speed is subcritical the shaft is more stable than when rotating at a critical speed. A “subcritical shaft” is a shaft that has a redline speed below the critical speed of the shaft.

The term “supercritical speed” refers to a shaft rotational speed that is above the fundamental, or natural frequency of the first order bending mode of the shaft (e.g., the shaft rotates at eighty Hz while the first-order modal frequency is about seventy Hertz). A supercritical shaft is less stable than a subcritical shaft because the shaft speed can pass through the critical speed since its fundamental mode is below the redline speed. A “supercritical shaft” is a shaft that has a redline speed above the critical speed of the shaft.

The term “critical modal frequency” for a gearbox or F_{GBX} is a natural frequency of vibration for a gearbox assembly, characterized by modal properties (mode shape, strain energy in various supporting structural, etc.) producing lateral inertial bending or displacement reaction forces through a gearbox sun-gear—midshaft coupling when the gearbox assembly. The gearbox assembly can produce a significant dynamic response characterized by these modal properties when there is an external force applied with an excitation frequency at or near F_{GBX} through the sun gear—midshaft coupling (e.g. by motion of the midshaft) or when the gearbox assembly undergoes a periodic acceleration at or near F_{GBX}.

The term “casing” herein refers to the structure that defines an airflow path (e.g., wall of duct, or casing). A mounting to the casing may be a direct bolted connection or through a load bearing frame.

The term “composite,” as used herein, is a material made by combining two or more distinct materials with different chemical properties and physical properties and having a finite interface between the two or more distinct materials. One of the distinct materials is a reinforcement, or reinforcing phase, while the other is a matrix phase. Examples of a composite material can be, but not limited to, a polymer matrix composite (PMC), a ceramic matrix composite (CMC), a metal matrix composite (MMC), carbon fibers, a polymeric resin, a thermoplastic, bismaleimide (BMI), a polyimide materials, an epoxy resin, glass fibers, and silicon matrix materials.

As used herein, a “composite” component refers to a structure or a component including any suitable composite material. Composite components, such as a composite airfoil, can include several layers or plies of composite material. The layers or the plies can vary in stiffness, material, and dimension to achieve the desired composite component or the desired composite portion of a component having a predetermined weight, size, stiffness, and strength.

One or more layers of adhesive can be used in forming or coupling composite components. Adhesives can include resin and phenolics, wherein the adhesive can require curing at elevated temperatures or other hardening techniques.

As used herein, PMC refers to a class of materials. By way of example, the PMC material is defined in part by a prepreg, which is a reinforcement material pre-impregnated with a polymer matrix material, such as thermoplastic resin. Non-limiting examples of processes for producing thermoplastic prepregs include hot melt pre-pregging in which the fiber reinforcement material is drawn through a molten bath of resin and powder pre-pregging in which a resin is deposited onto the fiber reinforcement material, by way of non-limiting example electrostatically, and then adhered to the fiber, by way of non-limiting example, in an oven or with the assistance of heated rollers. The prepregs can be in the form of unidirectional tapes or woven fabrics, which are then stacked on top of one another to create the number of stacked plies desired for the part.

Multiple layers of prepreg are stacked to the proper thickness and orientation for the composite component and then the resin is cured and solidified to render a fiber reinforced composite part. Resins for matrix materials of PMCs can be generally classified as thermosets or thermoplastics. Thermoplastic resins are generally categorized as polymers that can be repeatedly softened and flowed when heated and hardened when sufficiently cooled due to physical rather than chemical changes. Notable example classes of thermoplastic resins include nylons, thermoplastic polyesters, polyaryletherketones, and polycarbonate resins. Specific example of high performance thermoplastic resins that have been contemplated for use in aerospace applications include, polyetheretherketone (PEEK), polyetherketoneketone (PEKK), polyetherimide (PEI), polyaryletherketone (PAEK), and polyphenylene sulfide (PPS). In contrast, once fully cured into a hard rigid solid, thermoset resins do not undergo significant softening when heated, but instead thermally decompose when sufficiently heated. Notable examples of thermoset resins include epoxy, bismaleimide (BMI), and polyimide resins.

Instead of using a prepreg, in another non-limiting example, with the use of thermoplastic polymers, it is possible to utilize a woven fabric. Woven fabric can include, but is not limited to, dry carbon fibers woven together with thermoplastic polymer fibers or filaments. Non-prepreg braided architectures can be made in a similar fashion. With this approach, it is possible to tailor the fiber volume of the part by dictating the relative concentrations of the thermoplastic fibers and reinforcement fibers that have been woven or braided together. Additionally, different types of reinforcement fibers can be braided or woven together in various concentrations to tailor the properties of the part. For example, glass fibers, carbon fibers, and thermoplastic fibers could all be woven together in various concentrations to tailor the properties of the part. The carbon fibers provide the strength of the system, the glass fibers can be incorporated to enhance the impact properties, which is a design characteristic for parts located near the inlet of the engine, and the thermoplastic fibers provide the binding for the reinforcement fibers.

In yet another non-limiting example, resin transfer molding (RTM) can be used to form at least a portion of a composite component. Generally, RTM includes the application of dry fibers or matrix material to a mold or cavity. The dry fibers or matrix material can include prepreg, braided material, woven material, or any combination thereof.

Resin can be pumped into or otherwise provided to the mold or cavity to impregnate the dry fibers or matrix material. The combination of the impregnated fibers or matrix material and the resin are then cured and removed from the mold. When removed from the mold, the composite component can require post-curing processing.

RTM can be a vacuum assisted process. That is, the air from the cavity or mold can be removed and replaced by the resin prior to heating or curing. The placement of the dry fibers or matrix material can be manual or automated.

The dry fibers or matrix material can be contoured to shape the composite component or direct the resin. Optionally, additional layers or reinforcing layers of material differing from the dry fiber or matrix material can also be included or added prior to heating or curing.

As used herein, the term “ceramic matrix composite” (“CMC”) refers to a subgroup of composite materials and a subgroup of ceramics. The terms “CMC” and “CMC material” are used interchangeably herein. When the engine component (e.g., the higher pressure turbine module, nozzle, or blade thereof) comprises or includes “CMC” or “CMC material,” it is understood that the engine component may include one of, or combinations of one or more of the ceramic matrix composite materials described herein. Such engine component may also include non-ceramic matrix composite materials, such as a metal alloy (e.g., a CMC material for an airfoil and separate disk with dovetail slot made from a metal alloy). Reference to a “first” or “second” or “third” CMC material does not preclude the materials from including multiple CMC materials, different CMC materials, or the same CMC materials.

More specifically, CMC refers to a class of materials that includes a reinforcing material (e.g., reinforcing fibers) surrounded by a ceramic matrix phase. Generally, the reinforcing fibers provide structural integrity to the ceramic matrix. Some examples of matrix materials of CMCs can include, but are not limited to, non-oxide silicon-based materials (e.g., silicon carbide, silicon nitride, or mixtures thereof), oxide ceramics (e.g., silicon oxycarbides, silicon oxynitrides, aluminum oxide (Al₂O₃), silicon dioxide (SiO₂), aluminosilicates, or mixtures thereof), or mixtures thereof. Optionally, ceramic particles (e.g., oxides of Si, Al, Zr, Y, and combinations thereof) and inorganic fillers (e.g., pyrophyllite, wollastonite, mica, talc, kyanite, and montmorillonite) may also be included within the CMC matrix.

Some examples of reinforcing fibers of CMCs can include, but are not limited to, non-oxide silicon-based materials (e.g., silicon carbide, silicon nitride, or mixtures thereof), non-oxide carbon-based materials (e.g., carbon), oxide ceramics (e.g., silicon oxycarbides, silicon oxynitrides, aluminum oxide (Al₂O₃), silicon dioxide (SiO₂), aluminosilicates such as mullite, or mixtures thereof), or mixtures thereof.

Generally, particular CMCs may be referred to as their combination of type of fiber/type of matrix. For example, C/SiC for carbon-fiber-reinforced silicon carbide; SiC/SiC for silicon carbide-fiber-reinforced silicon carbide, SiC/SiN for silicon carbide fiber-reinforced silicon nitride; SiC/SiC—SiN for silicon carbide fiber-reinforced silicon carbide/silicon nitride matrix mixture, etc. In other examples, the CMCs may include a matrix and reinforcing fibers comprising oxide-based materials such as aluminum oxide (Al₂O₃), silicon dioxide (SiO₂), aluminosilicates, and mixtures thereof. Aluminosilicates can include crystalline materials such as mullite (3Al₂O₃·2SiO₂), as well as glassy aluminosilicates.

In certain embodiments, the reinforcing fibers may be bundled and/or coated prior to inclusion within the matrix. For example, bundles of the fibers may be formed as a reinforced tape, such as a unidirectional reinforced tape. A plurality of the tapes may be laid up together to form a preform component. The bundles of fibers may be impregnated with a slurry composition prior to forming the preform or after formation of the preform. The preform may then undergo thermal processing and subsequent chemical processing to arrive at a component formed of a CMC material having a desired chemical composition. For example, the preform may undergo a cure or burn-out to yield a high char residue in the preform, and subsequent melt-infiltration (“MI”) with silicon, or a cure or pyrolysis to yield a silicon carbide matrix in the preform, and subsequent chemical vapor infiltration (“CVI”) with silicon carbide. Additional steps may be taken to improve densification of the preform, either before or after chemical vapor infiltration, by injecting it with a liquid resin or polymer followed by a thermal processing step to fill the voids with silicon carbide. CMC material as used herein may be formed using any known methods or hereinafter developed including but not limited to melt infiltration, chemical vapor infiltration, polymer impregnation pyrolysis (PIP) and any combination thereof.

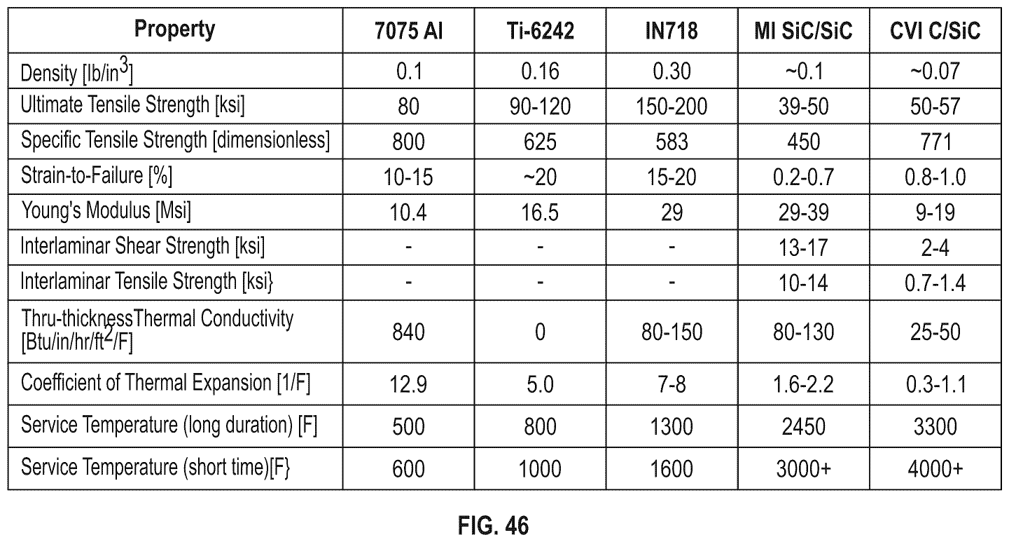

Such materials, along with certain monolithic ceramics (i.e., ceramic materials without a reinforcing material), are particularly suitable for higher temperature applications. Additionally, these ceramic materials are lightweight compared to metal alloys (e.g., superalloys), yet can still provide strength and durability to the component made therefrom. Therefore, such materials are currently being considered for many gas turbine components used in higher temperature sections of turbofan engines, such as airfoils (e.g., turbines, and vanes), combustors, shrouds and other like components, that would benefit from the lighter-weight and higher temperature capability these materials can offer. FIG. 46 compares properties of CVI type and MI type CMC materials to metal alloys.

The term “metallic” as used herein is indicative of a material that includes metal such as, but not limited to, titanium, iron, aluminum, stainless steel, and nickel alloys. A metallic material or an alloy can be a combination of at least two or more elements or materials, where at least one is a metal.

As used herein, an alloy is “based” on a particular element when that element is present in the alloy at the greatest weight percent, by total weight of the alloy, of all elements contained in the alloy. For example, an iron-based alloy has a higher weight percentage of iron than any other single element present in the alloy. In some embodiments, the metal alloy detailed herein is chosen from iron-based alloys, titanium-based alloys, nickel-based alloys, cobalt-based alloys, and aluminum-based alloys. In some embodiments, the iron-based alloy is a steel. In some embodiments, the alloy includes at least one alloy chosen from high strength steel, titanium-based alloys, and nickel-based alloys. In some embodiments, the high strength steel, titanium-based alloys, and nickel-based alloys are chosen from Special Metals Corporation's Inconel® 600, Special Metals Corporation's Inconel® 722 and Special Metals Corporation's Inconel® 718, Special Metals Corporation's Nimonic®, Teledyne Allvac's Rene® 88DT, Teledyne Allvac's Rene® 104, Teledyne Allvac's Rene® 95, Teledyne Allvac's Rene® 100, Teledyne Allvac's Rene® 80, Teledyne Allvac's Rene® 77, Special Metals Corporation's Udimet® 500, Haynes International's Hastelloy X, and Haynes International's Haynes® 188. In some embodiments, the metal alloy is Rene® 65.

Here and throughout the specification and claims, range limitations are combined and interchanged. Such ranges are identified and include all the sub-ranges contained therein unless context or language indicates otherwise. For example, all ranges disclosed herein are inclusive of the endpoints, and the endpoints are independently combinable with each other.

The present disclosure provides for turbofan engines that have a variable pitch fan. Such engines include a fan actuation system that includes one or more actuators for changing a pitch of fan blades of the variable pitch fan. The fan actuation system typically includes a hydraulic system that supplies hydraulic fluid to one or more chambers to actuate the actuators. The actuators are coupled to the fan blades and actuation of the actuators causes the fan blades to rotate about a pitch axis P to change the pitch of the fan blades. Some fan actuation systems are designed for turboprop engines that include a propeller, rather than a fan.

Turboprop engines produce less thrust than turbofan engines. Turboprop engines typically provide cruise speeds for an aircraft with a Mach number that is less than 0.7 and have fewer than ten propeller blades, such as fewer than eight propeller blades or fewer than five propeller blades. Turbofan engines include ten or more fan blades that extend from a disk and provide cruise speeds for an aircraft with a Mach number that is 0.7 or greater. To achieve these higher speeds, the fan aerodynamics for the turbofan engines are different than the propeller aerodynamics for turboprop engines, resulting in the turbofan engines having more fan blades for aerodynamic efficiency at higher Mach speeds. Turbofan engines with variable pitch fan blades also benefit from guide vanes, such as outlet guide vanes behind the fan blades, and/or inlet guide vanes forward of the fan, to reduce losses at higher speeds.

The loading environment associated with the variable pitch mechanism for turboprop engines is less than the loading environment presented for a variable pitch turbofan engine. There is a lower disk loading capability requirement on parts (e.g., trunnion, bearings, gearing, actuators, etc.) and associated less actuation force resources needed (e.g., hydraulic fluid) to operate a variable pitch turboprop as compared to a variable pitch turbofan engine. At the same time, the available space, the desirable space, or the volume in that part of the engine for the higher-load-carrying fan blade pitch actuation system and the greater number of blades of a turbofan engine is not correspondingly larger than the space available for the lower-load-carrying fan blade pitch actuation system with fewer fan blades of a turboprop. Turbofan engines having variable pitch fan blades require more compactness for the pitch change system, relative to a turboprop, when considering the larger space requirements assumed if one were to simply scale-up a pitch actuation system for a turboprop for use in a turbofan engine. This can be realized when one considers that a larger, stronger structure is needed to support the more numerous blades and react the higher pitch loads associated with a turbofan engine. One cannot simply scale-up the space available for a pitch change mechanism and associated structure, and also scale up to account for the impact of a significantly increased number of blades when designing a variable pitch turbofan engine. Accommodation of the pitch change mechanism, trunnion, and associated structure for holding and articulating the fan blades within an engine housing therefore presents unique challenges for the turbofan engine in terms of the available space. The existing pitch change mechanisms and structure used to support blades in turboprop engines are not faced with similar challenges and therefore provide limited insight into how to implement a variable pitch mechanism within the more limited space, and more numerous fan blade system of a turbofan engine.

Many actuation systems for turboprop engines include a counterweight system to help pitch the propeller blades (e.g., the weight counteracts inertial loading associated with turning the propeller blade). For turbofan engines, a counterweight system may not be feasible because there is not the space available to accommodate the counterweight system. Thus, an alternative is needed to articulate the blades without exceeding load limits, which implies more compactness given the limited space available. Additionally, it was realized that pitch lock devices to lock the more-numerous fan blades in a feather position for turbofan engines, in case of fan actuation system failure, need to be considered when determining the minimum size needed for the turbofan engine fan actuation system. Additionally, it should be realized the very different types of inlets between a turboprop engine, on the one hand, and turbofan engine on the other hand, impact the amount of available space within the engine housing. Inlets to the turbofan engine (e.g., inlet to the hot gas path through the compressor section, the combustion section, and the turbine section) of a turboprop engine have a relatively narrow circumferential extent (sometimes called “chin” inlets). As such, there is more space available for a pitch change mechanism. Inlets to turbofan engines, however, have annular inlets, which take up more space within the engine housing than the more limited circumferential extent occupied by a turboprop inlet. Accommodating both a pitch change mechanism and annular inlet poses a unique challenge for a turbofan engine with variable pitch fan blades.

For at least these reasons, the loading on a pitch change mechanism and packaging of this system for a turbofan engine having greater number of blades than a turboprop engine presents challenges. It is not simply a matter of scaling-up the space available and size of component parts used in a turboprop engine fan actuation system. Indeed, it has been found that the problem is both unique to the engine type and complex—not amenable to a ready solution based on pre-existing variable pitch turboprop engine design. The inventors, seeking a need to find a solution to this problem, designed and tested several different turbofan engine architectures in an effort to arrive at a fan actuation system that met both the higher loading and more compact space requirements of a turbofan engine.

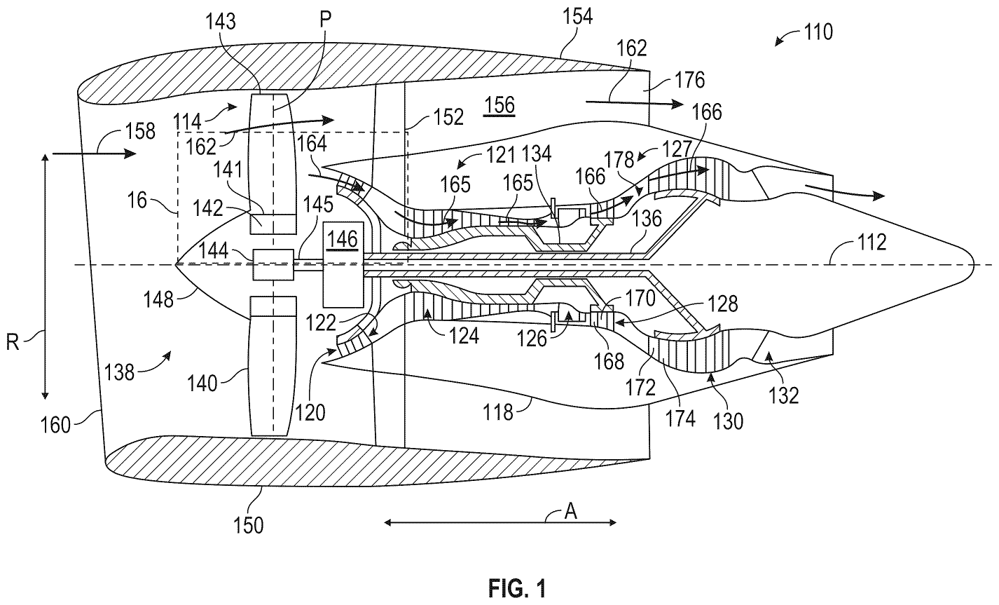

Referring now to the drawings, FIG. 1 is a schematic cross-sectional diagram of a turbofan engine 110, taken along a longitudinal centerline axis 112 of the turbofan engine 110, according to an aspect of the present disclosure. As shown in FIG. 1, the turbofan engine 110 defines an axial direction A (extending parallel to the longitudinal centerline axis 112 provided for reference) and a radial direction R that is normal to the axial direction A. In general, the turbofan engine 110 includes, in serial flow relationship, a fan assembly 114, a compressor section 121, a combustion section 126, and a turbine section 127. The compressor section 121, the combustion section 126, and the turbine section 127 are substantially enclosed within a core cowl 118 that is substantially tubular and defines a core inlet 120 having an annular shape that is annular about the longitudinal centerline axis 112. As schematically shown in FIG. 1, the compressor section 121 includes a booster or a low-pressure (LP) compressor 122 followed downstream by a high-pressure (HP) compressor 124. The combustion section 126 is downstream of the compressor section 121 and includes a combustor. The turbine section 127 is downstream of the combustion section 126 and includes a high-pressure (HP) turbine 128 followed downstream by a low-pressure (LP) turbine 130, also referred to as a power turbine. The turbofan engine 110 also includes a core exhaust nozzle 132 that is downstream of the turbine section 127. The turbofan engine 110 further includes a high-pressure (HP) shaft 134, also referred to as a high-speed shaft, that drivingly connects the HP turbine 128 to the HP compressor 124. The HP turbine 128 and the HP compressor 124 rotate in unison through the HP shaft 134. The turbofan engine 110 includes a low-pressure (LP) shaft 136, also referred to as a low-speed shaft, that drivingly connects the LP turbine 130 to the LP compressor 122. The LP turbine 130 and the LP compressor 122 rotate in unison through the LP shaft 136. The compressor section 121, the combustion section 126, the turbine section 127, and the core exhaust nozzle 132 together define a core air flow path.

In FIG. 1, the fan assembly 114 includes a fan 138 (e.g., a variable pitch fan) having a plurality of fan blades 140 coupled to a fan disk 142 in a spaced apart manner. As depicted in FIG. 1, the fan blades 140 extend outwardly from the fan disk 142 generally along the radial direction R from a fan root 141 to a fan tip 143. Each fan blade 140 is rotatable relative to the fan disk 142 about a pitch axis P by virtue of the fan blades 140 being operatively coupled to a fan actuation system 144 configured to collectively vary the pitch of the fan blades 140 in unison, as detailed further below. The fan actuation system 144 is disposed within a fan hub 148. The fan blades 140, the fan disk 142, and the fan actuation system 144 are together rotatable about the longitudinal centerline axis 112 via a fan shaft 145 that is powered by the LP shaft 136 across a power gearbox, also referred to as a gearbox assembly 146.

The gearbox assembly 146 is shown schematically in FIG. 1. The gearbox assembly 146 includes a plurality of gears for adjusting the rotational speed of the fan shaft 145 and, thus, the fan 138 relative to the LP shaft 136. The gearbox assembly 146 has a gear ratio in a range from 3.5:1 to 5:1 for a ducted engine (e.g., the turbofan engine 110). The LP shaft 136, the gearbox assembly 146, and the fan shaft 145 are disposed in an in-line configuration such that the LP shaft 136, the gearbox assembly 146, and the fan shaft 145 are coaxial and are each disposed about the longitudinal centerline axis 112. The in-line configuration helps to reduce the space needed within the turbofan engine 110 for the gearbox assembly 146 and allows a greater amount of torque to be transferred from the LP shaft 136 to the fan shaft 145 through the gearbox assembly 146 as compared to turboprop engines in which the gearbox assembly is typically disposed in a stepped configuration and is not coaxial with the LP shaft and the fan shaft.

The fan disk 142 is covered by a fan hub 148 that rotates and is aerodynamically contoured to promote an airflow through the plurality of fan blades 140. In addition, the fan assembly 114 includes an annular fan casing or a nacelle 150 that circumferentially surrounds the fan 138 and at least a portion of the core cowl 118. In this way, the turbofan engine 110 is a ducted engine. The nacelle 150 is supported relative to the core cowl 118 by a plurality of fan guide vanes 152, also referred to as outlet guide vanes, that is spaced circumferentially about the nacelle 150. Moreover, a downstream section 154 of the nacelle 150 extends over an outer portion of the core cowl 118 to define a bypass airflow passage 156 therebetween.

During operation of the turbofan engine 110, a volume of air 158 enters the turbofan engine 110 through an inlet 160 of the nacelle 150 or the fan assembly 114. As the volume of air 158 passes across the fan blades 140, a first portion of air, referred to as bypass air 162, is directed or routed into the bypass airflow passage 156, and a second portion of air, referred to as core air 164, is directed or is routed into the upstream section of the core air flow path, or, more specifically, into the core inlet 120 of the LP compressor 122. The ratio between the bypass air 162 and the core air 164 is commonly known as a bypass ratio. The pressure of the core air 164 is then increased by the LP compressor 122 to form compressed air 165, and the compressed air 165 is routed through the HP compressor 124 and into the combustion section 126, where the compressed air 165 is mixed with fuel and burned to generate combustion gases 166.

The combustion gases 166 are routed into the HP turbine 128 and expanded through the HP turbine 128 where a portion of thermal energy and kinetic energy from the combustion gases 166 is extracted via one or more stages of HP turbine stator vanes 168 that are coupled to the core cowl 118 and HP turbine rotor blades 170 that are coupled to the HP shaft 134. This causes the HP shaft 134 to rotate, thereby supporting operation of the HP compressor 124 (e.g., a self-sustaining cycle). In this way, the combustion gases 166 do work in the HP turbine 128 to cause the HP turbine rotor blades 170 (and the HP shaft 134) to rotate at a sufficient rate to maintain the compression ratio of the HP compressor 124 (e.g., self-sustaining cycle). The combustion gases 166 are then routed into the LP turbine 130 and expanded through the LP turbine 130. Here, a second portion of the thermal energy and the kinetic energy is extracted from the combustion gases 166 via one or more stages of LP turbine stator vanes 172 that are coupled to the core cowl 118 and LP turbine blades 174 that are coupled to the LP shaft 136. This causes the LP shaft 136 to rotate, thereby supporting operation of the LP compressor 122 and rotation of the fan 138 via the gearbox assembly 146 (e.g., a self-sustaining cycle). In this way, the combustion gases 166 do work in the LP turbine 130 to cause the LP turbine blades 174 (and the LP shaft 136) to rotate.

The combustion gases 166 are subsequently routed through the core exhaust nozzle 132 to provide propulsive thrust at a thrust level of the turbofan engine 110. The thrust level of the turbofan engine 110 includes a cruise thrust level defined by a cruise Mach number M_{cruise} that is the Mach number of the turbofan engine 110 at cruise conditions, or mid-level power conditions. Simultaneously, the bypass air 162 is directed through the bypass airflow passage 156 before being exhausted from a fan exhaust nozzle 176 of the turbofan engine 110, also providing propulsive thrust. The HP turbine 128, the LP turbine 130, and the core exhaust nozzle 132 at least partially define a hot gas path 178 for routing the combustion gases 166 through the turbofan engine 110.

The turbofan engine 110 depicted in FIG. 1 is by way of example only. In other aspects, the turbofan engine 110 may have other suitable configurations. In other aspects, any other suitable number or configuration of compressors, turbines, shafts, or a combination thereof may be provided. The turbofan engine 110 may also be a direct drive engine, which does not have a power gearbox. The fan speed is the same as the LP shaft speed for a direct drive engine. In still other aspects, aspects of the present disclosure may be incorporated into other suitable turbofan engines, such as, for example, propfan (e.g., unducted fan) engines.

FIG. 2 shows a schematic view of an unducted, three-stream, turbofan engine 210 for an aircraft, that may incorporate one or more aspects of the present disclosure. In this way, the turbofan engine 210 is an unducted fan engine or an open fan engine. The turbofan engine 210 is a “three-stream engine” in that its architecture provides three distinct streams (labeled S1, S2, and S3) of thrust-producing airflow during operation, as detailed further below.

As shown in FIG. 2, the turbofan engine 210 defines an axial direction A, a radial direction R, and a circumferential direction C. Moreover, the turbofan engine 210 defines a longitudinal centerline axis 212 that extends along the axial direction A. In general, the axial direction A extends parallel to the longitudinal centerline axis 212, the radial direction R extends outward from, and inward to, the longitudinal centerline axis 212 in a direction orthogonal to the axial direction A, and the circumferential direction C extends three hundred sixty degrees (360°) around the longitudinal centerline axis 212. The turbofan engine 210 extends between a forward end 214 and an aft end 216, e.g., along the axial direction A.

The turbofan engine 210 includes a fan assembly 250, a compressor section, a combustion section, a turbine section, and an exhaust section. Particularly, as shown in FIG. 2, the turbofan engine 210 includes an engine core 218 and a core cowl 222 that annularly surrounds the compressor section, the combustion section, and the turbine section. The core cowl 222 define a core inlet 224 having an annular shape that is annular about the longitudinal centerline axis 212. The core cowl 222 further encloses and supports a low-pressure (LP) compressor 226 (also referred to as a booster) for pressurizing the air that enters the turbofan engine 210 through the core inlet 224. A high-pressure (HP) compressor 228 receives pressurized air from the LP compressor 226 and further increases the pressure of the air. The pressurized air flows downstream to a combustor 230 where fuel is injected into the pressurized air and ignited to raise the temperature and the energy level of the pressurized air, thereby generating combustion gases.

The combustion gases flow from the combustor 230 downstream to a high-pressure (HP) turbine 232. The HP turbine 232 drives the HP compressor 228 through a first shaft, also referred to as a high-pressure (HP) shaft 236 (also referred to as a “high-speed shaft”). In this regard, the HP turbine 232 is drivingly coupled with the HP compressor 228. Together, the HP compressor 228, the combustor 230, and the HP turbine 232 define the engine core 218. The combustion gases then flow to a power turbine or a low-pressure (LP) turbine 234. The LP turbine 234 drives the LP compressor 226 and components of the fan assembly 250 through a second shaft, also referred to as a low-pressure (LP) shaft 238 (also referred to as a “low-speed shaft”). In this regard, the LP turbine 234 is drivingly coupled with the LP compressor 226 and components of the fan assembly 250. The LP shaft 238 is coaxial with the HP shaft 236 in FIG. 2. After driving each of the HP turbine 232 and the LP turbine 234, the combustion gases exit the turbofan engine 210 through a core exhaust nozzle 240. The turbofan engine 210 defines a core flowpath, also referred to as a core duct 242, that extends between the core inlet 224 and the core exhaust nozzle 240. The core duct 242 is an annular duct positioned generally inward of the core cowl 222 along the radial direction R.

The fan assembly 250 includes a fan 252, also referred to as a primary fan. In FIG. 2, the fan 252 is an open rotor fan, also referred to as an unducted fan. However, in other aspects, the fan 252 may be ducted, e.g., by a fan casing or a nacelle circumferentially surrounding the fan 252, similar to the aspect of FIG. 1. The fan 252 includes a plurality of fan blades 254 (only one shown in FIG. 2) that extends in the radial direction R from a fan root 251 to a fan tip 253. The plurality of fan blades 254 is rotatable about the longitudinal centerline axis 212 via a fan shaft 256. As shown in FIG. 2, the fan shaft 256 is coupled with the LP shaft 238 via a speed reduction gearbox or a power gearbox, also referred to as a gearbox assembly 255, e.g., in an indirect-drive configuration.

The gearbox assembly 255 is shown schematically in FIG. 2. The gearbox assembly 255 includes a plurality of gears for adjusting the rotational speed of the fan shaft 256 and, thus, the fan 252 relative to the LP shaft 238 to a more efficient rotational fan speed. The gearbox assembly may have a gear ratio of 4:1 to 12:1, or 7:1 to 12:1, or 4:1 to 10:1, or 5:1 to 9:1, or 6:1 to 9:1, and may be configured in an epicyclic star or a planet gear configuration. Preferably, the gearbox assembly has a gear ratio of 4:1 to 10:1 for an unducted fan engine (e.g., the turbofan engine 210). The gearbox may be a single stage gearbox or a compound gearbox (e.g., having a plurality of stages). The LP shaft 238, the gearbox assembly 255, and the fan shaft 256 are disposed in an in-line configuration such that the LP shaft 238, the gearbox assembly 255, and the fan shaft 256 are coaxial and are each disposed about the longitudinal centerline axis 212.

The fan blades 254 can be arranged in equal spacing around the longitudinal centerline axis 212. Each fan blade 254 extends outwardly from a disk (not shown in FIG. 2) generally along the radial direction R. The disk is covered by a fan hub 257 that is rotatable and aerodynamically contoured to promote an airflow through the plurality of fan blades 254. Each fan blade 254 has a root and a tip, and a span defined therebetween. Each of the plurality of fan blades 254 defines a pitch axis P. In FIG. 2, each of the plurality of fan blades 254 of the fan 252 is rotatable about their respective pitch axis P, e.g., in unison with one another. A fan actuation system 258 controls one or more actuators 259 to pitch the fan blades 254 about their respective pitch axis P. The fan actuation system 258 is disposed within the fan hub 257.

The fan assembly 250 further includes a fan guide vane array 260 that includes a plurality of fan guide vanes 262 (only one shown in FIG. 2) disposed around the longitudinal centerline axis 212. In FIG. 2, the plurality of fan guide vanes 262 is not rotatable about the longitudinal centerline axis 212. Each of the plurality of fan guide vanes 262 has a root and a tip, and a span defined therebetween. The plurality of fan guide vanes 262 can be unshrouded as shown in FIG. 2 or can be shrouded, e.g., by an annular shroud spaced outward from the tips of the fan guide vanes 262 along the radial direction R. Each of the plurality of fan guide vanes 262 defines a vane pitch axis 264. In FIG. 2, each of the plurality of fan guide vanes 262 of the fan guide vane array 260 is rotatable about their respective vane pitch axis 264, e.g., in unison with one another. One or more actuators 266 are controlled to pitch the plurality of fan guide vanes 262 about their respective vane pitch axis 264. In other aspects, each of the plurality of fan guide vanes 262 is fixed or is unable to be pitched about the vane pitch axis 264. The plurality of fan guide vanes 262 is mounted to a fan cowl 270. Notably, the turbofan engine 210 defines a bypass passage 295 over the fan cowl 270 and the core cowl 222. The bypass passage 295 of an open fan engine, such as the turbofan engine 210 of FIG. 2, is defined from the fan cowl 270 and the core cowl 222 to the fan tip 253 of the fan blades 254.

The fan cowl 270 annularly encases at least a portion of the core cowl 222 and is generally positioned outward of the core cowl 222 along the radial direction R. Particularly, a downstream section of the fan cowl 270 extends over a forward portion of the core cowl 222 to define a fan flowpath, also referred to as a fan duct 272. Incoming air enters through the fan duct 272 through a fan duct inlet 276 and exits through a fan exhaust nozzle 278 to produce propulsive thrust. The fan duct 272 is an annular duct positioned generally outward of the core duct 242 along the radial direction R. The fan cowl 270 and the core cowl 222 are connected together and supported by a plurality of struts 274 (only one shown in FIG. 2) that extends substantially radially and are circumferentially spaced about the longitudinal centerline axis 212. The plurality of struts 274 is each aerodynamically contoured to direct air flowing thereby. Other struts, in addition to the plurality of struts 274, can be used to connect and to support the fan cowl 270 and the core cowl 222.

The turbofan engine 210 also defines or includes an inlet duct 280. The inlet duct 280 extends between an engine inlet 282 and the core inlet 224 and the fan duct inlet 276. The engine inlet 282 is defined generally at the forward end of the fan cowl 270 and is positioned between the fan 252 and the fan guide vane array 260 along the axial direction A. The inlet duct 280 is an annular duct that is positioned inward of the fan cowl 270 along the radial direction R. Air flowing downstream along the inlet duct 280 is split, not necessarily evenly, into the core duct 242 and the fan duct 272 by a splitter 284 of the core cowl 222. The inlet duct 280 is wider than the core duct 242 along the radial direction R. The inlet duct 280 is also wider than the fan duct 272 along the radial direction R.

The fan assembly 250 also includes a mid-fan 286. The mid-fan 286 includes a plurality of mid-fan blades 288 (only one shown in FIG. 2). The plurality of mid-fan blades 288 is rotatable, e.g., about the longitudinal centerline axis 212. The mid-fan 286 is drivingly coupled with the LP turbine 234 via the LP shaft 238. The plurality of mid-fan blades 288 can be arranged in equal circumferential spacing about the longitudinal centerline axis 212. The plurality of mid-fan blades 288 is annularly surrounded (e.g., ducted) by the fan cowl 270. In this regard, the mid-fan 286 is positioned inward of the fan cowl 270 along the radial direction R. The mid-fan 286 is positioned within the inlet duct 280 upstream of both the core duct 242 and the fan duct 272. A ratio of a span of a fan blade 254 to that of a mid-fan blade 288 (a span is measured from a root to tip of the respective blade) is greater than 2 and less than 10, to achieve the desired benefits of the third stream (S3), particularly, the additional thrust it offers to the engine, which can enable a smaller diameter fan blade 254 (benefits engine installation).

Accordingly, air flowing through the inlet duct 280 flows across the plurality of mid-fan blades 288 and is accelerated downstream thereof. At least a portion of the air accelerated by the mid-fan blades 288 flows into the fan duct 272 and is ultimately exhausted through the fan exhaust nozzle 278 to produce propulsive thrust. Also, at least a portion of the air accelerated by the plurality of mid-fan blades 288 flows into the core duct 242 and is ultimately exhausted through the core exhaust nozzle 240 to produce propulsive thrust. Generally, the mid-fan 286 is a compression device positioned downstream of the engine inlet 282. The mid-fan 286 is operable to accelerate air into the fan duct 272, also referred to as a secondary bypass passage.

During operation of the turbofan engine 210, an initial airflow or an incoming airflow passes through the fan blades 254 of the fan 252 and splits into a first airflow and a second airflow. The first airflow bypasses the engine inlet 282 and flows generally along the axial direction A outward of the fan cowl 270 along the radial direction R. The first airflow accelerated by the fan blades 254 passes through the fan guide vanes 262 and continues downstream thereafter to produce a primary propulsion stream or a first thrust stream S1. A majority of the net thrust produced by the turbofan engine 210 is produced by the first thrust stream S1. The second airflow enters the inlet duct 280 through the engine inlet 282.

The second airflow flowing downstream through the inlet duct 280 flows through the plurality of mid-fan blades 288 of the mid-fan 286 and is consequently compressed. The second airflow flowing downstream of the mid-fan blades 288 is split by the splitter 284 located at the forward end of the core cowl 222. Particularly, a portion of the second airflow flowing downstream of the mid-fan 286 flows into the core duct 242 through the core inlet 224. The portion of the second airflow that flows into the core duct 242 is progressively compressed by the LP compressor 226 and the HP compressor 228, and is ultimately discharged into the combustion section. The discharged pressurized air stream flows downstream to the combustor 230 where fuel is introduced to generate combustion gases or products.

The combustor 230 defines an annular combustion chamber that is generally coaxial with the longitudinal centerline axis 212. The combustor 230 receives pressurized air from the HP compressor 228 via a pressure compressor discharge outlet. A portion of the pressurized air flows into a mixer. Fuel is injected by a fuel nozzle (omitted for clarity) to mix with the pressurized air thereby forming a fuel-air mixture that is provided to the combustion chamber for combustion. Ignition of the fuel-air mixture is accomplished by one or more igniters (omitted for clarity), and the resulting combustion gases flow along the axial direction A toward, and into, a first stage turbine nozzle 233 of the HP turbine 232. The first stage turbine nozzle 233 is defined by an annular flow channel that includes a plurality of radially extending, circumferentially spaced nozzle vanes 235 that turn the combustion gases so that the combustion gases flow angularly and impinge upon first stage turbine blades of the HP turbine 232. The combustion gases exit the HP turbine 232 and flow through the LP turbine 234, and exit the core duct 242 through the core exhaust nozzle 240 to produce a core air stream, also referred to as a second thrust stream S2. As noted above, the HP turbine 232 drives the HP compressor 228 via the HP shaft 236, and the LP turbine 234 drives the LP compressor 226, the fan 252, and the mid-fan 286 via the LP shaft 238.

The other portion of the second airflow flowing downstream of the mid-fan 286 is split by the splitter 284 into the fan duct 272. The air enters the fan duct 272 through the fan duct inlet 276. The air flows generally along the axial direction A through the fan duct 272 and is ultimately exhausted from the fan duct 272 through the fan exhaust nozzle 278 to produce a third stream, also referred to as a third thrust stream S3.

The third thrust stream S3 is a secondary air stream that increases fluid energy to produce a minority of total propulsion system thrust. In some aspects, a pressure ratio of the third stream is higher than that of the primary propulsion stream (e.g., a bypass or a propeller driven propulsion stream). The thrust may be produced through a dedicated nozzle or through mixing of the secondary air stream with the primary propulsion stream or a core air stream, e.g., into a common nozzle. In certain aspects, an operating temperature of the secondary air stream is less than a maximum compressor discharge temperature for the engine. Furthermore, aspects of the third stream (e.g., airstream properties, mixing properties, or exhaust properties), and thereby a percent contribution to total thrust, are passively adjusted during engine operation or can be modified purposefully through the use of engine control features (such as fuel flow, electric machine power, variable stators, variable inlet guide vanes, valves, variable exhaust geometry, or fluidic features) to adjust or to improve overall system performance across a broad range of potential operating conditions.

The turbofan engine 210 depicted in FIG. 2 is by way of example only. In other aspects, the turbofan engine 210 may have other suitable configurations. For example, the fan 252 can be ducted by a fan casing or a nacelle such that a bypass passage is defined between the fan casing and the fan cowl 270. Moreover, in other aspects, any other suitable number or configuration of compressors, turbines, shafts, or a combination thereof may be provided. Further, aspects of the present disclosure may be incorporated into any other suitable turbofan engine, such as, for example, turbofan engines defining two streams (e.g., a bypass stream and a core air stream).

Further, in FIG. 2, the turbofan engine 210 includes an electric machine 290 (e.g., a motor-generator) operably coupled with a rotating component thereof. In this regard, the turbofan engine 210 is a hybrid-electric propulsion machine. Particularly, as shown in FIG. 2, the electric machine 290 is operatively coupled with the LP shaft 238. The electric machine 290 can be mechanically connected to the LP shaft 238, either directly, or indirectly, e.g., by way of a gearbox assembly 292 (shown schematically in FIG. 2). Further, although the electric machine 290 is operatively coupled with the LP shaft 238 at an aft end of the LP shaft 238, the electric machine 290 can be coupled with the LP shaft 238 at any suitable location or can be coupled to other rotating components of the turbofan engine 210, such as the HP shaft 236 or the LP shaft 238. For instance, in some aspects, the electric machine 290 can be coupled with the LP shaft 238 and positioned forward of the mid-fan 286 along the axial direction A. In some aspects, the turbofan engine of FIG. 1 also includes an electric machine coupled to the LP shaft and located in the tail cone of the engine.

In some aspects, the electric machine 290 can be an electric motor operable to drive or to motor the LP shaft 238. In other aspects, the electric machine 290 can be an electric generator operable to convert mechanical energy into electrical energy. In this way, electrical power generated by the electric machine 290 can be directed to various engine systems or aircraft systems. In some aspects, the electric machine 290 can be a motor/generator with dual functionality. The electric machine 290 includes a rotor 294 and a stator 296. The rotor 294 is coupled to the LP shaft 238 and rotates with rotation of the LP shaft 238. In this way, the rotor 294 rotates with respect to the stator 296, thereby generating electrical power. Although the electric machine 290 has been described and illustrated in FIG. 2 as having a particular configuration, the present disclosure may apply to electric machines having alternative configurations. For instance, the rotor 294 or the stator 296 may have different configurations or may be arranged in a different manner than illustrated in FIG. 2.

Moreover, referring still to FIG. 2, in exemplary embodiments, air passing through the fan duct 272 may be relatively cooler (e.g., lower temperature) than one or more fluids utilized in the core duct 242. In this way, one or more heat exchangers 2200 are positioned in thermal communication with the fan duct 272. For example, the one or more heat exchangers 2200 are disposed within the fan duct 272 and utilized to cool one or more fluids from the core engine with the air passing through the fan duct 272, as a resource for removing heat from a fluid, e.g., compressor bleed air, oil or fuel.

Although not depicted, the heat exchanger 2200 may be an annular heat exchanger extending substantially 360 degrees in the fan duct 272 (e.g., at least 300 degrees, such as at least 330 degrees). In such a manner, the heat exchanger 2200 may effectively utilize the air passing through the fan duct 272 to cool one or more systems of the turbofan engine 210 (e.g., a cooled cooling air system (described below), lubrication oil systems, compressor bleed air, electrical components, etc.). The heat exchanger 2200 uses the air passing through the fan duct 272 as a heat sink and correspondingly increases the temperature of the air downstream of the heat exchanger 2200 and exiting the fan exhaust nozzle 278.

As will be appreciated, the turbofan engine 210 defines a total sea level static thrust output Fn_{Total}, corrected to standard day conditions, which is generally equal to a maximum total engine thrust. As used heren, “sea level static thrust corrected to standard day conditions” refers to an amount of thrust an engine is capable of producing while at rest relative to the earth and the surrounding air during standard day operating conditions.

The total sea level static thrust output Fn_{Total} is equal to a sum of: a fan stream thrust Fn_{Fan} (i.e., an amount of thrust generated by the fan 252 through the bypass passage 295), the third stream thrust Fn_{3S} (i.e., an amount of thrust generated through the fan duct 272), and a turbofan engine thrust Fn_{TM} (i.e., an amount of thrust generated by an airflow through the core exhaust nozzle 240), each during the static, sea level, standard day conditions. The turbofan engine 210 defines a total sea level static thrust output Fn_{Total} greater than or equal to fifteen thousand pounds (15,000 pounds). For example, the turbofan engine 210 is configured to generate at least twenty-five thousand pounds (25,000 pounds) and less than eighty thousand pounds (80,000 pounds), such as between twenty-five thousand pounds and fifty thousand pounds (25,000 pounds and 50,000 pounds), such as between thirty-five thousand pounds and forty-five thousand pounds (35,000 pounds and 45,000 pounds) of thrust during a takeoff operating power, corrected to standard day sea level conditions.

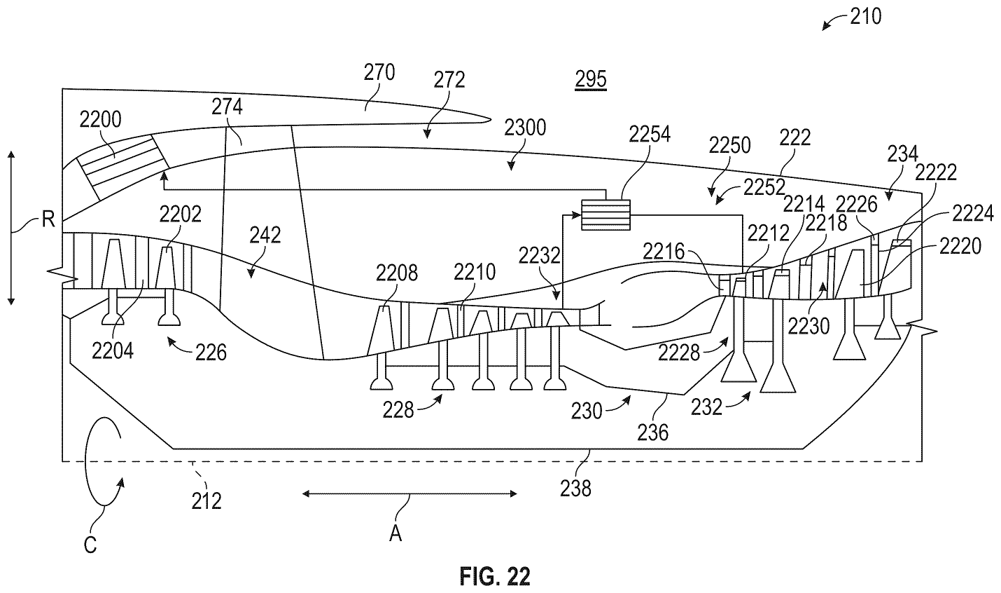

The turbofan engine 210 defines a redline exhaust gas temperature (referred to herein as “EGT”), which is defined above, and for the embodiment of FIG. 2 refers to a maximum permitted takeoff temperature of an airflow after a first HP turbine stator vane downstream of a last stage of rotor blades of the HP turbine 232 (at location 2230 into the first of the plurality of LP turbine rotor blades. See FIG. 22).

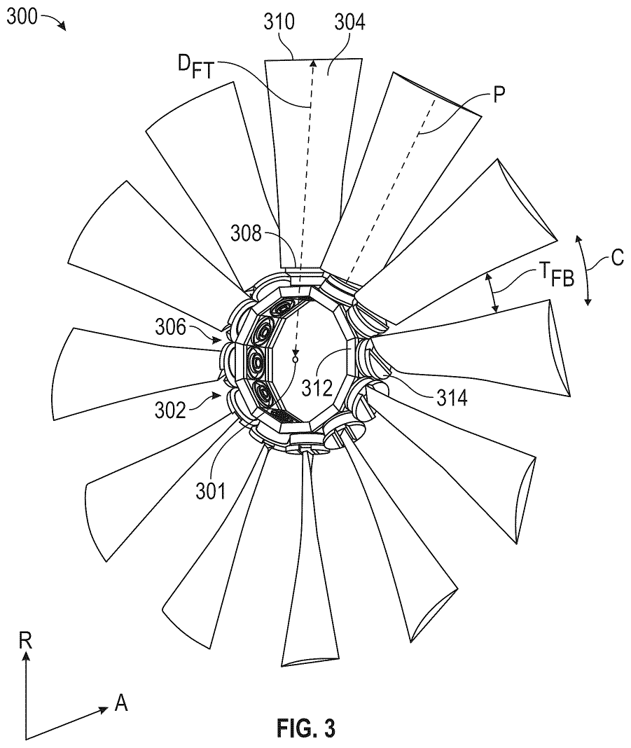

FIG. 3 shows a fan 300 having a fan actuation system 302, according to the present disclosure. The fan 300 can be utilized as the fan 138 of FIG. 1 or as the fan 252 of FIG. 2. The fan 300 includes a plurality of fan blades 304 that is coupled to a disk 306 and is spaced circumferentially about a longitudinal centerline axis 301 of the fan 300. The fan 300 includes a number of fan blades, and, in particular, includes ten to eighteen fan blades 304. In FIG. 3, the fan 300 includes twelve fan blades 304. Each fan blade 304 extends in the radial direction R along a span of the fan blade 304 and from a fan root 308 to a fan tip 310. Each fan blade 304 has a fan tip diameter D_{FT} that extends through the longitudinal centerline axis 301 to the fan tip 310 of each fan blade 304. While the fan tip diameter D_{FT} is detailed with respect to the plurality of fan blades 304, the fan tip diameter D_{FT} is a measurement of any of the fan blades detailed herein. The fan tip diameter D_{FT} is in a range from seven feet to sixteen feet (7 ft. to 16 ft.), as detailed further below. A tangential fan blade distance TFB is defined in the circumferential direction C as a circumferential distance or a tangential distance between adjacent fan blades 304. As used herein, adjacent means two fan blades with no intervening fan blade therebetween.

The disk 306 includes a plurality of disk segments 312 that is rigidly coupled together or integrally molded together in a generally annular shape. One fan blade 304 is coupled to each disk segment 312 at a trunnion mechanism 314 of the fan actuation system 302. The trunnion mechanism 314 facilitates retaining the respective fan blade 304 on the disk 306 during rotation of the disk 306, while still rendering the respective fan blade 304 rotatable relative to the disk 306 about a pitch axis P of the fan blade 304. For example, the trunnion mechanism 314 provides a load path to the disk 306 for the centrifugal load generated by the fan blade 304 during rotation of the fan blade 304 about the longitudinal centerline axis 301. The trunnion mechanism 314 includes a plurality of bearings disposed within the disk segment 312 that allows the fan blade 304 to rotate about the pitch axis P.

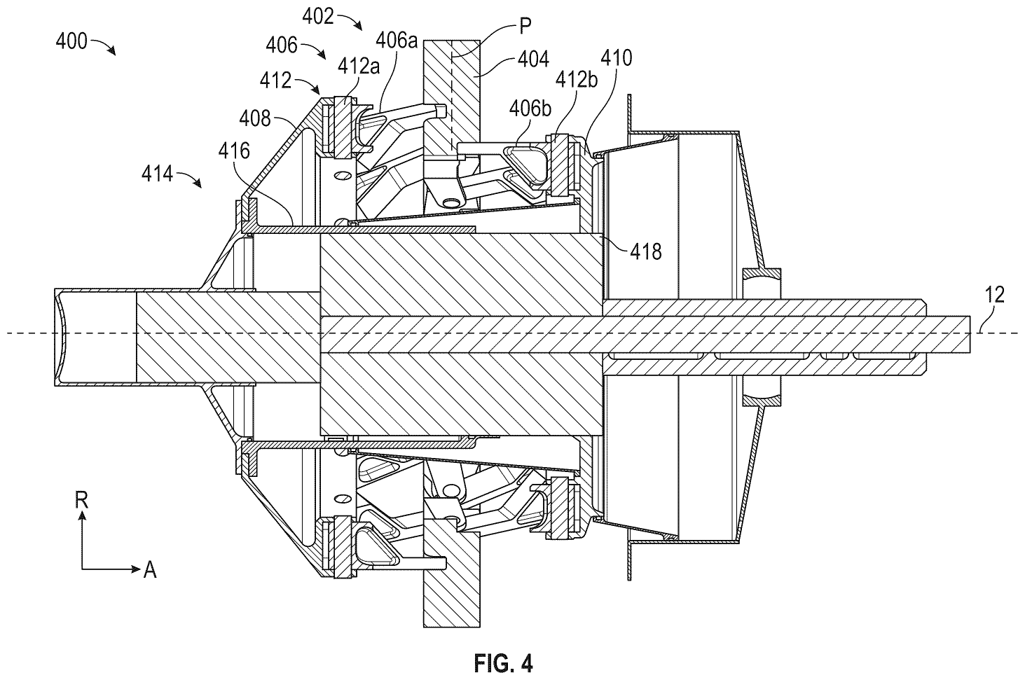

FIG. 4 is a schematic cross-sectional diagram of a fan actuation system 400 for a turbofan engine, taken along a longitudinal centerline axis 112 of the turbofan engine, according to the present disclosure. The fan actuation system 400 can be utilized for any of the fans detailed herein. The fan actuation system 400 includes a trunnion mechanism 402 and one or more actuators 414. The trunnion mechanism 402 includes a plurality of trunnions 404. Each fan blade of the fan is coupled to a respective trunnion 404. Each of the plurality of trunnions 404 is rotatable about a pitch axis P to pitch the fan blades of the fan. The trunnion mechanism 402 includes a plurality of trunnion links 406 that is coupled to the plurality of trunnions 404. For example, a respective trunnion link 406 is coupled to a respective trunnion 404. The plurality of trunnion links 406 includes a plurality of forward trunnion links 406a and a plurality of aft trunnion links 406b that are coupled to the plurality of trunnions 404. The plurality of forward trunnion links 406a is pivotably coupled to the plurality of trunnions 404.

The trunnion mechanism 402 includes a plurality of unison rings 408, 410 including a forward unison ring 408 positioned forward of the plurality of trunnions 404 and an aft unison ring 410 positioned aft of the plurality of trunnions 404. The forward unison ring 408 and the aft unison ring 410 couple the plurality of trunnions 404 together. The plurality of trunnion links 406 is coupled to the forward unison ring 408 or the aft unison ring 410 via a plurality of pins 412. The plurality of forward trunnion links 406a is pivotably coupled to the forward unison ring 408 by a plurality of forward pins 412a such that the plurality of trunnions 404 is coupled to the forward unison ring 408. For example, each forward trunnion link 406a extends forward from a respective trunnion 404 to the forward unison ring 408 and a respective forward pin 412a is disposed through the forward trunnion link 406a at the forward unison ring 408 to pivotably couple the forward trunnion link 406a to the forward unison ring 408. Each aft trunnion link 406b extends aftward from the respective trunnion 404 to the aft unison ring 410 and a respective aft pin 412b is disposed through the aft trunnion link 406b at the aft unison ring 410 to pivotably couple the aft trunnion link 406b to the aft unison ring 410. In this way, each of the plurality of trunnions 404 is pivotably coupled to the forward unison ring 408 and to the aft unison ring 410 such that the plurality of trunnions 404 can pivot about the pitch axis P in unison.

The one or more actuators 414 include a hydraulic cylinder 416 and a piston 418 disposed within the hydraulic cylinder 416. The hydraulic cylinder 416 and the piston 418 are movable along the axial direction A. In this way, the one or more actuators 414 are hydraulic linear actuators such that the hydraulic cylinder 416 and the piston 418 move linearly along the axial direction A (e.g., in opposite directions along the longitudinal centerline axis 112). The forward unison ring 408 is coupled to the hydraulic cylinder 416 such that the forward unison ring 408 moves when the hydraulic cylinder 416 moves. The aft unison ring 410 is coupled to the piston 418 such that aft unison ring 410 moves when the piston 418 moves.

In operation, the fan actuation system 400 moves the plurality of fan blades 140 (FIG. 1) between a first end position and a second end position. The first end position, referred to herein as a feather position, corresponds to a position in which the plurality of fan blades 140 produces the least (e.g., minimal) amount of resistance or drag. In some examples, this position corresponds to a position in which the plurality of fan blades 140 is aligned or substantially aligned (e.g., ±5°) with the flow of the volume of air (e.g., the volume of air 158 of FIG. 1). The second end position is a reverse position in which the plurality of fan blades 140 exceeds, for example, a plane that is transverse to the longitudinal centerline axis 112 (the direction of forward movement of the aircraft) by a certain degree (e.g., 30°) so as to assist with the braking of the aircraft. Therefore, in some examples, the angular stroke of the plurality of fan blades 140 between the feather position and the reverse position is, for example, approximately 120°. The plurality of fan blades 140 can be moved to any position or any angle between the feather position and the reverse position depending on the phase of flight to improve (e.g., optimize) efficiency of the turbofan engine 110 (FIG. 1). In some examples, one or more stops or limits are provided to prevent the plurality of fan blades 140 from being rotated beyond the two end positions. In other examples, the fan actuation system 400 can be configured to provide a greater stroke or a lesser stroke and/or the end positions may be different.

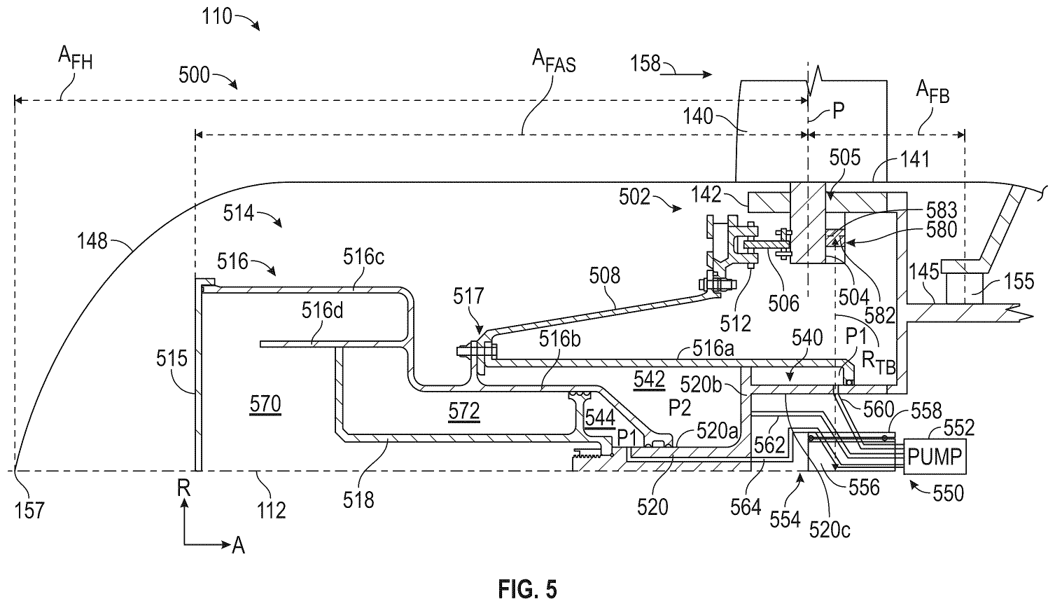

A hydraulic system supplies a hydraulic fluid (e.g., oil) to one or more hydraulic chambers of the one or more actuators 414 to move the hydraulic cylinder 416 and the piston 418 to pitch the plurality of fan blades 140. An exemplary hydraulic system and hydraulic chambers are detailed below with respect to FIG. 5. The plurality of trunnions 404 is disposed in FIG. 4 such that the plurality of fan blades 140 is in the first end position (e.g., the feather position). The pressure of the hydraulic fluid in the one or more hydraulic chambers can be increased to move the hydraulic cylinder 416 in a first direction and to move the piston 418 in a second direction such that the plurality of trunnions 404 move the plurality of fan blades 140 from the feather position towards the reverse position (e.g., the second end position). For example, the hydraulic cylinder 416 can move axially aftward (e.g., to the right in FIG. 4) and the piston 418 can move axially forward (e.g., to the left in FIG. 4) when the pressure of the hydraulic fluid is increased. To move the plurality of fan blades 140 from the reverse position to the feather position, the pressure of the hydraulic fluid in the one or more hydraulic chambers can be decreased to move the hydraulic cylinder 416 in the second direction (e.g., axially forward) and to move the piston 418 in the first direction (e.g., axially aftward).

As the hydraulic cylinder 416 moves axially along the axial direction A, the hydraulic cylinder 416 causes the forward unison ring 408 to move, thereby causing the plurality of forward trunnion links 406a to pivot and to pitch the plurality of trunnions 404, and, therefore, pitching the plurality of fan blades 140 about the pitch axis P. At the same time, movement of the piston 418 along the axial direction A causes the aft unison ring 410 to move, thereby, causing the plurality of aft trunnion links 406b to pivot in an opposite direction as the forward trunnion links 406a, and, therefore, pitching the plurality of fan blades 140 about the pitch axis P. In this way, the fan actuation system 400 translates linear motion of the one or more actuators 414 (e.g., along the axial direction A) into rotational motion of the plurality of fan blades 140. Such a configuration enables a compact and lightweight design of the fan actuation system 400. Further, each of the hydraulic cylinder 416 and the piston 418 provides only half of the force needed to actuate the plurality of trunnions 404 and provides a redundant path in the event that one of the hydraulic cylinder 416 or the piston 418 fails.

FIG. 5 is a schematic cross-sectional view of a fan actuation system 500 for a turbofan engine, according to another aspect. The fan actuation system 500 is shown as being utilized in the turbofan engine 110, but can be utilized in the turbofan engine 210. Only the top half of the fan actuation system 500 is shown in FIG. 5. However, the fan actuation system 500 is symmetrical about the longitudinal centerline axis 112. The fan actuation system 500 may also be referred to as a fan pitch actuation system (FPAS). The fan actuation system 500 controls the pitch (e.g., angle, orientation) of the plurality of fan blades 140 about the pitch axis P. In some examples, the fan actuation system 500 can move the fan blades 140 between a first end position and a second end position.

FIG. 5 shows the fan shaft 145 of the turbofan engine 110 (FIG. 1). The fan shaft 145 is coupled to, and driven by, the LP shaft 136 (FIG. 1). One or more fan bearings 155 support rotation of the fan shaft 145. The one or more fan bearings 155 can include roller bearings, tapered roller bearings, ball bearings, or the like. The one or more fan bearings 155 are disposed aft of the fan disk 142. As shown in FIG. 5, the fan disk 142 is coupled to (e.g., directly or indirectly), and driven by, the fan shaft 145. Each of the plurality of fan blades 140 is coupled to, and extends radially outward from, the fan disk 142. Therefore, as the fan shaft 145 is rotated (via the LP shaft 136), the fan shaft 145 rotates the fan disk 142, which rotates the plurality of fan blades 140 to generate thrust. The fan hub 148 (shown schematically in FIG. 5) includes a fan hub tip 157 that defines an axially forward-most point of the fan hub 148.

The fan actuation system 500 includes a trunnion mechanism 502 including a plurality of trunnions 504. Each fan blade 140 is coupled to a respective one of the plurality of trunnions 504. The plurality of trunnions 504 extends through an opening 505 in the fan disk 142. The plurality of trunnions 504 is rotatable in the opening 505. This enables the plurality of fan blades 140 to rotate about the pitch axis P. As such, the pitch of the plurality of fan blades 140 can be changed relative to the flow of the volume of air 158. In particular, the plurality of fan blades 140 can be rotated (e.g., pitched) to any position between the first end position (e.g., the feather position) and the second end position (e.g., the reverse position). In FIG. 5, the plurality of fan blades 140 is shown in the feather position. In the feather position, the plurality of fan blades 140 is substantially aligned with the flow of the volume of air 158, which reduces resistance or drag. The plurality of fan blades 140 is typically held in the feather position when the turbofan engine 110 (FIG. 1) is not operating.

The fan actuation system 500 includes a plurality of trunnion links 506 and a unison ring 508. The plurality of trunnion links 506 is pivotably coupled to the plurality of trunnions 504. For example, each trunnion link 506 is coupled to a respective trunnion 504 and to the unison ring 508. In this way, the unison ring 508 couples the plurality of trunnions 504 together. The plurality of trunnion links 506 is coupled to the unison ring 508 via a plurality of pins 512. In this way, the plurality of trunnions 504 is pivotably coupled to the unison ring 508 such that the plurality of trunnions 504, and, thus, the plurality of fan blades 140, can pivot about the pitch axis P in unison, as detailed further below.

The fan actuation system 500 includes one or more actuators 514 that include a hydraulic cylinder 516, a piston 518, and a piston retainer 520. The piston retainer 520 is coupled (e.g., bolted) to the fan shaft 145 such that the piston retainer 520 rotates with the fan shaft 145. Therefore, the piston retainer 520 is coupled (e.g., indirectly) to, and rotated by, the LP shaft 136 (FIG. 1). Also, the piston 518 is coupled to, and extends in a forward direction, from the piston retainer 520. Therefore, the piston 518 also rotates with the piston retainer 520 and the fan shaft 145. The hydraulic cylinder 516 also rotate with the piston retainer 520 and the piston 518, but is axially slidable relative to the piston retainer 520 and the piston 518, as disclosed in further detail herein. In some examples, the hydraulic cylinder 516 is disposed within the fan hub 148 (FIG. 1) of the turbofan engine 110 (FIG. 1).

In the illustrated example of FIG. 5, the piston retainer 520 has a first portion 520a (e.g., a post), a second portion 520b (e.g., a flange) that extends radially outward from the first portion 520a, and a third portion 520c (e.g., a shaft) that extends axially from the second portion 520b. The third portion 520c is coupled (e.g., bolted) to the fan shaft 145. The piston retainer 520 can be constructed as multiple parts coupled (e.g., welded) together or as a single unitary part or component (e.g., a monolithic structure). The piston 518 is coupled to, and extends forward from, the first portion 520a of the piston retainer 520.

The hydraulic cylinder 516 is disposed radially outward of (e.g., around, surrounding) the piston retainer 520 and the piston 518. The hydraulic cylinder 516 is keyed to the piston retainer 520. As such, the piston retainer 520 rotates the hydraulic cylinder 516. However, the hydraulic cylinder 516 is slidable along the piston retainer 520 in the axial direction A (left and right in FIG. 5). This movement is used to change the pitch of the plurality of fan blades 140. The hydraulic cylinder 516 is coupled to the unison ring 508 at a joint 517 such that the hydraulic cylinder 516 is coupled to the plurality of fan blades 140 via the trunnion mechanism 502. The fan actuation system 500 can be activated to move the hydraulic cylinder 516 axially (left or right in FIG. 5), which causes the plurality of trunnion links 506 to rotate the plurality of trunnions 504, which rotates the plurality of fan blades 140 about the pitch axis P. As such, movement of the hydraulic cylinder 516 causes all of the fan blades 140 to rotate (e.g., pitch) simultaneously. When the hydraulic cylinder 516 is moved in a first axial direction (the forward direction, or to the left in FIG. 5), the plurality of fan blades 140 is rotated to the feather position, and when the hydraulic cylinder 516 is moved in a second axial direction (the rearward direction, or to the right in FIG. 5), the plurality of fan blades 140 is rotated away from the feather position and toward the reverse position. However, in other examples, the fan actuation system 500 can be configured so that the movement of the hydraulic cylinder 516 is reversed.

The hydraulic cylinder 516 has a first portion 516a, a second portion 516b, a third portion 516c, and a fourth portion 516d. The first portion 516a extends generally in the axial direction A and is coupled to the unison ring 508 at the joint 517 (e.g., a bolted joint). The second portion 516b is disposed radially inward of the first portion 516a and is coupled to the first portion 516a and to the unison ring 508 at the joint 517. The third portion 516c extends forward from the joint 517 (e.g., from the first portion 516a, the second portion 516b, and the unison ring 508) and forms a pressurized pneumatic chamber 570, disclosed in further detail herein. The fourth portion 516d is coupled to, and extends axially within, the third portion 516c. The first portion 516a, the second portion 516b, the third portion 516c, and the fourth portion 516d form the hydraulic cylinder 516. In some examples, the first portion 516a, the second portion 516b, the third portion 516c, and the fourth portion 516d are separate parts or components that are coupled (e.g., welded, bolted) together. In other examples, one or more of the first portion 516a, the second portion 516b, the third portion 516c, and the fourth portion 516d can be constructed as a single unitary part or component (e.g., a monolithic structure). In some aspects, the hydraulic cylinder 516 and the unison ring 508 form a single unitary part or component.

The first portion 516a of the hydraulic cylinder 516 is sealingly engaged with (e.g., engaged with a seal to prevent fluid leakage) the third portion 520c of the piston retainer 520. The second portion 520b of the piston retainer 520 is sealingly engaged with the first portion 516a of the hydraulic cylinder 516. The second portion 516b of the hydraulic cylinder 516 is sealingly engaged with the first portion 520a of the piston retainer 520. The piston 518 is sealingly engaged with the second portion 516b and with the fourth portion 516d of the hydraulic cylinder 516.

The fan actuation system 500 includes one or more hydraulic chambers defined between the hydraulic cylinder 516, the piston 518, and the piston retainer 520. These hydraulic chamber(s) are used to control the position of the hydraulic cylinder 516, and, thus, to control the pitch of the plurality of fan blades 140. As shown in FIG. 5, the fan actuation system 500 includes a first hydraulic chamber 540, a second hydraulic chamber 542, and a third hydraulic chamber 544. The first hydraulic chamber 540 is formed or is defined between the first portion 516a of the hydraulic cylinder 516, the second portion 520b of the piston retainer 520, and the third portion 520c of the piston retainer 520. The second hydraulic chamber 542 is formed or is defined between the first portion 516a of the hydraulic cylinder 516, the second portion 516b of the hydraulic cylinder 516, the first portion 520a of the piston retainer 520, and the second portion 520b of the piston retainer 520. The third hydraulic chamber 544 is formed or is defined between second portion 516b of the hydraulic cylinder 516, an aft end of the piston 518, and the first portion 520a of the piston retainer 520. In this example, the first hydraulic chamber 540 and third hydraulic chamber 544 are provided with hydraulic fluid at a first pressure, referred to herein as P1, and the second hydraulic chamber 542 is provided with hydraulic fluid at a second pressure, referred to herein as P2. The first pressure P1 and the second pressure P2 can be any amount depending on the specific design. In some examples, the first pressure P1 and the second pressure P2 can be as high as one thousand pounds per square inch (1000 psi) or even higher. The first pressure P1 and the second pressure P2 can be increased or can be decreased to cause the hydraulic cylinder 516 to move axially forward or axially rearward, thus changing the pitch of the plurality of fan blades 140. For example, if the force acting on the hydraulic cylinder 516 from the first pressure P1 in the first hydraulic chamber 540 and the third hydraulic chamber 544 is greater than the force acting on the hydraulic cylinder 516 from the second pressure P2 in the second hydraulic chamber 542, the hydraulic cylinder 516 moves (e.g., slides) rearward (axially aftward, or to the right in FIG. 5) along the piston 518 and the piston retainer 520. Conversely, if the force acting on the hydraulic cylinder 516 from the first pressure P1 in the first hydraulic chamber 540 and the third hydraulic chamber 544 is less than the force acting on the hydraulic cylinder 516 from the second pressure P2 in the second hydraulic chamber 542, the hydraulic cylinder 516 moves (e.g., slides) axially forward (to the left in FIG. 5) along the piston 518 and the piston retainer 520. Therefore, the first hydraulic chamber 540 and the third hydraulic chamber 544 receive hydraulic fluid to move the hydraulic cylinder 516 in the rearward direction (e.g., aftward direction) while the second hydraulic chamber 542 receives hydraulic fluid to move the hydraulic cylinder 516 in the forward direction.

The fan actuation system 500 includes a hydraulic system 550 to provide hydraulic fluid, such as oil, to one or more of the hydraulic chambers 540, 542, 544 to control the movement of the hydraulic cylinder 516. The hydraulic system 550 includes a pump 552 to control the first pressure P1 and the second pressure P2. The pump 552 is activated to move the hydraulic fluid into, or out of, the hydraulic chambers 540, 542, 544 to increase or to decrease the first pressure P1 and the second pressure P2, and, therefore, to cause the hydraulic cylinder 516 to move forward or to move rearward. In the illustrated example, the hydraulic system 550 includes an oil transfer bearing 554. The oil transfer bearing 554 includes a fixed portion 556 (e.g., a shaft) with fluid passageways fluidly coupled to the pump 552. The fixed portion 556 is a static component and does not rotate or move axially. The oil transfer bearing 554 includes a sleeve 558 that is rotatable about the fixed portion 556. The hydraulic system 550 includes a first fluid line 560, a second fluid line 562, and a third fluid line 564 fluidly coupled between the oil transfer bearing 554 and the respective hydraulic chambers 540, 542, and 544. The first fluid line 560 is in fluid communication with the first hydraulic chamber 540, the second fluid line 562 is in fluid communication with the second hydraulic chamber 542, and the third fluid line 564 is in fluid communication with the third hydraulic chamber 544. The first fluid line 560, the second fluid line 562, and the third fluid line 564 are coupled to the sleeve 558. The sleeve 558 enables fluid communication among the first fluid line 560, the second fluid line 562, and the third fluid line 564, which are rotating with the fan actuation system 500, and the fixed portion 556 of the oil transfer bearing 554. Thus, the oil transfer bearing 554 enables the hydraulic fluid to be transferred between a stationary component and a rotating component. As disclosed above, the first hydraulic chamber 540 and the third hydraulic chamber 544 are provided with the hydraulic fluid at the same first pressure P1. The oil transfer bearing 554 fluidly couples the hydraulic fluid in the first fluid line 560 and the third fluid lines 564 such that the first hydraulic chamber 540 and the third hydraulic chamber 544 remain at the same first pressure P1.

To move the plurality of fan blades 140 away from the feather position and toward the reverse position, the pump 552 is activated to increase the first pressure P1 in the first hydraulic chamber 540 and the third hydraulic chamber 544 and to reduce the second pressure P2 in the second hydraulic chamber 542. As a result, the hydraulic cylinder 516 moves in the rearward direction (to the right in FIG. 5). The hydraulic cylinder 516 pushes the plurality of trunnion links 506 rearward (to the right in FIG. 5), which causes the plurality of fan blades 140 to rotate away from the feather position and toward the reverse position. In this way, the plurality of fan blades 140 can be moved between the feather position and the reverse position. When the desired position is reached, the pump 552 is deactivated or can otherwise balance the loads on the hydraulic cylinder 516 to maintain the current position. The pump 552 can further increase the first pressure P1 or decrease the second pressure P2 to further move the plurality of fan blades 140 toward the reverse position. Otherwise, to move the plurality of fan blades 140 back to the feather position, the pump 552 is activated to reduce the first pressure P1 in the first hydraulic chamber 540 and the third hydraulic chamber 544 or to increase the second pressure P2 in the second hydraulic chamber 542. Thus, the hydraulic system 550 is used to control the position of the hydraulic cylinder 516 for controlling the pitch of the plurality of fan blades 140 along the pitch axis P. The first pressure P1 being the same in the first hydraulic chamber 540 and the third hydraulic chambers 544 reduces the overall first pressure P1 required to control the hydraulic cylinder 516. In other examples, however, the first hydraulic chamber 540 and the third hydraulic chamber 544 can be pressurized at different pressures.

The pressurized pneumatic chamber 570 is formed or is defined by the third portion 516c of the hydraulic cylinder 516 and the piston 518. The pressurized pneumatic chamber 570 is filled with a pressurized gas. In some examples, the pressurized pneumatic chamber 570 contains pressurized nitrogen. In other examples, the pressurized pneumatic chamber 570 can be filled with another pressurized gas (e.g., air). The pressurized pneumatic chamber 570 is sealed. A such, the volume of the pressurized gas (e.g., nitrogen) in the pressurized pneumatic chamber 570 does not change. During manufacture or assembly of the fan actuation system 500, the pressurized pneumatic chamber 570 can be charged with gas (e.g., nitrogen) and then sealed. The pressurized pneumatic chamber 570 can be pressurized to any amount depending on the size of the pressurized pneumatic chamber 570 and on the size of the hydraulic chambers 540, 542, 544 and the desired biasing force. In some examples, the pressure in the pressurized pneumatic chamber 570 is in a range from seven hundred twenty pounds per square inch to nine hundred twenty pounds per square inch (720 psi to 920 psi). In other examples, however, the pressure may be less than, or greater than, these exemplary values.

The pressurized gas in the pressurized pneumatic chamber 570 generates a constant force or a constant load that biases the hydraulic cylinder 516 in the forward direction (to the left in FIG. 5), which corresponds to the feather position of the plurality of fan blades 140. This provides a failsafe to move the plurality of fan blades 140 to the feather position in an event of failure of the hydraulic system 550 or a shutdown of the turbofan engine 110. For example, if the hydraulic system 550 or the turbofan engine 110 fails or is shut down, the hydraulic system 550 is not able to provide pressurized hydraulic fluid to the hydraulic chambers 540, 542, and 544 to control or to maintain the position of the hydraulic cylinder 516. In such an instance, the force on the hydraulic cylinder 516 from the pressurized gas in the pressurized pneumatic chamber 570 overcomes the force on the hydraulic cylinder 516 from the first hydraulic chamber 540 and the third hydraulic chamber 544. As such, the hydraulic cylinder 516 moves in the forward direction (to the left in FIG. 5), which moves the plurality of fan blades 140 to the feather position shown in FIG. 5. As such, the pressurized pneumatic chamber 570 provides a passive system that moves the plurality of fan blades 140 to the feather position in the event of a failure or a deactivation of the hydraulic system 550, which may occur if the turbofan engine 110 fails or is shut down. Therefore, if one of the turbofan engines of an aircraft fails or is deactivated during flight, the fan actuation system 500 automatically moves the plurality of fan blades 140 to the feather position (FIG. 5). This is advantageous because, in the feather position, the plurality of fan blades 140 produces less resistance, which reduces drag on the turbofan engine 110 and on the aircraft. This also reduces or prevents the plurality of fan blades 140 from spinning (due to incoming airflow) the internal turbo-machinery parts of the turbofan engine 110.

The example pressurized pneumatic chamber 570 is advantageous because it has a high load capability due to the compressibility of the pneumatic gas (e.g., nitrogen). Further, the pressurized pneumatic chamber 570 enables a longer travel of the hydraulic cylinder 516 with relatively little change in load. Therefore, the pressurized pneumatic chamber 570 provides a relatively constant load throughout the stroke. Also, the volume and areas of the pressurized pneumatic chamber 570 and the piston 518 can be varied to optimize the load versus travel of the hydraulic cylinder 516.

Therefore, during normal operation of the fan actuation system 500, the first hydraulic chamber 540 and the third hydraulic chamber 544 act to bias the hydraulic cylinder 516 in the rearward direction, while the second hydraulic chamber 542 and the pressurized pneumatic chamber 570 act to bias the hydraulic cylinder 516 in the forward direction. The pressures in the hydraulic chambers 540, 542, and 544 and in the pressurized pneumatic chamber 570 can be controlled to substantially balance the forces and to maintain the hydraulic cylinder 516 in a desired position. In the illustrated example of FIG. 5, a chamber 572 is formed or is defined between the hydraulic cylinder 516 and the piston 518. The chamber 572 is vented to the atmosphere. As such, the chamber 572 does not provide a force in either direction. In this example, the pressurized pneumatic chamber 570 is forward of the piston retainer 520 and the piston 518. In some examples, this is beneficial because there is additional space forward of these components. In other examples, however, the pressurized pneumatic chamber 570 can be disposed rearward of the piston 518 and the piston retainer 520.

In the example of FIG. 5, the fan actuation system 500 is devoid of a pitch lock device and counterweights for reducing inertial loading associated with rotation of fan blades. In particular, in known fan actuation systems, a separate pitch lock device is required to hold the plurality of fan blades 140 once the plurality of fan blades 140 is in the feather position. Further, in known fan actuation systems, a counterweight is used to provide additional force to help pitch the fan blades. However, with the fan actuation system 500, the pressurized pneumatic chamber 570 provides a constant biasing force to hold the plurality of fan blades 140 in the feather position, which eliminates the need for a separate pitch lock device. Further, the hydraulic system 550 provides the first pressure P1 in both the first hydraulic chamber 540 and the third hydraulic chamber 544 to provide a higher pressure to pitch the fan blades 140, which eliminates the need for a counterweight. This reduces parts, complexity, weight, and costs of the fan actuation system 500.

Examples have been disclosed herein that improve the ability for the fan actuation system 500 to move the fan blades 140 to the feather position in the event of failure of the fan actuation system 500 or a shutdown of the turbofan engine 110. The example systems disclosed herein are passive and, thus, do not require complicated activation components or control systems. The example pressurized pneumatic chamber 570 is capable of handling high rotational speeds and a large variation in operating temperatures, such as encountered during use on aircraft. The examples disclosed herein also eliminate the need for a pitch lock device. As such, the example systems can result in fewer parts, less complexity, reduced weight, and lower costs compared to known systems. The fan actuation system 500 is particularly useful in turbofan engines (e.g., the turbofan engine 110 of FIG. 1 or the turbofan engine 210 of FIG. 2) in which the space for the fan actuation system 500 is smaller as compared to turboprop engines. Components of the fan actuation system 500 can be used in combination with any of the fan actuation systems disclosed herein.

The turbofan engine 110 also includes one or more thrust bearings, also referred to as one or more radial thrust (radial blade load) bearings 580, disposed between the trunnion 504 and the fan disk 142 such that the trunnion 504 rotates about the pitch axis P with respect to the fan disk 142. The one or more radial thrust bearings 580 transmit the load (the radial blade load) from the respective fan blade 140 to a static structure of the turbofan engine 110. In particular, the radial thrust bearings 580 include a plurality of rolling elements 582. The rolling elements 582 can include, for example, ball bearings, tapered roller bearings, or the like, for transmitting the radial blade load from the fan blade 140 to the static structure.

The one or more radial thrust bearings 580 are disposed radially at a thrust bearing radius R_{TB}. The thrust bearing radius R_{TB} is defined in the radial direction R from the longitudinal centerline axis 112 to a radial center 583 of the one or more radial thrust bearings 580. The radial center 583 is a center of the radial thrust bearings 580 in the radial direction R. Particularly, the radial center 583 is defined as a radial center of the rolling elements 582. The amount of space, or the volume, beneath the fan 138 that is available for the fan actuation system 500 is defined by the thrust bearing radius R_{TB}. The fan actuation system 500 needs to be accommodated radially below the one or more radial thrust bearings 580 and within the thrust bearing radius R_{TB}.

The turbofan engine 110 includes a fan hub axial length A_{FH}, a fan actuation system axial length A_{FAS}, and a fan bearing axial length A_{FB}. The fan hub axial length A_{FH} is an axial length, in the axial direction (e.g., parallel with the longitudinal centerline axis 112) from the fan hub tip 157 to the pitch axis P of the fan blades 140. The fan actuation system axial length A_{FAS} is an axial length, in the axial direction (e.g., parallel with the longitudinal centerline axis 112), from an axially forward-most surface 515 of the fan actuation system 500 to the pitch axis P of the fan blades 140. In FIG. 5, the axially forward-most surface 515 is defined by an axially forward-most surface of the actuators 514 (e.g., of the hydraulic cylinder 516). The fan actuation system axial length A_{FAS} is a maximum of 80% of the fan hub axial length A_{FH}. In this way, the fan actuation system 500 fits within the fan hub 148 such that the actuators 514 can move axially without contacting the fan hub 148. The fan bearing axial length A_{FB} is an axial length, in the axial direction (e.g., parallel with the longitudinal centerline axis 112) from the pitch axis P of the fan blades 140 to an axial center of the fan bearings 155.

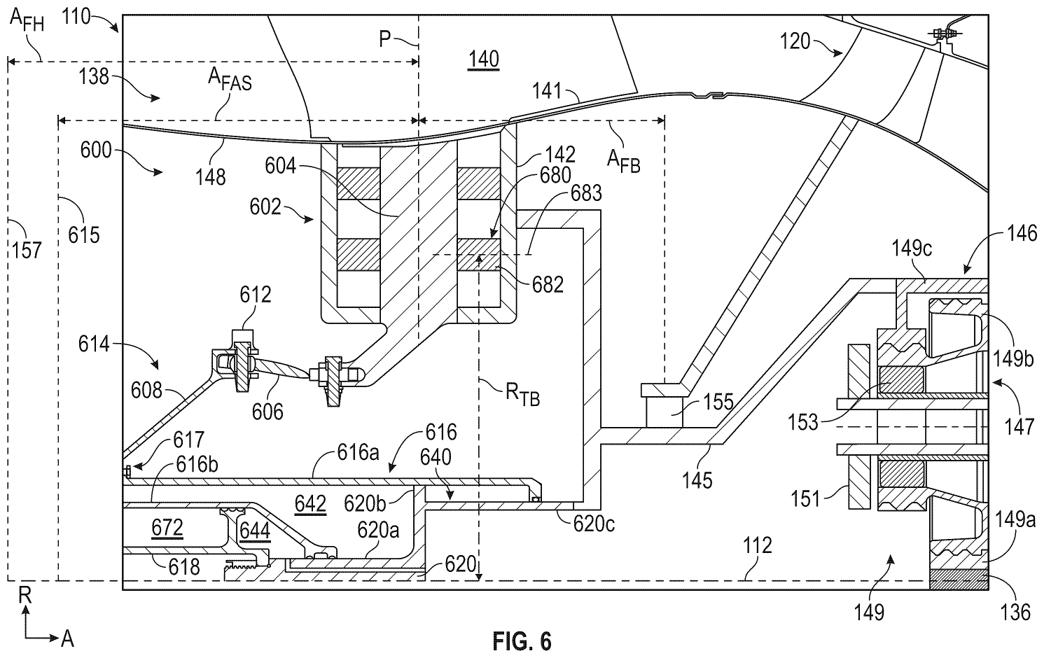

FIG. 6 is a schematic cross-sectional view of a fan actuation system 600 for the turbofan engine 110, taken along the longitudinal centerline axis 112 of the turbofan engine 110, according to the present disclosure. While the fan actuation system 600 is described as being utilized in the turbofan engine 110, the fan actuation system 600 can be utilized in the turbofan engine 210 of FIG. 2. The fan actuation system 600 is substantially similar to the fan actuation system 500 of FIG. 5. The same reference numerals will be used for components of the fan actuation system 600 that are the same as or similar to the components of the fan actuation system 500 discussed above. The description of these components above also applies to this aspect, and a detailed description of these components is omitted here.

The fan actuation system 600 includes a trunnion mechanism 602, a plurality of trunnions 604, a plurality of trunnion links 606, a unison ring 608, a plurality of pins 612, one or more actuators 614, a hydraulic cylinder 616, a joint 617, a piston 618, and a piston retainer 620. The hydraulic cylinder 616 has a first portion 616a and a second portion 616b. Although not shown in the view of FIG. 6, the hydraulic cylinder 616 also includes a third portion and a fourth portion similar to the third portion 516c and the fourth portion 516d of the hydraulic cylinder 516 of FIG. 5. The piston retainer 620 has a first portion 620a, a second portion 620b, and a third portion 620c. The fan actuation system 600 also includes a first hydraulic chamber 640, a second hydraulic chamber 642, a third hydraulic chamber 644, and a pressurized pneumatic chamber (not shown in the view of FIG. 6), and a chamber 672. The first hydraulic chamber 640 and the third hydraulic chamber 644 receive the hydraulic fluid at a first pressure P1, and the second hydraulic chamber 642 receives the hydraulic fluid at a second pressure P2, as detailed above with respect to FIG. 5. The fan actuation system 600 operates substantially similar as to the fan actuation system 500 of FIG. 5.

FIG. 6 shows one fan blade 140 of the fan 138, the core inlet 120, and the gearbox assembly 146. The gearbox assembly 146 includes a gear assembly 147 having a plurality of gears 149 including a first gear 149a, one or more second gears 149b secured by a planet carrier 151, and a third gear 149c. In FIG. 6, the first gear 149a is a sun gear, the one or more second gears 149b are planet gears, and the third gear 149c is a ring gear. The gear assembly 147 is an epicyclic gear assembly. When the gear assembly 147 is an epicyclic gear assembly, the one or more second gears 149b include a plurality of second gears 149b (e.g., two or more second gears 149b).

In the epicyclic gear assembly, the gear assembly 147 can be in a star arrangement or a rotating ring gear type gear assembly (e.g., the third gear 149c is rotating and the planet carrier 151 is fixed and stationary). In such an arrangement, the fan 138 is driven by the third gear 149c. For example, the third gear 149c is coupled to the fan shaft 145 such that rotation of the third gear 149c causes the fan shaft 145, and, thus, the fan 138, to rotate. In this way, the third gear 149c is an output of the gear assembly 147. However, other suitable types of gear assemblies may be employed. In one non-limiting aspect, the gear assembly 147 is a planetary arrangement, in which the third gear 149c is held fixed, with the planet carrier 151 allowed to rotate. In such an arrangement, the fan 138 is driven by the planet carrier 151. For example, the planet carrier 151 is coupled to the fan shaft 145 such that rotation of the planet carrier 151 causes the fan shaft 145, and, thus, the fan 138, to rotate. In this way, the one or more second gears 149b (e.g., via the planet carrier 151) are the output of the gear assembly 147. In another non-limiting aspect, the gear assembly 147 may be a differential gear assembly in which the third gear 149c and the planet carrier 151 are both allowed to rotate. While an epicyclic gear assembly is detailed herein, the gear assembly can include any type of gear assembly including, for example, a single stage gear assembly or a compound gear assembly (e.g., a gear assembly having a plurality of stages).

The plurality of gears 149 includes one or more gear bearings 153 disposed therein. For example, the one or more second gears 149b each includes one or more gear bearings 153 disposed therein. The one or more gear bearings 153 enable the plurality of gears 149 to rotate about the one or more gear bearings 153 such that the plurality of gears 149 rotates. The one or more gear bearings 153 can include any type of bearing for a gear, such as, for example, journal bearings, roller bearings, or the like. The gearbox assembly 146 can include a plurality of gear bearings that includes a forward gear bearing and an aft gear bearing. The one or more gear bearings 153 shown in the view of FIG. 6 are the forward gear bearing.

The first gear 149a is coupled to an input shaft of the turbofan engine 110. For example, the first gear 149a is coupled to the LP shaft 136 such that rotation of the LP shaft 136 causes the first gear 149a to rotate. Radially outward of the first gear 149a, and intermeshing therewith, is the one or more second gears 149b that are coupled together and supported by the planet carrier 151. The planet carrier 151 supports and constrains the one or more second gears 149b such that the each of the one or more second gears 149b is enabled to rotate about a corresponding axis of each second gear 149b without rotating about the periphery of the first gear 149a. Radially outwardly of the one or more second gears 149b, and intermeshing therewith, is the third gear 149c, which is an annular ring gear. The third gear 149c is coupled via an output shaft to the fan 138 and rotates to drive rotation of the fan 138 about the longitudinal centerline axis 112. For example, the fan shaft 145 is coupled to the third gear 149c.

The fan shaft 145 is coupled to the fan disk 142 such that rotation of the fan shaft 145 causes the plurality of fan blades 140 to rotate about the longitudinal centerline axis 112. The turbofan engine 110 also includes one or more radial thrust bearings 680, disposed between the trunnion 604 and the fan disk 142 such that the trunnion 604 rotates about the pitch axis P with respect to the fan disk 142. In particular, the radial thrust bearings 680 include a plurality of rolling elements 682.

The one or more radial thrust bearings 680 are disposed radially at the thrust bearing radius R_{TB} defined in the radial direction R from the longitudinal centerline axis 112 to a radial center 683 of the one or more radial thrust bearings 680, as discussed above. The fan actuation system axial length A_{FAS} is an axial length, in the axial direction (e.g., parallel with the longitudinal centerline axis 112), from an axially forward-most surface 615 (shown schematically in FIG. 6) of the fan actuation system 600 to the pitch axis P of the fan blades 140.

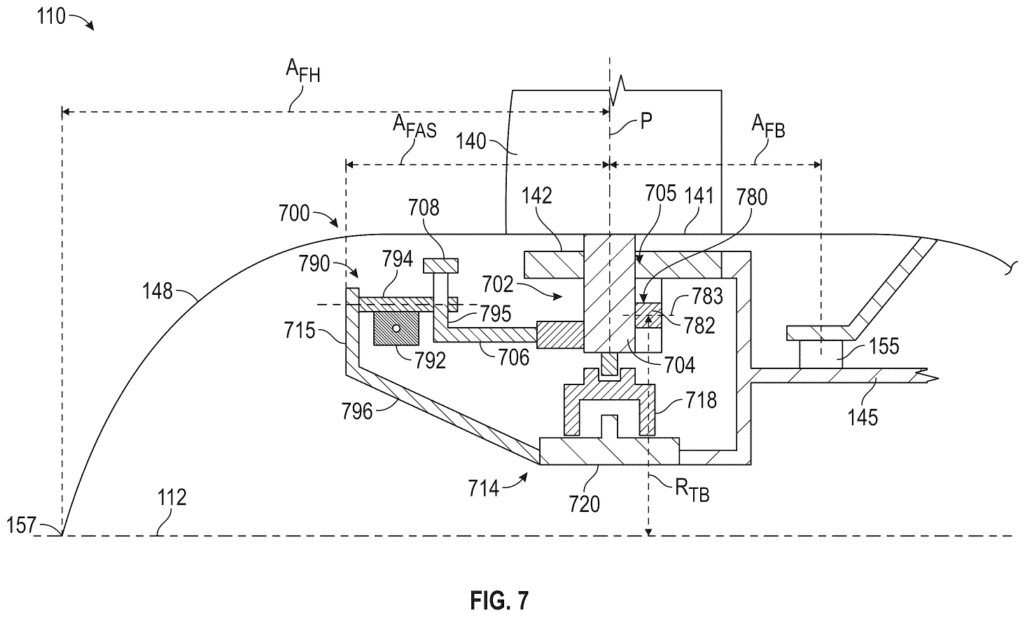

FIG. 7 is a schematic cross-sectional view of a fan actuation system 700 for the turbofan engine 110, taken along the longitudinal centerline axis 112 of the turbofan engine 110, according to the present disclosure. While the fan actuation system 700 is described as being utilized in the turbofan engine 110, the fan actuation system 700 can be utilized in the turbofan engine 210 of FIG. 2. The fan actuation system 700 is substantially similar to the fan actuation system 500 of FIG. 5. The same or similar reference numerals will be used for components of the fan actuation system 700 that are the same as or similar to the components of the fan actuation system 500 discussed above. The description of these components above also applies to this aspect, and a detailed description of these components is omitted here.

The fan actuation system 700 includes a trunnion mechanism 702, a plurality of trunnions 704, an opening 705, one or more trunnion links 706, a unison ring 708, one or more actuators 714, an axially forward-most surface 715, a piston 718, a piston retainer 720, and one or more radial thrust bearings 780. The piston retainer 720 is stationary (e.g., coupled to a static structure of the turbofan engine 110) and the piston 718 moves with respect to the piston retainer 720 to change a pitch of the fan blades 140. For example, the piston 718 can be coupled to a hydraulic cylinder that receives hydraulic fluid for moving the piston 718, as detailed above. The one or more trunnion links 706 include one or more ring gears that mesh with a corresponding gear of the trunnions 704.

The fan actuation system 700 also includes a counterweight assembly 790 including one or more counterweights 792. The counterweights 792 are axially spaced from the trunnions 704 to counter a centrifugal twisting moment of the fan blades 140. The counterweights 792 can be any high-density mass that can rotate about a counterweight centerline. The counterweights 792 can have offset masses that are movable relative to the counterweight centerline. In particular, the counterweights 792 are coupled to one or more counterweight shafts 794 that are drivingly coupled to the trunnion links 706 via one or more counterweight gears 795. The counterweight shafts 794 are supported by one or more counterweight support members 796 that are coupled to the piston retainer 720. In FIG. 7, the axially forward-most surface 715 is defined by an axially forward-most surface of the counterweight support member 796. In this way, the axially forward-most surface 715 is defined by the counterweight assembly 790.

As the trunnions 704 rotate, the trunnions 704 cause the trunnion links 706 to rotate with respect to the unison ring 708, and in turn, the trunnion links 706 cause the counterweight shafts 794 to rotate. As the trunnion links 706 and the counterweight shafts 794 rotate, the counterweights 792 rotate via the counterweight shafts 794. In this way, the counterweights 792 change position relative to the counterweight centerline. Thus, the counterweight assembly 790 counters a centrifugal twisting moment of the fan blades 140 to help rotate the fan blades 140 when the pitch of the fan blades 140 changes.

A mass of the counterweights 792 can be changed based on a length of the counterweight shafts 794. In particular, the counterweights 792 can have less mass with longer counterweight shafts 794 and can have more mass with shorter counterweight shafts 794. In this way, the axially further the counterweights 792 are disposed from the pitch axis P of the fan blades 140, the lesser mass the counterweights 792 can have, while still countering the centrifugal twisting moment of the fan blades 140 and helping to rotate the fan blades 140 when the pitch of the fan blades 140 changes. Accordingly, the mass of the counterweights 792 needed to pitch the fan blades 140 and counter the twisting moment is a function of the axial position of the counterweights 792 with respect to the pitch axis P.

The one or more radial thrust bearings 780 are disposed radially at the thrust bearing radius R_{TB} defined in the radial direction R from the longitudinal centerline axis 112 to a radial center 783 of a plurality of rolling elements 782 of the radial thrust bearings 780, as discussed above. The fan actuation system axial length A_{FAS} is an axial length, in the axial direction (e.g., parallel with the longitudinal centerline axis 112), from an axially forward-most surface 715 of the fan actuation system 700 to the pitch axis P of the fan blades 140.

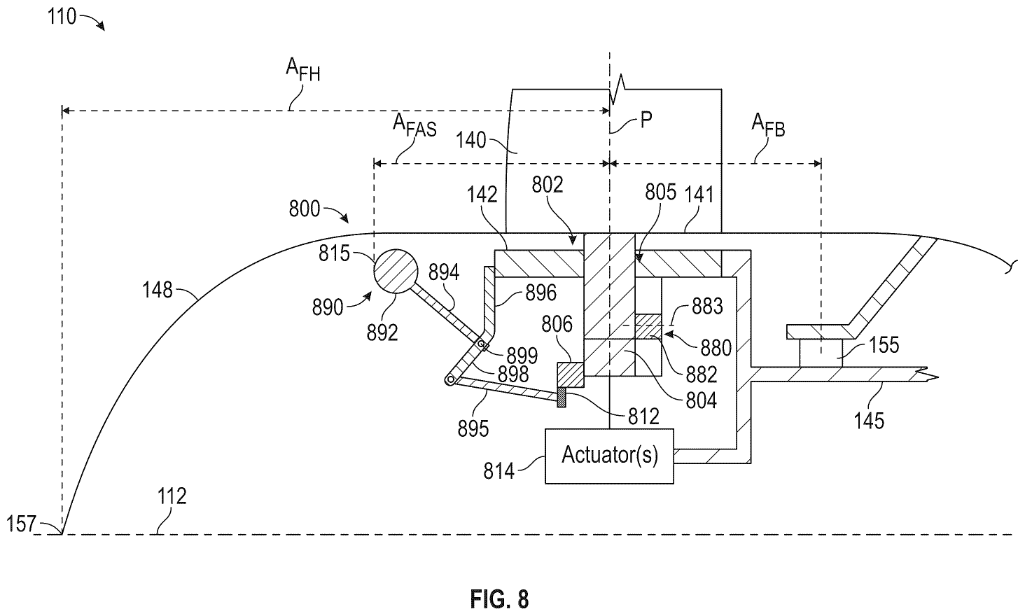

FIG. 8 is a schematic cross-sectional view of a fan actuation system 800 for the turbofan engine 110, taken along the longitudinal centerline axis 112 of the turbofan engine 110, according to the present disclosure. While the fan actuation system 800 is described as being utilized in the turbofan engine 110, the fan actuation system 800 can be utilized in the turbofan engine 210 of FIG. 2. The fan actuation system 800 is substantially similar to the fan actuation system 700 of FIG. 7. The same or similar reference numerals will be used for components of the fan actuation system 800 that are the same as or similar to the components of the fan actuation system 700 discussed above. The description of these components above also applies to this aspect, and a detailed description of these components is omitted here.

The fan actuation system 800 includes a trunnion mechanism 802, a plurality of trunnions 804, an opening 805, one or more trunnion links 806, a plurality of pins 812, one or more actuators 814 (shown schematically in FIG. 8), an axially forward-most surface 815, and one or more radial thrust bearings 880. The actuators 814 can include any of the actuators disclosed herein for changing a pitch of the fan blades 140. The one or more trunnion links 806 include arms that extend from the trunnions 804. The pins 812 extend through the arms and are coupled to a counterweight assembly 890.

The counterweight assembly 890 includes one or more counterweights 892, one or more counterweight shafts 894, and one or more counterweight support members 896. The one or more counterweight support members 896 are coupled to the fan disk 142 such that the counterweight assembly 890 rotates about the longitudinal centerline axis 112 with rotation of the fan 138. The counterweight assembly 890 also includes one or more link arms 895 and one or more lever arms 898. The one or more lever arms 898 are pivotably coupled to the counterweight support members 896 via a pivot 899. The link arms 895 are coupled to the trunnion links 806 via the pins 812 and are pivotably coupled to the lever arms 898. The counterweight shafts 894 are pivotably coupled to the lever arms 898 at the pivot 899.

In FIG. 8, the axially forward-most surface 815 is defined by an axially forward-most surface of the counterweights 892 at a maximum axial extent of the counterweights 892, as detailed further below. In this way, the axially forward-most surface 815 is defined by the counterweight assembly 890.

As the trunnions 804 rotate, the trunnions 804 cause the trunnion links 806 to rotate, and in turn, the trunnion links 806 cause the pins 812 to rotate, and, thus, cause the link arms 895 to pivot. As the link arms 895 pivot, the link arms 895 cause the lever arms 898 to pivot, and, thus, cause the counterweight shafts 894 to pivot about the pivot 899. In this way, the counterweight shafts 894 cause the counterweights 892 to travel along a partially circular arc radially outward away from the longitudinal centerline axis 112 or radially inward towards the longitudinal centerline axis 112. Thus, the counterweight assembly 890 counters a centrifugal twisting moment of the fan blades 140 to help rotate the fan blades 140 when the pitch of the fan blades 140 changes.

The one or more radial thrust bearings 880 are disposed radially at the thrust bearing radius R_{TB} defined in the radial direction R from the longitudinal centerline axis 112 to a radial center 883 of a plurality of rolling elements 882 of the radial thrust bearings 880, as discussed above. The fan actuation system axial length A_{FAS} is an axial length, in the axial direction (e.g., parallel with the longitudinal centerline axis 112), from an axially forward-most surface 815 of the fan actuation system 800 to the pitch axis P of the fan blades 140.

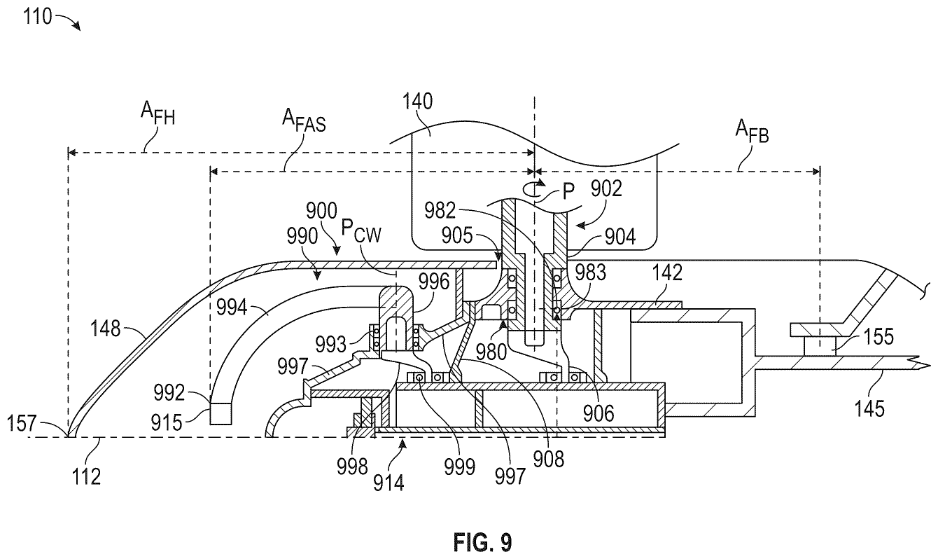

FIG. 9 is a schematic cross-sectional view of a fan actuation system 900 for the turbofan engine 110, taken along the longitudinal centerline axis 112 of the turbofan engine 110, according to the present disclosure. While the fan actuation system 900 is described as being utilized in the turbofan engine 110, the fan actuation system 900 can be utilized in the turbofan engine 210 of FIG. 2. The fan actuation system 900 is substantially similar to the fan actuation system 700 of FIG. 7. The same or similar reference numerals will be used for components of the fan actuation system 900 that are the same as or similar to the components of the fan actuation system 700 discussed above. The description of these components above also applies to this aspect, and a detailed description of these components is omitted here.

The fan actuation system 900 includes a trunnion mechanism 902, a plurality of trunnions 904, an opening 905, one or more trunnion links 906, a unison ring 908, one or more actuators 914, an axially forward-most surface 915, and one or more radial thrust bearings 980. The actuators 914 can include any of the actuators disclosed herein for changing a pitch of the fan blades 140. The one or more trunnion links 906 and the unison ring 908 couple the trunnions 904 to the actuators 914 such that movement of the actuators 914 causes the trunnions 904 to rotate, thus, causing the fan blades 140 to rotate about the pitch axis P.

The counterweight assembly 990 includes one or more counterweights 992, one or more counterweight shafts 994, one or more counterweight support members 996, and one or more lever arms 998. In FIG. 9, the counterweight shafts 994 are counterweight levers and the counterweight support members 996 are counterweight trunnions.

The counterweight assembly 990 includes a counterweight hub 997 that may be connected to the fan disk 142, such that rotation of the fan disk 142 about the longitudinal centerline axis 112 drives rotation of the counterweight hub 997 about the longitudinal centerline axis 112. The counterweight shafts 994 are rotationally connected to the counterweight hub 997. For example, each of the counterweight shafts 994 may be mounted to the counterweight hub 997 via one or more counterweight bearings 993 that provide the ability for the counterweight shafts 994 to rotate about a counterweight lever rotational axis P_{CW}. The counterweight bearings 993 may be any type of bearing (e.g., tapered roller bearings, spherical roller bearings, cylindrical roller bearings, needle roller bearings, thrust ball bearings, angular contact roller bearings, deep groove ball bearings, etc.), and are not limited to any particular type of bearing Each of the counterweight support members 996 are rotational about a counterweight lever rotational axis P_{CW} that extends through a respective counterweight support member 996 and extends radially (i.e., in the radial direction R) from the longitudinal centerline axis 112.

Each counterweight shaft 994 is a cantilever arm having a first end connected to a respective counterweight support member 996 and a second end offset from the respective counterweight lever rotational axis P_{CW}. A respective counterweight 992 is connected to the second end of the counterweight shaft 994. Each counterweight 992 has a counterweight center-of-gravity that is utilized in locating the counterweight 992 within the counterweight assembly 990.

The one or more counterweight support members 996 are coupled to the fan disk 142 such that the counterweight assembly 990 rotates about the longitudinal centerline axis 112 with rotation of the fan 138. The counterweight assembly 990 also includes one or more lever arms 998 that are rotationally connected to the actuators 914 via one or more lever bearings 999. The lever arms 998 are connected to the counterweight support members 996 such that axial translation of the actuators 914 along the longitudinal centerline axis 112 drives the lever arms 998 and the counterweight support members 996 about the respective counterweight lever rotational axis P_{CW} so as to rotate the counterweight shafts 994. In FIG. 9, the counterweight shafts 994 are at a ninety-degree rotated position.

In FIG. 9, the axially forward-most surface 915 is defined by an axially forward-most surface of the counterweights 992 at a maximum axial extent of the counterweights 992 (e.g., at the ninety-degree rotated position). In this way, the axially forward-most surface 915 is defined by the counterweight assembly 990.

As the actuators 914 move axially, the actuators 914 cause the trunnions 904 and the counterweight support members 996 to rotate. In turn, the counterweight support members 996 cause the counterweight shafts 994 to rotate about the counterweight lever rotational axis P_{CW}, and, thus, cause the counterweights 992 to rotate. In particular, the counterweight shafts 994, and the counterweights 992, rotate in to or out of the page between the ninety-degree rotated position that defines a maximum axial extent of the counterweights 992 and a zero-degree rotated position that defines a minimum axial extend of the counterweights 992. Thus, the counterweight assembly 990 counters a centrifugal twisting moment of the fan blades 140 to help rotate the fan blades 140 when the pitch of the fan blades 140 changes.

The one or more radial thrust bearings 980 are disposed radially at the thrust bearing radius R_{TB} defined in the radial direction R from the longitudinal centerline axis 112 to a radial center 983 of a plurality of rolling elements 982 of the radial thrust bearings 980, as discussed above. The fan actuation system axial length A_{FAS} is an axial length, in the axial direction (e.g., parallel with the longitudinal centerline axis 112), from an axially forward-most surface 915 of the fan actuation system 900 to the pitch axis P of the fan blades 140.

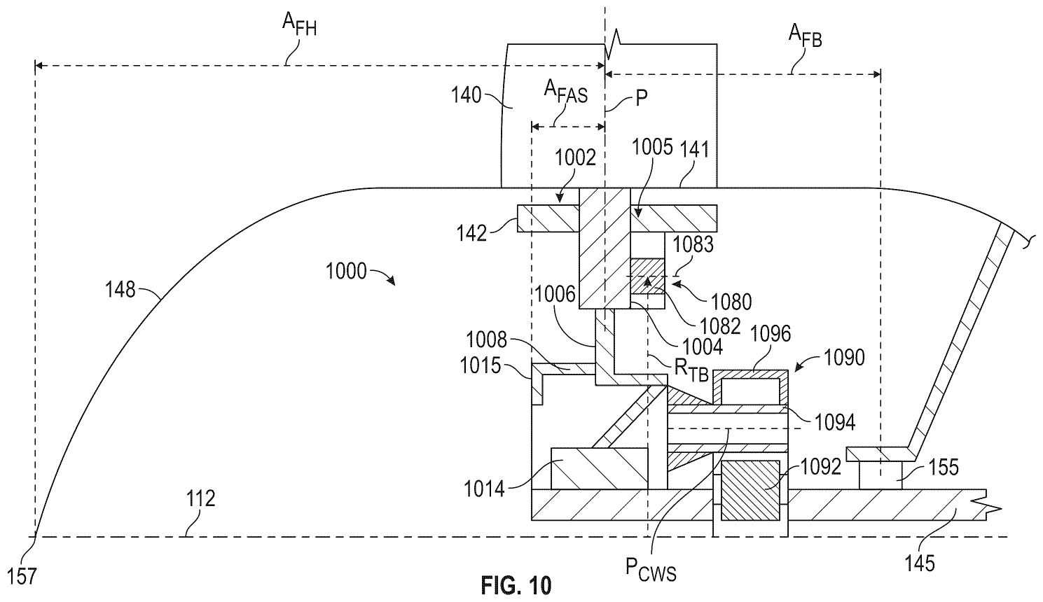

FIG. 10 is a schematic cross-sectional view of a fan actuation system 1000 for the turbofan engine 110, taken along the longitudinal centerline axis 112 of the turbofan engine 110, according to the present disclosure. While the fan actuation system 1000 is described as being utilized in the turbofan engine 110, the fan actuation system 1000 can be utilized in the turbofan engine 210 of FIG. 2. The fan actuation system 1000 is substantially similar to the fan actuation system 500 of FIG. 5. The same or similar reference numerals will be used for components of the fan actuation system 1000 that are the same as or similar to the components of the fan actuation system 500 discussed above. The description of these components above also applies to this aspect, and a detailed description of these components is omitted here.

The fan actuation system 1000 includes a trunnion mechanism 1002, a plurality of trunnions 1004, an opening 1005, one or more trunnion links 1006, a unison ring 1008, one or more actuators 1014, an axially forward-most surface 1015, one or more radial thrust bearings 1080, and a counterweight assembly 1090. The actuators 1014 can include any of the actuators disclosed herein for changing a pitch of the fan blades 140. The one or more trunnion links 1006 and the unison ring 1008 couple the trunnions 1004 to the actuators 1014 such that movement of the actuators 1014 causes the trunnions 1004 to rotate, thus, causing the fan blades 140 to rotate about the pitch axis P. In FIG. 10, the axially forward-most surface 1015 is defined by an axially forward-most surface of the unison ring 1008.

The counterweight assembly 1090 includes one or more counterweights 1092, one or more counterweight shafts 1094, and one or more counterweight support members 1096. The one or more counterweight support members 1096 are coupled to the fan disk 142 via the unison ring 1008 such that the counterweight assembly 1090 rotates about the longitudinal centerline axis 112 with rotation of the fan 138. The counterweights 1092 are positioned axially aft of the fan blades 140, particularly, axially aft of the pitch axis P. For example, the counterweights 1092 are positioned axially between the pitch axis P and the fan bearings 155.

The counterweight support members 1096 act as a carrier for the counterweight shafts 1094. The counterweight shafts 1094 are aligned generally parallel to the longitudinal centerline axis 112 and pass through the counterweight support members 1096. The counterweight shafts 1094 are rotatably connected (e.g., via one or more gears) at a first end to the unison ring 1008. The counterweights 1092 are connected to a second end of the counterweight shafts 1094. The counterweight shafts 1094, and the counterweights 1092, are rotatable relative to the counterweight support members 1096, about a respective counterweight shaft axis PCWs.

All of the counterweight shafts 1094 are meshed via one or more gears with the unison ring 1008. Thus connected, the movement of the fan blades 140, unison ring 1008, and the counterweights 1092 are linked together such that rotary motion of the unison ring 1008, for example, caused by the actuators 1014, will cause a simultaneous change in the pitch angle of all of the fan blades 140, and of the angular orientation of the counterweights 1092. The unison ring 1008 transmits forces between the fan blades 140 and the counterweights 1092. In this way, the counterweight shafts 1094 cause the counterweights 1092 to travel along a partially circular arc radially outward away from the longitudinal centerline axis 112 or radially inward towards the longitudinal centerline axis 112, and axially closer to, or axially further from, the pitch axis P. Thus, the counterweight assembly 1090 counters a centrifugal twisting moment of the fan blades 140 to help rotate the fan blades 140 when the pitch of the fan blades 140 changes.

The one or more radial thrust bearings 1080 are disposed radially at the thrust bearing radius R_{TB} defined in the radial direction R from the longitudinal centerline axis 112 to a radial center 1083 of a plurality of rolling elements 1082 of the radial thrust bearings 1080, as discussed above. The fan actuation system axial length A_{FAS} is an axial length, in the axial direction (e.g., parallel with the longitudinal centerline axis 112), from an axially forward-most surface 1015 of the fan actuation system 1000 to the pitch axis P of the fan blades 140.

As mentioned earlier, the inventors sought to address the problem implementing a variable pitch actuation system within the more limited packaging space available in a turbofan engine and while accounting for the significantly higher loading environment and more numerous blades relative to a turboprop engine. By way of testing various engine architectures the inventors experimented with different configurations of the pitch actuation system, fine and coarse pitch actuators, hydraulic actuators, and bearing placement that could sustain the higher loading associated with more numerous blades, higher disk loading, and Mach speed sufficient to satisfy operational and safety requirements in the event of, e.g., loss of hydraulic pressure. Additionally, while it was possible to arrive at such a system after experiments and testing, there was a challenge to determine how to fit the system within a comparatively more limited space of a turbofan engine.

During the course of evaluating the different embodiments as set forth herein, with the goal of providing the necessary force to pitch the fan blades, taking due account for the number of blades, accounting for loss in fluid pressure or generally lost power conditions, aerodynamic performance, cooling, aeromechanics, and disc loading/fan blade loading, etc., the inventors had discovered there was indeed much less space available for this system to operate as required for the engine's pitch actuation system. After evaluating several different architectures of pitch change mechanisms (with and without counterweight, oil transfer devices, fine and coarse pitch system, torque transfer load path for pitching blades and delivery of shaft power from gearbox, etc.—both for a ducted engine and an open fan engine—it was discovered, unexpectedly, that there is relationships among the number of fan blades, the fan tip diameter D_{FT}, the cruise Mach number, and the thrust bearing radius R_{TB}, and an axial length L_{AXIAL} capable of differentiating an architecture that satisfies operational and packaging requirements from an architecture that does not satisfy these requirements. These relationships moreover are capable of uniquely identifying a finite and readily ascertainable number of embodiments suitable for a particular architecture that accounts for the size and the loading requirements needed to pitch the fan blades without overly sacrificing the aerodynamic performance, cooling aeromechanics, and load margins on the fan blades. For example, the cruise Mach number was not expected to be a significant factor, but as discussed further below, the cruise Mach number was found to be a factor and particularly in conjunction with fan diameter at higher Mach numbers. The inventors submit that the relationships enable one to select a size for the fan pitch actuation system that can reduce the size and the weight of the fan pitch actuation system, while accounting for the factors discussed above. The inventors further submit that the relationships can help identify an improved fan efficiency, or penalties to efficiency by choosing one fan pitch actuation system architecture over another. A relationship is referred to as a fan actuation system (FAS) envelope, in relationship (1):

$$FAS envelope = \frac{{N}_{FB} \times {D}_{FT} \times {M}_{cruise}}{( \frac{{R}_{TB}}{{N}_{FB}} )} . \qquad ( 1 )$$

N_{FB} is the number of fan blades of the fan, D_{FT} is the fan tip diameter, M_{cruise} is the Mach number at cruise (mid-level power operation), and R_{TB} is the thrust bearing radius of the radial thrust bearings (any of the radial thrust bearings detailed herein). N_{FB}×D_{FT}×M_{cruise} is referred to as a loading envelope, and R_{TB}/N_{FB} is referred to as a spacing envelope. Accordingly, the FAS envelope is given by the loading envelope divided by the spacing envelope.

A second relationship is referred to as a fan actuation system length (FASL) envelope, in relationship (2):

$$FASL envelope = \frac{{N}_{FB} \times {D}_{FT}}{{L}_{AXIAL} \times ( \frac{{R}_{TB}}{{N}_{FB}} )} . \qquad ( 2 )$$

N_{FB} is the number of fan blades of the fan, D_{FT} is the fan tip diameter, R_{TB} is the thrust bearing radius of the radial thrust bearings, and L_{AXIAL} is an axial length, along the longitudinal centerline axis 112 from the fan hub tip 157 to the fan bearings 155. In particular, L_{AXIAL} is a summation of the fan hub axial length A_{FH} and the fan bearing axial length A_{FB}. N_{FB}×D_{FT} is referred to as a loading envelope, and L_{ANIAL}×(R_{TB}/N_{FB}) is referred to as a spacing envelope. Accordingly, the FASL envelope is given by the loading envelope divided by the spacing envelope.

As discussed further below, the inventors identified a range for the FAS envelope and the FASL envelope that enables a fan actuation system design for different turbofan engine architectures that accounts for the integrity/reliability of load paths needed to pitch the fan blades within the space constraints imposed by a turbofan engine (vs. a turboprop's space constraints). Fan pitch actuation system architectures that fall within this range are believed to satisfy packaging requirements for a turbofan engine, while those architectures that do not fall within the FAS envelope range or the FASL envelope range are believed to not satisfy the packaging requirements, which indicate that the system would be unacceptably large and not result in an aircraft engine that met aero efficiency and weight requirements (i.e., an undesirable engine architecture). Using these unique relationships, the size of the fan actuation system can be selected to achieve a more compact fan pitch actuation system for a turbofan engine. Using the FAS envelope or the FASL envelope as a guide, a fan pitch actuation system can be developed that takes into account the loading associated with pitching of the fan blades based on the size of the fan blades, the number of fan blades, the size of thrust bearing, the cruise Mach number, or the axial length, which factors were found—as a result of the extensive number of architectures considered for different thrust class engines, some successful and some not successful—to largely define the packaging size needed to accommodate a pitch actuation system capable of handling the fan loading environment.

Table 1 represents exemplary embodiments 1 to 14 and their corresponding FAS envelope and FASL envelope values for various turbofan engines at various cruise Mach numbers. Embodiments 1 to 14 may represent the turbofan engine 110 of FIG. 1 (e.g., ducted engine) or the turbofan engine 210 of FIG. 2 (e.g., unducted fan engine) and can be applied to any of the pitch actuation systems detailed herein. In particular, embodiments 7, 9, and 13 are ducted engines (e.g., such as the turbofan engine 110 of FIG. 1), and embodiments 1 to 6, 8, 10 to 12, and 14 are unducted fan engines (e.g., such as the turbofan engine 210 of FIG. 2). In Table 1, the FAS envelope values were determined based on relationship (1) described above, the FASL envelope values were determined based on relationship (2) described above, and using fan tip diameters D_{FT}, thrust bearing radiuses R_{TB}, and axial lengths L_{AXIAL} in inches.

TABLE 1

| | | D_{FT} | R_{TB} | A_{FH} | A_{FB} | | FAS | FASL |
|---|---|---|---|---|---|---|---|---|
| Emb. | N_{FB} | (in.) | (in.) | (in.) | (in.) | M_{cruise} | Envelope | Envelope |
| 1 | 12 | 156.0 | 26.9 | 60.60 | 21.60 | 0.8 | 668 | 10.2 |
| 2 | 14 | 156.0 | 24.9 | 60.60 | 20.98 | 0.8 | 982 | 15.1 |
| 3 | 14 | 154.0 | 24.7 | 59.82 | 20.92 | 0.8 | 978 | 15.1 |
| 4 | 14 | 153.8 | 24.3 | 59.75 | 20.79 | 0.8 | 992 | 15.4 |
| 5 | 14 | 164.3 | 24.6 | 63.82 | 20.89 | 0.8 | 1047 | 15.5 |
| 6 | 14 | 110.4 | 19.5 | 42.89 | 19.31 | 0.8 | 888 | 17.8 |
| 7 | 12 | 88.7 | 19.0 | 34.46 | 19.15 | 0.9 | 605 | 12.5 |
| 8 | 10 | 120.0 | 14.8 | 46.62 | 17.85 | 0.9 | 730 | 12.6 |
| 9 | 10 | 84.0 | 14.0 | 32.63 | 17.61 | 0.75 | 450 | 11.9 |
| 10 | 18 | 168.0 | 27.0 | 65.26 | 21.63 | 0.9 | 1814 | 23.2 |
| 11 | 10 | 120 | 14.0 | 46.62 | 17.61 | 0.8 | 686 | 13.3 |
| 12 | 14 | 168.0 | 19.0 | 65.26 | 19.15 | 0.88 | 1525 | 20.5 |
| 13 | 10 | 84.0 | 19.0 | 32.63 | 19.15 | 0.8 | 354 | 8.5 |
| 14 | 14 | 120.0 | 27.0 | 46.62 | 21.63 | 0.88 | 767 | 12.8 |
| 15 | 14 | 180.0 | 19.0 | 69.92 | 19.15 | 0.92 | 1708 | 20.8 |

The FAS envelope and the FASL envelope are only valid for an engine with fan blades N_{FB} in a range from ten to eighteen for a ducted engine, and from ten to sixteen for an open fan engine. In some aspects, the number of fan blades N_{FB} is in ten to fourteen for an open fan engine. The number of fan blades N_{FB} affects the volume (e.g., amount of space) circumscribed by the fan blades. Increasing the number of fan blades N_{FB} increases the amount of airflow that the fan can produce for a particular fan tip diameter and fan rotation speed, but a higher N_{FB} also reduces the tangential distance TFB between fan blades at the fan hub, which impacts the available space for pitch actuation of each individual blade, referring to the space needed per blade for pitch levers, gearing, oil transfer devices, related mechanisms for pitching fan blades and size of load bearing parts of the trunnion and related supporting structure capable of carrying the fan blade loads. This space is at a premium because with an increased number of fan blades the loading capability per blade needs to be satisfied within a smaller space compared to an engine with fewer blades (e.g., such as a turboprop engine). The FAS envelope values and the FASL envelope values account for the number of fan blades N_{FB} selected to increase the amount of airflow but without imposing an unrealistically narrow tangential fan blade distance TFB between adjacent fan blades in order to fit within the desired packaging envelope.

The FAS envelope and the FASL envelope are only valid for a fan tip diameter D_{FT} in a range from eighty-four inches to one hundred ninety-two inches (84.0 in. to 192.0 in.). In some aspects, the FAS envelope and the FASL envelope are valid for a fan tip diameter D_{FT} in a range from eighty-four inches to one hundred eighty inches (84.0 in. to 180.0 in.). In some aspects, the FAS envelope and the FASL envelope are valid for a fan tip diameter D_{FT} in a range from eighty-four inches to one hundred sixty-eight inches (84.0 in. to 168.0 in.). The fan tip diameter D_{FT} also affects the volume needed for supporting the fan blades during operation. Increasing the fan tip diameter D_{FT} increases the fan tip speed for a given rotational speed and therefore the load that needs to get reacted at the trunnion, and torque needed in the pitching mechanism for pitching the blade. The radial spacing between blades and within the volume circumscribed by the fan blades (e.g., within the space circumscribed by the radial thrust bearings) decreases, thereby decreasing the volume beneath the fan and providing less space for the load bearing structure that can react the blade loads. Furthermore, as the bearing radius R_{TB} is extended out, the structure supporting the blade at its root needs to be capable of sustaining higher loads because the blade is disposed further from the fan rotation axis. The more robust root results in a larger fan disk, further providing less space underneath the fan for the fan actuation system. In view of these weight and size considerations, as well as the ability to install such fan blades and fans without resulting in unacceptable aero efficiency penalties, the inventors determined that a fan tip diameter D_{FT} should be less than one hundred ninety-two inches (192.0 in.). In some aspects, the fan tip diameter D_{FT} should be less than one hundred eighty inches (180.0 in.). In some aspects, the fan tip diameter D_{FT} should be less than one hundred sixty-eight inches (168.0 in.). The fan tip diameter D_{FT} may therefore be limited as it impacts the space available for a pitch actuation system suitable for carrying fan blade loads. The size of the fan blades in ducted engines is limited by the duct (e.g., the nacelle). In embodiments for a ducted engine (e.g., the turbofan engine 110 of FIG. 1), the fan tip diameter DET is in a range from eighty-four inches to one hundred twenty inches (84.0 in. to 120.0 in.). In embodiments for an open fan engine (e.g., the turbofan engine 210 of FIG. 2), the fan tip diameter D_{FT} is in a range from one hundred twenty inches to one hundred ninety-two inches (120.0 in. to 192.0 in.). In some aspects for an open fan engine (e.g., the turbofan engine 210 of FIG. 2), the fan tip diameter D_{FT} is in a range from one hundred twenty inches to one hundred eighty inches (120.0 in. to 180.0 in.). In some aspects for an open fan engine (e.g., the turbofan engine 210 of FIG. 2), the fan tip diameter D_{FT} is in a range from one hundred twenty inches to one hundred sixty-eight inches (120.0 in. to 168.0 in.).

The FAS envelope and the FASL envelope are only valid for a thrust bearing radius R_{TB} in a range from ten inches to twenty-seven inches (10 in. to 27 in.). In some aspects, the thrust bearing radius R_{TB} is in a range from twelve inches to twenty-seven inches (12 in. to 27 in.). In some aspects, the thrust bearing radius R_{TB} is in a range from fourteen inches to twenty-seven inches (14 in. to 27 in.). The thrust bearing radius R_{TB} defines the amount of space, or the volume available for the fan actuation system. Increasing the thrust bearing radius R_{TB} provides more space for the fan actuation system but sacrifices aerodynamic performance by making the fan hub radius ratio (i.e., the ratio of the fan hub radius to the fan blade radius) larger. Decreasing the thrust bearing radius R_{TB} reduces the fan hub radius ratio and reduces the size of the turbofan engine but provides less space to carry the loads from the fan blades. The thrust bearing radius R_{TB} reflects the need for adequately accommodating the diameter needed for packaging the fan actuation system but without overly sacrificing aerodynamic performance of the turbofan engine. In embodiments for a ducted engine (e.g., the turbofan engine 110 of FIG. 1), the thrust bearing radius R_{TB} is in a range from twelve inches to nineteen inches (12 in. to 19 in.). In some aspects for a ducted engine, the thrust bearing radius R_{TB} is in a range from fourteen inches to nineteen inches (14 in. to 19 in.). In embodiments for an open fan engine (e.g., the turbofan engine 210 of FIG. 2), the thrust bearing radius R_{TB} is in a range from ten inches to twenty-seven inches (10 in. to 27 in.). In some aspects for an open fan engine (e.g., the turbofan engine 210 of FIG. 2), the thrust bearing radius R_{TB} is in a range from twelve inches to twenty-seven inches (12 in. to 27 in.). In some aspects for an open fan engine, the thrust bearing radius R_{TB} is in a range from nineteen inches to twenty-seven inches (19 in. to 27 in).

The FAS envelope and the FASL envelope are valid for a cruise Mach number M_{cruise} in a range from 0.7 to 0.92. In some aspects, the FAS envelope and the FASL envelope are valid for a cruise Mach number M_{cruise} in a range from 0.7 to 0.9. As mentioned above, turbofan engines operate at higher cruise speeds than turboprop engines. At higher cruise speeds, the aerodynamic loads on fan blades increase, thereby requiring more torque for actuating blades in pitch. This means a larger actuation system is needed to handle the higher reaction loads resulting when a torque is applied in flight to change the blade pitch, to move the blade to a feathered position, or coarse/fine pitch changes. The cruise Mach number M_{cruise} reflects this higher loading environment when pitching fan blades. In some aspects, the cruise Mach number M_{cruise} in a range from 0.75 to 0.9. In some aspects, the cruise Mach number M_{cruise} is in a range from 0.8 to 0.88.

The FAS envelope and the FASL envelope are only valid for a fan hub axial length A_{FH} of twenty-five inches to eighty-five inches (25 in. to 85 in.). In some aspects, the FAS envelope and the FASL envelope are only valid for a fan hub axial length A_{FH} of twenty-five inches to seventy-five inches (25 in. to 75 in.). In some aspects, the FAS envelope and the FASL envelope are only valid for a fan hub axial length A_{FH} of forty inches to eighty-five inches (40 in. to 85 in.). The fan hub axial length A_{FH} defines the amount of axial space, or the volume available for the fan actuation system, forward of the pitch axis P of the fan blades 140. Increasing the fan hub axial length A_{FH} provides more space for the fan actuation system but increases the overall weight of the turbofan engine. Decreasing the fan hub axial length A_{FH} reduces the fan performance and the pressure distribution to the fan due to a smaller axial length for the aerodynamic flow lines into the fan hub but provides less axial space to fit the fan actuation system within the fan hub 148. The fan hub axial length A_{FH} reflects the need for aerodynamic performance for the fan and adequately accommodating the axial length needed for packaging the fan actuation system but without overly sacrificing aerodynamic performance of the turbofan engine and allowing for a more efficient fan actuation system. In embodiments for a ducted engine (e.g., the turbofan engine 110 of FIG. 1), the fan hub axial length A_{FH} is in a range from twenty-five inches to forty inches (25 in. to 40 in.). In some aspects for an open fan engine (e.g., the turbofan engine 210 of FIG. 2), the fan hub axial length A_{FH} is in a range from twenty-five inches to seventy-five inches (25 in. to 75 in). In some aspects for an open fan engine (e.g., the turbofan engine 210 of FIG. 2), the fan hub axial length A_{FH} is in a range from forty inches to eighty-five inches (40 in. to 85 in). In this way, the fan hub axial length A_{FH} is greater for open fan engines as compared to ducted fan engines as more space is needed due to the longer fan blades of the open fan engines as compared to the ducted engines.

The FAS envelope and the FASL envelope are only valid for a fan bearing axial length A_{FB} of ten inches to twenty-three inches (10 in. to 23 in.). In some aspects, the FAS envelope and the FASL envelope are only valid for a fan bearing axial length A_{FB} of sixteen inches to twenty-three inches (16 in. to 23 in.). The fan bearing axial length A_{FB} defines the amount of axial space, or the volume available for the fan actuation system, aft of the pitch axis P of the fan blades 140. Increasing the fan bearing axial length A_{FB} provides more space for the fan actuation system but increases the overall weight of the engine and increases loads on the bearings. Decreasing the fan bearing axial length A_{FB} decreases overall engine weight and reduces loads on the bearings but provides less axial space to fit the fan actuation system within the fan hub 148. The fan bearing axial length A_{FB} reflects the need for adequately accommodating the axial length needed for packaging the fan actuation system while minimizing the fan bearing axial length A_{FB} to reduce loads on the bearings and reduce overall weight of the engine. In embodiments for a ducted engine (e.g., the turbofan engine 110 of FIG. 1), the fan hub axial length A_{FH} is in a range from seventeen inches to twenty inches (17 in. to 20 in.). In embodiments for an open fan engine (e.g., the turbofan engine 210 of FIG. 2), the fan hub axial length A_{FH} is in a range from ten inches to twenty-three inches (10 in. to 23 in). In some aspects for an open fan engine (e.g., the turbofan engine 210 of FIG. 2), the fan hub axial length A_{FH} is in a range from sixteen inches to twenty-three inches (16 in. to 23 in).

FIG. 11 represents, in graph form, the FAS envelope as a function of the loading envelope (N_{FB}×D_{FT}×M_{cruise}). An area 1100 represents the boundaries of the FAS envelope. The FAS envelope is in a range from three hundred to one thousand eight hundred sixty (300 to 1860) for a loading envelope in a range from five hundred eighty-eight inches to two thousand seven hundred twenty-two inches (588 in. to 2722 in.). Table 1 and FIG. 11 show that the FAS envelope increases as the loading envelope increases. In this way, the FAS envelope increases as the number of fan blades N_{FB}, the fan tip diameter D_{FT}, or the cruise Mach number M_{cruise} increase. The range of the FAS envelope identifies the specific architectures that can accommodate the fan pitch actuation system, accounting for both the mechanisms and structural load paths needed to pitch the fan blades under an aerodynamic loading, but without exceeding the volume available for packaging the pitch actuation system within the limited space of a turbofan engine.

A first area 1102 represents the boundaries of the FAS envelope for ducted engines, such as, for example, the turbofan engine 110 of FIG. 1. A second area 1104 represents the boundaries of the FAS envelope for unducted fan engines, such as, for example, the turbofan engine 210 of FIG. 2. Ducted engines tend to have more limited space for the fan actuation system due to the presence of a fan casing, fan duct, or outer nacelle. On the other hand, the fan actuation system of ducted engines are expected to experience lower loads associated with supporting fan blades and pitching fan blades due to the fan blades having a smaller diameter compared to an open fan engine. The FAS envelope, represented by the first area 1102, is in a range from three hundred to six hundred sixty (300 to 660) for ducted engines. The FAS envelope, represented by the second area 1104, is in a range from six hundred sixty to one thousand eight hundred sixty (660 to 1860) and, preferably, in a range from six hundred sixty to one thousand twenty (660 to 1020) and includes open fan engines.

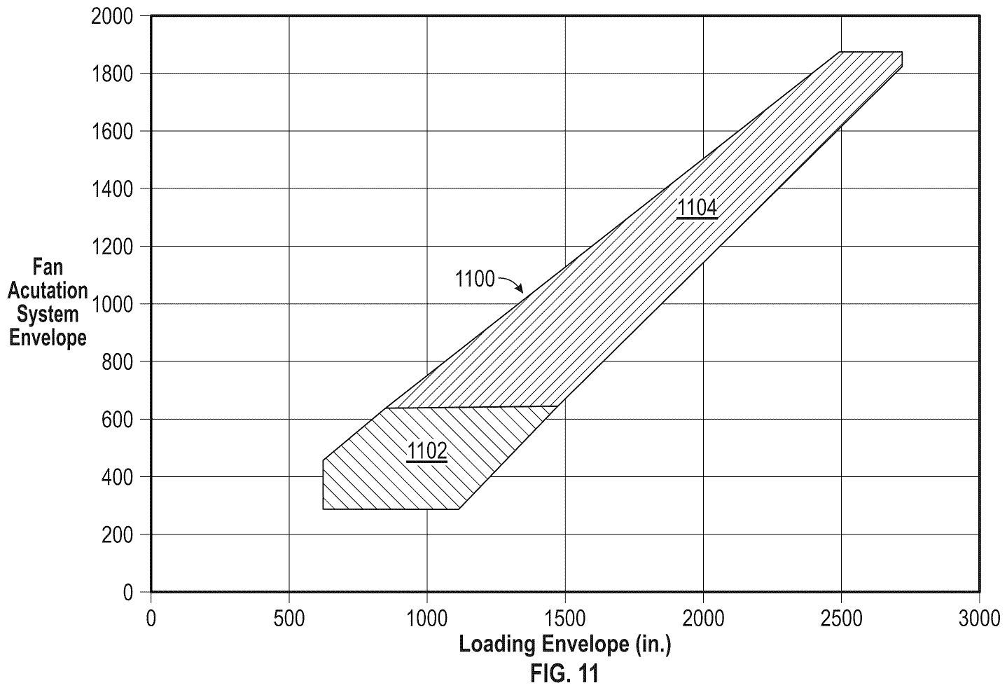

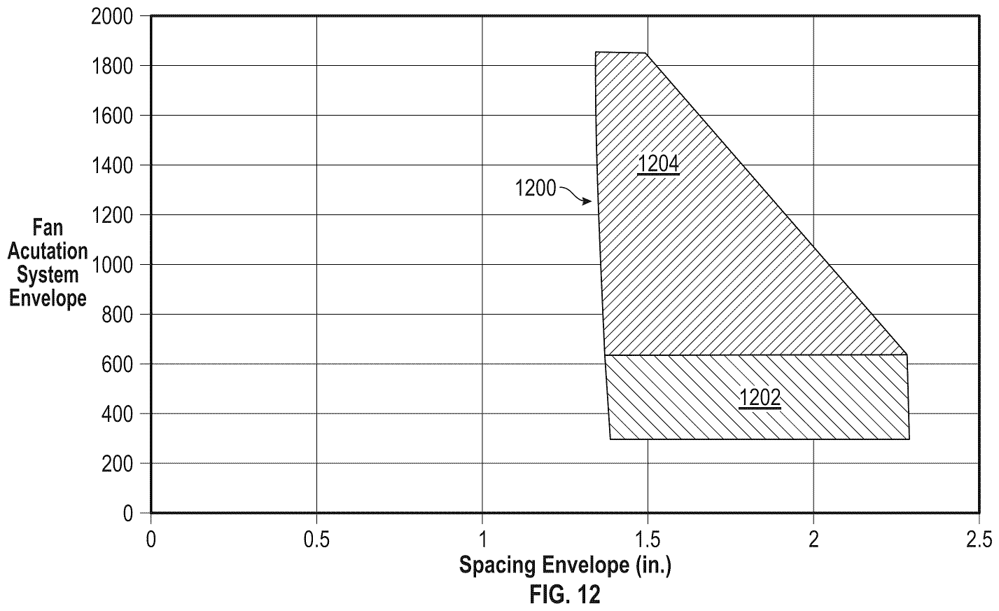

FIG. 12 represents, in graph form, the FAS envelope as a function of the spacing envelope (R_{TB}/N_{FB}). An area 1200 represents the boundaries of the FAS envelope. The FAS envelope is in a range from three hundred to one thousand eight hundred sixty (300 to 1860) for a spacing envelope in a range from one point three five inches to two point two five inches (1.35 in. to 2.25 in.). Table 1 and FIG. 12 show that the FAS envelope decreases as the spacing envelope increases. In this way, the FAS envelope decreases as the thrust bearing radius R_{TB} increases or the number of fan blades N_{FB} decreases. A first area 1202 represents the boundaries of the FAS envelope for ducted engines, and is in a range from three hundred to six hundred sixty (300 to 660) for ducted engines, as detailed above. A second area 1204 represents the boundaries of the FAS envelope for unducted fan engines, and is in a range from six hundred sixty to one thousand eight hundred sixty (660 to 1860) and, preferably, in a range from six hundred sixty to one thousand twenty (660 to 1020), as detailed above.

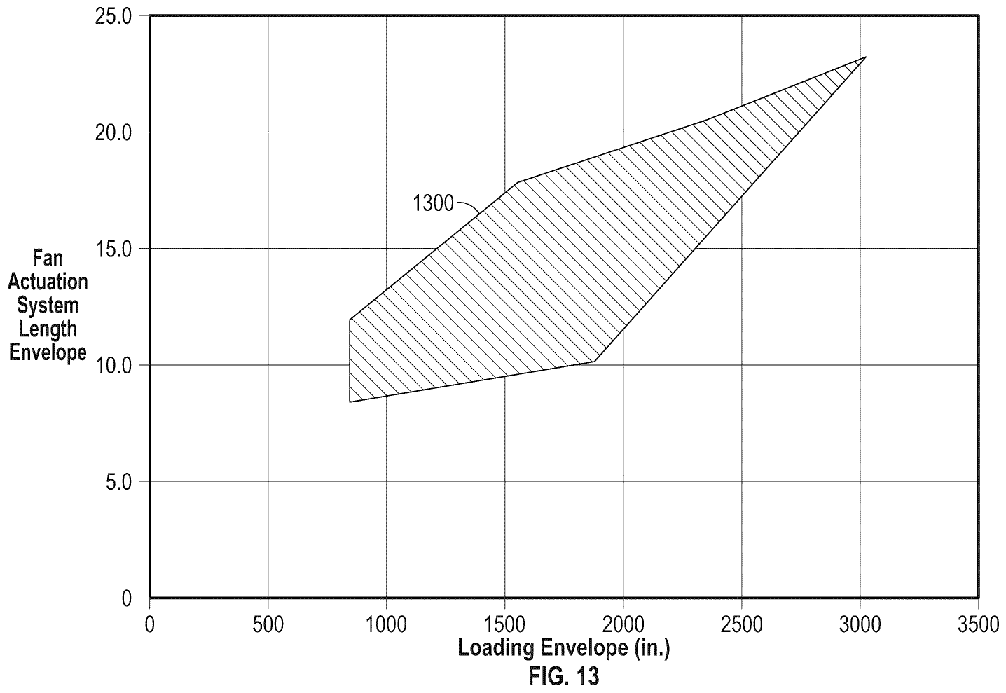

FIG. 13 represents, in graph form, the FASL envelope as a function of the loading envelope (N_{FB}×D_{FT}). An area 1300 represents the boundaries of the FASL envelope. The FASL envelope is in a range from eight point five to twenty-four (8.5 to 24) for a loading envelope in a range from eight hundred forty inches to three thousand twenty-four inches (840 in. to 3,024 in.). Table 1 and FIG. 13 show that the FASL envelope increases as the loading envelope increases. In this way, the FASL envelope increases as the number of fan blades N_{FB} or the fan tip diameter D_{FT} increase. The range of the FASL envelope identifies the specific architectures that can accommodate the fan pitch actuation system, accounting for both the mechanisms and structural load paths needed to pitch the fan blades under an aerodynamic loading, but without exceeding the volume available for packaging the pitch actuation system within the limited space of a turbofan engine. As mentioned above, ducted engines tend to have more limited space for the fan actuation system due to the presence of a fan casing, fan duct, or outer nacelle, while experiencing lower loads associated with supporting fan blades and pitching fan blades due to the fan blades having a smaller diameter compared to an open fan engine. For ducted engines, the FASL envelope is in a range from eight point five to thirteen (8.5 to 13).

FIG. 14 represents, in graph form, the FASL envelope as a function of the spacing envelope L_{AXIAL}×(R_{TB}/N_{FB}). An area 1400 represents the boundaries of the FASL envelope. The FASL envelope is in a range from eight point five to twenty-four (8.5 to 24) for a spacing envelope in a range from seventy square inches to one hundred eighty-five square inches (70 in.² to 185 in.²). Table 1 and FIG. 14 show that the FASL envelope decreases as the spacing envelope increases. In this way, the FASL envelope decreases as the thrust bearing radius R_{TB} increases, or the number of fan blades N_{FB} or the axial length L_{AXIAL} decreases. As mentioned above, for ducted engines, the FASL envelope is in a range from eight point five to thirteen (8.5 to 13).

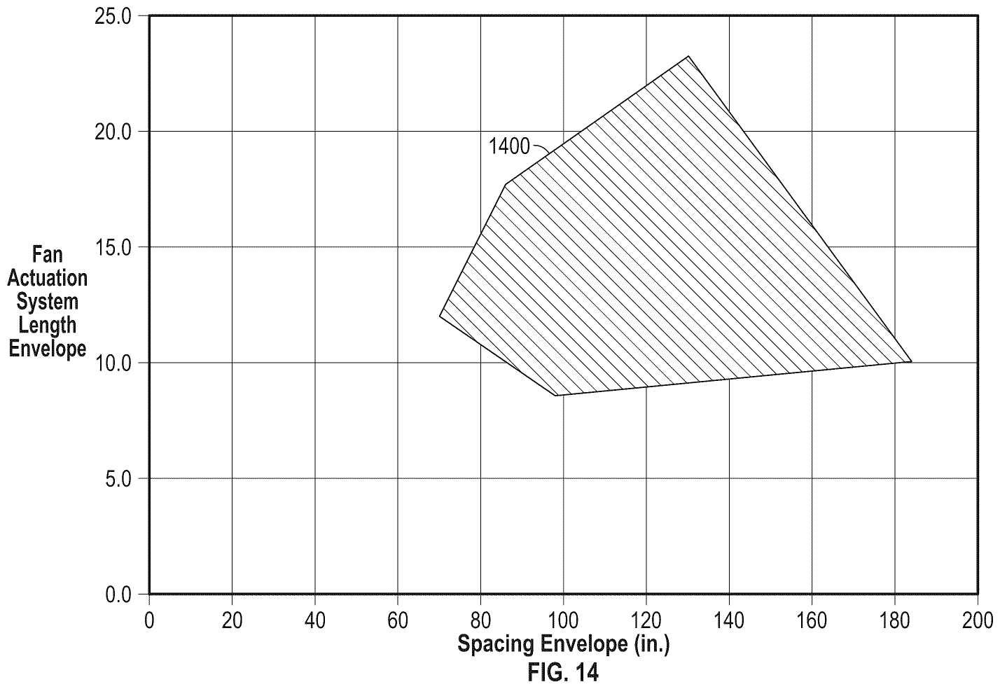

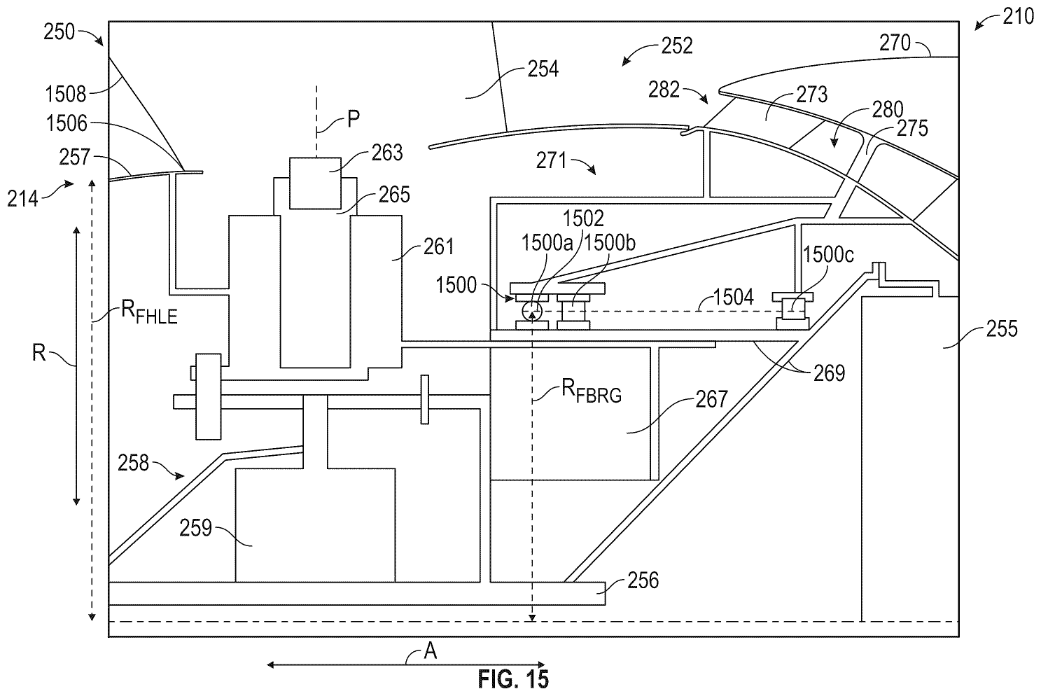

The FAS envelope and the FASL envelope herein provide a fan actuation system a low fan hub radius ratio (a ratio of the hub radius of the blades to the tip radius of the blades of the fan) and a high fan blade count. In one example, a low hub fan radius ratio is in a range from 0.22 to 0.30. This allows the fan diameter to be minimized to meet competing efficiency and installation requirements. To further enable a low fan hub radius ratio, the turbofan engine can include a relatively high fan bearing radius relative to the fan hub radius, as detailed further below with respect to FIGS. 15 to 20. Such a high fan bearing radius allows for a desired packaging of, e.g., the fan actuation system and the fan counterweights. The increased fan bearing radius allows the fan bearings to carry the forward thrust load of the turbofan engine while minimizing, e.g., any moments on the fan bearings in the event of a variation in a distribution of the forward thrust load on the fan bearings. In this way, the high fan bearing radius allows for a variable pitch fan (e.g., the inclusion of a fan actuation system) while maintaining a low fan hub radius ratio and a smaller outer casing, which provides for less drag and a larger frontal area for a given fan blade size.

FIG. 15 is a schematic view of the forward end 214 of the fan assembly 250 of the turbofan engine 210 of FIG. 2. As depicted in FIG. 15, each fan blade 254 defines a base 263 at an inner end along a radial direction R. Each fan blade 254 is coupled at the base 263 to a disk 261 via a trunnion mechanism 265. In FIG. 15, the base 263 is configured as a dovetail received within a correspondingly shaped dovetail slot of the trunnion mechanism 265. In other aspects, the base 263 may be attached to the trunnion mechanism 265 in any other suitable manner. For example, the base 263 may be attached to the trunnion mechanism 265 using a pinned connection, or any other suitable connection. In still other aspects, the base 263 may be formed integrally with the trunnion mechanism 265. Notably, the trunnion mechanism 265 facilitates rotation of a respective fan blade 254 about the pitch axis P of the respective fan blades 254. The fan assembly 250 can also include one or more fan counterweights 267 to balance the fan 252 during operation. Further, the disk 261 is attached to the gearbox assembly 255 through the fan shaft 256, which includes one or more individual structural members 269.

The fan assembly 250 includes a fan frame 271 that is connected to the fan cowl 270 through an inlet vane 273 and a strut 275. In this way, the fan frame 271 is a static or a stationary component that supports static components of the fan assembly 250. While the fan frame 271 is depicted as being connected to the fan cowl 270 through both the inlet vane 273 and the strut 275, the fan frame 271 can be connected to the fan cowl 270 through at least one of the inlet vane 273 or the strut 275.

The fan assembly 250 also includes one or more fan bearings 1500 for supporting rotation of the various rotating components of the fan assembly 250, such as the plurality of fan blades 254 via the fan shaft 256 and the disk 261. More particularly, the various rotating components of the fan assembly 250 rotate with respect to the fan frame 271 via the one or more fan bearings 1500. In FIG. 15, the one or more fan bearings 1500 includes a first fan bearing 1500a, a second fan bearing 1500b, and a third fan bearing 1500c. The first fan bearing 1500a is a ball bearing, the second fan bearing 1500b is a roller bearing, and the third fan bearing 1500c is a roller bearing. The first fan bearing 1500a is positioned forward of the second fan bearing 1500b and the third fan bearing 1500c. The fan bearings 1500 can include any other suitable number or type of bearings for supporting rotation of the plurality of fan blades 254. For example, the one or more fan bearings 1500 can include a pair (two) tapered roller bearings, or any other suitable bearings.

Referring still to FIG. 15, the one or more fan bearings 1500 are located axially aft of the disk 261 and the trunnion mechanisms 265 and radially outward of the one or more actuators 259 along the radial direction R and also outward of the one or more fan counterweights 267 along the radial direction R. In particular, the fan bearings 1500 are located axially between the disk 261 and the gearbox assembly 255. Such a configuration of the fan bearings 1500 allows for the actuators 259 to be axially aligned with the disk 261 and the trunnion mechanisms 265 along the axial direction A and radially inward of the disk 261 and the trunnion mechanisms 265 along the radial direction R. Moreover, such a configuration allows for the one or more fan counterweights 267 to be positioned adjacent to the one or more actuators 259.

As shown in FIG. 15, the one or more fan bearings 1500 define a fan bearing radius R_{FBRG} along the radial direction R. The fan bearing radius R_{FBRG} is defined as a distance along the radial direction R from the longitudinal centerline axis 212 of the turbofan engine 210 to a central axis or a center point of the one or more fan bearings 1500. More particularly, each of the first fan bearing 1500a, the second fan bearing 1500b, and the third fan bearing 1500c are radially aligned such that a center point 1502 of the first fan bearing 1500a and a central axis 1504 of the second fan bearing 1500b and the third fan bearing 1500c are each positioned at the same radial distance from the longitudinal centerline axis 212. In some aspects, one or more of the fan bearings 1500 may be stepped or otherwise positioned at different distances from the longitudinal centerline axis 212 along the radial direction R. In such aspects, the fan bearing radius R_{FBRG} refers to a radius of the innermost fan bearing 1500 along the radial direction R (i.e., a distance of the central point 1502 or the center axis 1504 of the innermost fan bearing 1500 along the radial direction R to the longitudinal centerline axis 212).

The fan hub 257 defines a fan hub leading edge radius R_{FHLE} along the radial direction R. The fan hub leading edge radius R_{FHLE} is defined as a radial distance of an outermost point of the fan hub 257 along the radial direction R to the longitudinal centerline axis 212 of the turbofan engine 210. In particular, the fan hub leading edge radius R_{FHLE} is a distance along the radial direction R from the longitudinal centerline axis 212 to a radially innermost point 1506 of a leading edge 1508 of the fan blades 254 (to the fan root 251 at the leading edge 1508. The fan hub leading edge radius R_{FHLE} is indicative of an overall size of a core portion of the fan assembly 250. Accordingly, the fan assembly 250 defines a fan bearing radius ratio R_{FHLE}:R_{FBRG} (i.e., a ratio of the fan hub leading edge radius R_{FHLE} to the fan bearing radius R_{FBRG}) in a range from 1.0 to 2.75. In some aspects, the fan bearing radius ratio is less than or equal to 2.75, such as less than or equal to 2.5, such as less than or equal to 2.0, such as less than or equal to 1.75. More particularly, the hub radius to fan bearing radius ratio R_{FHLE}:R_{FBRG} is greater than or equal to 1.0 and less than or equal to 1.5.

The plurality of fan blades 254 are rotatable about the axial direction A at a maximum rotational speed during operation of the fan assembly 250. The maximum rotational speed refers to a maximum speed at which the fan blades 254 are configured to rotate during a full power condition of the turbofan engine 210, such as when the turbofan engine 210 is generating a maximum takeoff thrust. The one or more fan bearings 1500 supporting rotation of the plurality of fan blades 254 may define a DN value during operation of the fan assembly 250 and rotation of the plurality of fan blades 254 at the maximum rotational speed of at least about 0.6 million. For example, in certain exemplary embodiments, the one or more fan bearings 1500 supporting rotation of the plurality of fan blades 254 may define a DN value during rotation of the plurality of fan blades 254 of at least 0.7 million, at least 0.8 million, at least 1 million, or at least 1.5 million. As used herein, the term “DN value” refers to a fan bearing speed quantifier calculated by multiplying a bore of the bearing in millimeters by a rotational speed in revolutions per minute (RPM). The bore of the one or more fan bearings 1500 supporting rotation of the plurality of fan blades 254 of the fan assembly 250 refers to a distance from the longitudinal centerline axis 112 to an inner race of the one or more fan bearings 1500.

Accordingly, in order to maintain the DN value of the one or more fan bearings 1500 below one or more of the above stated DN values, the fan assembly 250 may define a relatively low maximum rotational speed during operation. For example, in certain exemplary embodiments, the fan assembly 250 may define a maximum rotational speed in a range from 300 RPM to 8,500 RPM during operation. In some aspects, the maximum rotational speed is less than 8,500 RPM during operation. More specifically, in certain exemplary embodiments, the fan assembly 250 may define a maximum rotational speed of less than 8,000 RPM during operation, less than 7,500 rpm during operation, less than 7,000 RPM during operation, less than 6,500 rpm during operation, or less than 6,000 RPM during operation. In some aspects, the maximum rotational speed is in a range from 300 RPM to 1,100 RPM during operation.

As discussed above, inclusion of a relatively high fan bearing radius relative to a fan hub radius may allow for a desired packaging of, e.g., the fan actuation system and one or more fan counterweights in the fan assembly of the turbofan engine. Moreover, when the turbofan engine is an indirect drive turbofan engine (e.g., including a gearbox connecting a driveshaft and a fan shaft while reducing a rotational speed of the fan shaft relative to the driveshaft) the increased fan bearing radius may additionally provide for a more stable fan during operation. Specifically, with direct drive turbofan engine (e.g., without a gearbox), a forward thrust load generated by the fan during operation may be counteracted by a reverse thrust load generated by the turbine section of the turbofan engine (the turbine section being directly connected to the fan via a shaft in such a configuration). By contrast, within an indirect drive turbofan engine, such as the turbofan engine 110 depicted in FIG. 1 and the turbofan engine 210 in FIG. 2, the forward ball bearing (e.g., the first fan bearing 1500a) is required to carry substantially all of an amount of forward thrust generated by the fan during operation, as the gearbox assembly prevents the LP shaft from offsetting such forward thrust load of the fan with a reverse thrust load of the turbine section. Accordingly, the increased fan bearing radius allows the one or more fan bearings to carry the forward thrust load while minimizing, e.g., any moments on such one or more fan bearings in the event of a variation in a distribution of the forward thrust load on the one or more fan bearings.

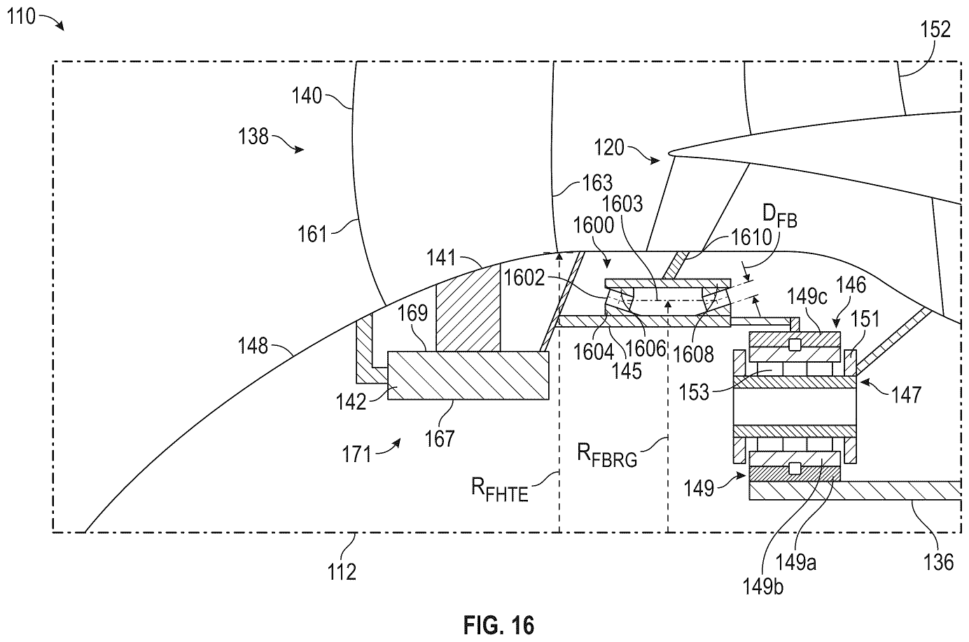

FIG. 16 is an enlarged, schematic, cross-sectional diagram of the turbofan engine 110 of FIG. 1 and having one or more fan bearings 1600, taken along the longitudinal centerline axis 112, according to the present disclosure. While FIG. 16 shows the turbofan engine 110 of FIG. 1, the fan bearings 1600 can also be implemented in the turbofan engine 210 of FIG. 2. FIG. 16 shows one fan blade 140 of the fan 138, the fan disk 142, the core inlet 120, and the gearbox assembly 146. Further, although not shown for clarity, the turbofan engine 110 can include any of the fan actuation systems disclosed herein.

The fan shaft 145 is coupled to the fan disk 142 such that rotation of the fan shaft 145 causes the plurality of fan blades 140 to rotate about the longitudinal centerline axis 112. Each of the fan blades 140 extends from a leading edge 161 and a trailing edge 163. The fan root 141 is at the fan hub 148. The fan disk 142 is defined between an inner surface 167 and an outer surface 169. The inner surface 167 is a radially-most inner surface of the fan disk 142 and the outer surface 169 is a radially-most outer surface of the fan disk 142. The fan disk 142 includes a disk bore 171 defined by the inner surface 167 of the fan disk 142. In particular, the disk bore 171 is defined from the longitudinal centerline axis 112 to the inner surface 167. The fan hub 148 includes a fan hub trailing edge radius R_{FHTE} that is defined in the radial direction from the longitudinal centerline axis 112 to the fan hub 148 at the trailing edge 163 of the fan blades 140.

The turbofan engine 110 also has a fan hub radius ratio that is defined as a ratio of the fan hub trailing edge radius R_{FHTE} to a fan tip radius of the fan blades 140 (e.g., the radius from the longitudinal centerline axis 112 to the fan tip 143 at the trailing edge 163 of the fan blades 140). The fan hub radius ratio is in a range from 0.1 to 0.4. Lower fan hub radius ratios result in lower core engine inlets. A lower fan hub radius and a lower core engine inlet radius result in a core engine with a lesser diameter (e.g., smaller core engine), and, thus, a reduced overall engine weight, as compared to turbofan engines with fan hub radius ratios greater than 0.4. In some aspects, the fan hub radius ratio is in a range from 0.15 to 0.32. In some aspects, the fan hub radius ratio is in a range from 0.2 to 0.35. In some aspects, the fan hub radius ratio is in a range from 0.2 to 0.3. The lower fan hub can also reduce the probability of foreign object damage (FOD), such as, for example, from bird strikes, in the core engine, as the fan tends to push the foreign objects radially outward by the centripetal force imparted to the foreign object by the spinning fan blades. A lower fan hub also improves aerodynamic efficiency of the fan. The lower fan hub radius ratios disclosed herein are enabled by the fan actuation system being characterized by the FASL as detailed above. In particular, the FASL enables a smaller fan actuation system to fit within a tighter packaging underneath the fan while ensuring the fan actuation system can provide an adequate force or torque to pitch the fan blades in the higher loading environment of a turbofan engine (as compared to a turboprop engine). In this way, if the fan actuation system has a FASL that falls within the ranges detailed above, the fan hub radius ratio can be made lower to achieve the improved aerodynamic efficiency of the fan in guiding the incoming airflow into the core inlet.

The fan bearings 1600 are radial thrust (radial shaft load) bearings that transmit a load (e.g., the radial shaft load) from the fan shaft 145 to a static structure of the turbofan engine 110. The fan bearings 1600 each includes one or more rolling elements 1602, an inner race 1604, and an outer race 1606. The fan bearings 1600 support rotation of the fan shaft 145. In FIG. 16, fan bearings 1600 include a forward fan bearing and an aft fan bearing. The rolling elements 1602 are tapered rolling elements that include tapered cylindrical bodies and are disposed between the inner race 1604 and the outer race 1606. In this way, the one or more fan bearings 1600 are roller bearings. The outer race 1606 of each of the fan bearings 1600 is connected to a fan bearing support member 1608. The fan bearing support member 1608 is connected to a fan bearing housing 1610 that is connected to a static component of the turbofan engine 110. The inner race 1604 is connected to the fan shaft 145. In this way, the fan bearings 1600 are connected to the static component and to the fan shaft 145 such that the inner race 1604, and the rolling elements 1602, rotates with respect to the outer race 1606, such that the fan bearings 1600 support rotation of the fan shaft 145.

The fan bearings 1600 are positioned aft, and radially outward, of the fan disk 142. In particular, the fan bearings 1600 are positioned entirely axially aft of the fan disk 142 and entirely radially outward of the fan disk 142 (e.g., radially outward of the outer surface 169 of the fan disk 142). In this way, the fan bearings 1600 are positioned radially outward of the disk bore 171 (e.g., of the inner surface 167) of the fan disk 142. The fan bearings 1600 are positioned axially between the fan disk 142 and the gearbox assembly 146. Further, the fan bearings 1600 are positioned radially outward of the gearbox assembly 146, particularly, radially outward of the third gear 149c.

The fan bearings 1600 have a fan bearing radius R_{FBRG} that is defined in the radial direction from the longitudinal centerline axis 112 to a radial center 1603 of the fan bearings 1600. Particularly, the radial center 1603 of the fan bearings 1600 is the radial center 1603 of the rolling elements 1602. The fan bearings 1600 also have a rolling element diameter D_{FB} of the rolling elements 1602 that is defined as a distance of a straight line passing from side to side of a respective rolling element 1602 through a center (e.g., the radial center 1603) of the respective rolling element 1602.

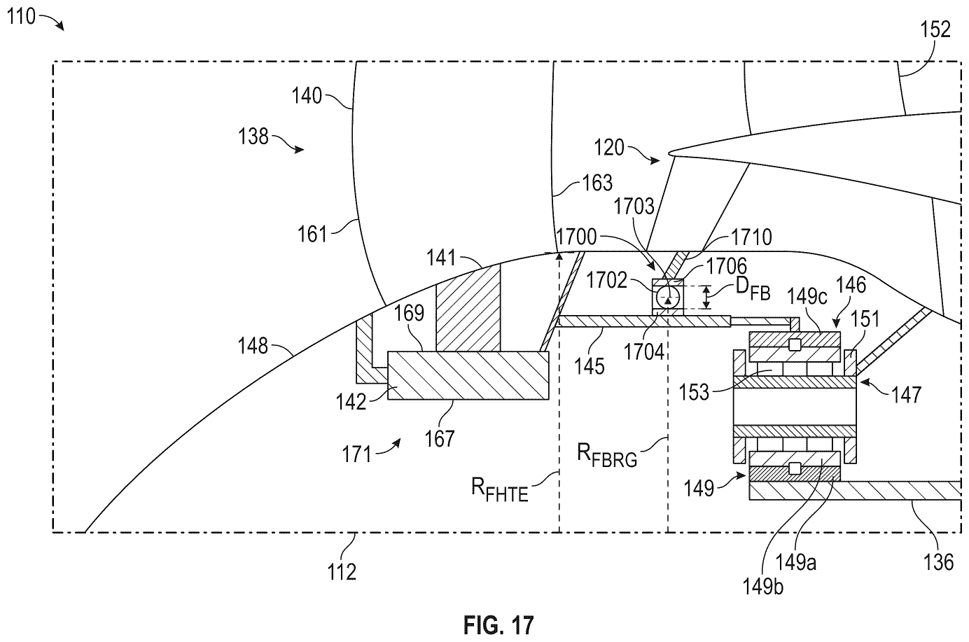

FIG. 17 is an enlarged, schematic, cross-sectional diagram of the turbofan engine 110 and having one or more fan bearings 1700, taken along the longitudinal centerline axis 112, according to another aspect. The fan bearings 1700 are substantially similar to the fan bearings 1600 of FIG. 16. The same reference numerals will be used for components of the fan bearings 1700 that are the same as or similar to the components of the fan bearings 1600 discussed above. The description of these components above also applies to this embodiment, and a detailed description of these components is omitted here.

The fan bearings 1700 each includes one or more rolling elements 1702, an inner race 1704, and an outer race 1706. The fan bearings 1700 support rotation of the fan shaft 145. The rolling elements 1702 are balls that are disposed between the inner race 1704 and the outer race 1706. In this way, the fan bearings 1700 are ball bearings. The turbofan engine 110 also includes a fan bearing housing 1710.

The fan bearings 1700 are positioned aft, and radially outward, of the fan disk 142. In particular, the fan bearings 1700 are positioned entirely axially aft of the fan disk 142 and entirely radially outward of the fan disk 142 (e.g., radially outward of the outer surface 169 of the fan disk 142). In this way, the fan bearings 1700 are positioned radially outward of the disk bore 171 (e.g., of the inner surface 167) of the fan disk 142. The fan bearings 1700 are positioned axially between the fan disk 142 and the gearbox assembly 146. Further, the fan bearings 1700 are positioned radially outward of the gearbox assembly 146, particularly, radially outward of the third gear 149c.

The fan bearings 1700 have a fan bearing radius R_{FBRG} that is defined in the radial direction from the longitudinal centerline axis 112 to a radial center 1703 of the fan bearings 1700 (e.g., of the rolling elements 1702). The fan bearings 1700 also have a rolling element diameter D_{FB} of the rolling elements 1702 that is defined as a distance of a straight line passing from side to side of a respective rolling element 1702 through a center (e.g., the radial center 1703) of the respective rolling element 1702.

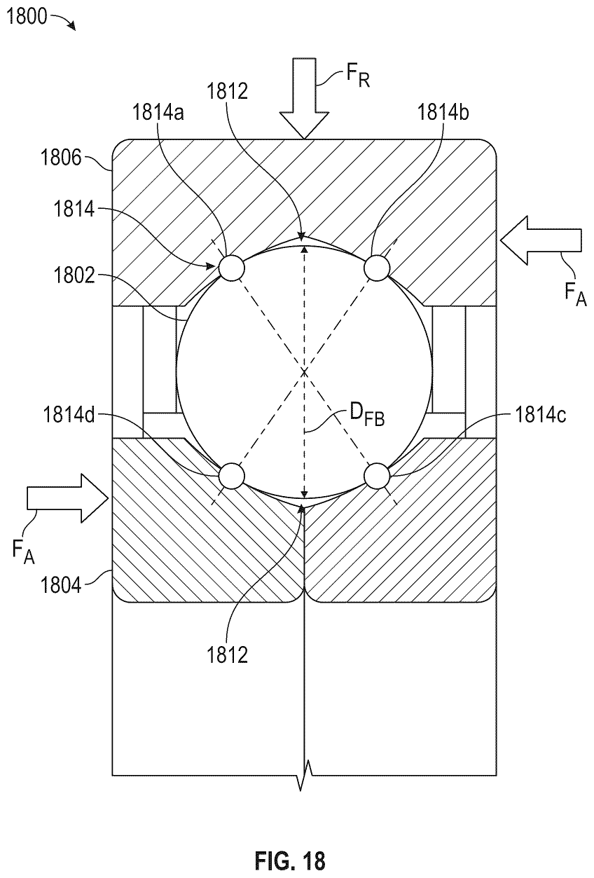

FIG. 18 is a schematic cross-sectional view of a fan bearing 1800 for the turbofan engine 110, according to another aspect. The fan bearing 1800 can be utilized as any of the fan bearings detailed herein. The fan bearing includes one or more rolling elements 1802, an inner race 1804, and an outer race 1806. In some embodiments, the inner race 1804 has a split ring configuration to facilitate easier mounting of the bearing and improved precision. In some embodiments, each of the inner race 1804 and the outer race 1806 defines a concavity having an arch 1812 to allow the rolling element 1802 to have four contact points 1814 with the inner race 1804 and the outer race 1806. In particular, the fan bearing 1800 has two contact points, including a first contact point 1814a and a second contact point 1814b, on the outer race 1806 and two contact points, including a third contact point 1814c and a fourth contact point 1814d, on the inner race 1804. In this way, the fan bearing 1800 is a four-point contact ball bearing. The four-point contact design allows the fan bearing 1800 to handle both radial loads FR and axial loads FA by transmitting the load between the second contact point 1814b and the fourth contact point 1814d, and between the first contact point 1814a and the third contact point 1814c.

In some embodiments, the fan bearing 1800 has a tight bearing configuration, i.e., there is minimal clearance between the rolling elements 1802 and the inner race 1804 and the outer race 1806. In particular, the clearance between the rolling elements 1802 and the inner race 1804 and the outer race 1806 is dimensioned to limit axial movement of the fan shaft 145 (FIG. 1) in relation to the gearbox assembly 146 (FIG. 1) to no greater than 0.010 inches or 10 mil. In some embodiments, the clearance between the rolling elements 1802 and the inner race 1804 and the outer race 1806 is dimensioned to limit axial movement of the fan shaft 145 to no greater than 0.007 inches or 7 mil. The fan bearing 1800 limits axial endplay, i.e., axial movement of the fan shaft 145 in relation to the gearbox assembly 146, thus protecting the gearbox assembly 146 from excessive stress and facilitating a reduction in size and extension of the life of the gearbox assembly 146.

The fan bearing 1800 is designed to withstand extreme conditions including high temperatures, high loads, and high rotational speeds. The materials used to construct the fan bearing 1800 are selected to maximize durability, temperature resistance, and fatigue life. In some embodiments, the fan bearing 1800 can be formed from steel, steel alloys, ceramic materials, cobalt and nickel-based superalloys, or polytetrafluoroethylene (PTFE) and phenolic resins. In addition, the fan bearing 1800 may include coatings, such as, for example, titanium nitride or other anti-friction coatings to further reduce wear and to minimize friction.

The fan bearings of FIGS. 15 to 18 are designed to address the problem of sizing the fan bearings to account for the stresses encountered from the fan shaft, while balancing for minimizing the space under the fan for the fan bearings and other fan components, as well as providing a required amount of thrust for a particular size of the turbofan engine. Additionally, the fan bearings address the challenge in reducing the inner radius of the engine flow path and lowering the fan hub radius ratio, while increasing the fan bearing radius.

Moving the fan bearings aft of the fan disk and increasing the fan bearing radius provide for a reduction in the inner radius of the flow path and the fan hub radius, without overly increasing the heat load on the fan bearings. Further, moving the fan bearings radially outward enables a greater number of rolling elements, which results in a reduced rolling element diameter.

The set of novel embodiments detailed herein include several different architectures of fan bearings and turbofan engines with various sizes and locations. A set of fan bearing designs, producing favorable results, can be characterized by a combination of the fan hub trailing edge radius, the fan bearing radius, the rolling element diameter, and the takeoff thrust, capable of differentiating an architecture that satisfies the operational requirements (e.g., fan bearings capable of handling the stresses from the fan shaft) and the packaging requirements (e.g., lowering the fan hub radius and the inner radius of the flow path) from an architecture that does not satisfy these requirements. As such, a finite and readily ascertainable number of embodiments of the fan bearings account for the operational requirements and the packaging requirements without overly increasing the fan bearing heat load. The novel designs are based on a size of the fan bearings, a size of the rolling elements, and a location of the fan bearings that can reduce the size and the weight of the turbofan engine, while accounting for the factors discussed above. These novel designs can be characterized as a fan bearing envelope (FBE), as set forth in relationship (3):

$$FBE = ( \frac{{R}_{FBRG}}{{R}_{FHTE}} ) \times \frac{{D}_{FB}}{( \frac{{Thrust}_{TO}}{1000} )} . \qquad ( 3 )$$

In relationship (3), R_{FBRG} is the fan bearing radius, R_{FHTE} is the fan hub trailing edge radius, D_{FB} is the rolling element diameter, and Thrust_{TO} is the takeoff thrust of the turbofan engine. The takeoff thrust Thrust_{TO} is a high power operation (e.g., greater than 85% of the SLS maximum engine rated thrust) of the turbofan engine during a takeoff condition of the aircraft.

As discussed further below, the fan bearings include fan bearing designs for different turbofan engine architectures that accounts for handling the stresses from the fan shaft during operation, while reducing the fan hub radius, and, thus, providing for an improved specific flow through the fan and reducing the fan diameter required to achieve a certain thrust or reduces the fan pressure ratio and improves propulsive efficiency of the fan. These improved fan bearing designs can be characterized according to a defined range for the FBE.

Table 2 below represents exemplary embodiments 16 to 27 and their corresponding FBE values for various turbofan engines and fan bearings. Embodiments 16 to 27 may represent the turbofan engine 110 of FIG. 1 (e.g., ducted engine) or the turbofan engine 210 of FIG. 2 (e.g., unducted fan engine) and can be applied to any of the fan bearings detailed herein. In Table 2, the FBE values were determined based on relationship (3) described above, and using fan hub trailing edge radius, fan bearing radius, fan bearing diameter values in millimeters and takeoff thrust values in kilo-Newtons. In particular, embodiments 16, 17, 22, 24, and 26 are tapered roller bearings (e.g., the fan bearings 1600 of FIG. 16). Embodiments 18 to 21, 23, 25, and 27 are ball bearings (e.g., the fan bearings 1700 of FIG. 17 or the fan bearing 1800 of FIG. 18).

TABLE 2

| | | | | | | Fan |
|---|---|---|---|---|---|---|
| | | | | | | Bearing |
| | R_{FHTE} | R_{FBRG} | R_{FBRG}/ | D_{FB} | Thrust_{TO} | Envelope |
| Emb. | (mm) | (mm) | R_{FHTE} | (mm) | (kN) | (FBE) |
| 16 | 360.934 | 212.09 | 0.588 | 19.05 | 155.688 | 71.901 |
| 17 | 628.396 | 312.42 | 0.497 | 19.05 | 155.688 | 60.834 |
| 18 | 360.934 | 212.09 | 0.588 | 50.80 | 155.688 | 191.735 |
| 19 | 628.396 | 312.42 | 0.497 | 50.80 | 155.688 | 162.224 |
| 20 | 360.934 | 212.09 | 0.588 | 57.15 | 155.688 | 215.702 |
| 21 | 360.934 | 212.09 | 0.588 | 63.50 | 155.688 | 239.669 |
| 22 | 103.124 | 60.60 | 0.588 | 5.00 | 44.482 | 66.050 |
| 23 | 103.124 | 60.60 | 0.588 | 15.00 | 44.482 | 198.151 |
| 24 | 902.335 | 530.23 | 0.588 | 50.80 | 389.220 | 76.694 |
| 25 | 902.335 | 530.23 | 0.588 | 127.00 | 389.220 | 191.735 |
| 26 | 1191.082 | 699.90 | 0.588 | 63.50 | 513.770 | 72.627 |
| 27 | 1191.082 | 699.90 | 0.588 | 170.00 | 513.770 | 194.434 |

The fan bearing designs provide the aforementioned benefits including achieving a lower radius ratio (ratio of hub to fan tip radii) for a rated thrust, or a percentage thereof at takeoff. During the course of creating those designs it was determined what ranges would be suitable to achieve the desired results, while taking into account fan shaft stresses, packaging and accessibility, reliability and lubrication requirements for the engine. The values for terms used to compute an FBE value are strictly limited to certain ranges based on the various designs evaluated where those values had varied. Otherwise, the engine made will not produce the favorable results.

The FBE is only valid for a fan hub trailing edge radius R_{FHTE} in a range from ninety millimeters (90 mm) to one thousand two hundred millimeters (1,200 mm). In some embodiments, the fan hub trailing edge radius R_{FHTE} is in a range from one hundred millimeters (100 mm) to nine hundred millimeters (900 mm). The ranges of the fan hub trailing edge radius R_{FHTE} provide for a fan hub radius ratio that satisfies the operational requirements and the packaging requirements of a particular engine without overly increasing the fan bearing heat load. Values of the fan hub trailing edge radius R_{FHTE} outside of the ranges disclosed herein either have a fan hub radius ratio that is too small such that the fan bearings cannot be packaged under the fan disk or too great such that the aerodynamic efficiency of the fan is reduced.

The FBE is only valid for a fan bearing radius R_{FBRG} in a range from fifty millimeters (50 mm) to seven hundred millimeters (700 mm). In some embodiments, the fan bearing radius R_{FBRG} is in a range from sixty millimeters (60 mm) to five hundred fifty millimeters (550 mm). The ranges of the fan bearing radius R_{FBRG} provide for a lower fan hub radius ratio that satisfies the operational requirements and the packaging requirements of a particular engine without overly increasing the fan bearing heat load. Values of the fan bearing radius R_{FBRG} outside of the ranges disclosed herein either have a fan hub radius ratio that is too small such that the fan bearings cannot be packaged under the fan disk or too great such that the aerodynamic efficiency of the fan is reduced and the heat load on the fan bearings is increased so much that the fan bearings require a great amount of lubricant to cool the fan bearings. Thus, fan bearings having a fan bearing radius R_{FBRG} greater than seven hundred millimeters (700 mm) also result in a greater sized lubrication system, and, thus, results in a heavier turbofan engine.

The FBE is only valid for a radius ratio of the fan bearing radius to the fan hub trailing edge radius (R_{FBRG}/R_{FHTE}) in a range from 0.4 to 1.0. The range of R_{FBRG}/R_{FHTE} provides satisfies the operational requirements and the packaging requirements of a particular engine without overly increasing the fan bearing heat load. Values of the R_{FBRG}/R_{FHTE} outside of the ranges disclosed herein either have a fan hub radius ratio that is too small such that the fan bearings cannot be packaged under the fan disk or too great such that the aerodynamic efficiency of the fan is reduced. In particular, values of R_{FBRG}/R_{FHTE} greater than 1.0 provide for the fan bearings to be radially outward of the fan hub trailing edge, and, thus, reduce the radius of the core engine inlet. Values of R_{FBRG}/R_{FHTE} less than 0.4 provide for fan bearings that require larger rolling elements to account for the stresses, while also increasing the fan hub radius and the inner radius of the flow path.

The FBE is only valid for a rolling element diameter D_{FB} in a range from three millimeters (3 mm) to one hundred fifty millimeters (150 mm). In some embodiments, the rolling element diameter D_{FB} is in a range from five millimeters (5 mm) to one hundred twenty-seven millimeters (127 mm).

The FBE is only valid for a takeoff thrust Thrust_{TO} in a range from forty kilo-Newtons (40 kN) to five hundred twenty-five kilo-Newtons (525 kN). In some embodiments, the takeoff thrust Thrust_{TO} is in a range from forty-four kilo-Newtons (44 kN) to four hundred fifty kilo-Newtons (450 kN).

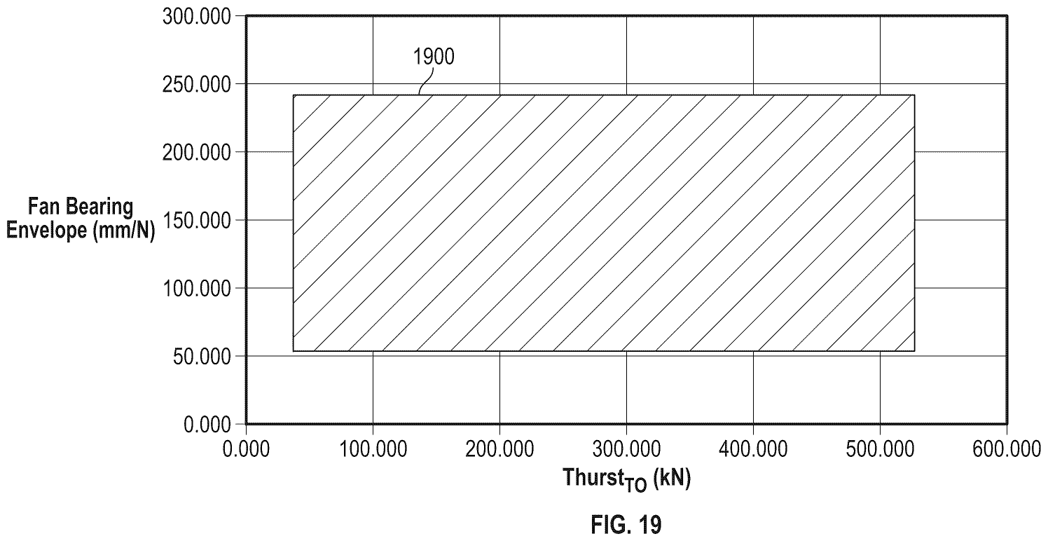

FIG. 19 represents, in graph form, the FBE as a function of the Thrust_{TO} of the turbofan engine, according to the present disclosure. An area 1900 represents the boundaries of the FBE. The FBE is in a range from fifty-four millimeters per Newton (54 mm/N) to two hundred forty millimeters per Newton (240 mm/N) for a takeoff thrust Thrust_{TO} in a range from forty kilo-Newtons (40 kN) to five hundred twenty-five kilo-Newtons (525 kN). The range of the FBE identifies the specific architectures (fan bearing sizing and location), rolling elements sizing, and takeoff thrusts, while accounting for the stresses from the fan shaft and the inner flow path radius and the fan hub radius. In particular, if the FBE is within the area 1900, then the fan bearing and the turbofan engine architecture are capable of handling the stresses from the fan shaft during operation, while reducing the fan hub radius, and, thus, providing for an improved specific flow through the fan and reducing the fan diameter required to achieve a certain thrust, or reduces the fan pressure ratio and improves propulsive efficiency of the fan. If the FBE is outside of the area 1900, then the fan bearings may become damaged or fail under the stresses from the fan shaft, or the fan hub radius (e.g., the inner radius of the flow path) is too great, such that the fan efficiency decreases or the specific flow through the fan is reduced for a certain thrust. Thus, the turbofan engine having an FBE within the area 1900 provides for an improved fan bearing architecture that is capable of handling the stresses from the fan shaft, while accounting for the fan hub radius to improve propulsive efficiency and specific flow for achieving a certain thrust.

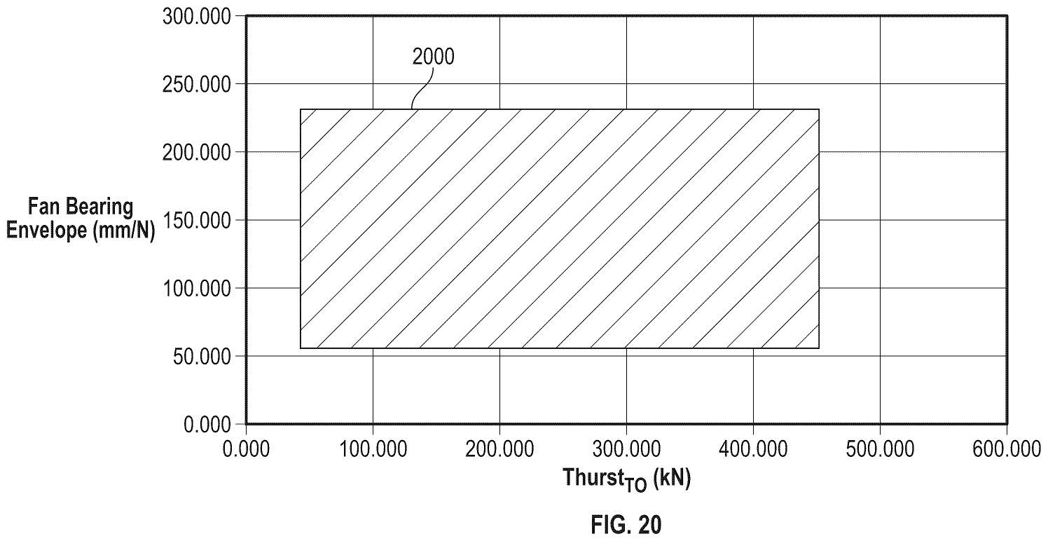

FIG. 20 represents, in graph form, the FBE as a function of the Thrust_{TO}, according to another aspect. An area 2000 represents the boundaries of the FBE. The FBE is in a range from fifty-eight millimeters per Newton (58 mm/N) to two hundred thirty millimeters per Newton (230 mm/N) for a takeoff thrust Thrust_{TO} in a range from forty-four kilo-Newtons (44 kN) to four hundred fifty kilo-Newtons (450 kN). The range of the FBE identifies the specific architectures (fan bearing sizing and location), rolling elements sizing, and takeoff thrusts, while accounting for the stresses from the fan shaft and the inner flow path radius and the fan hub radius. In particular, if the FBE is within the area 2000, then the fan bearing and the turbofan engine architecture are capable of handling the stresses from the fan shaft during operation, while reducing the fan hub radius, and, thus, providing for an improved specific flow through the fan and reducing the fan diameter required to achieve a certain thrust, or reduces the fan pressure ratio and improves propulsive efficiency of the fan. If the FBE is outside of the area 2000, then the fan bearings may become damaged or fail under the stresses from the fan shaft, or the fan hub radius (e.g., the inner radius of the flow path) is too great, such that the fan efficiency decreases or the specific flow through the fan is reduced for a certain thrust. Thus, the turbofan engine having an FBE within the area 2000 provides for an improved fan bearing architecture that is capable of handling the stresses from the fan shaft, while accounting for the fan hub radius to improve propulsive efficiency and specific flow for achieving a certain thrust.

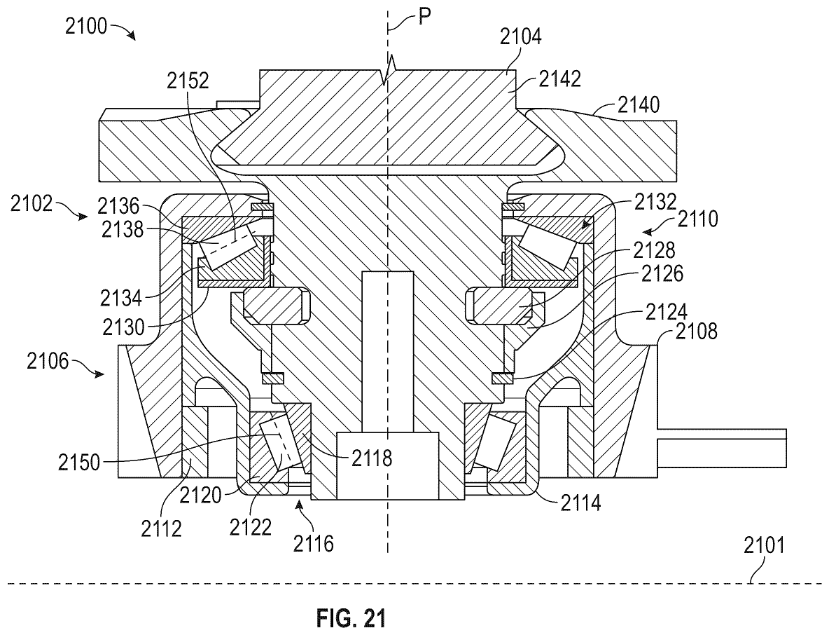

FIG. 21 is an enlarged schematic, cross-sectional view of a segment of a fan 2100 having a fan actuation system 2102, taken along a longitudinal centerline axis 2101 of the fan 2100, according to the present disclosure. The fan 2100 can be utilized as the fan 138 of FIG. 1 or as the fan 252 of FIG. 2. The fan 2100 includes a plurality of fan blades 2104 that is coupled to a disk 2106 and is spaced circumferentially about the longitudinal centerline axis 2101 of the fan 2100.

The disk 2106 includes a plurality of disk segments 2108 (only one shown in FIG. 21) that is rigidly coupled together or integrally molded together in a generally annular shape. One fan blade 2104 is coupled to each disk segment 2108 at a trunnion mechanism 2110 of the fan actuation system 2102. The trunnion mechanism 2110 facilitates retaining the respective fan blade 2104 on the disk 2106 during rotation of the disk 2106, while still rendering the respective fan blade 2104 rotatable relative to the disk 2106 about a pitch axis P of the fan blade 104. The trunnion mechanism 2110 includes a plurality of bearings disposed within the disk segment 2108 that allows the fan blade 2104 to rotate about the pitch axis P, as detailed above and below.

The trunnion mechanism 2110 extends through a respective disk segment 2108 and includes a coupling nut 2112, a lower bearing support 2114, a first radial thrust bearing 2116 (having, for example, an inner race 2118, an outer race 2120, and a plurality of rolling elements 2122), a snap ring 2124, a key hoop retainer 2126, a segmented key 2128, a bearing support 2130, a second radial thrust bearing 2132 (having, for example, an inner race 2134, an outer race 2136, and a plurality of rolling elements 2138), a trunnion 2140, and a base 2142 (e.g., a dovetail). The first radial thrust bearing 2116 and the second radial thrust bearing 2132 can include any type of roller bearings, including, for example, cylindrical roller radial thrust bearings, tapered roller radial thrust bearings, spherical roller radial thrust bearings (e.g., ball bearings), needle roller radial thrust bearings, or tapered roller needle radial thrust bearings. The coupling nut 2112 is threadedly engaged with the disk segment 2108 so as to sandwich the remaining components of the trunnion mechanism 2110 between the coupling nut 2112 and the disk segment 2108, thus, retaining the trunnion mechanism 2110 attached to the disk segment 2108.

The first radial thrust bearing 2116 is oriented at a different angle than the second radial thrust bearing 2132 (as measured from a rolling element longitudinal centerline axis 2150 of the plurality of rolling elements 2122 relative to the pitch axis P, and from a rolling element longitudinal centerline axis 2152 of the plurality of rolling elements 2138 relative to the pitch axis P). More specifically, the first radial thrust bearing 2116 and the second radial thrust bearing 2132 are preloaded against one another in a face-to-face (or duplex) arrangement, in which the rolling element longitudinal centerline axes 2150, 2152 are oriented substantially perpendicular to one another, as opposed to being arranged in tandem so as to be oriented substantially parallel to one another.

The centrifugal loads experienced closer to the pitch axis P are larger than the centrifugal loads experienced further away from the pitch axis P. As such, to facilitate making the trunnion mechanism 2110 more compact, the bearings of the trunnion mechanism 2110 are positioned closer to the pitch axis P. Such a configuration enables a greater number of trunnion mechanisms 2110 to be assembled on the disk 2106 and, thus, more fan blades 2104 to be coupled to the disk 2106 for a given diameter of the disk 2106. The trunnion mechanism 2110 herein is made more compact due to the first radial thrust bearing 2116 and the second radial thrust bearing 2132 being line contact bearings as compared to trunnion mechanisms that utilize angular point contact ball bearings. In this way, the trunnion mechanism 2110 is made more compact while being better able to withstand larger centrifugal loads associated with such a bearing placement without fracturing or plastically deforming. In particular, the first radial thrust bearing 2116 and the second radial thrust bearing 2132 being line contact bearings provide for larger contact surfaces, and, thus, can withstand larger centrifugal loads as compared to angular point contact ball bearings. Thus, line contact bearings (e.g., the first radial thrust bearing 2116 and the second radial thrust bearing 2132) can be spaced closer to the pitch axis P than angular point contact ball bearings.

In one aspect, the first radial thrust bearing 2116 and the second radial thrust bearing 2132 are a tapered roller bearings in which the rolling elements 2122 and the rolling elements 2138 are tapered. In one example, the first radial thrust bearing 2116 is fabricated from a steel material and has twenty rolling elements 2122 arranged at a 20° contact angle and a 3.6 inch pitch diameter, with each rolling element 2122 being 0.6 inches long and having a 0.525 inch minor diameter, a 0.585 inch major diameter, and a 6° taper angle. In the same example, the second radial thrust bearing 2132 is fabricated from a steel material and has 36 rolling elements 2138 arranged at a 65° contact angle and a 6 inch pitch diameter, with each rolling element 2138 being 0.8 inches long and having a 0.45 inch minor diameter, a 0.6 inch major diameter, and a 9° taper angle. In other aspects, the first radial thrust bearing 2116 and the second radial thrust bearing 2132 can be configured in any suitable manner that facilitates enabling the first radial thrust bearing 2116 and the second radial thrust bearing 2132 to function as described herein.

The first radial thrust bearing 2116 and the second radial thrust bearing 2132 facilitate providing a turbofan engine with a smaller variable pitch fan that can generate larger amounts of thrust. Particularly, the first radial thrust bearing 2116 and the second radial thrust bearing 2132 facilitate providing a turbofan engine with a variable pitch fan having a higher blade count and a lower blade length, while also providing the turbofan engine with a lower fan hub radius ratio. The first radial thrust bearing 2116 and the second radial thrust bearing 2132 further facilitate providing a trunnion mechanism that is more compact and is better able to withstand the higher centrifugal loads associated with higher blade counts, given that higher blade counts tend to yield a higher tip velocity and, therefore, a higher centrifugal loading. The first radial thrust bearing 2116 and the second radial thrust bearing 2132 further facilitate providing a smaller diameter disk for a variable pitch fan by providing the variable pitch fan with a fan counterweight device for the fan blades.

In addition to the sizing requirements and the loading requirements addressed by the FAS and the FASL above, conventional turbofan engine design practice has limited a compressor pressure ratio based at least in part on the gas temperatures at the exit stage of a high-pressure compressor. These relatively high temperatures at the exit of the high-pressure compressor may also be avoided when they result in prohibitively high temperatures at an inlet to the turbine section, as well as when they result in prohibitively high exhaust gas temperatures through the exhaust section. For a desired turbofan engine thrust output produced from an increased pressure ratio across the high-pressure compressor, there is an increase in the gas temperature at the compressor exit, at a combustor inlet, at the turbine section inlet, and through an exhaust section of the turbofan engine.

There are generally three approaches to making a turbofan engine capable of operating at higher temperatures while providing a net benefit to engine performance: reducing the temperature of a gas used to cool core components, utilizing materials capable of withstanding higher operating temperature conditions, increasing the amount of cooling air, or a combination thereof.

Referring to the case of an engine that utilizes cooled cooling air for operating at higher temperatures, the costs associated with achieving a higher compression by reducing gas temperatures used to cool core components to accommodate higher core gas temperatures may indeed produce a net benefit, contrary to prior expectations in the art. The present disclosure provides for a design of several engine architectures of varying thrust classes and mission requirements (including the engines illustrated and described in detail herein) and a relationship that exists among the exhaust gas passing through the exhaust section, the desired maximum thrust for the engine, and the size of the exit stage of the high-pressure compressor, whereby including this technology produces a net benefit. Previously, the cost for including a technology to reduce the temperature of gas intended for cooling compressor and turbine components was too prohibitive, as compared to the benefits of increasing the core temperatures.

For example, a cooled cooling air system may be included while maintaining or even increasing the maximum turbofan engine thrust output, based on this discovery. The cooled cooling air system may receive an airflow from the compressor section, reduce a temperature of the airflow using a heat exchanger, and provide the cooled airflow to one or more components of the turbine section, such as a first stage of high-pressure turbine rotor blades. In such a manner, a first stage of high-pressure turbine rotor blades may be capable of withstanding increased temperatures by using the cooled cooling air, while providing a net benefit to the turbofan engine, i.e., while taking into consideration the costs associated with accommodations made for the system used to cool the cooling air.

The present disclosure also evaluates potentially negative impacts to engine performance brought on by introduction of a cooled cooling air system. For example, a cooled cooling air system may generally include a duct extending through a diffusion cavity between a compressor exit and a combustor within the combustion section, such that increasing the cooling capacity may concomitantly increase a size of the duct and thus increase a drag or blockage of an airflow through the diffusion cavity, potentially creating problems related to, e.g., combustor aerodynamics. Similarly, a dedicated or shared heat exchanger of the cooled cooling air system may be positioned in a bypass passage of the turbofan engine, which may create an aerodynamic drag or may increase a size of the shared heat exchanger and increase aerodynamic drag. Size and weight increases associated with maintaining certain risk tolerances were also taken into consideration. For example, a cooled cooling air system must be accompanied with adequate safeguards in the event of a burst pipe condition, which safeguards result in further increases in the overall size, complexity, and weight of the system.

With a goal of arriving at an improved turbofan engine capable of operating at higher temperatures at the compressor exit and turbine inlet, without overly increasing the size of the turbofan engine, the present disclosure provides for turbofan engines having an overall pressure ratio, total thrust output, redline exhaust gas temperature, and the supporting technology characteristics, checking the propulsive efficiency and qualitative turbofan engine characteristics of the designed turbofan engine, redesigning the turbofan engine to have higher or lower compression ratios based on the impact on other aspects of the architecture, total thrust output, redline exhaust gas temperature, and supporting technology characteristics, rechecking the propulsive efficiency and qualitative turbofan engine characteristics of the redesigned turbofan engine, etc., during the design of several different types of turbofan engines, including the turbofan engines described below with reference to FIGS. 1, 2, and 24 through 28 through 31, which will now be discussed in greater detail.

One or more components of the engine described herein below may be manufactured or formed using any suitable process, such as an additive manufacturing process, such as a three-dimensional (3D) printing process. The use of such a process may allow such a component to be formed integrally, as a single monolithic component, or as any suitable number of sub-components. In particular, the additive manufacturing process may allow such a component to be integrally formed and include a variety of features not possible when using prior manufacturing methods. For example, the additive manufacturing methods described herein enable the manufacture of shafts having unique features, configurations, thicknesses, materials, densities, passageways, headers, and mounting structures that may not have been possible or practical using prior manufacturing methods. Some of these features are described herein.

Further, a turbofan engine includes a power turbine that drives a bypass fan. The bypass fan is coupled to the power turbine via a turbine shaft. The bypass fan generates the majority of the thrust of the turbofan engine. The generated thrust can be used to move a payload (e.g., an aircraft). A turbine shaft coupled to the power turbine and the fan (either directly or through a gearbox) can experience vibrations during operation of the engine (e.g., during rotation of the shaft). For example, when the shaft rotates at its critical speed, the shaft will vibrate excessively. The excessive vibration is due primarily to excitation of a first-order beam bending mode of the shaft. Thus, the shaft may be characterized by its first order bending mode, the fundamental resonance frequency (fundamental frequency) of this mode, and the shaft's critical speed of rotation. If the first order bending mode may be excited by a low-pressure shaft rate occurring during a standard operating range of the engine, undetected vibration as well as an increased risk of whirl instability, may result. There is a continuing need to address vibrations induced by rotating shafts in turbofan engines.

As mentioned above, the engines disclosed herein provide for higher EGTs, provided for, for example, faster shaft speeds for the low-pressure turbine (LPT), and longer shafts to accommodate a longer engine core (e.g., the high-pressure compressor, the combustor, and the high-pressure turbine). Additionally, it is desirable to house the engine core within a smaller space, thus, reducing the available space under the fan for a fan actuation system in such turbofan engines. These trends can result in reductions in stiffness-to-weight ratio for the shaft and structure that influence dynamics of the LP shaft, which may have the effect of lowering the critical speed and/or limiting the available options for increasing the critical speed for the LPT's shaft (referred to as the low-pressure shaft or the low-pressure (LP) shaft). Accordingly, different approaches for engine types, midshaft geometry, bearing support, and material compositions are required for next-generation turbofan engines, to permit high-speed operation without resulting in an unstable bending mode during regular operation. The present disclosure provides for a wide variety of shafts having different combinations of stiffness, material, bearing type and location, shaft length, and diameter in order to determine which embodiment(s) were most promising for a variety of contemplated engine designs. The various embodiments, as described herein and as shown in the figures, include turbine shafts that employ one or more of these techniques to increase the critical speed of the first order bending mode.

The aforementioned shaft structure and features also, however, directly affect other components in the engine and the operation of the engine itself. For example, shortening the length of the low-pressure shaft reduces the available space for the high-pressure compressor stages, the combustor, the low-pressure turbine stages, the low-pressure compressor stages, ducts, mounts, fan actuation system, and other engine components etc. This, in turn, has a negative impact on engine operation by reducing the power output of the engine and reducing combustor efficiency. Indeed, there is a desire to have a lengthened high-pressure compressor or more high-pressure compressor stages to improve combustor efficiency. Likewise, increasing the diameter and/or mass of the low-speed shaft can have a similar effect, reducing available space for the remaining engine components and increasing weight of the engine, thus, again, negatively impacting engine performance. Thus, a balance is ultimately struck (penalties vs. benefits) to maintain or enhance engine performance, while also enabling an increase in the critical speed of the low-pressure turbine shaft, or not lowering the critical speed, e.g., add 1 or 2 additional stages to a compressor to increase efficiency, to allow for faster speeds for the power turbine while avoiding sustained operations at or near the critical speed. To achieve this balance, tradeoffs are made to 1) allow for a lengthened high-pressure compressor, shortened overall length of the engine for aero-performance, or reduced nacelle length or size, or any combination thereof, while 2) shortening the low-pressure turbine shaft length, in particular, the midshaft length and increasing the shaft diameter of the low-pressure turbine shaft to increase the critical speed of the low-pressure/low speed turbine shaft (LP shaft).

Different materials for the engine core (rotor disks, airfoils) and changes in size of the core have an impact on the dynamics of the high speed shaft, the low speed shaft, and the interaction between these two shafts as can occur through dynamic excitation transmitted through shaft bearings. Next generation engines will operate with a higher power density (power/weight), which can mean lengthening the core by adding additional compression stages to the high speed compressor. Additionally, or alternatively, a core operating at a higher power density is expected to operate at higher temperatures at the compressor exit stage and the downstream turbine stages (e.g., higher EGTs as discussed above). In this regard, higher-temperature-tolerant material can be used to enable operating at higher temperatures, such as, a ceramic matrix composite (CMC) material. The use of such higher temperature-tolerant material is expected to bring about changes in weight and component size and volume, which is expected to influence the behavior of both the high-speed shaft and mid-shaft. Thus, the present disclosure also considers how the dynamics of the midshaft and high speed shaft might change when the engine core changes in size and weight, in response to a need to operate at higher power densities enabled by use of higher temperature-tolerant material.

Different approaches for engine types, midshaft geometry, bearing support, and material compositions are needed for next-generation turbofan engines, to permit high-speed operation without resulting in an unstable bending mode, and, therefore, vibrations during regular operation. The present disclosure provides for a suitable design to meet these requirements while lowering vibrations, or at least maintaining a tolerable vibration environment during flight conditions (e.g., takeoff or max thrust), including a wide variety of shafts having different combinations of stiffness, material, bearing type and location, shaft length, and diameter in order to determine which embodiment(s) were most promising for a variety of contemplated engine designs, including different engine core sizes for different sized high-pressure compressors and high-pressure turbines. The various embodiments, as described herein including illustrated examples for both a ducted engine and an open fan engine, include turbine shafts that employ one or more of the above-mentioned techniques to increase the critical speed of the LP shaft and/or maintain a design speed for improved efficiency while mitigating or avoiding a subcritical or critical speed situation during flight operations, or operating supercritical within a 5% to 10% margin of the redline speed, and having a fan actuation system that is capable of meeting the required loads while fitting in the limited spaces of such turbofan engines.

FIG. 22 is a close-up, simplified, schematic view of a portion of the turbofan engine 210 of FIG. 2, according to the present disclosure. The LP compressor 226 includes a plurality of stages of LP compressor rotor blades 2202 and a plurality of stages of LP compressor stator vanes 2204 alternatingly spaced with the plurality of stages of LP compressor rotor blades 2202. Similarly, the HP compressor 228 includes a plurality of stages of HP compressor rotor blades 2208 and a plurality of stages of HP compressor stator vanes 2210 alternatingly spaced with the plurality of stages of HP compressor rotor blades 2208. Moreover, within the turbine section, the HP turbine 232 includes at least one stage of HP turbine rotor blades 2212 and at least one stage of HP turbine stator vanes 2216, and the LP turbine 234 includes a plurality of stages of LP turbine rotor blades 2220 and a plurality of stages of LP turbine stator vanes 2224 alternatingly spaced with the plurality of stages of LP turbine rotor blades 2220. With reference to the HP turbine 232, the HP turbine 232 includes at least a first stage 2228 of HP turbine rotor blades 2212.

Each of the HP turbine rotor blades 2212 includes a shroud 2214 integral with the HP turbine rotor blades 2212. The shroud 2214 is positioned on at least one of the outer end or the inner end of the HP turbine rotor blades 2212. The shroud 2214 acts as a barrier, preventing air from bypass the HP turbine rotor blades 2212 at the tips, as well as help to provide a secure connection between adjacent HP turbine rotor blades 2212 to help maintain structural integrity of the stage of HP turbine rotor blades 2212 and reduce vibration during operation.

Each of the HP turbine stator vanes 2216 includes a shroud 2218 integral with the HP turbine stator vane 2216. The shroud 2218 is positioned on at least one of the outer end or the inner end of the HP turbine stator vane 2216. The shroud 2218 can include hooks that hook into respective openings in the outer casing or the inner casing of the HP turbine 232 such that the outer casing or the inner casing support the HP turbine stator vanes 2216. The shroud 2218 acts as a barrier, preventing air from bypass the HP turbine stator vanes 2216 at the tips or at the roots, as well as help to provide a secure connection between adjacent HP turbine stator vanes 2216 to help maintain structural integrity of the stage of HP turbine stator vanes 2216 and reduce vibration during operation.

Each of the LP turbine rotor blades 2220 includes a shroud 2222 integral with the LP turbine rotor blades 2220. The shroud 2222 is positioned on at least one of the outer end or the inner end of the LP turbine rotor blades 2220. The shroud 2222 acts as a barrier, preventing air from bypass the LP turbine rotor blades 2220 at the tips, as well as help to provide a secure connection between adjacent LP turbine rotor blades 2220 to help maintain structural integrity of the stage of LP turbine rotor blades 2220 and reduce vibration during operation.

Each of the LP turbine stator vanes 2224 includes a shroud 2226 integral with the LP turbine stator vane 2224. The shroud 2226 is positioned on at least one of the outer end or the inner end of the LP turbine stator vane 2224. The shroud 2226 can include hooks that hook into respective openings in the outer casing or the inner casing of the LP turbine 234 such that the outer casing or the inner casing support the LP turbine stator vanes 2224. The shroud 2226 acts as a barrier, preventing air from bypass the LP turbine stator vanes 2224 at the tips or at the roots, as well as help to provide a secure connection between adjacent LP turbine stator vanes 2224 to help maintain structural integrity of the stage of LP turbine stator vanes 2224 and reduce vibration during operation.

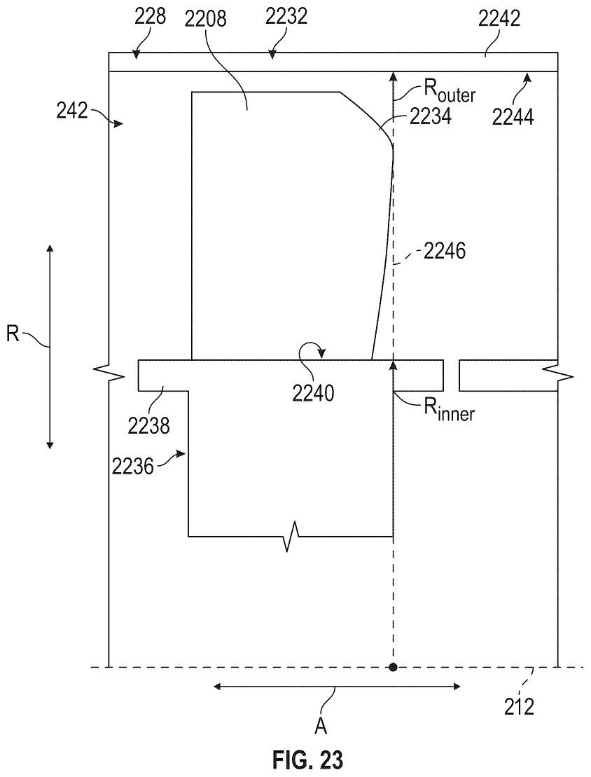

Referring particularly to the HP compressor 228, the plurality of stages of HP compressor rotor blades 2208 includes an aftmost stage 2232 of HP compressor rotor blades 2208. Referring briefly to FIG. 23, a close-up view of an HP compressor rotor blade 2208 in the aftmost stage 2232 of HP compressor rotor blades 2208 is provided. As will be appreciated, the HP compressor rotor blade 2208 includes a trailing edge 2234 and the aftmost stage 2232 of HP compressor rotor blades 2208 includes a rotor 2236 having a base 2238 to which the HP compressor rotor blade 2208 is coupled. The base 2238 includes a flowpath surface 2240 defining in part the core duct 242 through the HP compressor 228. Moreover, the HP compressor 228 includes a shroud or liner 2242 located outward of the HP compressor rotor blade 2208 along the radial direction R. The shroud or liner 2242 also includes a flowpath surface 2244 defining in part the core duct 242 through the HP compressor 228.

The turbofan engine 210 (FIG. 23) defines a reference plane 2246 intersecting with an aft-most point of the trailing edge 2234 of the HP compressor rotor blade 2208 depicted, the reference plane 2246 being orthogonal to the axial direction A. Further, the HP compressor 228 defines a high-pressure compressor exit area (A_{HPCExit}) within the reference plane 2246. More specifically, the HP compressor 228 defines an inner radius (R_{INNER}) extending along the radial direction R within the reference plane 2246 from the longitudinal centerline axis 212 to the flowpath surface 2240 of the base 2238 of the rotor 2236 of the aftmost stage 2232 of HP compressor rotor blades 2208, as well as an outer radius (R_{OUTER}) extending along the radial direction R within the reference plane 2246 from the longitudinal centerline axis 212 to the flowpath surface 2244 of the shroud or liner 2242. The HP compressor 228 exit area is defined according to relationship (4):

$${A}_{HPCExit} = π ( {{R}_{OUTER}}^{2} - {{R}_{INNER}}^{2} ) . \qquad ( 4 )$$

For a given total thrust output (Fn_{Total}), a decrease in size of the high-pressure compressor exit area (A_{HPCExit}) may generally relate in an increase in a compressor exit temperature (i.e., a temperature of the airflow through the core duct 242 at the reference plane 2246), a turbine inlet temperature (i.e., a temperature of the airflow through the core duct 242 provided to the first stage 2228 of HP turbine rotor blades 2212. See FIG. 22), and the redline exhaust gas temperature (EGT). In particular, the high-pressure compressor exit area (A_{HPCExit}) may generally be used as an indicator of the above temperatures to be achieved by the turbofan engine 210 during operation for a given total thrust output (Fn_{Total}) of the turbofan engine 210.

Referring back to FIG. 22, the exemplary turbofan engine 210 depicted includes one or more technologies to accommodate the relatively small high-pressure compressor exit area (A_{HPCExit}) for the total thrust output (Fn_{Total}) of the turbofan engine 210. In particular, for the embodiment depicted, the turbofan engine 210 includes a cooled cooling air system 2250. While the cooled cooling air system 2250 is depicted as being utilized in the turbofan engine 210 of FIG. 2, the cooled cooling air system 2250 can be utilized in the turbofan engine 110 of FIG. 1.

The cooled cooling air system 2250 is in fluid communication with the HP compressor 228 and the first stage 2228 of HP turbine rotor blades 2212. More specifically, the cooled cooling air system 2250 includes a duct assembly 2252 and a cooled cooling air (CCA) heat exchanger 2254. The duct assembly 2252 is in fluid communication with the HP compressor 228 for receiving an airflow from the HP compressor 228 and providing such airflow to the first stage 2228 of HP turbine rotor blades 2212 during operation of the turbofan engine 210. The CCA heat exchanger 2254 is in thermal communication with the airflow through the duct assembly 2252 for reducing a temperature of the airflow through the duct assembly 2252 upstream of the first stage 2228 of HP turbine rotor blades 2212.

Briefly, as will be explained in more detail below, the turbofan engine 210 depicted further includes a thermal transport bus 2300, with the CCA heat exchanger 2254 of the cooled cooling air system 2250 in thermal communication with, or integrated into, the thermal transport bus 2300. For the embodiment depicted, the turbofan engine 210 further includes the heat exchanger 2200 in the fan duct 272 in thermal communication with, or integrated into, the thermal transport bus 2300, such that heat from the CCA heat exchanger 2254 of the cooled cooling air system 2250 may be transferred to the heat exchanger 2200 in the fan duct 272 using the thermal transport bus 2300.

FIG. 24 is a close-up, schematic view of the turbofan engine 210 of FIG. 2, including the cooled cooling air system 2250.

The turbine section includes a compressor casing 2256, and the combustor 230 generally includes an outer combustor casing 2258, an inner combustor casing 2260, and a combustor 2262. The combustor 2262 generally includes an outer combustion chamber liner 2264 and an inner combustion chamber liner 2266, together defining at least in part a combustion chamber 2268. The combustor 2262 further includes a fuel nozzle 2270 configured to provide a mixture of fuel and air to the combustion chamber 2268 to generate combustion gases.

The turbofan engine 210 further includes a fuel delivery system 2272 including at least a fuel line 2274 in fluid communication with the fuel nozzle 2270 for providing fuel to the fuel nozzle 2270.

The turbofan engine 210 includes a diffuser nozzle 2276 located downstream of the aftmost stage 2232 of HP compressor rotor blades 2208 of the HP compressor 228, within the core duct 242. The diffuser nozzle 2276 is coupled to, or integrated with the inner combustor casing 2260, the outer combustor casing 2258, or both. The diffuser nozzle 2276 is configured to receive compressed airflow from the HP compressor 228 and straighten such compressed air prior to such compressed air being provided to the combustor 230. The combustor 230 defines a diffusion cavity 2278 downstream of the diffuser nozzle 2276 and upstream of the combustion chamber 2268.

As noted above, the exemplary turbofan engine 210 further includes the cooled cooling air system 2250. The cooled cooling air system 2250 includes the duct assembly 2252 and the CCA heat exchanger 2254. More specifically, the duct assembly 2252 includes a first duct 2280 in fluid communication with the HP compressor 228 and the CCA heat exchanger 2254. The first duct 2280 more specifically extends from the HP compressor 228, through the compressor casing 2256, to the CCA heat exchanger 2254. For the embodiment depicted, the first duct 2280 is in fluid communication with the HP compressor 228 at a location in between the last two stages of HP compressor rotor blades 2208. In such a manner, the first duct 2280 is configured to receive a cooling airflow from the HP compressor 228 and to provide the cooling airflow to the CCA heat exchanger 2254.

In other aspects, the first duct 2280 may additionally or alternatively be in fluid communication with the HP compressor 228 at any other suitable location, such as at any other location closer to a downstream end of the HP compressor 228 than an upstream end of the HP compressor 228, or alternatively at a location closer to the upstream end of the HP compressor 228 than the downstream end of the HP compressor 228.

The duct assembly 2252 further includes a second duct 2282 extending from the CCA heat exchanger 2254 to the outer combustor casing 2258 and a third duct 2284 extending from the outer combustor casing 2258 inwardly generally along the radial direction R. The CCA heat exchanger 2254 may be configured to receive the cooling airflow and to extract heat from the cooling airflow to reduce a temperature of the cooling airflow. The second duct 2282 may be configured to receive cooling airflow from the CCA heat exchanger 2254 and provide the cooling airflow to the third duct 2284. The third duct 2284 extends through the diffusion cavity generally along the radial direction R.

Moreover, the duct assembly 2252 further includes a manifold 2286 in fluid communication with the third duct 2284 and a fourth duct 2288. The manifold 2286 extends generally along the circumferential direction C of the turbofan engine 210, and the fourth duct 2288 is more specifically a plurality of fourth ducts 2288 extending from the manifold 2286 at various locations along the circumferential direction C forward generally along the axial direction A towards the turbine section. In such a manner, the duct assembly 2252 of the cooled cooling air system 2250 may be configured to provide cooling airflow to the turbine section at a variety of locations along the circumferential direction C.

Notably, referring still to FIG. 24, the combustor 230 includes an inner stator assembly 2290 located at a downstream end of the inner combustion chamber liner 2266, and coupled to the inner combustor casing 2260. The inner stator assembly 2290 includes a nozzle 2292. The fourth duct 2288, or rather, the plurality of fourth ducts 2288, are configured to provide the cooling airflow to the nozzle 2292. The nozzle 2292 may include a plurality of vanes spaced along the circumferential direction C configured to impart a circumferential swirl to the cooling airflow provided through the plurality of fourth ducts 2288 to assist with such airflow being provided to the first stage 2228 of HP turbine rotor blades 2212.

In particular, for the embodiment depicted, the HP turbine 232 further includes a first stage HP turbine rotor 2294, with the plurality of HP turbine rotor blades 2212 of the first stage 2228 coupled to the first stage HP turbine rotor 2294. The first stage HP turbine rotor 2294 defines an internal cavity 2296 configured to receive the cooling airflow from the nozzle 2292 and provide the cooling airflow to the plurality of HP turbine rotor blades 2212 of the first stage 2228. In such a manner, the cooled cooling air system 2250 may provide cooling airflow to the HP turbine rotor blades 2212 to reduce a temperature of the plurality HP turbine rotor blades 2212 at the first stage 2228 during operation of the turbofan engine 210.

For example, in certain exemplary aspects, the cooled cooling air system 2250 may be configured to provide a temperature reduction of the cooling airflow equal to at least fifteen percent (15%) of the EGT and up to forty-five percent (45%) of the EGT. Further, in certain exemplary aspects, the cooled cooling air system 2250 may be configured to receive between two and a half percent (2.5%) and thirty-five percent (35%) of an airflow through the core duct 242 at an inlet to the HP compressor 228, such as between three percent (3%) and twenty percent (20%), such as between four percent (4%) and fifteen percent (15%).

In addition, as briefly mentioned above, the cooled cooling air system 2250 may utilize the thermal transport bus 2300 to reject heat from the cooling air extracted from the compressor section. In particular, for the embodiment shown the CCA heat exchanger 2254 is in thermal communication with or integrated into the thermal transport bus 2300. Notably, the thermal transport bus 2300 further includes a fuel heat exchanger 2302 in thermal communication with the fuel line 2274. In such a manner, the thermal transport bus 2300 may extract heat from the cooling air extracted from the compressor section through the cooled cooling air system 2250 and provide such heat to a fuel flow through the fuel line 2274 upstream of the fuel nozzle 2270. The thermal transport bus 2300 includes a conduit having a flow of thermal transport fluid therethrough as detailed with respect to FIG. 25.

FIG. 25 is a schematic view of a thermal transport bus 2300, according to the present disclosure. The thermal transport bus 2300 can be utilized with the turbofan engine 110 of FIG. 1 or the turbofan engine 210 of FIG. 2.

The thermal transport bus 2300 includes an intermediary heat exchange fluid flowing therethrough and is formed of one or more suitable fluid conduits 2304. The heat exchange fluid may be an incompressible fluid having a high temperature operating range. Additionally, or alternatively, the heat exchange fluid may be a single-phase fluid, or alternatively, may be a phase change fluid. In certain exemplary embodiments, the heat exchange fluid may be a supercritical fluid, such as a supercritical CO₂.

The exemplary thermal transport bus 2300 includes a pump 2306 in fluid communication with the heat exchange fluid in the thermal transport bus 2300 for generating a flow of the heat exchange fluid in and through the thermal transport bus 2300.

Moreover, the thermal transport bus 2300 includes one or more heat source exchangers 2308 in thermal communication with the heat exchange fluid in the thermal transport bus 2300. Specifically, the thermal transport bus 2300 depicted includes a plurality of heat source exchangers 2308. The plurality of heat source exchangers 2308 are configured to transfer heat from one or more of the accessory systems of an engine within which the thermal transport bus 2300 is installed (e.g., the turbofan engine 110 of FIG. 1 or the turbofan engine 210 of FIG. 2) to the heat exchange fluid in the thermal transport bus 2300. For example, in certain exemplary embodiments, the plurality of heat source exchangers 2308 may include one or more of: a CCA heat source exchanger (such as the CCA heat exchanger 2254 in FIGS. 22 and 24), a main lubrication system heat source exchanger for transferring heat from a main lubrication system, an advanced clearance control (ACC) system heat source exchanger for transferring heat from an ACC system, a generator lubrication system heat source exchanger for transferring heat from the generator lubrication system; an environmental control system (ECS) heat exchanger for transferring heat from an ECS, an electronics cooling system heat exchanger for transferring heat from the electronics cooling system, a vapor compression system heat source exchanger, an air cycle system heat source exchanger, and an auxiliary system(s) heat source exchanger.

In FIG. 25, there are three heat source exchangers 2308. The heat source exchangers 2308 are each arranged in series flow along the thermal transport bus 2300. However, in other exemplary embodiments, any other suitable number of heat source exchangers 2308 may be included and one or more of the heat source exchangers 2308 may be arranged in parallel flow along the thermal transport bus 2300 (in addition to, or in the alternative to the serial flow arrangement depicted). For example, in other embodiments there may be a single heat source exchanger 2308 in thermal communication with the heat exchange fluid in the thermal transport bus 2300, or alternatively, there may be at least two heat source exchangers 2308, at least four heat source exchangers 2308, at least five heat source exchangers 2308, or at least six heat source exchangers 2308, and up to twenty heat source exchangers 2308 in thermal communication with heat exchange fluid in the thermal transport bus 2300.

Additionally, the exemplary thermal transport bus 2300 of FIG. 25 further includes one or more heat sink exchangers 2310 permanently or selectively in thermal communication with the heat exchange fluid in the thermal transport bus 2300. The one or more heat sink exchangers 2310 are located downstream of the plurality of heat source exchangers 2308 and are configured for transferring heat from the heat exchange fluid in the thermal transport bus 2300, e.g., to atmosphere, to fuel, to a fan stream, etc. For example, in certain embodiments the one or more heat sink exchangers 2310 may include at least one of a RAM heat sink exchanger, a fuel heat sink exchanger, a fan stream heat sink exchanger, a bleed air heat sink exchanger, an engine intercooler heat sink exchanger, a bypass passage heat sink exchanger, or a cold air output heat sink exchanger of an air cycle system. The fuel heat sink exchanger is a “fluid to heat exchange fluid” heat exchanger wherein heat from the heat exchange fluid is transferred to a stream of liquid fuel (see, e.g., fuel heat exchanger 2302 of the turbofan engine 210 of FIG. 24). Moreover, the fan stream heat sink exchanger is generally an “air to heat exchange fluid” heat exchanger which transfers heat from the heat exchange fluid to an airflow through the fan stream (see, e.g., the heat exchanger 2200 of FIG. 22). Further, the bleed air heat sink exchanger is generally an “air to heat exchange fluid” heat exchanger over which, e.g., bleed air flows from the LP compressor 226 over the heat exchange fluid to remove heat from the heat exchange fluid.

For the embodiment of FIG. 25, the one or more heat sink exchangers 2310 of the thermal transport bus 2300 depicted includes a plurality of individual heat sink exchangers 2310. More particularly, for the embodiment of FIG. 25, the one or more heat sink exchangers 2310 include three heat sink exchangers 2310 arranged in series. The three heat sink exchangers 2310 are configured as a bypass passage heat sink exchanger, a fuel heat sink exchanger, and a fan stream heat sink exchanger. However, in other exemplary embodiments, the one or more heat sink exchangers 2310 may include any other suitable number and/or type of heat sink exchangers 2310. For example, in other exemplary embodiments, a single heat sink exchanger 2310 may be provided, at least two heat sink exchangers 2310 may be provided, at least four heat sink exchangers 2310 may be provided, at least five heat sink exchangers 2310 may be provided, or up to twenty heat sink exchangers 2310 may be provided. Additionally, in still other exemplary embodiments, two or more of the one or more heat sink exchangers 2310 may alternatively be arranged in parallel flow with one another.

Referring still to the exemplary embodiment depicted in FIG. 25, one or more of the plurality of heat sink exchangers 2310 and one or more of the plurality of heat source exchangers 2308 are selectively in thermal communication with the heat exchange fluid in the thermal transport bus 2300. More particularly, the thermal transport bus 2300 depicted includes a plurality of bypass lines 2312 for selectively bypassing each heat source exchanger 2308 and each heat sink exchanger 2310 in the plurality of heat sink exchangers 2310. Each bypass line 2312 extends between an upstream juncture 2314 and a downstream juncture 2316—the upstream juncture 2314 located just upstream of a respective heat source exchanger 2308 or heat sink exchanger 2310, and the downstream juncture 2316 located just downstream of the respective heat source exchanger 2308 or heat sink exchanger 2310.

Additionally, each bypass line 2312 meets at the respective upstream juncture 2314 with the thermal transport bus 2300 via a three-way valve 2318. The three-way valves 2318 each include an inlet fluidly connected with the thermal transport bus 2300, a first outlet fluidly connected with the thermal transport bus 2300, and a second outlet fluidly connected with the bypass line 2312. The three-way valves 2318 may each be a variable throughput three-way valve, such that the three-way valves 2318 may vary a throughput from the inlet to the first outlet or the second outlet. For example, the three-way valves 2318 may be configured for providing anywhere between zero percent (0%) and one hundred percent (100%) of the heat exchange fluid from the inlet to the first outlet, and similarly, the three-way valves 2318 may be configured for providing anywhere between zero percent (0%) and one hundred percent (100%) of the heat exchange fluid from the inlet to the second outlet.

Notably, the three-way valves 2318 may be in operable communication with a controller of an engine including the thermal transport bus 2300 (e.g., the turbofan engine 110 of FIG. 1 or the turbofan engine 210 of FIG. 2).

Further, each bypass line 2312 also meets at the respective downstream juncture 2316 with the thermal transport bus 2300. Between each heat source exchanger 2308 or heat sink exchanger 2310 and downstream juncture 2316, the thermal transport bus 2300 includes a check valve 2320 for ensuring a proper flow direction of the heat exchange fluid. More particularly, the check valve 2320 prevents a flow of heat exchange fluid from the downstream juncture 2316 towards the respective heat source exchanger 2308 or heat sink exchanger 2310.

As alluded to earlier, during the course of turbofan engine design—i.e., designing turbofan engines having a variety of different high-pressure compressor exit areas, total thrust outputs, redline exhaust gas temperatures, and supporting technology characteristics and evaluating an overall engine performance and other qualitative turbofan engine characteristics—a significant relationship exists between a total sea level static thrust output, a compressor exit area, and a redline exhaust gas temperature that enables increased engine core operating temperatures and overall engine propulsive efficiency. The relationship can be thought of as an indicator of the ability of a turbofan engine to have a reduced weight or volume as represented by a high-pressure compressor exit area, while maintaining or even improving upon an overall thrust output, and without overly detrimentally affecting overall engine performance and other qualitative turbofan engine characteristics. The relationship applies to an engine that incorporates a cooled cooling air system, builds portions of the core using material capable of operating at higher temperatures, or a combination of the two. Significantly, the relationship ties the core size (as represented by the exit area of the higher pressure compressor) to the desired thrust and exhaust gas temperature associated with the desired propulsive efficiency and practical limitations of the engine design, as described below.

Referring to the case of an engine that utilizes cooled cooling air for operating at higher temperatures, the costs associated with achieving a higher compression, enabled by reducing gas temperatures used to cool core components to accommodate higher core gas temperatures, may indeed produce a net benefit, contrary to expectations in the art. Referring to the case of utilizing more temperature-resistant material, such as a Carbon Matrix Composite (CMC), certain aspects of the engine size, weight and operating characteristics can be positively affected while taking into account the complexities and/or drawbacks associated with such material. In either case, the relationship now described can apply to identify the interrelated operating conditions and core size—i.e., total sea level static thrust, redline exhaust gas temperature, and compressor exit area, respectively.

Bounding the relationship between a product of total thrust output and redline exhaust gas temperature at a takeoff power level and the high-pressure compressor exit area squared (corrected specific thrust) can result in a higher power density core. This bounded relationship, as described herein, takes into due account the amount of overall complexity and cost, or a low amount of reliability associated with implementing the technologies required to achieve the operating temperatures and exhaust gas temperature associated with the desired thrust levels. The amount of overall complexity and cost may be prohibitively high for turbofan engines outside the bounds of the relationship as described herein, or the reliability may prohibitively low outside the bounds of the relationship as described herein. The relationship discovered, infra, can therefore identify an improved engine configuration suited for a particular mission requirement, one that takes into account efficiency, weight, cost, complexity, reliability, and other factors influencing the optimal choice for an engine configuration.

In addition to yielding an improved turbofan engine, as explained in detail above, utilizing this relationship, the number of suitable or feasible turbofan engine designs capable of meeting the above design requirements could be greatly diminished, thereby facilitating a more rapid down selection of designs to consider as a turbofan engine is being developed. Such a benefit provides more insight to the requirements for a given turbofan engine well before specific technologies, integration and system requirements are developed fully. Such a benefit avoids late-stage redesign.

The desired relationship providing for the improved turbofan engine, is expressed in relationship (5) as:

$$CST = {Fn}_{Total} \times EGT / ( {{A}_{HPCExit}}^{2} \times 1000 ) , \qquad ( 5 )$$

where CST is corrected specific thrust; Fn_{Total} is a total sea level static thrust output of the turbofan engine in pounds; EGT is redline exhaust gas temperature in degrees Celsius; and A_{HPCExit} is a high-pressure compressor exit area in square inches.

CST values of an engine defined by relationship (5) in accordance with various embodiments of the present disclosure are from forty-two to ninety (42 to 90), such as from forty-five to eighty (45 to 80), such as from fifty to eighty (50 to 80). The units of the CST values may be pounds-degrees Celsius over square inches.

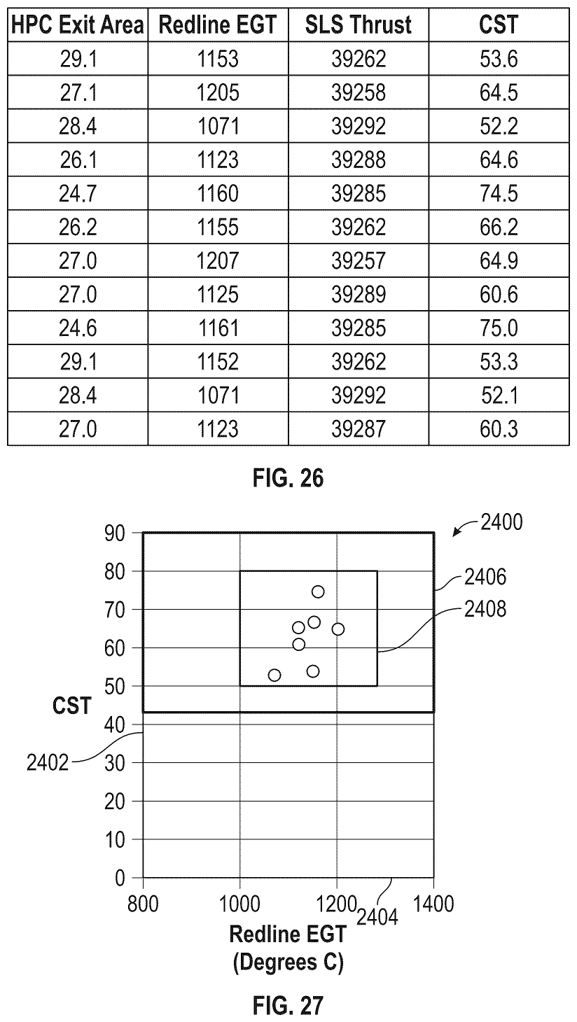

FIGS. 26 and 27 show various exemplary turbofan engines, according to the present disclosure. In particular, FIG. 26 provides a table including numerical values corresponding to several of the plotted turbofan engines in FIG. 27. FIG. 27 is a plot 2400 of turbofan engines in accordance with one or more exemplary embodiments of the present disclosure, showing the CST on a Y-axis 2402 and the EGT on an X-axis 2404.

As shown, the plot 2400 in FIG. 27 depicts a first range 2406, with the CST values between forty-two and ninety (42 and 90) and EGT values from eight hundred degrees Celsius to one thousand four hundred degrees Celsius (800° C. to 1400° C.). FIG. 27 additionally depicts a second range 2408, with the CST values between fifty and eighty (50 and 80) and EGT values from one thousand degrees Celsius to one thousand three hundred degrees Celsius (1000° C. to 1300° C.). In other embodiments, the EGT value may be greater than one thousand one hundred degrees Celsius (1100° C.) and less than one thousand two hundred fifty degrees Celsius (1250° C.), such as greater than one thousand one hundred fifty degrees Celsius (1150° C.) and less than one thousand two hundred fifty degrees Celsius (1250° C.), such as greater than one thousand degrees Celsius (1000° C.) and less than one thousand three hundred degrees Celsius (1300° C.).

Although the discussion above is generally related to an open rotor engine having a particular cooled cooling air system 2250 (FIG. 22), in various embodiments of the present disclosure, the relationship outlined above with respect to relationship (5) may be applied to any other suitable engine architecture, including any other suitable technology(ies) to allow the turbofan engine to accommodate higher temperatures to allow for a reduction in the high-pressure compressor exit area, while maintaining or even increasing the maximum turbofan engine thrust output without, e.g., prematurely wearing various components within the turbofan engine exposed the working gas flowpath.

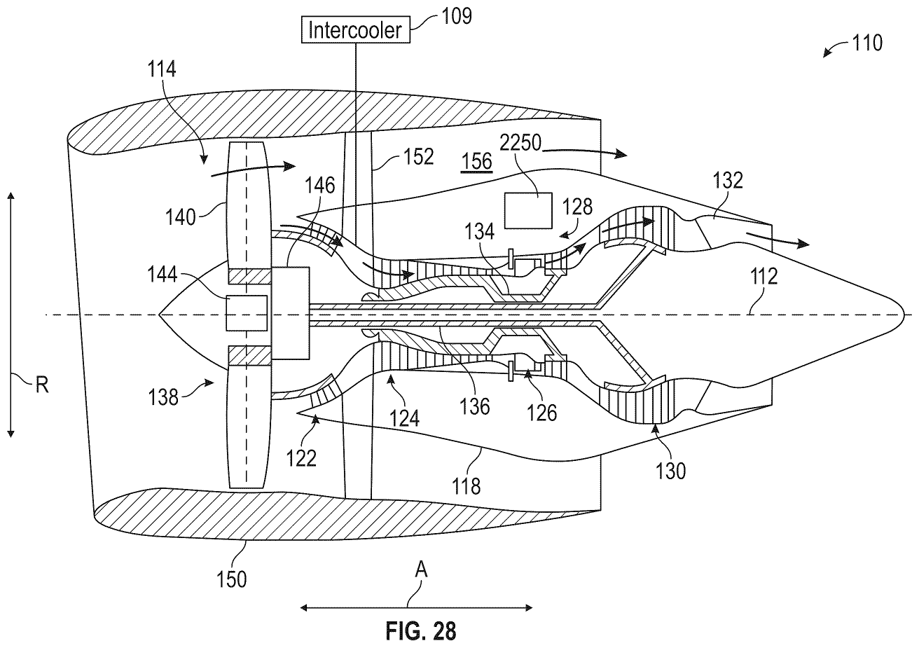

For example, reference will now be made to FIG. 28, which shows a schematic view of the turbofan engine 110. The turbofan engine 110 further includes an outer housing or a nacelle 150 circumferentially surrounding at least in part the fan assembly 114. The nacelle 150 defines the bypass airflow passage 156 between the nacelle 150 and the core cowl 118.

In some embodiments, the turbofan engine 110 includes an intercooler 109. The intercooler 109 cools the engine flow path air downstream of the low-pressure compressor 122 before the engine flow path air enters the high-pressure compressor 124 during flight conditions (e.g., takeoff or maximum thrust). The intercooler 109 can include any type of intercooler. For example, the intercooler 109 can include a heat exchanger in the fan guide vanes 152, also referred to as an inter-compressor frame, or an inter-compressor casing (e.g., in the outer casing 118) in which cooling fluid is used to absorb heat with the flow path air. The cooling fluid can include a thermal bus or fuel. The thermal bus can absorb heat from the core air and reject the heat into a heat sink, such as, for example, fuel and/or bypass air. In some embodiments, the intercooler 109 can include a heat exchanger between the core air and the bypass air. In some embodiments, the intercooler 109 includes water or steam that is injected into the core flow path at the inter-compressor frame. While the intercooler 109 is described in relation to FIG. 28, any of the engines detailed herein can include an intercooler 109.

Briefly, the turbofan engine 110 of FIG. 28 is configured as a two-stream engine, i.e., an engine without a third stream (e.g., the fan duct 272 in the exemplary turbofan engine 210 of FIG. 2). With such a configuration, a total sea level static thrust output Fn_{Total} of the turbofan engine 110 may generally be equal to a sum of: a fan stream thrust Fn_{Fan} (i.e., an amount of thrust generated by the fan 138 through the bypass airflow passage 156) and a turbofan engine thrust Fn_{TM} (i.e., an amount of thrust generated by an airflow through the core exhaust nozzle 132), each during the static, sea level, standard day conditions.

Further, for the exemplary embodiment of FIG. 28, the turbofan engine 110 additionally includes a cooled cooling air system 2250 configured to provide a turbine section with cooled cooling air during operation of the turbofan engine 110, to allow the turbofan engine 110 to accommodate higher temperatures to allow for a reduction in a high-pressure compressor exit area, while maintaining or even increasing a maximum turbofan engine thrust output.

In other exemplary embodiments of the present disclosure, the cooled cooling air system 2250 may be configured in any other suitable manner. For example, the cooled cooling air system 2250 described above with reference to FIGS. 22 and 23 is generally configured as a thermal bus cooled cooling air system. However, in other embodiments, the cooled cooling air system 2250 may instead be a dedicated heat exchanger cooled cooling air system (i.e., a cooled cooling air system including a heat exchanger that transfers heat directly to a cooling medium). Additionally, in other embodiments, the cooled cooling air system 2250 may be a bypass heat exchanger cooled cooling air system having a heat sink heat exchanger thermally coupled to an airflow through a bypass passage (see, e.g., FIG. 29, discussed below). Additionally, or alternatively, in other embodiments, the cooled cooling air system 2250 may be one of an air-to-air cooled cooling air system (a cooled cooling air system having a heat sink heat exchanger configured to transfer heat to an airflow. See, e.g., FIG. 29, discussed below), an oil-to-air cooled cooling air system (a cooled cooling air system having a heat sink heat exchanger configured to transfer heat to an oil flow), or a fuel-to-air cooled cooling air system (a cooled cooling air system having a heat sink heat exchanger configured to transfer heat to a fuel flow, such as a Jet A fuel flow, a liquid hydrogen or hydrogen gas fuel flow, etc. See, e.g., FIG. 24).

More particularly, referring generally to FIGS. 29 through 31, in other exemplary embodiments, the cooled cooling air system 2250 may be configured in any other suitable manner. The turbofan engines 210 depicted in FIGS. 29 through 31 may be configured in a similar manner as exemplary turbofan engine 210 described above with reference to FIGS. 2 and 22 through 24, and the same or similar numbers may refer to the same or similar parts.

The turbofan engines 210 depicted in FIGS. 29 to 31 additionally include a cooled cooling air system 2250. The cooled cooling air system 2250 generally includes a duct assembly 2252 and a CCA heat exchanger 2254.

However, referring particular to FIG. 29, for the exemplary embodiment depicted, the CCA heat exchanger 2254 is positioned in thermal communication with the bypass passage 295, and more specifically, the CCA heat exchanger 2254 is exposed to an airflow through or over the bypass passage 295. For the embodiment of FIG. 29, the CCA heat exchanger 2254 is positioned on the core cowl 222. In such a manner, the CCA heat exchanger 2254 may be an air-to-air CCA heat exchanger configured to exchange heat between an airflow extracted from the HP compressor 228 and the airflow through the bypass passage 295.

As is depicted in phantom, the cooled cooling air system 2250 may additionally or alternatively be positioned at any other suitable location along the bypass passage 295, such as on the fan cowl 270. Further, although depicted in FIG. 29 as being positioned on the core cowl 222, in other embodiments, the CCA heat exchanger 2254 may be embedded into the core cowl 222, and airflow through the bypass passage 295 may be redirected from the bypass passage 295 to the CCA heat exchanger 2254.

A size of the CCA heat exchanger 2254 may affect the amount of drag generated by the CCA heat exchanger 2254 being positioned within or exposed to the bypass passage 295. Accordingly, sizing the cooled cooling air system 2250 in accordance with the present disclosure may allow for a desired reduction in a HP compressor 228 exit area, while maintaining or even increasing a total thrust output for the turbofan engine 210, without creating an excess amount of drag on the turbofan engine 210 in the process.

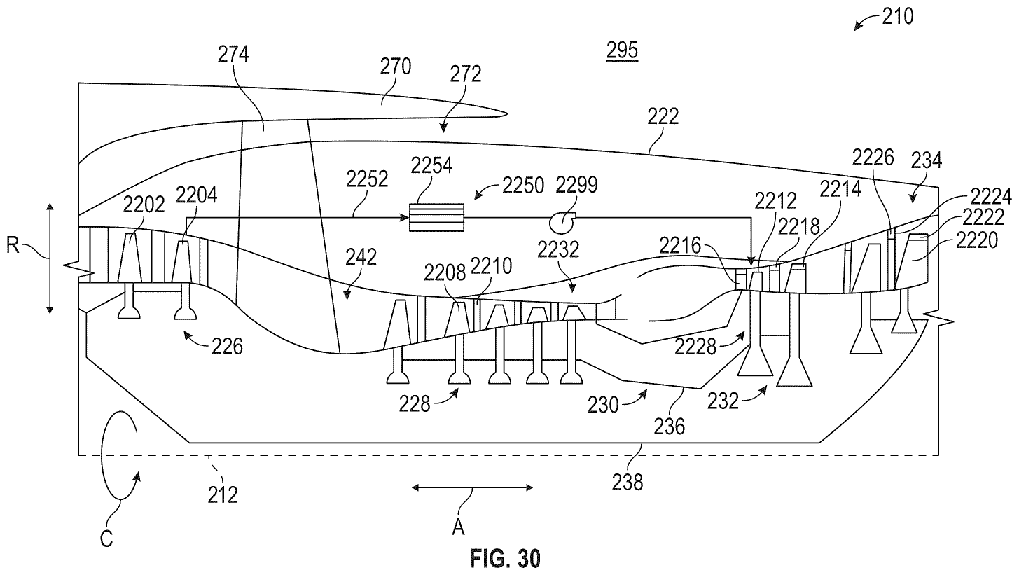

Referring now particularly to FIG. 30, for the exemplary embodiment depicted, the cooled cooling air system 2250 is configured to receive the cooling airflow from an air source upstream of a downstream half of the HP compressor 228. In particular, for the exemplary embodiment of FIG. 30, the exemplary cooled cooling air system 2250 is configured to receive the cooling airflow from a location upstream of the HP compressor 228, and, more specifically, still, from the LP compressor 226. In order to allow for a relatively low-pressure cooling airflow to be provided to a first stage 2228 of HP turbine rotor blades 2212 of the HP turbine 232, the cooled cooling air system 2250 further includes a pump 2299 in airflow communication with the duct assembly 2252 to increase a pressure of the cooling airflow through the duct assembly 2252. For the exemplary aspect depicted, the pump 2299 is positioned downstream of the CCA heat exchanger 2254. In such a manner, the pump 2299 may be configured to increase the pressure of the cooling airflow through the duct assembly 2252 after the cooling airflow has been reduced in temperature by the CCA heat exchanger 2254. Such may allow for a reduction in wear on the pump 2299.

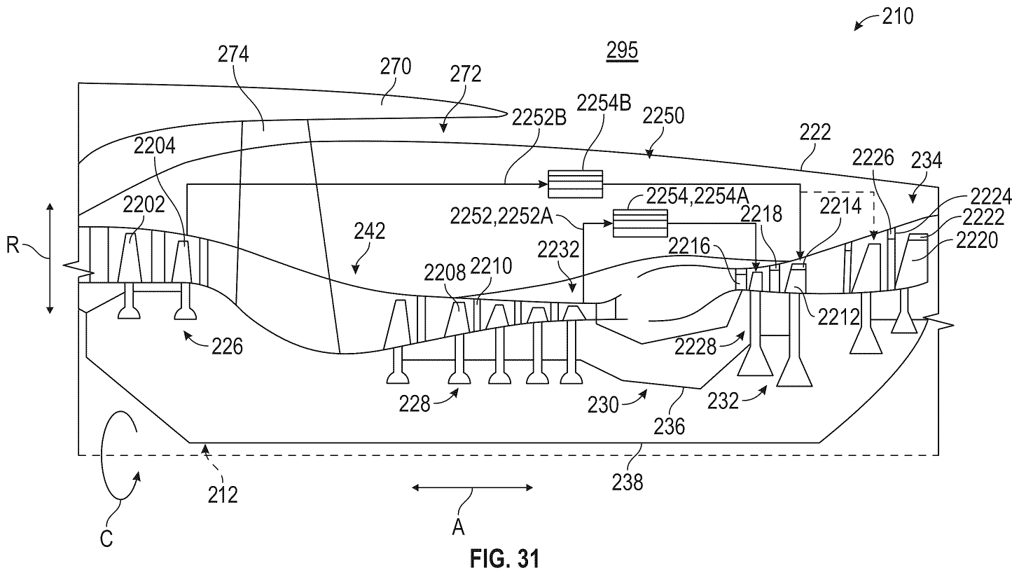

Referring now particularly to FIG. 31, the cooled cooling air system 2250 includes a high-pressure portion and a low-pressure portion operable in parallel. In particular, the duct assembly 2252 includes a high-pressure duct assembly 2252A and a low-pressure duct assembly 2252B, and the CCA heat exchanger 2254 includes a high-pressure CCA heat exchanger 2254A and a low-pressure CCA heat exchanger 2254B.

The high-pressure duct assembly 2252A is in fluid communication with the HP compressor 228 at a downstream half of the high-pressure compressor and is further in fluid communication with a first stage 2228 of HP turbine rotor blades 2212. The high-pressure duct assembly 2252A may be configured to receive a high-pressure cooling airflow from the HP compressor 228 through the high-pressure duct assembly 2252A and provide such high-pressure cooling airflow to the first stage 2228 of HP turbine rotor blades 2212. The high-pressure CCA heat exchanger 2254A may be configured to reduce a temperature of the high-pressure cooling airflow through the high-pressure duct assembly 2252A at a location upstream of the first stage 2228 of HP turbine rotor blades 2212.

The low-pressure duct assembly 2252B is in fluid communication with a location upstream of the downstream half of the high-pressure compressor 228 and is further in fluid communication with the HP turbine 232 and a location downstream of the first stage 2228 of HP turbine rotor blades 2212. In particular, for the embodiment depicted, the low-pressure duct assembly 2252B is in fluid communication with the LP compressor 226 and a second stage (not labeled) of HP turbine rotor blades 2212. The low-pressure duct assembly 2252B may be configured to receive a low-pressure cooling airflow from the LP compressor 226 through the low-pressure duct assembly 2252B and provide such low-pressure cooling airflow to the second stage of HP turbine rotor blades 2212. The low-pressure CCA heat exchanger 2254B may be configured to reduce a temperature of the low-pressure cooling airflow through the low-pressure duct assembly 2252B upstream of the second stage of HP turbine rotor blades 2212.

Inclusion of the exemplary cooled cooling air system 2250 of FIG. 31 may reduce an amount of resources utilized by the cooled cooling air system 2250 to provide a desired amount of cooling for the turbofan engine 210.

Further, for the exemplary embodiment of FIG. 31, the cooled cooling air system 2250 may further be configured to provide cooling to one or more stages of LP turbine rotor blades 2220, and in particular to a first stage (i.e., upstream-most stage) of LP turbine rotor blades 2220. Such may further allow for, e.g., the higher operating temperatures described herein.

FIG. 32 provides a schematic view of a turbofan engine 2500, according to another embodiment. The turbofan engine 2500 of FIG. 32 may be configured in substantially the same manner as the exemplary turbofan engine 210 described above with respect to FIGS. 2 and 22 through 24, and the same or similar reference numerals may refer to the same or similar parts. However, the turbofan engine 2500 is configured as a three-spool engine, instead of a two-spool engine.

For example, the turbofan engine 2500 is a turbofan engine and includes a fan section 2502. The fan section 2502 includes a fan 2506. The turbofan engine 2500 also includes a first compressor 2508, a second compressor 2510, a combustor 2512, a first turbine 2514, a second turbine 2516, and a third turbine 2518. The first compressor 2508 may be a high-pressure compressor, the second compressor 2510 may be a medium pressure compressor (or intermediate pressure compressor), the first turbine 2514 may be a high-pressure turbine, the second turbine 2516 may be a medium pressure turbine (or intermediate pressure turbine), and the third turbine 2518 may be a low-pressure turbine. Further, the turbofan engine 2500 includes a first shaft 2520 extending between, and rotatable with both of, the first compressor 2508 and first turbine 2514; a second shaft 2522 extending between, and rotatable with both of, the second compressor 2510 and second turbine 2516; and a third shaft 2524 extending between, and rotatable with both of, the third turbine 2518 and fan 2506. In such a manner, the turbofan engine 2500 may be referred to as a three-spool engine.

For the embodiment of FIG. 32, the term redline EGT refers to a maximum temperature of an airflow after the first stator downstream of the last stage of rotor blades of the intermediate speed turbine, e.g., at location 2526 in FIG. 32 (assuming the intermediate speed turbine (the second turbine 2516) includes a stage of stator vanes downstream of the last stage of rotor blades).

The cooled cooling air systems 2250 described hereinabove are provided by way of example only. In other exemplary embodiments, aspects of one or more of the exemplary cooled cooling air systems 2250 depicted may be combined to generate still other exemplary embodiments. For example, in still other exemplary embodiments, the cooled cooling air system 2250 of FIGS. 22 through 24 may not be utilized with a thermal transport bus (e.g., the thermal transport bus 2300), and instead may directly utilize a CCA heat exchanger 2254 positioned within the fan duct 272. Similarly, in other example embodiment, the exemplary cooled cooling air systems 2250 of FIGS. 29 through 31 may be utilized with a thermal transport bus (e.g., thermal transport bus 2300 of FIG. 22, 24, or 25) to reject heat for the CCA heat exchanger 2254. Additionally, although the exemplary cooled cooling air systems 2250 depicted schematically in FIGS. 29 through 31 depict the duct assembly 2252 as positioned outward of the core duct 242 along the radial direction R, in other exemplary embodiments, the duct assemblies 2252 may extend at least partially inward of the core duct 242 along the radial direction R (see, e.g., FIG. 24). In still other exemplary embodiments, the cooled cooling air system 2250 may include duct assemblies 2252 positioned outward of the core duct 242 along the radial direction R and inward of the core duct 242 along the radial direction R (e.g., in FIG. 31, the high-pressure duct assembly 2252A may be positioned inwardly of the core duct 242 along the radial direction R and the low-pressure duct assembly 2252B may be positioned outwardly of the core duct 242 along the radial direction R).

Moreover, in still other exemplary aspects, the turbofan engines herein may include additional or alternative technologies to allow the turbofan engine to accommodate higher temperatures while maintaining or even increasing the maximum turbofan engine thrust output, as may be indicated by a reduction in the high-pressure compressor exit area, without, e.g., prematurely wearing on various components within the turbofan engine exposed to the working gas flowpath.

For example, in additional or alternative embodiments, a turobfan engine may incorporate advanced materials capable of withstanding the relatively high temperatures at downstream stages of a high-pressure compressor exit (e.g., at a last stage of high-pressure compressor rotor blades), and downstream of the high-pressure compressor (e.g., a first stage of an HP turbine, downstream stages of the HP turbine, an LP turbine, an exhaust section, etc.).

In particular, a turbofan engine of the present disclosure may include an airfoil (e.g., rotor blade or stator vane) in one or more of the HP compressor, the first stage of the HP turbine, downstream stages of the HP turbine, the LP turbine, the exhaust section, or a combination thereof formed of a ceramic-matrix-composite or a “CMC.”

One or more of these components formed of a CMC material may include an environmental-barrier-coating or “EBC.” The term EBC refers to a coating system including one or more layers of ceramic materials, each of which provides specific or multi-functional protections to the underlying CMC. EBCs generally include a plurality of layers, such as rare earth silicate coatings (e.g., rare earth disilicates such as slurry or APS-deposited yttrium ytterbium disilicate (YbYDS)), alkaline earth aluminosilicates (e.g., including barium-strontium-aluminum silicate (BSAS), such as having a range of BaO, SrO, Al₂O₃, and/or SiO₂ compositions), hermetic layers (e.g., a rare earth disilicate), or outer coatings (e.g., comprising a rare earth monosilicate, such as slurry or APS-deposited yttrium monosilicate (YMS)). One or more layers may be doped as desired, and the EBC may also be coated with an abradable coating.

In such a manner, the EBCs may generally be suitable for application to “components” found in the relatively high temperature environments noted above. Examples of such components can include, for example, combustor components, turbine blades, shrouds, nozzles, heat shields, and vanes.

Additionally, or alternatively still, in other exemplary embodiments, a turbofan engine of the present disclosure may include an airfoil (e.g., rotor blade or stator vane) in one or more of an HP compressor, a first stage of an HP turbine, downstream stages of the HP turbine, an LP turbine, an exhaust section, or a combination thereof formed in part, in whole, or in some combination of materials including but not limited to titanium, nickel, or cobalt based superalloys (e.g., those available under the name Inconel® available from Special Metals Corporation). One or more of these materials are examples of materials suitable for use in additive manufacturing processes.

Further, in at least certain exemplary embodiments of the present disclosure, a method of operating a turbofan engine is provided. The method may be utilized with one or more of the turbofan engines discussed herein, such as in FIGS. 1, 2, 22 through 24, and 28 through 31. The method includes operating the turbofan engine at a takeoff power level, the turbofan engine having a high-pressure compressor defining a high-pressure compressor exit area (A_{HPCExit}) in square inches. The turbofan engine further defines a redline exhaust gas temperature (EGT) in degrees Celsius, a total sea level static thrust output (Fn_{Total}) in pounds, and a corrected specific thrust. The corrected specific thrust is greater than or equal to forty-two (42) and less than or equal to ninety (90), the corrected specific thrust determined as follows: Fn_{Total}×EGT/(A_{HPCExit}²×1000).

In certain exemplary aspects, operating the turbofan engine at the takeoff power level further includes reducing a temperature of a cooling airflow provided to a high-pressure turbine of the turbofan engine with a cooled cooling air system. For example, in certain exemplary aspects, reducing the temperature of the cooling airflow provided to the high-pressure turbine of the turbofan engine with the cooled cooling air system includes providing a temperature reduction of the cooling airflow equal to at least fifteen percent (15%) of the EGT and up to forty-five percent (45%) of the EGT.

Various embodiments of a turbofan engine are provided. Certain of these embodiments may be an unducted, single rotor turbofan engine (see FIG. 2) or a ducted turbofan engine (see FIG. 1). Another example of a ducted turbofan engine can be found in U.S. patent application Ser. No. 16/811,368 (Published as U.S. Patent Application Publication No. 2021/0108597), filed Mar. 6, 2020 (FIG. 10, Paragraph [0062], et al., including an annular fan case 13 surrounding the airfoil blades 21 of rotating element 20 and surrounding vanes 31 of stationary element 30, and including a third stream/fan duct 73 (shown in FIG. 10, described extensively throughout the application)). Various additional aspects of one or more of these embodiments are discussed below. These exemplary aspects may be combined with one or more of the exemplary turbofan engine(s) discussed above with respect to FIGS. 1, 2, 28, and 33.

For example, in some embodiments of the present disclosure, the turbofan engine may include a heat exchanger located in an annular duct, such as in a third stream. The heat exchanger may extend substantially continuously in a circumferential direction of the turbofan engine (e.g., at least 300 degrees, such as at least 330 degrees).

In one or more of these embodiments, a threshold power or disk loading for a fan (e.g., an unducted, single rotor or primary forward fan) may range from twenty-five horsepower per square foot (25 hp/ft²) or greater at cruise altitude during a cruise operating mode. In particular embodiments of the engine, structures and methods provided herein generate power loading between eighty horsepower per square foot and one hundred sixty horsepower per square foot (80 hp/ft² and 160 hp/ft²) or higher at cruise altitude during a cruise operating mode, depending on whether the engine is an open rotor or ducted engine.

In various exemplary embodiments, the fan (or rotor) may include twelve (12) fan blades. From a loading standpoint, such a blade count may allow a span of each blade to be reduced such that the overall diameter of the primary fan may also be reduced (e.g., to twelve feet in one exemplary embodiment). That said, in other embodiments, the fan may have any suitable blade count and any suitable diameter. In certain suitable embodiments, the fan includes at least eight (8) blades. In another suitable embodiment, the fan may have at least twelve (12) blades. In yet another suitable embodiment, the fan may have at least fifteen (15) blades. In yet another suitable embodiment, the fan may have at least eighteen (18) blades. In one or more of these embodiments, the fan includes twenty-six (26) or fewer blades, such as twenty (20) or fewer blades. Alternatively, in certain suitable embodiments, the fan may only include at least four (4) blades, such as with a fan of a turboprop engine.

Further, in certain exemplary embodiments, the rotor assembly may define a rotor diameter (or fan diameter) of at least ten feet (10 ft), such as at least eleven feet (11 ft), such as at least twelve feet (12 ft), such as at least thirteen feet (13 ft), such as at least fifteen feet (15 ft), such as at least seventeen feet (17 ft), such as up to twenty-eight feet (28 ft), such as up to twenty-six feet (26 ft), such as up to twenty-four feet (24 ft), such as up to eighteen feet (18 ft). In some embodiments, the fan has a fan diameter in a range of 84.0 inches to 180.0 inches. In embodiments for a ducted engine (e.g., the turbofan engine 110 of FIGS. 1 and 8), the fan diameter is in a range of 84.0 inches to 120.0 inches. In embodiments for an open fan engine (e.g., the turbofan engine 210 of FIG. 1), the fan diameter is in a range of 120.0 inches to 180.0 inches.

In various embodiments, it will be appreciated that the engine includes a ratio of a quantity of vanes to a quantity of blades that could be less than, equal to, or greater than 1:1. For example, in particular embodiments, the engine includes twelve (12) fan blades and ten (10) vanes. In other embodiments, the vane assembly includes a greater quantity of vanes to fan blades. For example, in particular embodiments, the engine includes ten (10) fan blades and twenty-three (23) vanes. For example, in certain embodiments, the engine may include a ratio of a quantity of vanes to a quantity of blades between 1:2 and 5:2. The ratio may be tuned based on a variety of factors including a size of the vanes to ensure a desired amount of swirl is removed for an airflow from the primary fan.

Additionally, in certain exemplary embodiments, where the engine includes the third stream and a mid-fan (a ducted fan aft of the primary, forward fan), a ratio R1/R2 may be between one and ten (1 and 100, or two and seven (2 and 7), or at least three point three (3.3), at least three point five (3.5), at least four (4) and less than or equal to seven (7), where R1 is the radius of the primary fan and R2 is the radius of the mid-fan.

It should be appreciated that various embodiments of the engine, such as the single unducted rotor engine depicted and described herein, may allow for normal subsonic aircraft cruise altitude operation at or above Mach 0.5. In certain embodiments, the engine allows for normal aircraft operation between Mach 0.55 and Mach 0.85 at cruise altitude. In still particular embodiments, the engine allows for normal aircraft operation between Mach 0.75 and Mach 0.85. In certain embodiments, the engine allows for rotor blade tip speeds at or less than seven hundred fifty feet per second (750 fps). In other embodiments, the rotor blade tip speed at a cruise flight condition can be six hundred fifty feet per second to nine hundred feet per second (650 fps to 900 fps), or seven hundred feet per second to eight hundred feet per second (700 fps to 800 fps). Alternatively, in certain suitable embodiments, the engine allows for normal aircraft operation of at least Mach 0.3, such as with turboprop engines.

A fan pressure ratio (FPR) for the primary fan of the fan assembly can be one point zero four to two point two (1.04 to 2.20), or in some embodiments one point zero five to one point two (1.05 to 1.2), or in some embodiments less than one point zero eight (1.08), as measured across the fan blades of the primary fan at a cruise flight condition.

In order for the turbofan engine to operate with a fan having the above characteristics to define the above FPR, a gear assembly may be provided to reduce a rotational speed of the fan assembly relative to a driving shaft (such as a low-pressure shaft coupled to a low-pressure turbine). In some embodiments, a gear ratio of the input rotational speed to the output rotational speed is between three and four (3.0 and 4.0), between three point two and three point five (3.2 and 3.5), or between three point five and four point five (3.5 and 4.5). In some embodiments, a gear ratio of the input rotational speed to the output rotational speed is greater than four point one (4.1). For example, in particular embodiments, the gear ratio is within a range of four point one to fourteen (4.1 to 14.0), within a range of four point five to fourteen (4.5 to 14.0), or within a range of six to fourteen (6.0 to 14.0). In certain embodiments, the gear ratio is within a range of three point two to twelve (3.2 to 12) or within a range of four point five to eleven (4.5 to 11.0).

With respect to a turbofan engine, the compressors and/or turbines can include various stage counts. As disclosed herein, the stage count includes the number of rotors or blade stages in a particular component (e.g., a compressor or turbine). For example, in some embodiments, a low-pressure compressor may include one to eight (1 to 8) stages, a high-pressure compressor may include four to fifteen (4 to 15) stages, a high-pressure turbine may include one to two (1 to 2) stages, and/or a low-pressure turbine (LPT) may include one to seven (1 to 7) stages. In particular, the LPT may have four (4) stages, or between four and six (4 and 6) stages. For example, in certain embodiments, an engine may include a one (1) stage low-pressure compressor, an eleven (11) stage high-pressure compressor, a two (2) stage high-pressure turbine, and four (4) stages, or between four and seven (4 and 7) stages for the LPT. As another example, an engine can include a three (3) stage low-pressure compressor, a ten (10) stage high-pressure compressor, a two (2) stage high-pressure turbine, and a seven (7) stage low-pressure turbine.

A core engine is generally encased in an outer casing defining one half of a core diameter (Dcore), which may be thought of as the maximum extent from a centerline axis (datum for R). In certain embodiments, the engine includes a length (L) from a longitudinally (or axial) forward end to a longitudinally aft end. In various embodiments, the engine defines a ratio of L/Dcore that provides for reduced installed drag. In one embodiment, L/Dcore is at least two (2). In another embodiment, L/Dcore is at least two point five (2.5). In some embodiments, the L/Dcore is less than five (5), less than four (4), and less than three (3). In various embodiments, it should be appreciated that the L/Dcore is for a single unducted rotor engine.

The reduced installed drag may further provide for improved efficiency, such as improved specific fuel consumption. Additionally, or alternatively, the reduced installed drag may provide for cruise altitude engine and aircraft operation at the above describe Mach numbers at cruise altitude. Still particular embodiments may provide such benefits with reduced interaction noise between the blade assembly and the vane assembly and/or decreased overall noise generated by the engine by virtue of structures located in an annular duct of the engine.

Additionally, it should be appreciated that ranges of power loading and/or rotor blade tip speed may correspond to certain structures, core sizes, thrust outputs, etc., or other structures of the core engine. However, as previously stated, to the extent one or more structures provided herein may be known in the art, it should be appreciated that the present disclosure may include combinations of structures not previously known to combine, at least for reasons based in part on conflicting benefits versus losses, desired modes of operation, or other forms of teaching away in the art.

Although depicted above as an unshrouded or open rotor engine, aspects of the disclosure provided herein may be applied to shrouded or ducted engines, partially ducted engines, aft-fan engines, or other turbofan engine configurations, including those for marine, industrial, or aero-propulsion systems. Certain aspects of the disclosure may address issues that may be particular to unshrouded or open rotor engines, such as, but not limited to, issues related to gear ratios, fan diameter, fan speed, length (L) of the engine, maximum diameter of the core engine (D_{CORE}) of the engine, L/Dcore of the engine, desired cruise altitude, or desired operating cruise speed, or combinations thereof.

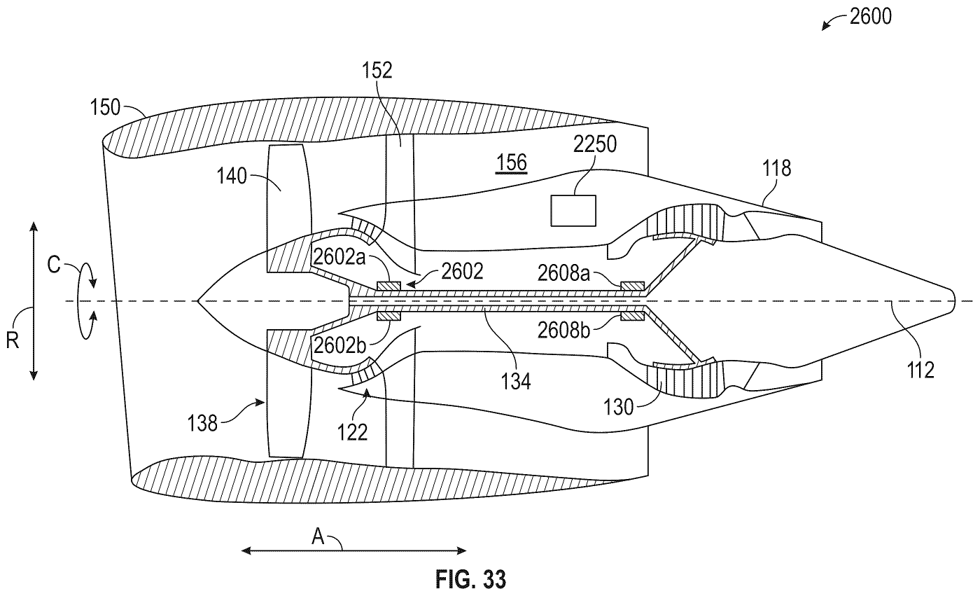

FIG. 33 shows a schematic, cross-sectional view of a turbofan engine 2600, taken along a longitudinal centerline axis 112 of the turbofan engine 2600, in accordance with another embodiment of the present disclosure. The embodiment of FIG. 33 may be configured in substantially the same manner as the exemplary turbofan engine 110 described above with respect to FIG. 1, and the same or similar reference numerals may refer to the same or similar parts. In particular, the turbofan engine 2600 includes the nacelle 150. The components of the core engine (e.g., the high-pressure compressor, the combustor, the high-pressure turbine, and the high-pressure shaft) are not shown in FIG. 33 for clarity.

The low-pressure shaft 136 is supported on bearings 2602a, 2602b, 2608a, 2608b, that are mounted to support structures (not shown) of the turbofan engine 2600. At each position, only two bearings are shown in FIG. 33 for clarity, though more than two bearings, e.g., 3 or 4 bearings forward or aft of the respective illustrated locations, may be arranged to support the low-pressure shaft 136 at the respective positions, and may be evenly spaced or irregularly spaced depending on the geometry of the bearing supporting structure, and available space and clearances.

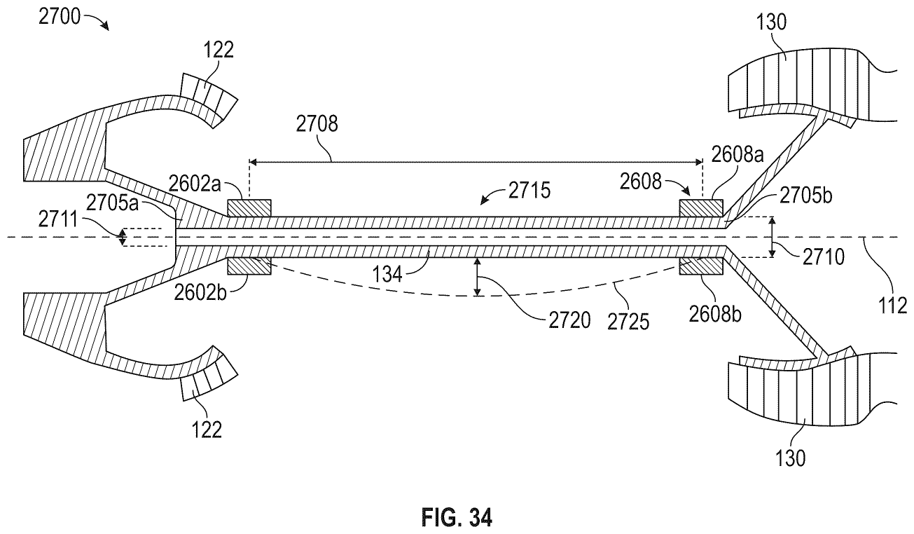

The low-pressure shaft 136, components of the low-pressure compressor 122, and components of the low-pressure turbine 130 all rotate around the longitudinal centerline axis 112 of the turbofan engine 2600, in either the same direction or a counter-rotating direction as that of the high-pressure spool. The low-pressure compressor 122 (or at least the rotating components thereof), the low-pressure turbine 130 (or at least the rotating components thereof), and the low-pressure shaft 136 may collectively be referred to as a low-pressure spool of the turbofan engine 2600 and is further described in FIG. 34.

As shown, the turbofan engine 2600 has a direct drive configuration in which the low-pressure shaft 136 is directly coupled to the fan 138 and thereby rotates the fan 138 at the same rotational speed as the low-pressure spool. Alternatively, in some embodiments, the turbofan engine 2600 includes a power gearbox (similar to the embodiment of FIG. 1), and the fan 138 is indirectly driven by the low-pressure spool across the power gearbox. The power gearbox may include a gearset for decreasing a rotational speed of the low-pressure spool relative to the low-pressure turbine 130, such that the fan 138 may rotate at a slower rotational speed than does the low-pressure spool.

FIG. 34 shows an enlarged view of a portion of the cross-sectional view of FIG. 33, that includes a low-pressure spool 2700 according to some embodiments of the present disclosure. For example, a portion of the low-pressure compressor 122 and a portion of the low-pressure turbine 130 are shown mounted to the low-pressure shaft 136 of the turbofan engine 2600 (FIG. 33), which in this example is a two-spool engine. Alternatively, the low-pressure shaft 136 may be an intermediate shaft in a three-spool engine (not shown). The low-pressure shaft 136 is supported by at least bearings 2602a to 2608b, which are located at mounting points 2705a, 2705b associated with a low-pressure compressor 226 location and a low-pressure turbine 234 location, respectively, for providing shaft rotational support at these locations. In the example of FIG. 14, bearings 2602a, 2602b, 2608a, and 2608b are all positioned inside of the mounting points 2705a and 2705b, which is referred to as an inbound bearing layout, or alternatively referred to as an overhung configuration for the low-pressure compressor 122 and the low-pressure turbine 130. If the bearings were positioned outside of the mounting point 2705b, then that would be referred to as an outbound layout. The bearings 2602a to 2608b can, however, be positioned at any point along the low-pressure shaft 136, and may both be inbound, both be outbound, or one inbound and the other outbound.

The low-pressure shaft 136 has a length “L” (indicated by arrow 2708) and an outer diameter “D” (indicated by arrow 2710). The length L is also referred to as L_{MSR} and the outer diameter D is also referred to D_{MSR}, as detailed further below. The low-pressure shaft 136 can be hollow, with an inner diameter “d” indicated by arrow 2711). In cases when the diameter of the low-pressure shaft 136 varies along the length L, the outer diameter “D” and the inner diameter “d” may be defined at a midpoint of the low-pressure shaft 136 (also referred to as the midshaft 2715). The thickness may be defined as the thickness of the walls of the low-pressure shaft 136 in embodiments in which the low-pressure shaft 136 is hollow. A difference between a stated outer diameter D and inner diameter d of the low-pressure shaft 136 may be understood as the shaft's wall thickness. In cases when the wall thickness varies along the length of the low-pressure shaft 136, the thickness may be defined as the difference between the inner diameter and the outer diameter at the midshaft 2715.

In some embodiments, the length L can be understood as the portion of the low-pressure shaft 136 between the bearings 2602a to 2608b and/or the mounting points 2705a, 2705b of engine components such as the low-pressure compressor 122 and the low-pressure turbine 130. For example, in the two-bearing arrangement of FIG. 34, the length L may be measured as the distance between midpoints of the bearings 2602a to 2608a, as indicated by the dashed vertical lines and arrow 2708. For a four-bearing arrangement, there may be additional bearings along the shaft, in which case the length L may be measured as the distance between the midpoints of an innermost pair of bearings, or the distance between pairs or other groupings of bearings. In some embodiments, the length may be measured relative to specific bearings associated with specific engine components such as the low-pressure compressor 122 and the low-pressure turbine 130.

During operation, the low-pressure shaft 136 rotates with a rotational speed that can be expressed in either rotations per minute (RPM), or as an outer diameter (OD) speed expressed in units of linear velocity, such as feet per second (ft/sec). The rotational stability of the low-pressure shaft 136 relative to its operational range may be characterized by the resonance frequency of the fundamental or first order bending mode. When an operational speed is the same as this resonance frequency, the shaft is operating at its critical speed. The low-pressure shaft 136, when supported by bearings 2602a to 2608b, has a mode shape for this first order bending mode that may be generally described as a half-sinusoid, with a midshaft 2715 location undergoing maximum displacement (indicated by arrow 2720, which is exaggerated for clarity and is not to scale) and, therefore, having a maximum kinetic energy of displacement relative to other portions of the low-pressure shaft 136. The fundamental mode shape is illustrated by dashed line 2725 extending from bearing 2602b to bearing 2608b in FIG. 34, though this is only half of the amplitude of oscillation. This unstable mode is a standing wave across the length L of the low-pressure shaft 136. The maximum deflection occurs when the excitation source has a periodicity or cyclic component near to the fundamental frequency. Since the bending mode is not active at the location of the innermost bearings 2602a to 2608b for the low-pressure shaft 136, the instability cannot be mitigated with the use of bearing dampers. When an engine is designed, the shaft speed expected to produce the highest deflection or instability at the midshaft is the shaft speed that equals the critical speed.

If the critical speed of the shaft critical speed falls within the standard operational range, i.e., if the critical speed is below the redline speed or the low-pressure shaft 136 is a supercritical shaft, then during routine operation, the low-pressure shaft 136 may at times operate at or pass through the critical speed, which induces an unstable condition. Even if the engine is operated at the critical speed temporarily, there is a possibility of undetected vibration, whirl instability, and some likelihood of damage. For low vibration and stability, it is preferable to have an operating range free of any intervening critical speeds.

There is a desire to pursue engines capable of operating at higher redline speeds. This pursuit of higher operating speeds requires that the low-pressure shaft 136 have a higher strength to weight characteristic if it is also desired that the shaft remain subcritical. The inventors sought this end result-higher speed shafts while remaining subcritical. To this end, a large number of engine designs were evaluated. Depending on the architecture, the positions and numbers of bearings relative to mounting points 2705a, 2705b were varied, and the resulting impact, not only on the critical speed but also the feasibility of such configurations given competing requirements (clearance, spacing, sump locations, oil supply lines), were taken into consideration, as will be readily apparent in view of the disclosure. A discussion of these embodiments follows. In the following discussion, strength to weight ratio is represented as E/rho, calculated as the ratio of Young's modulus E for the material (expressed, for example, in pounds per square foot) divided by the density rho (expressed, for example, in pounds per cubic inch). The shaft bending mode is represented as the critical rotational speed expressed in rotations per minute (RPM), though it could alternatively be expressed as the fundamental frequency of the bending mode in Hertz.

In some embodiments, high strength steel alloys, advanced materials, composite materials, and combinations thereof, were contemplated. For example, high strength-to-weight ratio materials such as titanium boride (TiB), a titanium metal matrix composite (TiMMC), provided 30% to 50% increased strength-to-weight ratio relative to steel or titanium alloys. In addition, coatings with materials such as graphene were found to improve strength by a factor of two in lab tests, without impacting weight. These types of changes in material composition may be characterized in some embodiments by the ratio of E/rho.

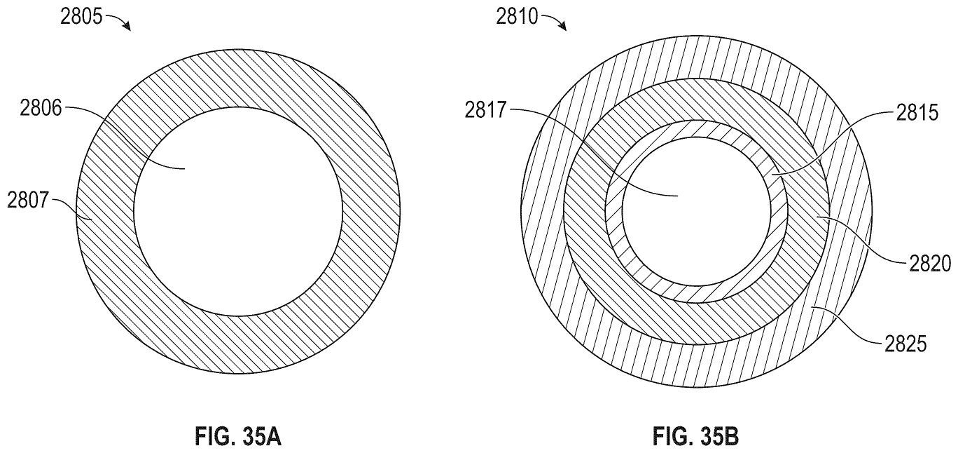

FIG. 35A shows a cross-sectional view of a steel shaft 2805, with a standard hollow interior 2806 surrounded by a steel layer 2807, and geometry defined by a length L, outer diameter D, inner diameter d, etc.

FIG. 35B shows a cross-sectional view of an example of a composite shaft 2810, with identical geometry to the steel shaft 2805. Rather than being composed entirely of steel, the composite shaft 2810 has an inner layer 2815 surrounding a hollow interior 2817, a middle layer 2820, and an outer coating 2825, all of different materials. The middle layer 2820 in this example is also steel, though in other embodiments the composite shaft could use no steel at all, or have a different layer be steel.

For example, both the steel shaft 2805 and the composite shaft 2810 have length L of seventy-six inches and outer diameter of three inches, along with a standard inbound two-bearings configuration as depicted in FIG. 34. The fundamental frequency of the unstable mode for the steel shaft 2805 is eighty Hertz (Hz), whereas the fundamental frequency for the composite shaft 2810 is ninety Hz.

In other embodiments, more layers or fewer layers may be used. Some or all of these layers and coatings may be of numerous alternative materials to steel, including but not limited to TiB, TiMMC, other metals and metal matrix composites, silicon carbide (SiC), silicon carbide reinforced metals or alloys (e.g., SiC-MMC), aluminum alloys, graphene, or combinations thereof. The concepts of the present disclosure are not limited by the particular materials used for the layers and coatings. For the composite shaft 2810, the critical speed corresponding to the unstable mode is increased relative to the (otherwise identical) steel shaft 2805, which means that relative to the steel shaft 2805, the composite shaft 2810 can attain a higher rotational speed before reaching the critical speed.

Depending on the type of composite materials chosen and the relative thickness and arrangement of the layers, the ratio of stiffness to weight can be modified, and, therefore the critical speed can be increased. The inventors conceived of a variety of embodiments resulting from the selection of different composite materials, thicknesses, and bearings configurations to allow for operation at higher speed. Two such embodiments are listed in Table 3. These embodiments were considered as possible designs that could increase the shaft stiffness to weight ratio in such a way to be compatible with engine architecture and without requiring modifications or limitations on the targeted operating range for a subcritical shaft.

TABLE 3

| Embod- | L | D | | E/rho | T_{eff} | Mode |
|---|---|---|---|---|---|---|
| iment | in | in | Bearing type | (in⁻¹) | (in) | (RPM) |
| 28 | 82.2 | 2.74 | 2-bearing outbound | 1.00E+08 | 0.35 | 4181 |
| 29 | 60.6 | 2.75 | inbound OTM | 1.27E+08 | 0.35 | 10263 |
| 30 | 82.2 | 2.74 | outbound OTM | 1.27E+08 | 0.35 | 6915 |

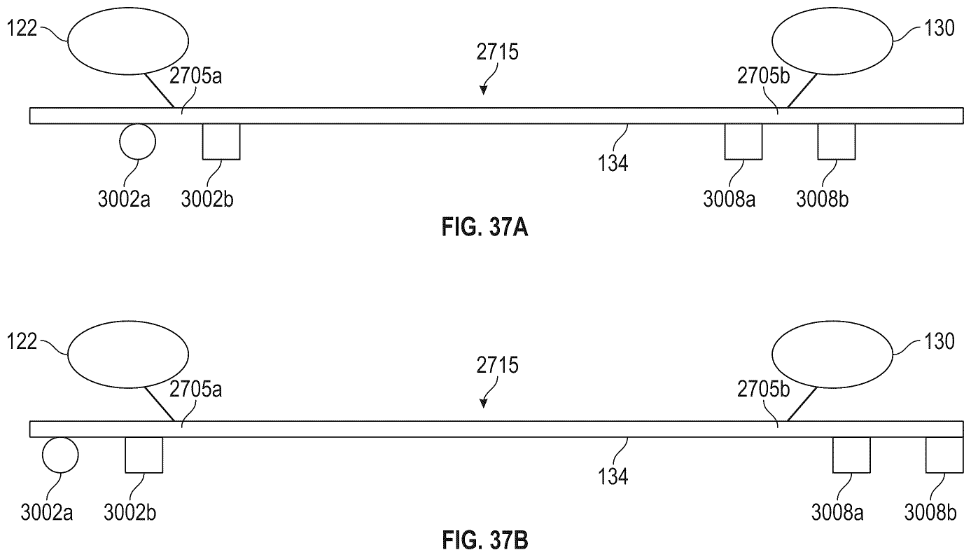

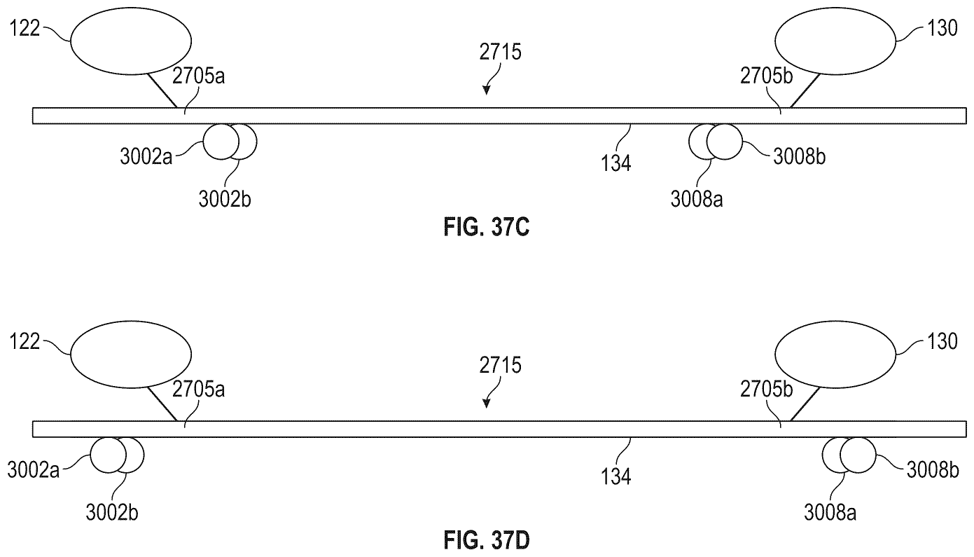

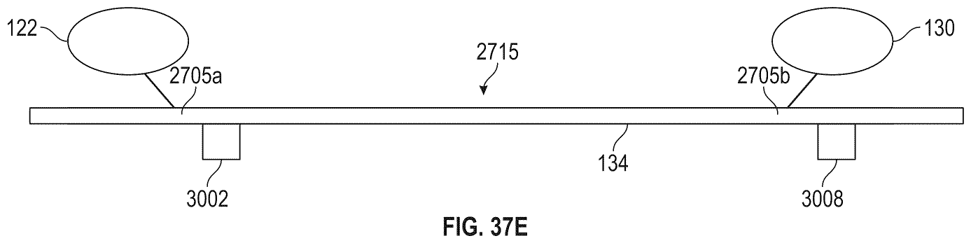

Embodiment 28 was evaluated using a high strength steel alloy and an outbound bearing layout. Embodiments 29 and 30 were evaluated with a composite material instead of steel alloy. Embodiment 29 uses overturning moment (OTM) bearings with an inbound bearing layout that is different from the layout used by Embodiment 28. Embodiment 30 uses OTM bearings with an outbound bearing layout that is similar to that used by Embodiment 28. These bearing types and layouts are described in further detail below with reference to FIG. 37A and TABLE 5. The values shown in TABLE 3 illustrate that Embodiments 29 and 30 achieve a higher strength-to-weight ratio (E/rho) when using a composite material, instead of the steel alloy used in Embodiment 28. As a result of these differences, the shaft mode critical speed occurs at 4181 RPM for Embodiment 28, at 10263 RPM for Embodiment 29 and at 6915 for Embodiment 30.

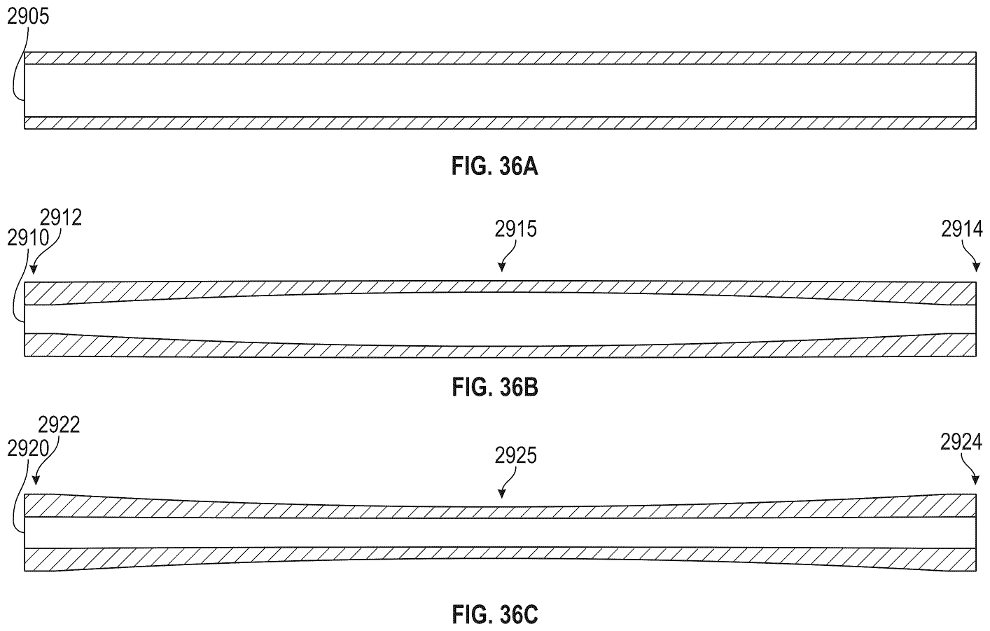

The shaft thickness was also modified along the shaft's length, to evaluate the effect on critical speed for a strength to weight ratio of E/rho that is not constant along the length L, and for different suitable materials. An example of a shaft with a uniform E/rho along its length L is shown in FIG. 36A, and examples of shafts having variable E/rho are shown in FIG. 36B and FIG. 36C.

FIG. 36A conceptually shows a cross-sectional view of a uniform shaft 2905 with a constant diameter and thickness. In this example, the uniform shaft 2905 has a length L of seventy-six inches. The outer diameter D of the uniform shaft 2905 is 3.0 inches. The uniform shaft 2905 is hollow, with a constant wall thickness of 0.2 inches and corresponding constant inner radius of 1.3 inches along its length. For this example of a uniform shaft 2905, and a two-bearing outbound configuration such as in FIG. 34, the fundamental frequency of the unstable mode is eighty Hz.

FIG. 36B conceptually shows a cross-sectional view of a concave shaft 2910 with a constant outer diameter D and a variable thickness. For comparison, the uniform shaft 2905 and the concave shaft 2910 have the same material (e.g., hollow steel), bearings (outbound), and length (seventy-six inches), with a constant outer radius of 1.5 inches along its length. The outer diameter D of the concave shaft 2910 is, therefore, 3.0 inches. Unlike the uniform shaft 2905, however, the concave shaft 2910 has a wall thickness of 0.3 inch at the ends 2912, 2914 (e.g., at the bearings, which are not shown in FIGS. 36A to 36C), and a thinner wall thickness of 0.15 inches in the midshaft region 2915. This results in an inner radius of 1.35 inches in the midshaft region 2915 and a smaller inner radius of 1.2 inches at the ends 2912, 2914. The concave shaft 2910 therefore has a reduced mass density in the midshaft region 2915. To achieve the resulting concave profile, various methods may be used to manufacture the concave shaft 2910, such as a bottle boring technique.

FIG. 36C conceptually shows a cross-sectional of a convex shaft 2920 with a variable outer diameter D and a variable thickness. For comparison, the uniform shaft 2905 and the convex shaft 2920 have the same material (e.g., hollow steel), bearings (outbound), and length (seventy-six inches), with a constant inner radius of 1.2 inches along its length. Unlike the uniform shaft 2905, the convex shaft 2920 has a wall thickness of 0.3 inch at the ends 2922, 2924, and a thinner wall thickness of 0.15 inches in the midshaft region 2925, just like the concave shaft 2910. Unlike the concave shaft 2910, the convex shaft 2920 has an outer radius of 1.5 inches at the ends 2922, 2924, and a smaller outer radius of 1.35 inches in the midshaft region 2925. The convex shaft 2920 also has a reduced mass density in the midshaft region 2925.

Since the radius (and, therefore, the diameter) are variable over the length of the convex shaft 2920, the diameter D is defined in some embodiments as the diameter at the midshaft region 2925, since this has the most relevance to the bending mode and undergoes maximum deflection. In the example of the convex shaft 2920, the shaft outer diameter D is 2.7 inches in the midshaft region 2925. In other embodiments, for example, embodiments when the radius has multiple minima and/or maxima, the diameter D may be defined at any of those minima or maxima. To achieve the resulting convex profile, various methods may be used to manufacture the convex shaft 2920, such as external machining.

For both convex and concave thickness profiles, as well as types of variable thickness profiles, the thickness may be described using an effective thickness value, T_{eff}. For a uniform shaft the thickness would simply be the difference between the outer diameter and the inner diameter. When these values are variable over the length of the shaft, the effective thickness can be calculated as the difference between the effective outer diameter and effective inner diameter. For example, the effective thickness may be defined at the midshaft in some embodiments.

With variable thickness, in some embodiments the concave shaft 2910 and the convex shaft 2920 can have twenty-five to thirty percent less weight than the uniform shaft 2905 in the midshaft region 2915 and 2925, respectively. Note that the variation in thickness need not be continuous, for example a stepped change in geometry could also be used. As a result, the fundamental frequency of the unstable mode for both the concave shaft 2910 and the convex shaft 2920 is increased to ninety Hz, which is higher than the eighty Hz fundamental frequency for the uniform shaft 2905. In other words, the concave shaft 2910 and the convex shaft 2920 can both attain a higher rotational speed than that of uniform shaft 2905, before reaching subcritical speeds.

The concave shaft 2910 and the convex shaft 2920 are examples of different thickness profiles that may be used in some embodiments. Other thickness profiles are also contemplated, which reduce or increase the mass density of the shaft in the midshaft region. The concepts of the current disclosure are not limited by the particular thickness profile used.

Depending on the thickness profile, the ratio of stiffness to weight can be modified to produce significant changes in the critical speed. embodiments are listed in TABLE 4. These embodiments were considered as possible designs that could modify the effective thickness in such a way to be compatible with engine architecture and without requiring modifications or limitations on the targeted operating range for a subcritical shaft.

TABLE 4

| Embod- | L | D | | E/rho | T_{eff} | Mode |
|---|---|---|---|---|---|---|
| iment | in | in | Bearing type | (in⁻¹) | (in) | (RPM) |
| 31 | 60.6 | 2.75 | inbound OTM | 1.00E+08 | 0.35 | 9001 |
| 32 | 82.2 | 2.74 | outbound OTM | 1.00E+08 | 0.35 | 6065 |
| 33 | 60.6 | 2.75 | inbound OTM | 1.00E+08 | 0.32 | 10039 |
| 34 | 82.2 | 2.74 | outbound OTM | 1.00E+08 | 0.32 | 6942 |

Embodiments 31, 32, 33, and 34 all use a steel alloy material composition. Embodiments 31 and 33 use an inbound bearing layout with OTM bearings, and Embodiments 32 and 34 use an outbound bearing layout with OTM bearings. Embodiments 31 and 32 are uniform shafts similar to the Example of FIG. 36A. Embodiments 33 and 34, however, have a convex thickness profile similar to the example of FIG. 36C, having been manufactured with a bottle boring manufacturing technique. The values shown in TABLE 4 illustrate that Embodiments 33 and 34 achieve a lower effective thickness T_{eff} due to their convex profile, instead of the uniform profile for Embodiments 31 and 32. As a result of these differences, the shaft mode critical speed occurs at 9001 RPM for Embodiment 31, and at 10039 RPM for Embodiment 33. The shaft mode critical speed occurs at 6065 RPM for Embodiment 32, and at 6942 RPM for Embodiment 34.

The present disclosure also provides for a variety of shafts with modified bearing configurations. Bearings are used to provide transverse support to the shaft along its length. Bearings may be ball-type bearings, which have a very small contact area with the shaft to provide less friction, or roller-type bearings, which have a large contact area with the shaft to provide increased rigidity and load bearing. Different types of bearings may be mixed in various bearing layouts. According to additional embodiments, different bearing layouts were considered, for different combinations of uniform, convex, and concave shafts, or varying shaft thickness profiles and material composition in order to determine which combination would work best for a given architecture and need, as well as taking into account competing engineering requirements.

A variety of combinations of bearing configurations were contemplated, such as embodiments when the number of bearings in duplex and/or straddling position relative to engine components (e.g., the low-pressure compressor 122 or the low-pressure turbine 130) were changed. Either or both of the engine components mounted to the low-pressure shaft 136 may be straddled or overhung. These variations can improve the critical speed and/or be more suitable to accommodate space limitations, lubrication resources or other architecture-imposed limitations. The embodiments included locating bearings at different inbound or outbound positions relative to the mounting points 2705a, 2705b.

Specific bearing layouts were preferentially used in various embodiments. These are now described in more detail, though the concepts of the present disclosure are not limited by the particular number or arrangement of bearings described herein.

For example, FIG. 37A conceptually shows the low-pressure compressor 122 and the low-pressure turbine 130 mounted on the low-pressure shaft 136 (e.g., a low-pressure shaft) supported by a four-bearing straddle configuration. Additional bearings located around the circumference of the low-pressure shaft 136 are omitted from FIG. 37A for clarity. In this system, one pair of bearings 3002a, 3002b straddle (i.e., placed forward and aft of) the mounting point 2705a of the low-pressure compressor 122, and a second pair of bearings 3008a, 3008b straddle a mounting point 2705b of the low-pressure turbine 130. In this example, the bearings 3002b, 3008a, and 3008b are roller bearings, and the bearing 3002a is a ball bearing, though these bearing types may vary in other embodiments. The length L for low-pressure shaft 136 is represented in some embodiments as the distance between the midpoints or centers of the innermost bearings 3002b, 3008a. The four-bearing straddle layout is used in several embodiments described with reference to TABLE 5.

As another example, FIG. 37B conceptually shows the low-pressure compressor 122 and the low-pressure turbine 130 mounted on the low-pressure shaft 136 supported by a four-bearing outbound configuration. Additional bearings located around the circumference of the low-pressure shaft 136 are omitted from FIG. 37B for clarity. This system is similar to that of the straddle system shown in FIG. 37A, but differs in that the bearings 3002a, 3002b are both placed forward of mounting point 2705a of the low-pressure compressor 122, and the bearings 3008a, 3008b are placed aft of mounting point 2705b of the low-pressure turbine 130. The low-pressure shaft 136 may extend beyond the bearings 3008a, 3008b. As in the example of FIG. 37A, the bearings 3002b, 3008a, and 3008b are roller bearings, and the bearing 3002a is a ball bearing, though these bearing types may vary. The length L for low-pressure shaft 136 is represented in some embodiments as the distance between the midpoints or centers of the innermost bearings 3002b, 3008a.

As yet another example, FIG. 37C conceptually shows the low-pressure shaft 136 with an inbound duplex bearing configuration. Additional bearings located around the circumference of the low-pressure shaft 136 are omitted from FIG. 37C for clarity. According to some embodiments, the bearings 3002a, 3002b are ball bearings and arranged in a duplex configuration aft of the mounting point 2705a for the low-pressure compressor 122. The bearings 3008a, 3008b are ball bearings and arranged in a duplex configuration forward of the mounting point 2705b for the low-pressure turbine 130. Duplex bearing arrangements may also be referred to as double-row bearings, or overturning moment (OTM) bearings, since they provide moment stiffness to the shaft, i.e., provide resistance to rotation across the bearing locations. In some embodiments duplex bearing types may include tandem bearings, back-to-back bearings, face-to-face bearings, and/or tapered roller bearings.

In the example shown in FIG. 37C, both the bearings 3002a, 3002b and the bearings 3008a, 3008b are in an inbound position, i.e., located closer towards the midshaft 2715 than the respective mounting points 2705a, 2705b. In this position, the low-pressure compressor 122 and the low-pressure turbine 130 are referred to as overhung. This inbound OTM layout is used in Embodiments 29, 31, and 33, for example, described above with reference to TABLES 3 and 4.

Alternatively, the bearings 3002a, 3002b and/or the bearings 3008a, 3008b may be in an outbound position, as shown in FIG. 37D, i.e., located farther from the midshaft 2715 than the respective mounting points 2705a, 2705b of the low-pressure compressor 122 and the low-pressure turbine 130. The length L for the duplex bearing configurations shown in FIG. 37C and FIG. 37D may be represented in some embodiments as the distance between the midpoints or centers of the innermost ball bearings 3002b and 3008a, or alternatively, as the distance between the center of the first pair of bearings 3002a, 3002b and the center of the second pair of bearings 3008a, 3008b. The outbound OTM layout is used in Embodiments 30, 32, and 35, for example, described above with reference to TABLES 3 and 4.

As a further example, FIG. 37E conceptually shows the low-pressure shaft 136 with a two-bearing configuration. This configuration employs a first bearing 3002 positioned aft of the mounting point 2705a for the low-pressure compressor 122, and a second bearing 3008 positioned aft of the mounting point 2705b for the low-pressure turbine 130. The length L for this two-bearing configuration is represented in some embodiments as the distance between the midpoints or centers of the bearings 3002, 3008. Alternative two-bearing configurations may position the two bearings in either an outbound configuration or an inbound configuration. An example of a two-bearing layout in an inbound configuration is shown in FIG. 33, that shows bearings 2602a, 2602b, 2608a, and 2608b are all located inbound of the mounting points for the low-pressure compressor 122 and the low-pressure turbine 130. Note that in this context, two is the number of bearings along the low-pressure shaft 136 and does not include additional bearings along the circumference of the low-pressure shaft 136. Embodiment 28, described above with reference to TABLE 3, uses a two-bearing layout in an outbound configuration (not shown).

In FIGS. 37A to 37E, the lines connecting the low-pressure compressor 122 to the mounting point 2705a and the low-pressure turbine 130 to the mounting point 2705b are intended only to indicate schematically the general location of a net force of the core engine components (e.g., the low-pressure compressor 122 or the low-pressure turbine 130) acting on the low-pressure shaft 136 relative to the bearings, and is illustrated in this fashion only for purposes of illustrating a relationship between the nearest engine component relative to the bearing(s). The actual loading on a shaft is distributed and comes from not only the engine components represented by the low-pressure compressor 122 and the low-pressure turbine 130, but other nearby structures as well. In these embodiments, the primary loading for purposes of this disclosure may, however, be thought of simply in terms of engine components attached to the low-pressure shaft 136 (e.g., the low-pressure turbine 130 and the low-pressure compressor 122). The representation shown in FIGS. 37A to 37E is sufficient in defining the parts of the engine that mostly influence the low-pressure shaft 136 behavior.

As discussed, at least one bearing may have an overturning moment (OTM) capability, which can resist relative rotation across the bearing in at least a lateral plane or a vertical plane. These relative rotations may occur during bending of the shaft. The position along the shaft of such bearings with OTM capabilities may directly affect the critical speed, by providing constraints to the relative rotations of the shaft, in addition to the transverse support function of the bearings.

Examples of embodiments with different bearing arrangements are summarized in TABLE 5. Generally, the inventors found that the number of bearings, the position of the bearings and the OTM capability of the bearings can be selected to make a full range of operations subcritical for an engine. In other words, the selection of bearing layout can affect (either increase or decrease) the shaft's critical speed.

TABLE 5

| Embod- | L | D | | E/rho | Teff | Mode |
|---|---|---|---|---|---|---|
| iment | in | in | Bearing type | (in⁻¹) | (in) | (RPM) |
| 35 | 60.6 | 2.75 | 4-bearing straddle | 1.00E+08 | 0.35 | 7746 |
| 36 | 60.6 | 2.75 | 4-bearing straddle | 1.00E+08 | 0.32 | 8555 |
| 37 | 60.6 | 2.75 | 4-bearing straddle | 1.27E+08 | 0.35 | 8832 |
| 38 | 82.2 | 2.74 | 4-bearing straddle | 1.27E+08 | 0.32 | 9703 |
| 39 | 60.6 | 2.75 | inbound OTM | 1.27E+08 | 0.32 | 11386 |
| 40 | 82.2 | 2.74 | outbound OTM | 1.27E+08 | 0.32 | 7873 |

Embodiments 35, 36, 37, and 38 use a four-bearing straddle layout. Embodiments 35 and 36 use steel alloy, while Embodiments 37 and 38 use composite materials. Embodiments 35 and 37 have a uniform thickness profile, while Embodiments 36 and 38 have a concave thickness profile, manufactured using a bottle boring method. As a result of these differences, the shaft mode critical speed occurs at 7746 RPM for Embodiment 35, 8555 RPM for Embodiment 36, 8832 RPM for Embodiment 37, and 9703 RPM for Embodiment 38.

Embodiments 38, 39, and 40 all use composite material and concave thickness profile via bottle boring. However, Embodiment 38 uses a four-bearing straddle layout, Embodiment 39 uses an inbound OTM bearing layout, and Embodiment 40 uses an outbound OTM bearing layout. As a result of these differences, the shaft mode critical speed occurs at 9703 RPM for Embodiment 38, 11386 RPM for Embodiment 39, and 7873 RPM for Embodiment 40.

Embodiment 38 can also be compared to Embodiments 35, 36, and 37 as described with reference to TABLE 5. This allows a comparison of the impact on critical speed of using composite material, variable thickness profile, and both, on a shaft with a four-bearing straddle layout.

Embodiment 39 can be compared to Embodiments 29, 31, and 33 described with reference to TABLE 4. This allows a comparison of the impact on critical speed of using composite material, variable thickness profile, and both, on a shaft with an inbound OTM layout.

Embodiment 40 can be compared to Embodiments 30, 32, and 34 described with reference to TABLE 4. This allows a comparison of the impact on critical speed of using composite material, variable thickness profile, and both, on a shaft with an outbound OTM layout.

Additionally, Embodiments 29 and 30 (in TABLE 3), and 27 (in TABLE 5) can be compared, to evaluate the impact on critical speed of using different bearing layouts on shafts using composite material. Embodiments 33 and 34 (in TABLE 4) and 36 (in TABLE 5) can be compared, to evaluate the impact on critical speed of using different bearing layouts on shafts using concave thickness profiles.

The embodiments of engines, and in particular the shafts associated with a power turbine described with reference to FIGS. 35A, 35B, 36A to 36C, 37A, and 37B, were found to provide an improvement in the performance of a shaft vis-à-vis its operating range. In addition to the mentioned embodiments and those provided in TABLES 3 to 5, the types of improvements to the critical speed of the shaft when these features were combined, taking into consideration the various benefits, as well as down-sides, to selecting a particular configuration for an engine architecture.

Examples of a subcritical shaft with a high redline speed include a shaft with a redline speed of, e.g., 70 ft/sec and adapted for a shaft mode of 5293 RPM, a shaft with a redline speed of, e.g., 75 ft/sec and adapted for a shaft mode of 6380 RPM, and a shaft with a redline speed of, e.g., 181 ft/sec and adapted for a shaft mode of 11410 RPM.

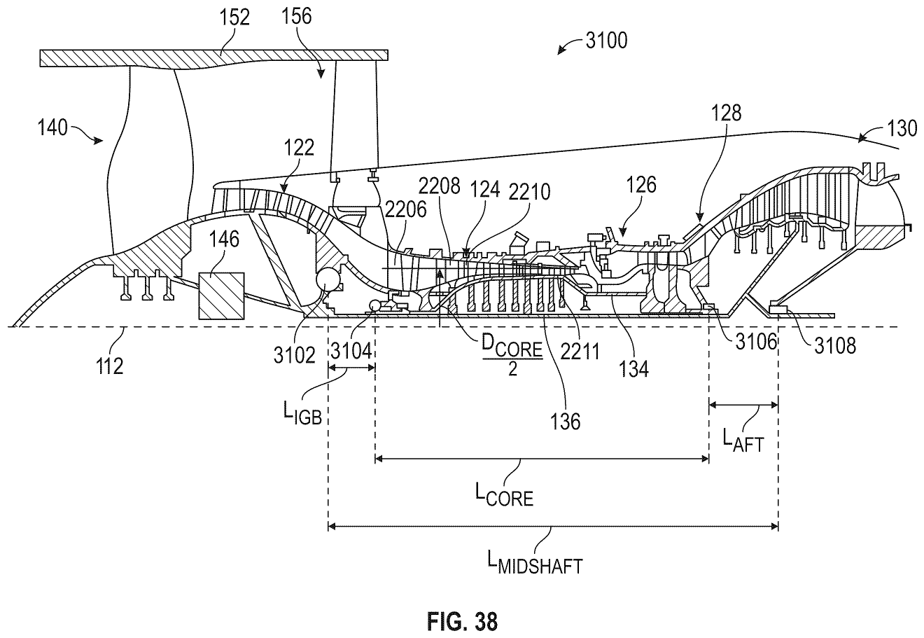

FIGS. 38 to 44 illustrate various turbofan engines. In the embodiments of FIGS. 18 to 24, the low-pressure shaft is supported within the engine with different bearing arrangements. The turbofan engines of FIGS. 38 to 44 may include structure that is the same as, or similar to, the turbofan engines described with respect to FIGS. 1, 28, and 33 and the turbofan engines may operate the same as, or similar, as the turbofan engines described with respect to FIGS. 1, 28, and 33. Accordingly, reference numerals are omitted from FIGS. 38 to 44 for clarity, but features of similar appearance are the same as or similar to the like features shown in FIGS. 1, 28, and 33. Although only one half of the turbofan engine is shown in FIGS. 38 to 44, a mirror image of the depicted half exists on the other side of the centerline axis (e.g., similar to the turbofan engine 110 shown in FIG. 1).

FIG. 38 is a cross-sectional view of a turbofan engine 3100, taken along a longitudinal centerline axis 112 of the turbofan engine 3100, in accordance with another exemplary embodiment of the present disclosure. The exemplary embodiment of FIG. 38 may be configured in substantially the same manner as the exemplary turbofan engine 110 described above with respect to FIG. 1, and the same or similar reference numerals may refer to the same or similar parts. In particular, the turbofan engine 3100 includes the nacelle 150. The HP compressor 124 includes an inlet guide vane (IGV) 2206 upstream from a first stage of the HP compressor 124. In this way, the IGV 2206 directs the core air into the HP compressor 124 at a particular angle.

The turbofan engine 3100 includes one or more bearings that rotationally support the shafts (e.g., the low-pressure shaft 136 or the high-pressure shaft 134). In particular, the turbofan engine 3100 includes a first bearing 3102, a second bearing 3104, a third bearing 3106, and a fourth bearing 3108. The first bearing 3102 rotationally supports the low-pressure shaft 136 on a forward side of the core engine and the fourth bearing 3108 rotationally supports the low-pressure shaft 136 on an aft side of the core engine. The second bearing 3104 supports the high-pressure shaft 134 on a forward side of the core engine and the third bearing 3106 supports the high-pressure shaft 134 on the aft side of the core engine. The first bearing 3102 and the second bearing 3104 are ball bearings and the third bearing 3106 and the fourth bearing 3108 are roller bearings. The first bearing 3102, the second bearing 3104, the third bearing 3106, and the fourth bearing 3108 can include any type of bearing or rotational support for rotationally supporting the low-pressure shaft 136 or the high-pressure shaft 134. In some embodiments, the bearings can include two axially spaced bearings at each location.

In FIG. 38, the length L_{MIDSHAFT} is a length of a portion of the low-pressure shaft 136, referred to as a midshaft. The length L_{MIDSHAFT} is defined from the first bearing 3102 (e.g., also referred to as an inboard low-pressure shaft forward bearing) to the fourth bearing 3108 (e.g., also referred to as an inboard low-pressure shaft aft bearing). The length L_{MIDSHAFT} is the lateral distance, parallel to the longitudinal centerline axis 112, defined between midpoints of the first bearing 3102 and the fourth bearing 3108.

The length L_{IGB} is the length from the first bearing 3102 (e.g., the inboard low-pressure shaft forward bearing) to the second bearing 3104 (e.g., also referred to as a core forward bearing). The length L_{IGB} is the lateral distance, parallel to the longitudinal centerline axis 112, defined between midpoints of the first bearing 3102 and the second bearing 3104.

The length L_{CORE} is the length of the engine core (e.g., the length including the high-pressure compressor 124, the combustion section 126, and the high-pressure turbine 128). The length L_{CORE} is defined between the second bearing 3104 (e.g., core forward bearing) and the core aft bearing (e.g., a core aft bearing). The length L_{CORE} is the lateral distance, parallel to the longitudinal centerline axis 112, defined between midpoints of the second bearing 3104 and the third bearing 3106. In this way, the length L_{CORE} is the length of the high-pressure shaft 134 from the second bearing 3104 to the third bearing 3106. In particular, the length L_{CORE} is defined as an axial distance between the core forward bearing and the core aft bearing with at least one stage of the high-pressure compressor 124 between the core forward bearing and the core aft bearing. In FIG. 38, the core forward bearing is positioned forward of a stage of the high-pressure compressor 124 and the core aft bearing is positioned aft of a stage of the high-pressure turbine 128. In some embodiments, one or more stages of the high-pressure compressor 124 can be positioned forward of the core forward bearing, while at least one stage of the high-pressure compressor 124 is positioned aft of the core forward bearing.

The length L_{AFT} is the length from aft of the core to the inboard low-pressure shaft aft bearing (e.g., the fourth bearing 3108). The length L_{AFT} is the lateral distance, parallel to the longitudinal centerline axis 112, defined between midpoints of the third bearing 3106 and the fourth bearing 3108.

The core diameter D_{CORE} represents the diameter of the engine core. The diameter D_{CORE} is defined by the outer diameter of the exit from a last stage 2211 of the high-pressure compressor 124, also referred to as the exit stage diameter. In this way, the last stage 2211 defines an exit of the high-pressure compressor 124. The radius of the core is shown in FIG. 38 as D_{CORE}/2.

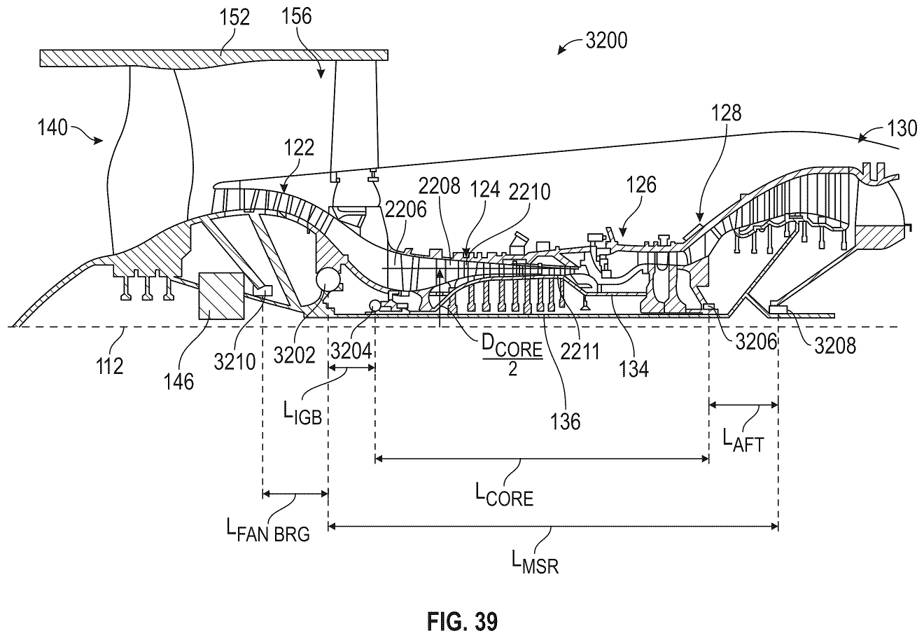

FIG. 39 shows a cross-sectional view of a turbofan engine 3200, taken at the longitudinal centerline axis 112, according to another embodiment. The turbofan engine 3200 includes a first bearing 3202, a second bearing 3204, a third bearing 3206, and a fourth bearing 3208. The turbofan engine 3200 also includes a second forward bearing, also referred to as a fifth bearing 3210 on the low-pressure shaft 136. The fifth bearing 3210, also referred to as a fan bearing, may be a roller bearing (e.g., a tapered roller bearing or a plurality of tapered roller bearings) and the first bearing 3202 may be a ball bearing. In this arrangement, the low-pressure shaft 136 has two bearings forward of the core (e.g., the first bearing 3202 and the fifth bearing 3210) and one bearing aft of the core (e.g., the fourth bearing 3208).

The turbofan engine 3200 also has a length L_{FAN BRG} that is the length from the fifth bearing 3210 (e.g., the fan bearing) to the first bearing 3202 (e.g., the inboard low-pressure shaft forward bearing). The length L_{FAN BRG} is the lateral distance, parallel to the longitudinal centerline axis 112, defined between midpoints of the fifth bearing 3210 and the first bearing 3202. Although not shown for clarity, any of the engines detailed herein can include the fifth bearing 3210.

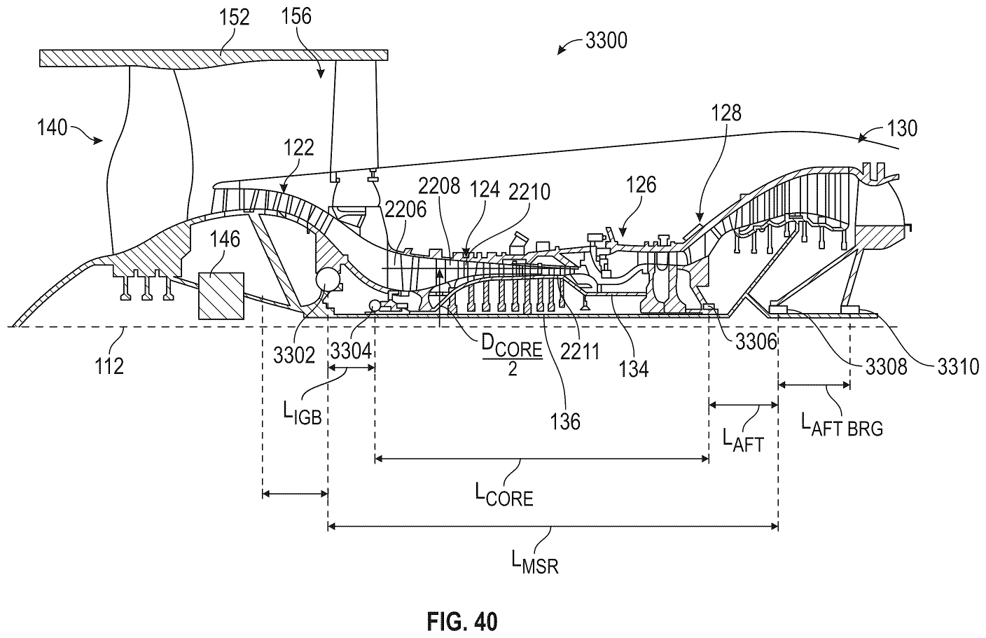

FIG. 40 shows a cross-sectional view of a turbofan engine 3300, taken along the longitudinal centerline axis 112, according to another embodiment. The turbofan engine 3300 includes a first bearing 3302, a second bearing 3304, a third bearing 3306, a fourth bearing 3308, and a fifth bearing 3310. The low-pressure shaft 136 is supported by one bearing on the forward side of the core (e.g., first bearing 3302) and two bearings on the aft side of the core (e.g., the fourth bearing 3308 and the fifth bearing 3310). The high-pressure shaft 134 is supported by the second bearing 3304 on a forward side and the third bearing 3306 on the aft side. The first bearing 3302 and the second bearing 3304 may be ball bearings, although other types of bearings or rotational supports are contemplated. The third bearing 3306, the fourth bearing 3308, and the fifth bearing 3310 may be roller bearings, although other types of bearings or rotational supports are contemplated.

In FIG. 40, the length L_{MSR} is the length of the low-pressure shaft 136 employed in relationship (6) (below) to determine the midshaft rating of the low-pressure shaft 136. The length L_{MSR} is defined between the inboard low-pressure shaft forward bearing (e.g., the first bearing 3302) and the inboard low-pressure shaft aft bearing (e.g., the fourth bearing 3308). The length L_{MSR} is the lateral distance, parallel to the longitudinal centerline axis 112, defined between midpoints of the first bearing 3302 and the fourth bearing 3308.

The length L_{IGB} is the length from the inboard low-pressure shaft forward bearing (e.g., the first bearing 3302) to the core forward bearing (e.g., the second bearing 3304). The length L_{IGB} is the lateral distance, parallel to the longitudinal centerline axis 112, defined between midpoints of the first bearing 3302 and the second bearing 3304.

The length L_{CORE} is the length of the engine core (e.g., the length including the high-pressure compressor 124, the combustion section 126, and the high-pressure turbine 128). The length L_{CORE} is defined between the core forward bearing (e.g., the second bearing 3304) and the core aft bearing (e.g., the third bearing 3306). The length L_{CORE} is the lateral distance, parallel to the longitudinal centerline axis 112, defined between midpoints of the second bearing 3304 and the third bearing 3306.

The length L_{AFT} is the length from aft of the core to the inboard low-pressure shaft aft bearing (e.g., the fourth bearing 3308). The length L_{AFT} is the lateral distance, parallel to the longitudinal centerline axis 112, defined between midpoints of the third bearing 3306 and the fourth bearing 3308.

The length L_{AFT BRG} is the length from the inboard low-pressure shaft aft bearing (e.g., the fourth bearing 3308) to an aftmost bearing (e.g., the fifth bearing 3310). The length L-_{AFT BRG} is the lateral distance, parallel to the longitudinal centerline axis 112, defined between midpoints of the fourth bearing 3308 and the fifth bearing 3310.

The core diameter D_{CORE} represents the diameter of the engine core. The diameter D_{CORE} is defined by the outer diameter of the exit from a last stage 2211 of the high-pressure compressor 124. The radius of the core is shown in FIG. 40 as

$$\frac{{D}_{CORE}}{2} .$$

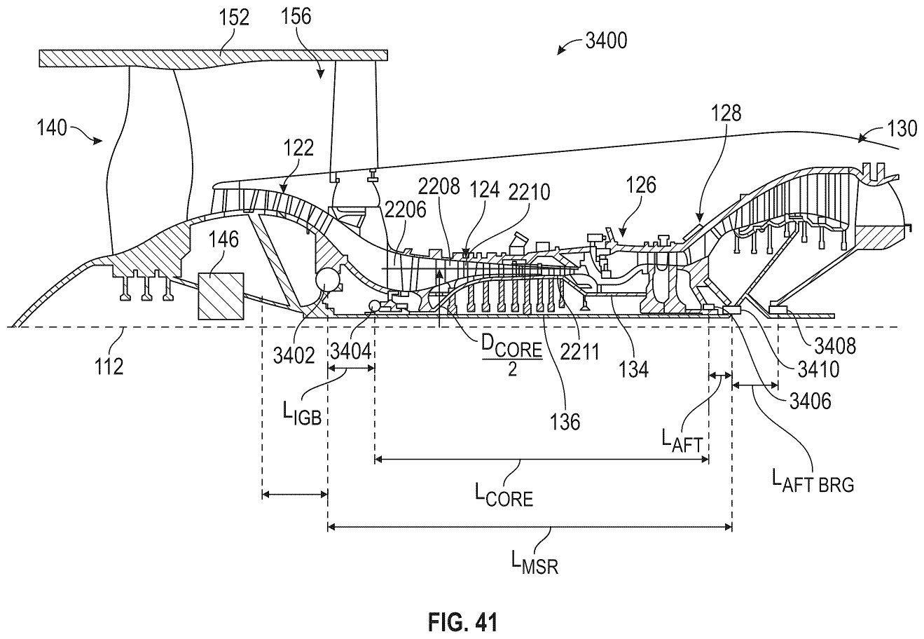

FIG. 41 shows a cross-sectional view of a turbofan engine 3400, taken along the longitudinal centerline axis 112. The turbofan engine 3400 includes a first bearing 3402, a second bearing 3404, a third bearing 3406, a fourth bearing 3408, and a fifth bearing 3410. The low-pressure shaft 136 is supported by one bearing on the forward side of the core (e.g., first bearing 3402) and two bearings on the aft side of the core (e.g., the fourth bearing 3408 and the fifth bearing 3410), where the two aft bearings are straddled as shown in FIG. 41. The high-pressure shaft 134 is supported by the second bearing 3404 on a forward side and the third bearing 3406 on the aft side. The first bearing 3402 and the second bearing 3404 may be ball bearings, although other types of bearings or rotational supports are contemplated. The third bearing 3406, the fourth bearing 3408, and the fifth bearing 3410 may be roller bearings, although other types of bearings or rotational supports are contemplated.

In FIG. 41, the length L_{MSR} is the length of the low-pressure shaft 136 defined between midpoints of the first bearing 3402 and the fourth bearing 3408. The length L_{IGB} is the length defined between midpoints of the first bearing 3402 and the second bearing 3404. The length L_{CORE} is the length of the engine core defined between midpoints of the second bearing 3404 and the third bearing 3406. The length L_{AFT} is the length defined between midpoints of the third bearing 3406 and the fifth bearing 3410. The length L_{AFT BRG} is the length defined between midpoints of the fifth bearing 3410 and the fourth bearing 3408.

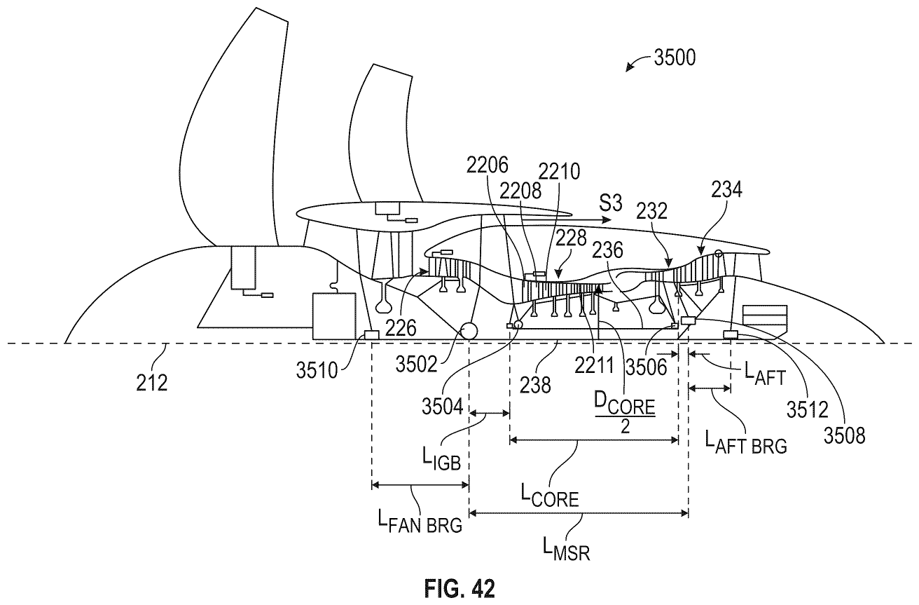

FIG. 42 shows a schematic view of a turbofan engine 3500. In particular, the turbofan engine 3500 is a three-stream, open fan engine, similar to the turbofan engine of FIG. 2. The turbofan engine 3500 includes a first bearing 3502, a second bearing 3504, a third bearing 3506, a fourth bearing 3508, a fifth bearing 3510, and a sixth bearing 3512. The first bearing 3502, the second bearing 3504, the third bearing 3506, and the fourth bearing 3508 are defined as above. The fifth bearing 3510 is positioned to support the low-pressure shaft 238 forward of the first bearing 3502, similar to the embodiment of FIG. 39. The sixth bearing 3512 is positioned to support the low-pressure shaft 238 aft of the fourth bearing 3508, similar to the embodiment of FIG. 40.

In FIG. 42, the length L_{MSR}, the length L_{IGB}, the length L_{CORE}, and the length L_{AFT} are defined as above. The length L_{AFT BRG} is defined as the length between the midpoint of the fourth bearing 3508 and the midpoint of the sixth bearing 3512.

The term “IGB” refers to the inlet gearbox to drive the core to start the engine, run pumps or other accessories. Referring to FIGS. 38 to 42, the location of the first bearing 3102, 3202, 3302, 3402, and 3502 relative to the second bearing 3104, 3204, 3304, 3404, and 3504 may also be chosen for reasons isolating, or reducing a dynamic coupling between vibration modes of the LP shaft (i.e., bending mode excited between the LP shaft rotates at its critical speed) and modes associated with other components supported by a separate frame from, or the same frame supporting the core. For example, referring to FIG. 42, coupling between a modal property of the frame supporting the mid-fan (located directly below the outlet guide vanes) and the modal property of the LP shaft may excite the LP shaft when the engine operates at certain speeds. The length L_{IGB} distance may also be affected when stages are added or removed from the booster (e.g., the low-pressure compressor 226) or when the outlet guide vanes are moved closer or further away from the primary fan. The L_{IGB} distance may also increase relative to the HPC front end in order to align the forward bearing (e.g., first bearing 3502) more closely with the axial center of gravity of the frame supporting the booster and OGV. The core is normally supported by a separate frame from the frames that supports the fan, gearbox and booster. In some embodiments the first bearing 3502 and the second bearing 3504 may be located so as to provide direct support for both a center frame (supporting the core) and a forward frame (supporting, e.g., the booster).

The bearing distances L_{AFT} and L_{AFT BRG} may be affected by the number of stages in the LPT. If a stage is added then the distances aft of L_{AFT} and/or L_{AFT BRG} from the HPT aft end may increase given the increased weight and support needed for additional stages, e.g., 3 to 4 stages, or 4 to 5 stages. Additionally, the bearings 3310, 3410 and 3512 in the embodiments of FIGS. 40 to 42 may be desired for higher speed LP shafts. The additional bearing can add a dampening effect to the LP shaft primary mode or otherwise influence the mode shape so that its deflection at resonance is reduced. The bearing distances L_{AFT} and L_{AFT BRG} may be affected by the presence of an electric machine coupled to the low-pressure shaft. The electric machine may increase the weight on the low-pressure shaft and, thus, increase the load that the bearings on the low-pressure shaft need to support and may also affect the frequency of the low-pressure shaft. Thus, the bearing distances L_{AFT} and L_{AFT BRG} are affected by the additional load from the electric machine. For example, in embodiments with an electric machine near an aft portion of the core, the bearing distances may increase or decrease in a direction further aft or further forward compared to embodiments without an electric machine, depending on the particular location of the electric machine within the engine. That is, the location of the bearings may be moved to a location more forward or more aft as compared to embodiments without an electric machine.

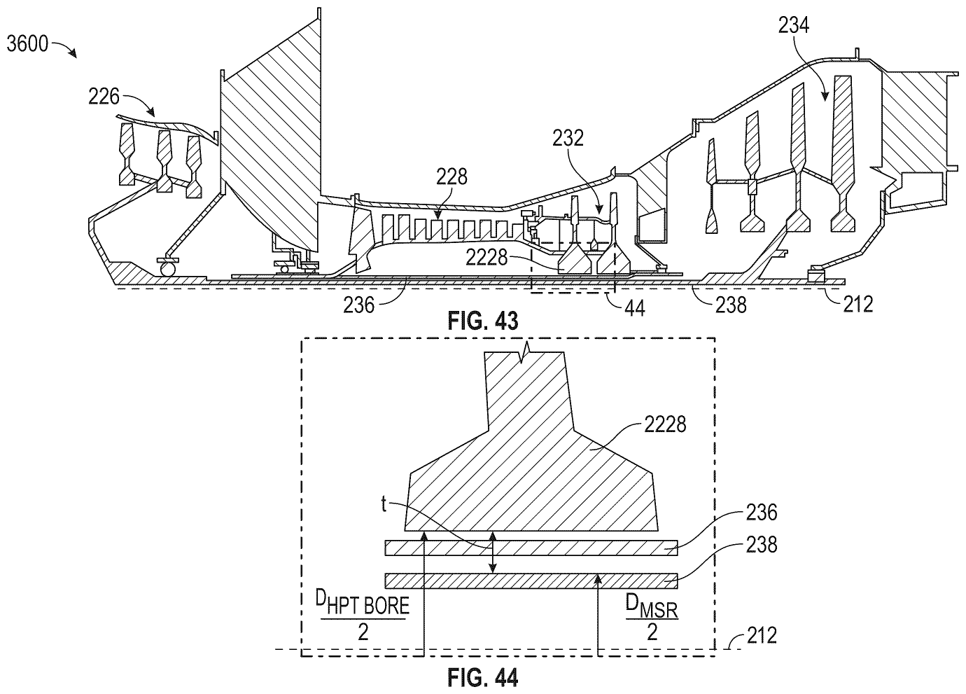

FIG. 43 shows a partial cross-sectional view of a turbofan engine 3600. As shown and previously described the high-pressure turbine 232 includes one or more stages, represented by high-pressure turbine stage 2228.

FIG. 44 illustrates a cross-sectional view of the high-pressure turbine stage 2228, taken at detail 44 in FIG. 43. In the example of FIGS. 43 and 44, the high-pressure turbine 232 has a core diameter D_{HPT BORE} defined by an inner diameter of the high-pressure turbine stage 2228. The radius of the high-pressure turbine stage 2228 is illustrated in FIG. 44 from the longitudinal centerline axis 212 to the high-pressure turbine stage 2228 and represented as

$$\frac{{D}_{HPTBORE}}{2} .$$

The low-pressure shaft 238 has a diameter D_{MSR} that is defined by an outer diameter of the low-pressure shaft 238. The radius of the low-pressure shaft 238 is illustrated in FIG. 44 from the longitudinal centerline axis 212 to the outer diameter of the low-pressure shaft 238 and represented as

$$\frac{{D}_{MSR}}{2} .$$

The diameter D_{MSR} is the diameter employed in relationship (6) to determine the midshaft rating of the low-pressure shaft 136. The difference between D_{HPT CORE} and D_{MSR} define an intershaft thickness t.

With regard to improving upon the speed of the low-speed shaft, consideration was given not simply to those factors affecting the low-pressure shaft, but also to factors considering the engine core of the engine, such as, the length of the engine core, the diameter of the engine core, the material of the components within the engine, the number of stages present in the high-pressure compressor, low-pressure compressor, high-pressure turbine, low-pressure turbine, and the location of bearings. In contrast to existing turbofan engines requiring lower speeds, embodiments considered presented challenges in determining how the low-speed shaft speed could be increased without operating at or near a critical speed, for at least sustained periods of time or during standard flight periods (i.e., takeoff or max thrust).

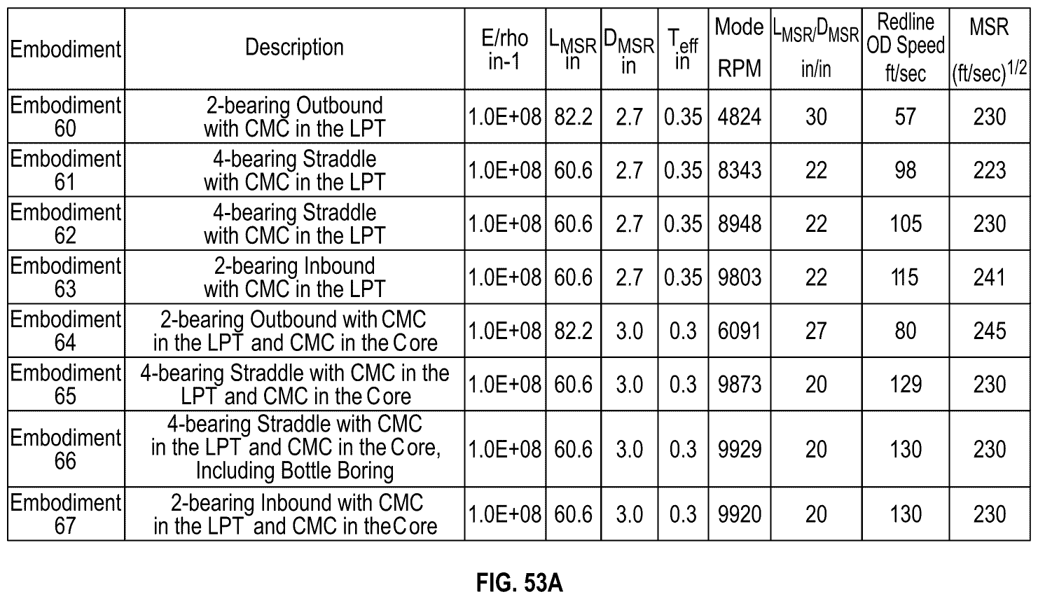

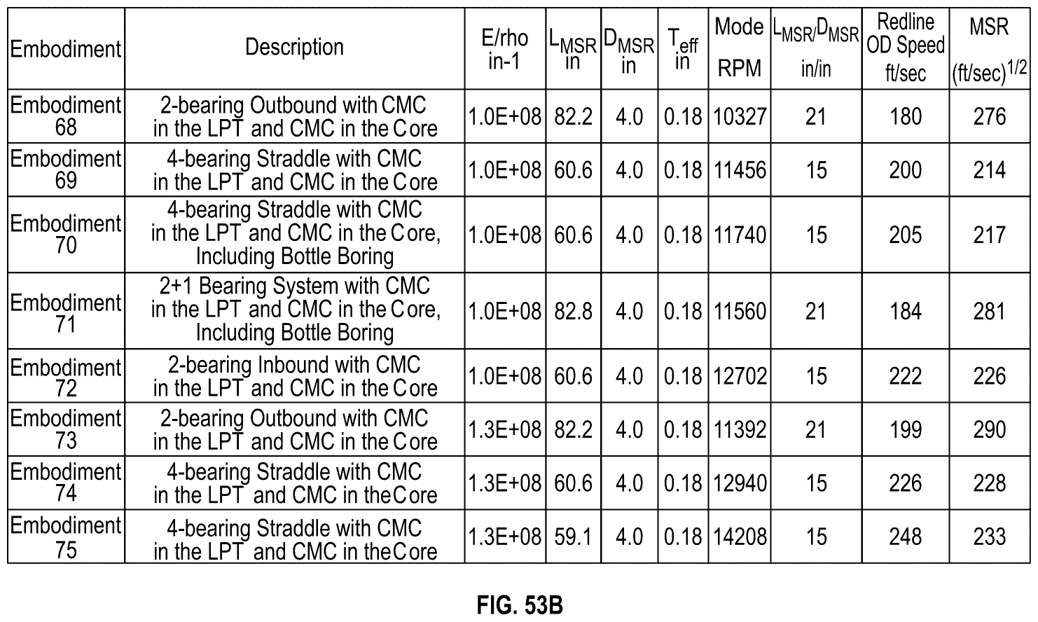

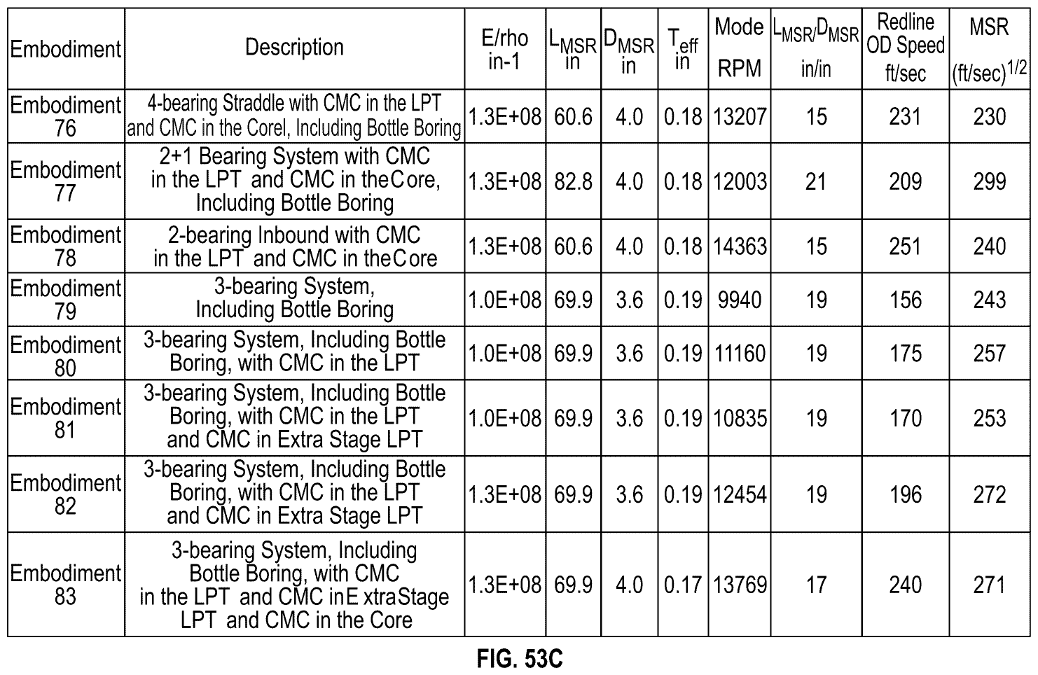

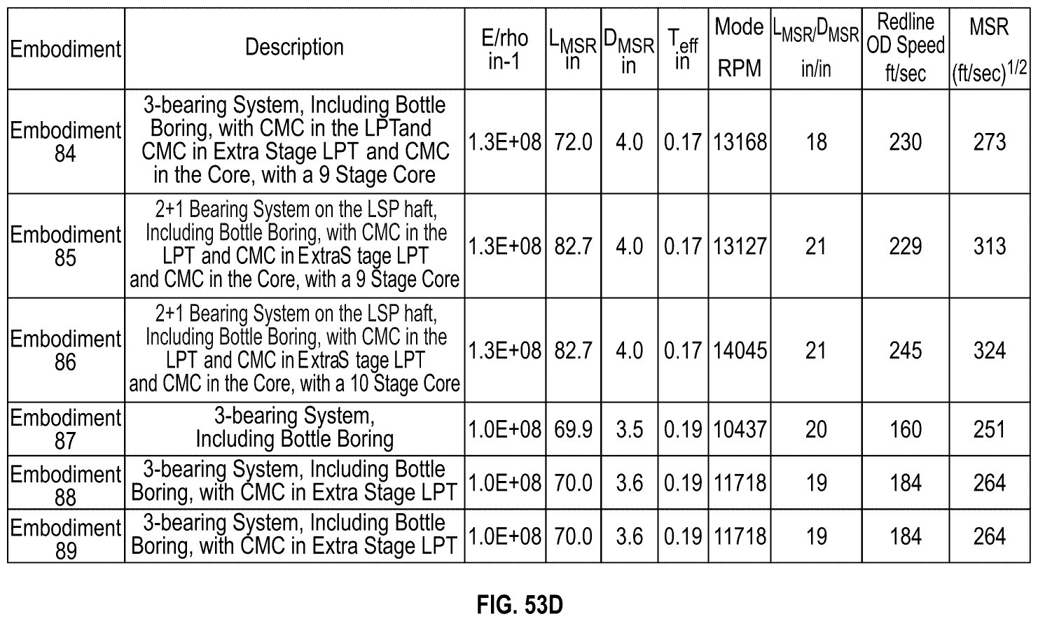

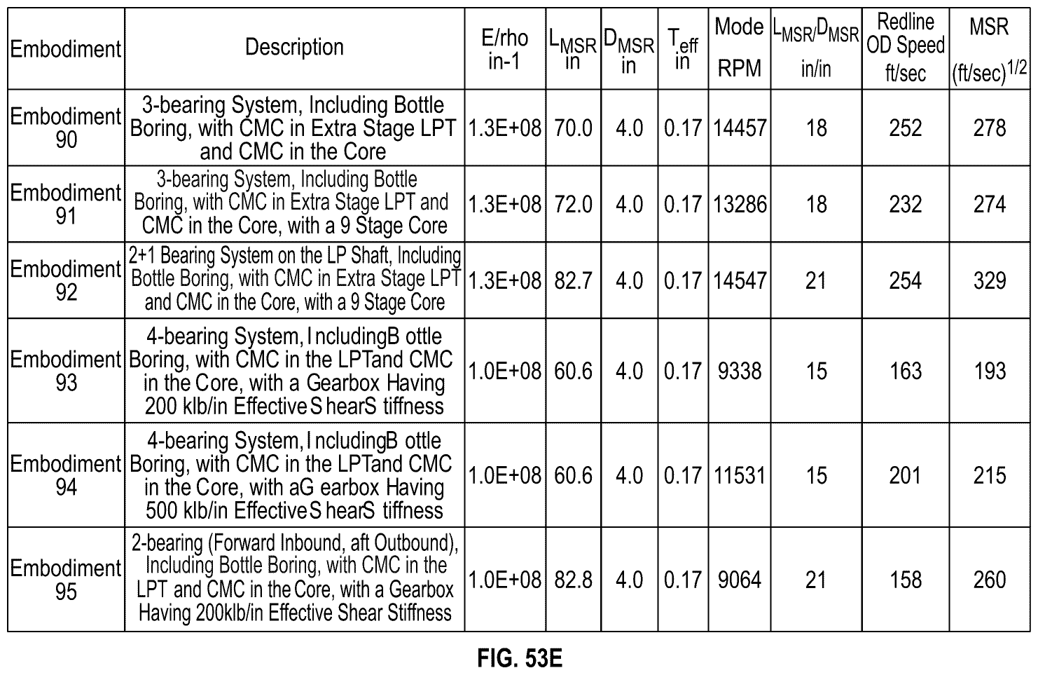

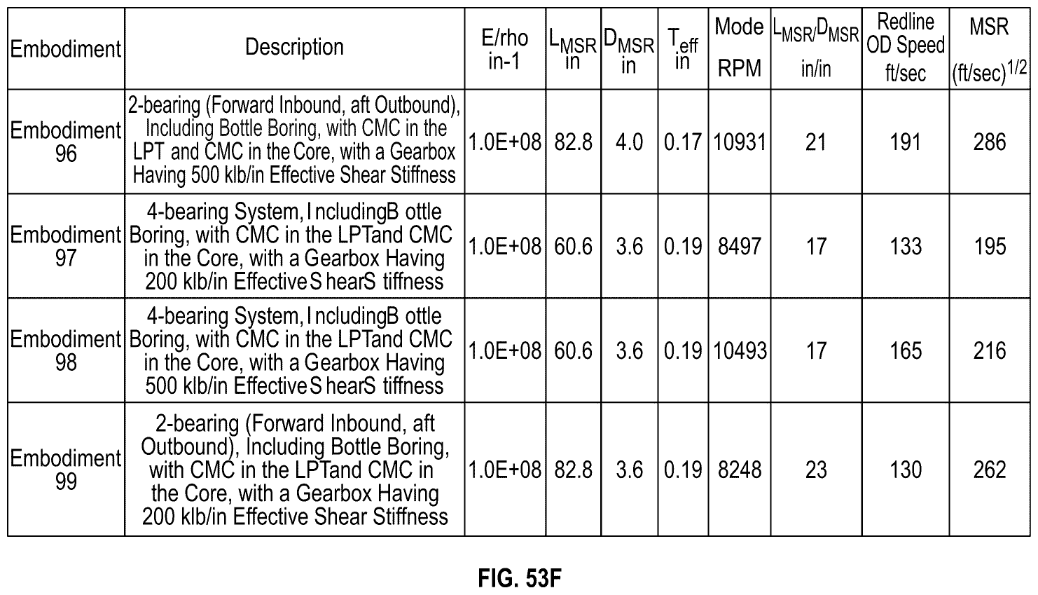

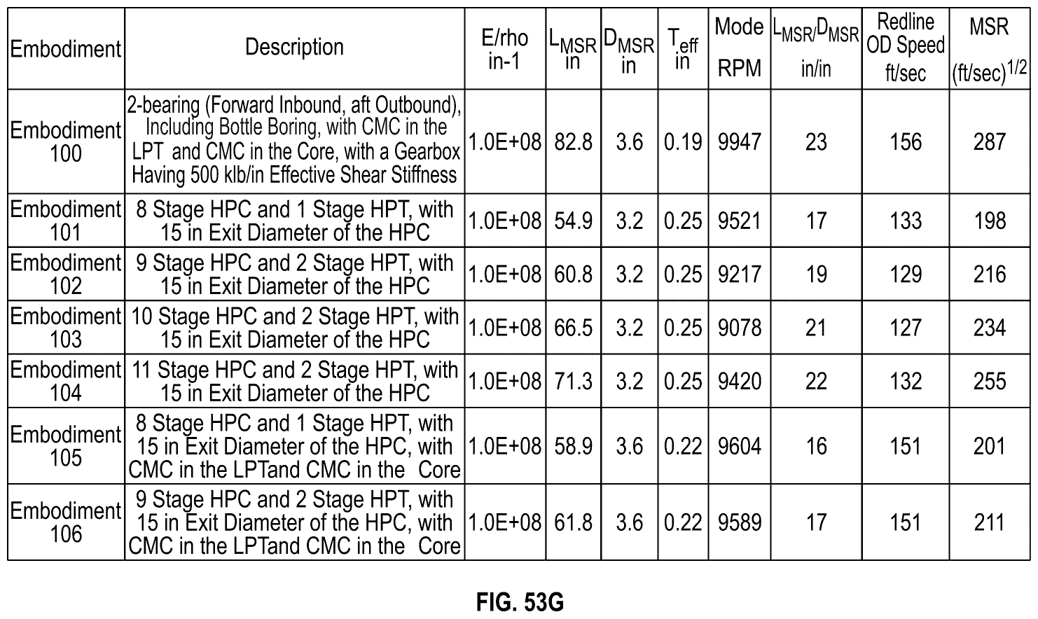

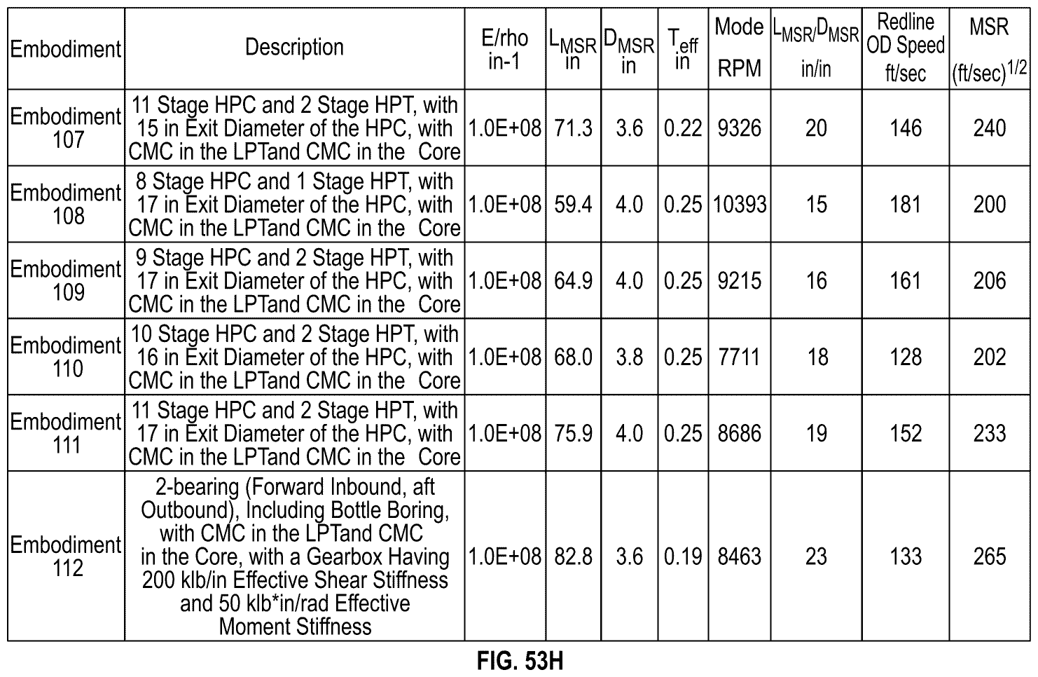

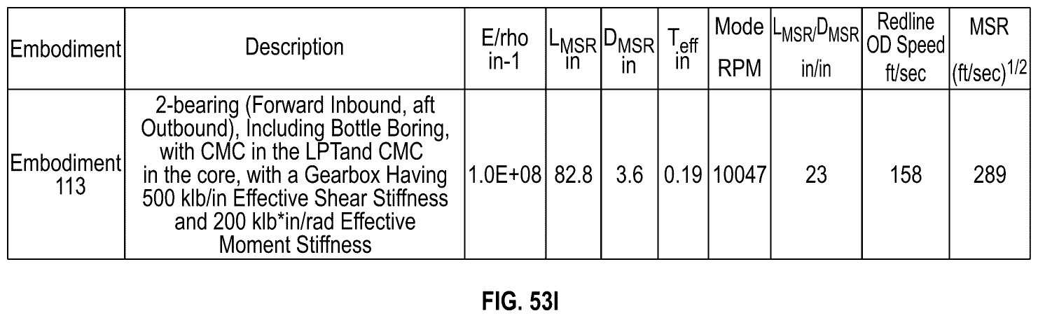

Further, a selection of power turbine shaft and bearing arrangements, and location of those bearings for a turbofan engine takes into consideration other factors, some of which can limit the selection of a shaft. During the course of making the several embodiments referred to in the foregoing, however, there is a particular range of designs, constraints on feasible designs that provided an unexpected benefit. These are the embodiments provided in FIGS. 53A to 53I, Tables 7, 9 and 10 and the accompanying description further describe features of those embodiments providing unexpected benefits.

Even taken separately from the integration of a shaft design with the rest of an engine, modifying an existing shaft to increase its critical speed is challenging, and the impact of the different types of improvements and configurations on critical speed is not easily predictable without empirical experimentation and simulation, which can be enormously expensive and time-consuming. A modification to the engine architecture, e.g., modification to the core or rear frame, may result in lowering a critical speed.

The present disclosure provides for a relationship among the critical speed of the shaft, redline speed, bearing supports and shaft properties at the mid-shaft region and outside this region, and the ratio L/D (also referred to as L_{MSR}/D_{MSR}), which characterize benefits of implementing features of any of the embodiments disclosed in FIGS. 53A through 53I, and Tables 7, 9, and 10 and accompanying disclosure, and excluding those embodiments that were disfavored, and judged suitable for a narrow body engine architecture, or rated thrust between 20 kips and 40 kips, to avoid a supercritical or critical shaft situation during normal operation of an engine. In some instances, during normal operating conditions for the engine, the shaft can operate at speeds higher than the maximum operating speed but less than the redline speed (e.g., 1% to 2.5%, 3% to 5%, 3.6% to 5%, or 5% to 10% less than a rated redline speed for the shaft) depending on the thrust required from the engine, the environment (e.g., ambient temperature, extreme cold or heat), or the altitude.

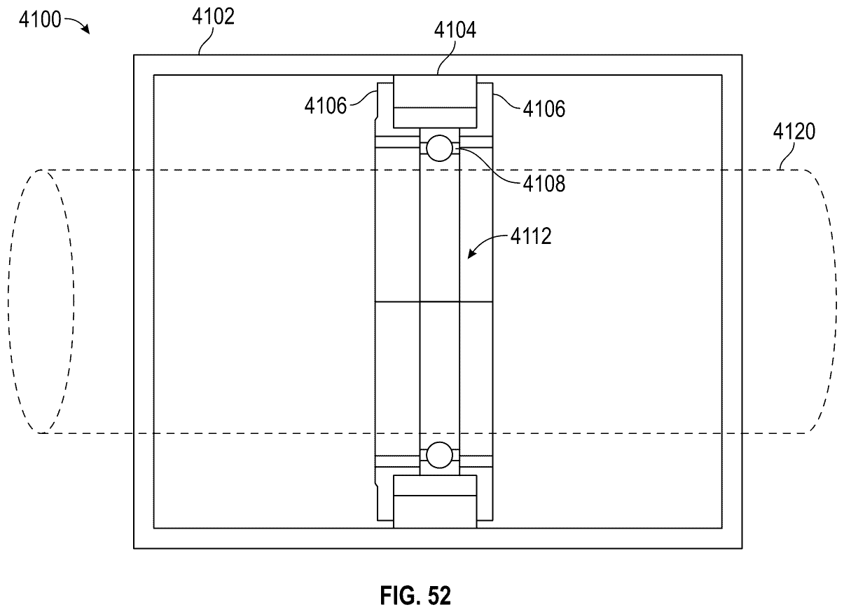

It is preferred, given the comparative cost, complexity or weight penalty, to ensure that the fundamental mode is always higher than the shaft redline speed and/or highest operating speed. Shaft flexural rigidity, and the number and types of bearings used to support the shaft, have the most influence on the fundamental mode compared to redline. Bearing dampers (e.g., the bearing damper assembly 4100 detailed below with respect to FIG. 52) affect the shaft fundamental mode shape (e.g., the first order bending mode). The bearing provides damping by circulating a layer of oil through the bearing to produce viscous damping at the bearing when under compression. Hot oil (e.g., oil temperature greater than an operational temperature range) to these dampers or no oil flow to the dampers reduces the effectiveness of bearing dampers (squeeze film dampers) in limiting deflection or lowering the shaft critical speed. Examples of operational ranges for oil are detailed below. Cold oil (e.g., oil temperature less than the operational temperature range) to the dampers increases the shaft fundamental mode with respect to the shaft fundamental mode during the normal operating conditions.

In the event that bearing dampers lose oil or the oil becomes too hot (e.g., the oil temperature is greater than the oil's effective operating temperature), a shaft's fundamental mode can drop below the shaft's redline speed and even below the shaft's normal operating speed, thereby presenting a supercritical shaft situation. To take this into account, a safety margin is designed into the shaft and bearing design. The safety margins (highest operating speed vs. critical speed) included in the embodiments utilizing a damper bearing (i.e., squeeze film damper) for the low-pressure shaft are critical speed above 1% to 2.5%, 3% to 5%, 3.6% to 5%, or 5% to 10% from the operating speed, and critical speed above 1% to 2.5%, 3% to 5%, 3.6% to 5%, or 5% to 10% above redline speed.

In one respect, the scope and number of embodiments discovered by the inventors in addressing the need for a subcritical shaft is characterized by a midshaft rating (MSR):

$$Midshaft Rating MSR = ( {L}_{MSR} / {D}_{MSR} ) {( Shaft OD Speed at redline )}^{1 / 2} \qquad ( 6 )$$

L_{MSR}/D_{MSR} is shaft length divided by effective shaft outer diameter. The ratio L_{MSR}/D_{MSR} is multiplied with the square root of the outer diameter (OD) rotation speed (OD Speed) at the redline speed for the engine architecture. Generally, the length L_{MSR} and diameter D_{MSR} are expressed in inches, and the shaft OD redline speed is the linear speed of the shaft surface. The OD redline speed in feet per second is calculated as the shaft mode speed (in RPM) multiplied by the outer circumference of the shaft (the outer diameter of the shaft multiplied by the number π), and with additional corrections to convert from inches to feet and from minutes to seconds. Accordingly, the midshaft rating has units of (velocity)^{1/2}.

The midshaft rating identifies embodiments for a turbofan engine's power turbine that allow subcritical operation of the engine for a rated redline speed. TABLE 5 lists embodiments of the turbine shaft along with its associated MSR value. The midshaft rating also identifies the suitable operating margins for the power turbine to avoid a critical or supercritical condition in respect to the rated or redline speed and/or normal range of operating speeds, as provided above. FIGS. 53A to 53I list embodiments of the turbine shaft along with its associate MSR value for configurations that incorporate CMC. TABLE 10 lists embodiments of the turbine shaft along with its associated MSR value for critical or supercritical shafts. The embodiments can inform one of the dimensions or qualities of the shaft that are believed reasonable and practical for a shaft according to its basic features and the intended, rated critical speed. In other words, the midshaft rating, and, optionally, the L_{MSR}/D_{MSR} ratio and/or the OD speed at redline, indicates the operating ranges of interest, taking into account the constraints within which a turbofan engine operates, e.g., size, dimensions, cost, mission requirements, airframe type, etc. and based on the embodiments listed in the Tables, which showed favorable results compared to embodiments that were less favored.

In other embodiments, the midshaft rating may also, or alternatively, be used to define the propulsive system operating at a relatively high redline speed. Such things as the requirements of a propulsive system, the requirements of its subsystem(s), airframe integration needs and limitations, and performance capabilities may, therefore, be summarized or defined by the midshaft rating when considered for an engine core that is more compact, higher power density, higher OPR.

As mentioned earlier, next generation turbofan engine cores are expected to operate at higher power densities, which can include a same level of power output as exists in current engines, but using a lighter weight core. A reduced weight core includes components coupled through the high-pressure shaft, which are the high-pressure compressor (HPC) and the high-pressure turbine (HPT). A higher power density will also mean higher engine operating temperatures (e.g., higher EGT as mentioned above), particularly at the HPC exit stage, combustor exit, HPT nozzle exit, and LPT. These changes in power density also result in changes in core size (length, width, bore heights, etc.) and in some cases significant changes in core weight, such as when a CMC material is used for core components. As such, it is desirable to assess the impact that next generation cores operating at higher power density can have on engine dynamics (e.g., dynamics of the LP shaft, the HP shaft, and/or a gearbox of the engine). These changes in core size also affect the amount of space available under the fan for a fan actuation system, as detailed above.

These changes in engine core size and weight effects not only the dynamic behavior of the HP shaft but also can influence the dynamic behavior of the LP shaft, e.g., the critical speed, that results in undesired vibrations. Likewise, the dynamic behavior of the LP shaft can influence the dynamics of the HP shaft. Dynamic excitation of natural modes/frequencies of these two shafts, while decoupled in rotation from each other, nonetheless can interact and amplify each other's natural modes of vibration via load paths through their respective supporting bearings. The addition of a fan actuation system allows for the LP shaft to rotate at higher speeds as the fan actuation system allows the fan to rotate at lower speeds. In this way, a turbofan engine with a fan actuation system also affects the LP shaft mode.

Acceptable dynamic behavior at redline, cruise, and maximum thrust operating conditions depends also on interaction between a high and low-pressure shaft. When a higher power density core is installed in the engine with concomitant lengths and sizes changing for the core, these changes influence not only the behavior of the LP shaft mode in isolation, but also dynamic interaction between the HP and LP shafts. Without proper consideration of the effects that the LP shaft dynamics have on the HP shaft dynamics (and HP shaft dynamics have on the LP shaft dynamics), intolerable vibrations may occur resulting from primary or higher frequency modal interaction between the shafts. To address these concerns, engine architectures were evaluated to determine the structural and/or inertial changes reflected in a higher power density core would cause unacceptable vibration in either or both of the HP shaft and the LP shaft. The core weights and sizes reflect improved performance from the general perspective of a reduced Specific Fuel Consumption (SFC), overall compactness of the engine, but could also create unanticipated or unmanageable dynamic excitation when the LP shaft and the HP shaft are operated at high speeds. The MSR and related critical dynamics are impacted by variations in such things as HPC stages to raise the overall pressure ratio of the gas entering the combustion chamber, and/or an increased number of stages for the HPT, the overall length of the LP shaft accounting for other changes in the engine cross-section affected by changes in the HPC and/or HPT, and the impact on stiffness and weight when advanced material such as CMC material is used in the core.

Changes to these aspects of the core influence, not only an overall length, weight, and size of the HPC and HPT, but also placement of shaft-supporting bearings and accessories. Changes in the core affect placement of other engine components encased within a core cowl. For example, changes in the core affect the amount of available space under the fan for the fan actuation system. Thus, examining the effects of, e.g., adding an additional HPC stage, require an understanding of adjacent engine components that need to accommodate an increased length of the core. To date, acceptable designs vs. unacceptable core design practice (from the perspective of structural dynamics) have often involved an iterative process involving design on experiment studies where many variations on architecture design are considered, with the hope that one of the variations might provide the desired configuration satisfying both core performance and dynamic stability for both the HP shaft and LP shaft. After consideration of several embodiments of a next generation engine core having between 8 and 11 stages for an HPC and 1 to 2 stages for an HPT, as well as different material (e.g., CMC material, Ni superalloys) each requiring different bearing placements relative to the core, it was found there are relationships between the length of the core, bearing supports at each end and L_{MSR} for each of the foregoing modifications to a core that produces a good approximation for the dynamic behavior of the engine. These relationships define the dynamic behaviors of the HP shaft and LP shaft in terms of factors attributable to a higher power density core, enabling the inventors to arrive at an improved engine design, one that took into account the often competing interests between dynamic stability and achieving a more compact and higher power density core.

With reference back to FIGS. 38 to 42, the LP shaft 136 length from the forward bearing (e.g., the first bearing 3102) to the aft bearing (e.g., the fourth bearing 3108), i.e., L_{MSR}, can be broken down into three portions: a length forward of the core (L_{IGB}), a length aft of the core (L_{AFT}), and the portion of the LP shaft that extends from the aft portion of the HPT to the forward end of the HPC (L_{CORE}). The flexural rigidity of the LP shaft portion (mid-shaft) extending along the engine core (HPC-combustor-HPT), between the nearest forward and aft bearings supporting the mid-shaft, is lower than portions outside the core due to the limited space available for a higher outer diameter for the LP shaft.

L_{MSR} is defined according to the relationship:

$${L}_{MSR} = {L}_{IGB} + {L}_{CORE} + {L}_{AFT} \qquad ( 7 )$$

L_{IGB} represents a minimum distance from core forward end and forward inboard low-pressure shaft bearing (e.g., the first bearing 3102 in FIG. 38) to the forward core bearing (e.g., the second bearing 3104 in FIG. 38). The length from the bearing supporting the input to the gearbox (e.g., 3102) to the core forward bearing (e.g. 3104) represented as L_{IGB} can range from four inches to twelve inches (the minimum length of four inches accommodates an accessary gearbox). The distance may be increased or decreased depending on factors such as, location of other components supported by a common frame, the location of the axial center of gravity for a frame, etc. as discussed earlier. Taking these factors into consideration, the length L_{IGB} may be estimated based on D_{CORE} using (8):

$${L}_{IGB} = 0.16 \times {D}_{CORE} + 1.7 \qquad ( 8 )$$

Wherein D_{CORE} is the diameter (measured from the engine centerline) of the last stage of the high-pressure compressor, measured as the tip-to-tip diameter of the rotor of the exit or aft-most/last stage of the high-pressure compressor. D_{CORE} varies from ten inches to thirty inches depending on whether there are 8, 9, 10 or 11 stages in the HPC. Examples are provided below in TABLE 6. Relation (8) is valid only for an HPC having 8, 9, 10 or 11 stages.

The length of the engine core from the core forward bearing (e.g., bearing 3404) to core aft bearing (e.g., 3406), L_{CORE1}, may be related to the number of HPC and HPT stages of the core, and the exit diameter as follows:

$${L}_{CORE 1} = {[ {m}^{( 20 + m )} \times {n}^{( 10 + n )} ]}^{( \frac{1}{100} )} \times {D}_{CORE} + CIS \qquad ( 9 )$$

Relationship (9) reflects the influence on core length changes impacted by adding additional HPC or HPT stages, leading to in an improved engine design that balances dynamics needs against a higher pressure ratio core choice for higher power density. The symbol m is the number of stages in the high-pressure compressor and n is the number of stages in the high-pressure turbine. The CIS accounts for changes in core supporting structure, seals, nozzle sizes, and changes to the combustor length associated with a change in the HPC and/or HPT stages. CIS can be from twenty inches up to thirty inches for HPC stages ranging between 8 to 11 and 1 to 2 HPT stages. The relation in (9) for L_{CORE1} is valid only for m being eight, nine, ten, or eleven, and n being one or two.

The aft length L_{AFT} is the length from the aft core bearing (e.g., the third bearing 3106 in FIG. 38) to the aft inboard low-pressure shaft bearing (e.g., the fourth bearing 3108 in FIG. 38). L_{AFT} can be from two inches to twenty-four inches, depending on the specific spacing needs/preferences aft of the HPT and turbine rear frame integration with the rotor. Also, placement of this bearing can be influenced by whether additional LPT stages are added, dynamics of the LP shaft and turbine rear frame. In some cases, an additional bearing L_{AFT BRG} as discussed earlier. The furthest aft bearing (e.g. 3108) supporting the turbine rear frame can include a bearing housing that includes a viscous damping system (e.g., squeeze-film damper whereby oil viscosity is used to dampen vibrations transmitted to/from the bearing).

TABLE 6 provides embodiments found to produce an acceptable dynamics environment, in terms of L_{MSR} according to relationships (7) to (9). The embodiments shown in TABLE 6 align with the like embodiment numbers in FIGS. 53A to 53I.

TABLE 6

| Embod- | L_{MSR} | L_{IGB} | L_{CORE} | L_{AFT} | D_{CORE} | CIS | HPC | HPT |
|---|---|---|---|---|---|---|---|---|
| iment | in | in | in | in | in | in | stages | stages |
| 101 | 54.9 | 4 | 47 | 4 | 15 | 20 | 8 | 1 |
| 102 | 60.8 | 4 | 54 | 3 | 15 | 23 | 9 | 2 |
| 103 | 66.5 | 4 | 59 | 4 | 15 | 26 | 10 | 2 |
| 104 | 71.3 | 4 | 64 | 3 | 15 | 30 | 11 | 2 |
| 105 | 58.9 | 4 | 48 | 7 | 15 | 21 | 8 | 1 |
| 106 | 61.8 | 4 | 54 | 4 | 15 | 23 | 9 | 2 |
| 107 | 71.3 | 4 | 64 | 3 | 15 | 30 | 11 | 2 |
| 108 | 60.4 | 4 | 52 | 4 | 17 | 22 | 8 | 1 |
| 109 | 64.9 | 4 | 58 | 3 | 17 | 23 | 9 | 2 |
| 110 | 68 | 6 | 58 | 4 | 16 | 24 | 10 | 2 |
| 111 | 75.9 | 4 | 69 | 3 | 17 | 30 | 11 | 2 |

D_{MSR} is defined according to the relationship:

$${D}_{MSR} = {D}_{HPT BORE} - 2 t \qquad ( 10 )$$

D_{HPT BORE} is the rotor bore diameter for the first stage of the high-pressure turbine. Its size may be approximated according to the relationship:

$${D}_{HPT BORE} = 0.26 {D}_{CORE} + 0.6 \qquad ( 11 )$$

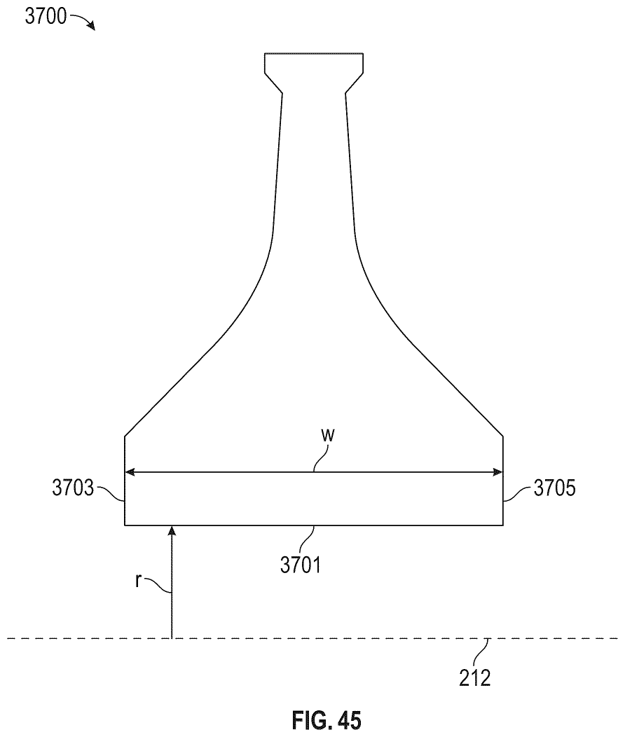

The thickness t is the intershaft thickness between the low-pressure shaft and the high-pressure turbine bore (e.g., as shown in FIG. 45). The thickness t can vary from 450 mils and 650 mils (from 0.45 in to 0.65 in).

CMC material may be used in the HPT, LPT, and/or HPC parts of a core engine as this type of material can withstand higher temperatures than more traditional metal alloys. Given the differences in material properties for a CMC material, particularly the higher strength to weight ratio (or higher specific modulus) of CMC versus a metal alloy used in existing gas turbofan engines in use currently, there is a need to ascertain the expected effects on HP shaft dynamics and LP shaft dynamics. Use of a CMC material introduces opportunities to increase a critical speed of the LP shaft, not only due to a weight reduction but also in making more space available for increasing the LP shaft diameter extending through the core given the materials higher strength. The components made, at least in-part, from CMC material may include the HP compressor rotors and disks, the HP turbine nozzles and/or rotors and rotor disks, and the LP turbine nozzles and/or rotors and disks. CMC allows for components to be made more stiff or reduced in size while having the same strength properties as metal alloys, thereby having equivalent capability for sustaining high stresses associated with centrifugal forces at high temperatures and operating speeds, in addition to reducing the weight of the core, as compared to metals. CMC also introduces new and untested structural dynamics, which can introduce tradeoffs or compromise between a desired aero-performance (temperatures, rotation rates, pressure ratios) and stable dynamics at cruise, takeoff/max thrust and redline speeds for both the HP shaft and LP shaft.

CMC provided in the low-pressure turbine, which drives the LP shaft, can enable an increased critical speed due to a reduced weight, thereby affecting MSR of the midshaft. For example, and referring back to FIGS. 1, 2, 22 to 24, and 28 to 45, rotors, blades, or blades and discs in the low-pressure turbine module can be formed partially or wholly of CMC. Additionally, the nozzles in the low-pressure turbine module can be formed partially or wholly of CMC, for example, the static vanes, the shrouds or both can be formed of CMC. Such components can be formed from CMC materials in a single stage, or multiple stages (e.g., the turbine stages 214). In some embodiments, a first, second, third, fourth or fifth stage of a LPT may have airfoils made from a CMC material. LPT nozzles may be made from CMC material. Or both the LPT airfoils on rotor and nozzle airfoils may be made from CMC material. When CMC is used in the LPT, the critical speed at which the low-pressure shaft can operate is increased significantly while also taking into account for the relatively brittle nature and temperature-dependent strength properties of CMC that goes along with the reduced weight (or increase in specific strength) benefits that the material provides. That is, with strength and toughness needs across different environments and operating conditions realized, the present disclosure provides a relation between CMC material used in the core for a resulting comparatively higher critical speed for the LP shaft, for maintaining a critical speed for increases in core length when used in the LPT, and for higher critical speeds without an associated un-acceptable MSR value indicating that the design using CMC material could have an LP shaft operating in a critical or supercritical range, or operating within 5% to 10% of the redline speed. In this way, the CMC material is used to increase the power density of the turbofan engine, while taking into account the effects on MSR and the engine dynamics. For example, and referring back to FIGS. 1, 2, 22 to 24, and 28 to 45, CMC used for the HPT and/or the HPC airfoils, HPT nozzle, and rotor disks supporting airfoils that influence the length of the core can influence the LP shaft design for other reasons as well, as explained in greater detail below. Example embodiments showing effect on LP shaft MSR values and critical speed for CMC used in the LPT are included in the Tables of FIGS. 53A to 53I. It was found that for an LPT made at least partially from CMC material the effective reduction in mass, i.e., the mass reduction can influence the MSR and critical speed by an amount that provides more opportunities for increased efficiency by enabling a higher rotation speed. FIGS. 53A to 53I provide examples.

Use of CMC material in the HPT rotor blades also affects the size of the HPT bore radius, because the higher strength to weight ratio of CMC material (when used for the rotor blades) reduces the strength requirements for the disk supporting the blades, thereby permitting the bore radius to increase. The bore radius limits the outer diameter of the LP shaft. It is desirable to increase the bore radius of the high-pressure turbine (first stage) to allow an increase in the low-pressure shaft diameter (e.g., D_{MSR}). Referring to FIG. 45, a schematic view of a first stage HPT airfoil disk 3700 is shown. The blade disk 3700 has a bore radius r defined from the longitudinal centerline axis 212 to an inner surface 3701 of the disk bore. Use of CMC material for the rotor blade permits an increase in the radius r to enable a larger D_{MSR} for the LP shaft, thereby affecting the critical speed and MSR of the midshaft. CMC material for the bore disk may also be desired. Each blade disk 3700 has a width w measured from a forward edge 3703 to an aft edge 3705. For a disk made from CMC material, the increased specific modulus (strength/weight) may allow for a meaningful reduction in the width w of the disk and therefore a reduction in L_{CORE}, which can enable an increased critical speed and higher MSR value, which is desired. Even if a metal alloy is used for the disk, a reduced width can be realized because of the lighter weight airfoil it needs to support.

FIG. 46 compares the properties of MI and CVI type CMC material compared to conventional metal alloys. The HPT may be made from CVI or MI types of CMC material, or a hybrid of MI and CVI. In some embodiments the HPT is made from CVI type CMC material, such as the airfoil, while the disk is made from a metal alloy (separate parts coupled through a dovetail slot), or both the disk and airfoil is made from the CVI material (blisk). In some embodiments the surface of an airfoil (LPT, HPT either on nozzles or rotors) facing the hot gas may be made from CVI material while the surface facing away from the hot gas is made from the MI material. The consideration of material to use includes not only high temperature resistance but also the strength and toughness of the material.

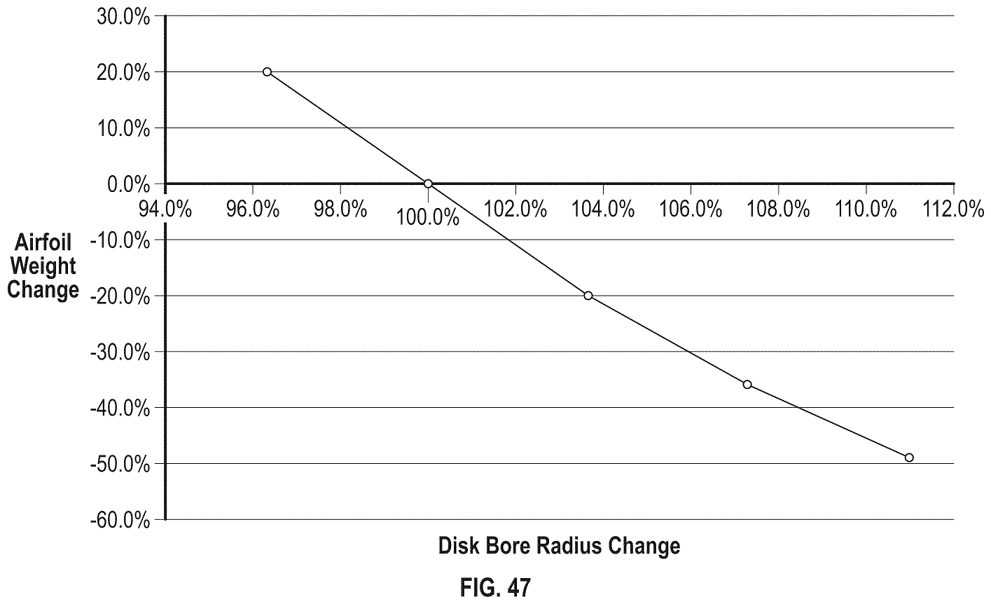

Referring to FIG. 47, the effects of using a CMC material in the HPT are shown. As more CMC material is used, the strength requirements needed to react the airfoil inertial loading reduces. As shown when the airfoil weight is reduced to 50% using CMC material, the radius of the bore increases by approximating 11%. This translates into a stiffer LP shaft (higher D_{MSR}), thereby providing a higher critical speed and a higher MSR value. FIGS. 53A to 53I include embodiments of an engine where the MSR and/or critical speed may increase as a result of an increased HPT disk bore radius.

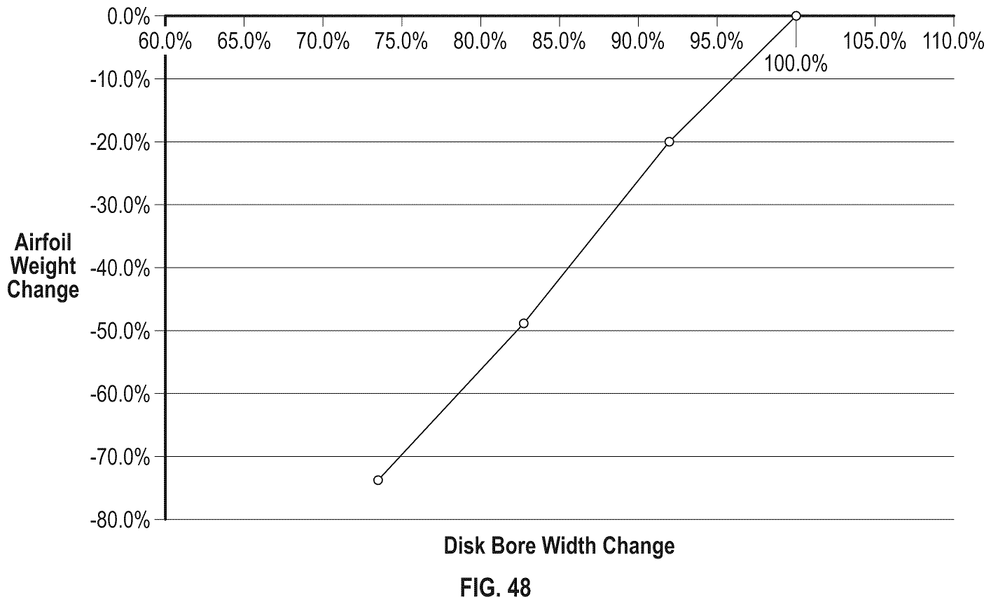

Referring to FIG. 48, further effects of using a CMC material in the HPT are shown. As more material is used, the strength requirements needed to react the airfoil inertial loading reduces. As shown when the airfoil weight is reduced to 50% using CMC material, the width of the bore decreases by approximately 17%. This translates into a stiffer HP and LP shaft (lower L_{CORE} and L_{MSR}), enabling higher critical speeds, mitigating against lower critical speeds as a result of adding additional stages to the HPC and/or HPT. FIGS. 53A to 53I include embodiments of an engine where the MSR and/or critical speed increase when the HPT disk width is decreased, enabling a decrease in L_{MSR}.

In addition to the aforementioned dimensional and weight changes in the core attributed to use of CMC material and affecting the LP shaft dynamics, using CMC material will also affect vibrational response for the HP shaft, also referred to as HP shaft dynamics.

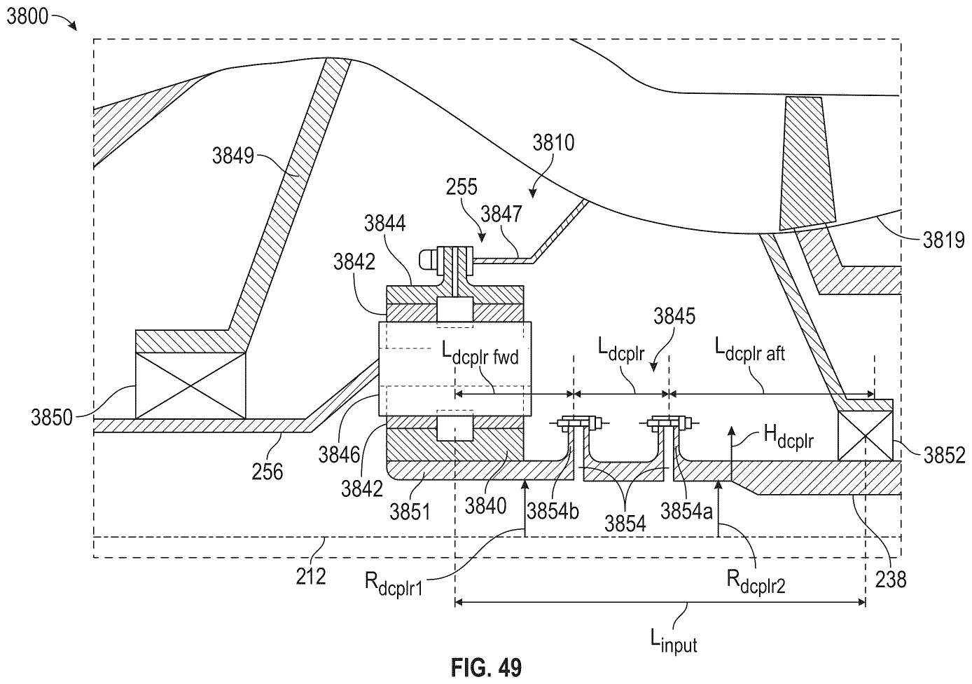

FIG. 49 illustrates an enlarged, schematic side cross-sectional view of the gearbox assembly 255 with a mounting assembly 3810 for a turbofan engine 3800, taken at the longitudinal centerline axis 212 of the turbofan engine 3800. The turbofan engine 3800 can be any of the engines detailed herein. The gearbox assembly 255 is in a planetary configuration. For example, the gearbox assembly 255 includes a sun gear 3840, a plurality of planet gears 3842, and a ring gear 3844. The low-pressure shaft 238 coupled to the sun gear 3840. The sun gear 3840 is coupled via a flex coupling 3845 to the low-pressure shaft 238. The plurality of planet gears 3842 is coupled together by a planet carrier 3846. In the embodiment of FIG. 49, the planet carrier 3846 is coupled, via the fan shaft 256, to a fan (e.g., any of the fans or fan assemblies detailed herein) to drive rotation of the fan about the longitudinal centerline axis 212. The fan shaft 256 is coupled to a fan frame 3849 via a fan bearing 3850. The ring gear 3844 is coupled via a flex mount 3847 to an engine static structure 3819. The flex coupling 3845, the flex mount 3847, and the fan frame 3849 define the mounting assembly 3810 for the gearbox assembly 255. As described herein, the flex coupling 3845, the flex mount 3847, and the fan frame 3849 may be referred to as mounting members.

In FIG. 49, the flex coupling 3845 is part of an input shaft portion 3851 of the low-pressure shaft 238 that extends from a forward bearing 3852 of the low-pressure shaft 238 to the sun gear 3840 (e.g., to an axially center of the sun gear 3840). The flex coupling 3845 is also referred to as a decoupler and includes one or more flex plates 3854 that absorb and reduce deflections and vibrations from propagating from the gearbox assembly 255 to the low-pressure shaft 238 or from the low-pressure shaft 238 to the gearbox assembly 255. In the embodiment shown in FIG. 49, the one or more flex plates 3854 include a first flex plate 3854a and a second flex plate 3854b spaced axially from each other along the input. The one or more flex plates 3854 can include any number of flex plates located at any axial position along the input, as desired. The flex plates 3854 are integral with the flex coupling 3845 and include axial gaps that absorb the deflections in an axial direction so that propagation of the deflections through the flex coupling 3845 is reduced. Accordingly, the flex coupling 3845 can be tuned or can be changed to achieve a particular desired vibrational frequency response such that vibrations of the gearbox assembly 255 do not excite the low-pressure shaft 238 when the redline speed is subcritical.

The input shaft portion 3851 includes an input shaft length Lᵢₙₚᵤₜ that extends axially from the forward bearing 3852 to the sun gear 3840 (e.g., an axial center of the sun gear 3840). The input shaft length Lᵢₙₚᵤₜ is equal to an aft decoupler length L_{dplr_aft}, a decoupler length L_{dcplr}, and a forward decoupler length L_{deplr_fwd}, added together. The aft decoupler length L_{dplr_aft} extends from the forward bearing 3852 to the first flex plate 3854a, the decoupler length L_{dcplr} extends from the first flex plate 3854a to the second flex plate 3854b, and the forward flex length L_{dcplr_fwd} extends from the second flex plate 3854b to the sun gear 3840 (e.g., to an axially center of the sun gear 3840). The flex coupling 3845 also includes a decoupler height H_{dcplr} and one or more decoupler radii. The decoupler height is a height of the flex plates 3854 in the radial direction from the input shaft portion 3851. The one or more decoupler radii is an inner radius of the input shaft portion 3851. The one or more decoupler radii include a first decoupler radius R_{dcplr1} and a second decoupler radius R_{dcplr2}. In the embodiment of FIG. 49, the first decoupler radius R_{dcplr1} is equal to the second decoupler radius R_{dcplr2} such that the input shaft portion 3851 has a constant inner radius. In some embodiments the first decoupler radius R_{dcplr1} is different than the second decoupler radius R_{dcplr2} such that the input shaft portion 3851 has a variable inner radius (e.g., the inner radius of the input shaft portion 3851 changes along the axial direction).

In consideration of midshaft operating speeds, whether during an aircraft maximum thrust at takeoff, redline or cruise operating condition, it is desirable to have any anticipated dynamic loading of the gearbox caused by midshaft motion to not act as to amplify or to excite fundamental or principal mode(s) of the gearbox through the sun gear-midshaft coupling. It is also desirable to avoid a dynamic excitation communicated through the sun gear/midshaft coupling and influenced by modal characteristics of the gearbox assembly to act as to excite fundamental mode(s) of the midshaft. To achieve this end result, it is desirable to have a decoupler moment stiffness KM_{dcplr} of the flex coupling 3845 and a decoupler shear stiffness KS_{dcplr} of the flex coupling 3845 (e.g., a moment stiffness and a shear stiffness at the sun gear-midshaft coupling) being such as to neither cause significant excitation of a fundamental midshaft mode, nor a dynamic excitation from the midshaft communicated at this coupling to cause significant excitation of a fundamental mode of the gearbox assembly. The decoupler moment stiffness KM_{dcplr} is an overturning moment stiffness of the flex coupling 3845 (e.g., a torque of the flex coupling 3845 applied radially on the flex coupling 3845), including the decoupler moment stiffness of the first flex plate 3854a and the decoupler moment stiffness of the second flex plate 3854b. The decoupler shear stiffness KS_{dcplr} is a stiffness of the flex coupling 3845 (e.g., between the first flex plate 3854a and the second flex plate 3854b) in the axial direction. The stiffness of the flex coupling 3845 (e.g., the decoupler moment stiffness KM_{dcplr} and the decoupler shear stiffness KS_{dcplr}) should be selected so as to not amplify midshaft properties or so as not excite the gearbox assembly 255 by midshaft dynamic behavior during engine operation.

Various rig tests and measurements taken to simulate engine operational conditions, accounting for any differences between a dynamic response for a recently fielded engine and an engine after several operational cycles, revealed common patterns in dynamic behavior for midshaft-gearbox interactions to inform the design of the flex coupling 3845 to avoid the modal coupling between gearbox and midshaft explained above. It was found that a decoupler moment stiffness KM_{dcplr} of the flex coupling 3845 in a range of 50 klb×in/rad to 200 klb×in/rad, and a decoupler shear stiffness KS_{dcplr} of the flex coupling 3845 in a range of 100 klb/in to 500 klb/in, should substantially avoid intolerable or sustained dynamic amplification of the gearbox assembly 255 or the midshaft (e.g., the low-pressure shaft) when there is excitation of either the gearbox assembly 255 or the midshaft during engine operations. In this way, the flex coupling 3845 prevents the gearbox assembly 255 from dynamically exciting the midshaft, and prevents the midshaft from dynamically exciting the gearbox assembly 255. In this way, the gearbox and its couplings are designed to prevent the gearbox dynamics from affecting the midshaft dynamics at subcritical speeds of the LP shaft, and vice versa. The decoupler moment stiffness KM_{dcplr} of the flex coupling 3845 is expressed in klb×in/rad, and the decoupler shear stiffness KS_{dcplr} of the flex coupling 3845 is expressed in klb/in. In view of the foregoing, the decoupler moment stiffness KM_{dcplr} of the flex coupling 3845 and the decoupler shear stiffness KS_{dcplr} of the flex coupling 3845 are desired to satisfy the relationships (12) and (13), respectively:

$${KM}_{dcplr} = \frac{E \times {K}_{m} \times {R}_{dcplr}^{4}}{{H}_{dcplr}} \qquad ( 12 )$$

$${KS}_{dcplr} = \frac{E \times {K}_{s} \times {R}_{dcplr}^{4}}{{L}_{dcplr}^{2}} \qquad ( 13 )$$

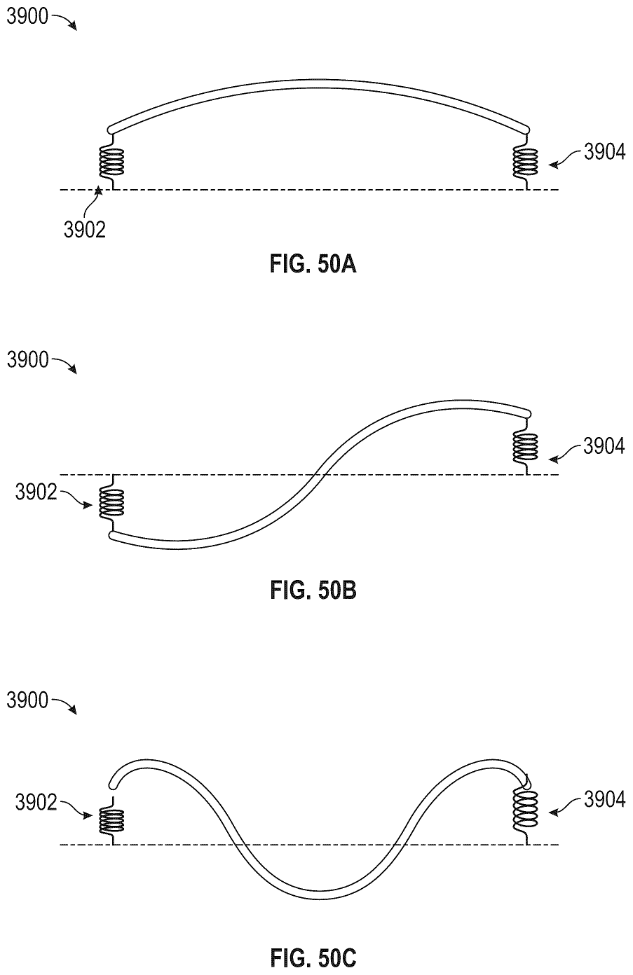

As discussed earlier, HP shaft excitation can influence LP shaft dynamics; and LP shaft excitation can influence HP shaft dynamics. Referring to FIGS. 50A to 50C, there is shown a schematic view of a high-pressure shaft (HP shaft) corresponding to the predominate three typical mode shapes of the HP shaft that need to be taken into consideration when designing an engine core and avoiding dynamic instability not only in the HP shaft, but also in the LP shaft, as realized by the inventors. The deformed HP shaft is supported at its ends by the HP shaft forward and aft bearings 3902 and 3904, respectively. The bearings are represented by their stiffnesses (shown as springs). FIG. 50A illustrates a first mode, also referred to as a fundamental bounce mode, also known as a bow rotor mode, of the high-pressure shaft 3900. The first mode can occur at sub-idle speeds of the high-pressure shaft, which are about twenty percent to thirty percent below a redline speeds of the low-pressure rotor (e.g., about ten percent below cruise speeds). In FIG. 50B, the high-pressure shaft 3900 has a second order bending mode, also known as the pitch mode. The second order bending mode occurs at near to cruise speeds of the high-pressure shaft, which are about twenty percent to thirty percent below the high-pressure shaft redline speeds. In FIG. 50C, the high-pressure shaft 3900 has a third order bending mode, also known as a S-shaped mode. The third order bending mode occurs near redline speeds of the high-pressure shaft.

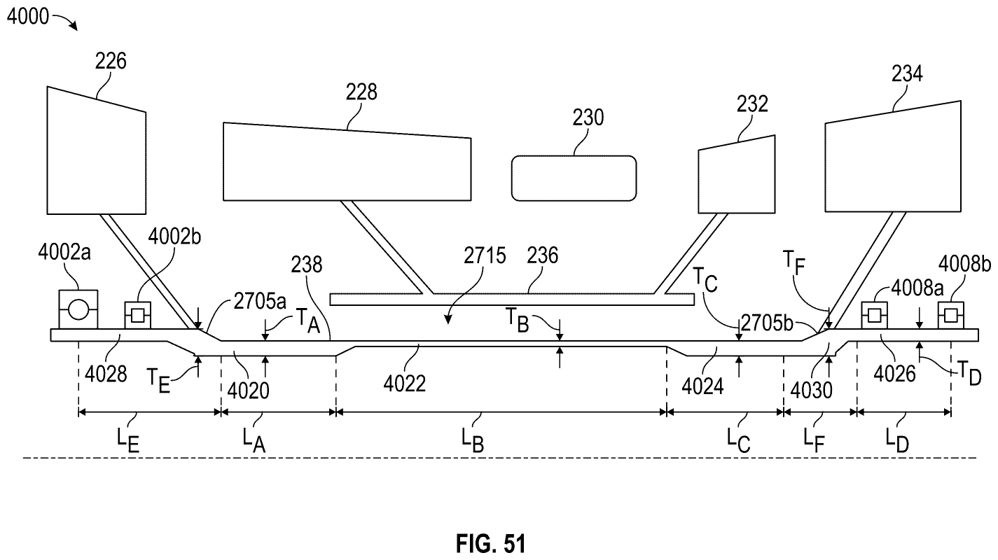

FIG. 51 shows a schematic view of a turbofan engine 4000, according to the present disclosure. This figure illustrates a design for the LP shaft that increases the critical and/or available redline speed while avoiding a supercritical shaft condition, and associated margins between operating and critical speeds, by varying the relative stiffness between shaft sections while taking into account the limited space available for the shaft in different sections of engine. The exemplary embodiment of FIG. 51 may be configured in substantially the same manner as the turbofan engine 210 described above with respect to FIGS. 2 and 22 through 24, and the same or similar reference numerals may refer to the same or similar parts. The turbofan engine 4000 includes the low-pressure compressor 226, the high-pressure compressor 228, the combustor 230, the high-pressure turbine 232, the low-pressure turbine 234, the high-pressure shaft 236, and the low-pressure shaft 238. The low-pressure compressor 226 is coupled to the low-pressure shaft 238 at the mounting point 2705a and the high-pressure compressor 228 is coupled to the low-pressure shaft 238 at the mounting point 2705b. The low-pressure shaft 238 has the midshaft 2715. In FIG. 51, the HP shaft bearings have been omitted for clarity, but the high-pressure shaft 236 can be supported by any of the HP shaft bearings detailed herein.

The low-pressure shaft 238 is supported on bearings 4002a, 4002b, 4008a, 4008b, which are mounted to support structures (not shown) of the turbofan engine 4000. The bearings 4002a, 4002b and the bearings 4008a, 4008b are in an outbound position, similar to the embodiment of FIG. 37D, i.e., located farther from the midshaft 2715 than the respective mounting points 2705a, 2705b of the low-pressure compressor 226 and the low-pressure turbine 234. The bearing 4002a is a ball bearing. The bearings 4002b, 4008a, and 4008b are roller bearings. In one embodiment, the low-pressure shaft 238 includes the bearing 4002a (e.g., ball bearing) and the bearings 4008a, 4008b (e.g., roller bearings). The bearing 4002a (and the bearing 4002b) is positioned axially forward of the mounting point 2705a. The bearings 4008a, 4008b are positioned axially aft of the mounting point 2705b. The bearing 4002b (e.g., roller bearing) provides additional support and can be positioned axially forward of the mounting point 2705a or axially aft of the mounting point 2705b.

Referring to FIG. 51, the low-pressure shaft 238 of the turbofan engine 4000 is illustrated to show differently sized shaft outer diameters between bearing 4008b and bearing 4002a reflecting differing dynamic properties between the bearings. As shown, the mid-shaft portion (L_{B}) has the smallest diameter, given the limited space through which it can extend across the engine core. The low-pressure shaft 238 in this embodiment has a varying stiffness between bearings, both in the shaft length and outer diameter along an axial length of the low-pressure shaft 238, the shaft stiffness being dependent on the lengthwise and bearings supporting the shaft.

In an alternative embodiment, the wall thickness of the shaft sections differs between shaft sections when space limitations prevent or limit the outer diameter shaft size, particularly for the mid-shaft. For example, the wall thickness of section L_{A}, L_{C}, L_{F}, L_{D}, L_{E}, and/or L_{A} may be increased relative to its length to produce similar shaft section stiffness properties without a significant change in the shaft outer diameter compared to adjacent sections.

The plurality of sections 4020 to 4030 include a first section 4020, a second section 4022, a third section 4024, a fourth section 4026, a fifth section 4028, and a sixth section 4030. The first section 4020 extends axially from a forward end that is aft of the mounting point 2705a to an aft end at the second section 4022. The second section 4022 extends axially from a forward end at the aft end of the first section 4020 to an aft end at the third section 4024. The second section 4022 defines the midshaft 2715. The third section 4024 extends axially from a forward end at the second section 4022 to an aft end at a forward end of the sixth section 4030. The fourth section extends from a forward end at an aft end of the sixth section 4030 to an aft end. The aft end of the fourth section 4026 defines an aft end of the low-pressure shaft 238 and is a free end of the low-pressure shaft 238. The fifth section 4028 extends from a forward end to an aft end at the forward end of the first section 4020. In this way, the fifth section 4028 includes the mounting point 2705a. The forward end of the fifth section 4028 defines a forward end of the low-pressure shaft 238 and is a free end of the low-pressure shaft 238. The sixth section 4030 extends from a forward end at the aft end of the third section 4024 to an aft end at the forward end of the fourth section 4026. In this way, the sixth section 4030 includes the mounting point 2705b.

The first section 4020 has a first section length L_{A} defined in the axial direction from the forward end of the first section 4020 to the aft end of the first section 4020. The second section 4022 has a second section length L_{B} defined in the axial direction from the forward end of the second section 4022 to the aft end of the second section 4022. The third section 4024 has a third section length L_{C} defined in the axial direction from the forward end of the third section 4024 to the aft end of the third section 4024. The fourth section 4026 has a fourth section length L_{D} defined in the axial direction from the forward end of the fourth section 4026 to the aft end of the fourth section 4026. The fifth section 4028 has a fifth section length L_{E} defined in the axial direction from the forward end of the fifth section 4028 to the aft end of the fifth section 4028. The sixth section 4030 has a sixth section length L_{F} defined in the axial direction from the forward end of the sixth section 4030 to the aft end of the sixth section 4030.

The first section 4020 has a first section thickness T_{A} defined as a maximum thickness in the radial direction of the first section 4020. The second section 4022 has a second section thickness T_{B} defined as a maximum thickness in the radial direction of the second section 4022. The third section 4024 has a third section thickness T_{C} defined as a maximum thickness in the radial direction of the third section 4024. The fourth section 4026 has a fourth section thickness T_{D} defined as a maximum thickness in the radial direction of the fourth section 4026. The fifth section 4028 has a fifth section thickness T_{E} defined as a maximum thickness in the radial direction of the fifth section 4028. The sixth section 4030 has a sixth section thickness T_{F} defined as a maximum thickness in the radial direction of the sixth section 4030.

The first section thickness T_{A} is in a range of 0.16 in to 0.78 in. In some embodiments, the first section thickness T_{A} is in a range of 0.232 in to 0.606 in. The second section thickness T_{B} is in a range of 0.16 in to 0.83 in. In some embodiments, the second section thickness T_{B} is in a range of 0.232 in to 0.488 in. The third section thickness T_{C} is in a range of 0.16 in to 0.78 in. In some embodiments, the third section thickness T_{C} is in a range of 0.232 in to 0.606 in. The fourth section thickness T_{D} is in a range of 0.16 in to 0.83 in. In some embodiments, the fourth section thickness T_{D} is in a range of 0.232 in to 0.488 in. The fifth section thickness T_{E} is in a range of 0.16 in to 1.17 in. In some embodiments, the fifth section thickness T_{E} is in a range of 0.232 in to 0.900 in. The sixth section thickness T_{F} is in a range of 0.16 in to 0.24 in. In some embodiments, the sixth section thickness T_{F} is in a range of 0.232 in to 1.818 in.

A ratio of the second section thickness T_{B} to the first section thickness T_{A} (T_{B}/T_{A}) is in a range of 0.3 to 1.0. A ratio of the second section thickness T_{B} to the third section thickness T_{C} (T_{B}/T_{C}) is in a range of 0.3 to 1.0. A ratio of the second section thickness T_{B} to the fourth section thickness T_{D} (T_{B}/T_{D}) is in a range of 0.4 to 1.0. A ratio of the second section thickness T_{B} to the fifth section thickness T_{E} (T_{B}/T_{E}) is in a range of 0.2 to 1.0. A ratio of the second section thickness T_{B} to the sixth section thickness T_{F} (T_{B}/T_{F}) is in a range of 0.1 to 1.0.

The lengths and thicknesses of the various sections 4020 to 4030 define a stiffness of each of the sections 4020 to 4030. The first section 4022 wall thickness and length (L_{A}, T_{A}), and the third section 4024 length and thickness (L_{C}, T_{C}) have a shaft stiffness greater than the stiffness for the midshaft 2715. The effect of this arrangement is that the midshaft 2715 has bending properties more similar to a midshaft having fixed end supporting bearings, as opposed to pinned bearing supports for the midshaft region. The first section thickness T_{A} and the third section thickness T_{C} and lengths are equal so that the stiffness of the first section 4020 and the stiffness of the third section 4024 are equal. The thickness of the LP shaft 238 increases at the mounting points 2705a, 2705b to provide additional support for mounting the LP compressor 226 and the LP turbine 234 to the LP shaft 238, thereby preventing lower frequency excitation from passing between the HP and LP shafts, in addition to raising the critical frequency for the LP shaft.

The first section length L_{A} and the third section length L_{C} are less than the second section length L_{B}. In some embodiments, the second section length L_{B} is equal to L_{CORE}, described above. The first section length L_{A} is equal to the third section length L_{C}. The fourth section length L_{D}, the fifth section length L_{E}, and the sixth section length L_{F} are less than the second section length L_{B}.

The first section length L_{A} is in a range of 8.8 in to 13.2 in. The second section length L_{B} is in a range of 29.7 in to 44.7 in. The third section length L_{C} is in a range of 8.8 in to 13.2 in. The fourth section length L_{D} is in a range of 10.6 in to 16.0 in. The fifth section length L_{E} is in a range of 5.7 in to 8.6 in. The sixth section length is in a range of 10.4 in to 15.8 in. The total length of the LP shaft 238 is in a range of 74.1 to 111.3 in.

A ratio of the first section length L_{A} to the second section length L_{B} of (L_{A}/L_{B}) is in a range of 0.16 to 0.3. A ratio of the third section length L_{C} to the second section length L_{B} (L_{C}/L_{B}) is in a range of 0.16 to 0.3. A ratio of the fourth section length L_{D} to the second section length L_{B} (L_{D}/L_{B}) is in a range of 0.07 to 0.36. A ratio of the fifth section length L_{E} to the second section length L_{B} (L_{E}/L_{B}) is in a range of 0.05 to 0.2. A ratio of the sixth section length L_{F} of to the second section length L_{B} (L_{F}/L_{B}) is in a range of 0.08 to 0.35.

The fourth section 4026 and the fifth section 4028 define bearing support sections of the low-pressure shaft 238. The thickness and the diameter of the fourth section 4026 and the fifth section 4028 are greater than the second section thickness TB and the diameter of the second section 4022. In this way, the fourth section 4026 and the fifth section 4028 have a greater stiffness than the second section 4022. Such a configuration of the fourth section 4026 and the fifth section 4028 provides for the low-pressure shaft 238 to act as a fixed-fixed beam (e.g., two fixed ends) rather than a pinned end beam, resulting in a higher frequency for the midshaft fundamental mode. In particular, given that the second section 4026 is the dominant stiffness making the fourth section 4026 and the fifth section 4028 with a greater stiffness than the second section 4022 means that the second section 4022 will behave more like a fixed beam (rather than a pinned beam). The low-pressure shaft 238 is a non-uniform cross section having a minimum wall thickness or outer diameter (or both) at the second section 4022 (e.g., at the midshaft 2715).

The stiffness of the low-pressure shaft 238 may be characterized by stiffness-to-weight ratios, as compared to the second section 4022:

$$\frac{[ \frac{{K}_{A}}{{m}_{A}} ]}{[ \frac{{K}_{B}}{{m}_{B}} ]} \qquad ( 14 )$$

$$\frac{[ \frac{{K}_{C}}{{m}_{C}} ]}{[ \frac{{K}_{B}}{{m}_{B}} ]} \qquad ( 15 )$$

$$\frac{[ \frac{{K}_{D}}{{m}_{D}} ]}{[ \frac{{K}_{B}}{{m}_{B}} ]} \qquad ( 16 )$$

$$\frac{[ \frac{{K}_{E}}{{m}_{E}} ]}{[ \frac{{K}_{B}}{{m}_{B}} ]} \qquad ( 17 )$$

$$\frac{[ \frac{{K}_{F}}{{m}_{F}} ]}{[ \frac{{K}_{B}}{{m}_{B}} ]} \qquad ( 18 )$$

K_{A}/m_{A} is the stiffness to mass ratio of the first section 4020, where K_{A} is the bending stiffness of the first section 4020 and m_{A} is the mass of the first section 4020. K_{A}/m_{A} is in a range of 4.85×10⁻⁹ rad/in to 2.00×10⁻⁸ rad/in. K_{B}/m_{B} is the stiffness to mass ratio of the second section 4022, where K_{B} is the bending stiffness of the second section 4022 and m_{B} is the mass of the second section 4022. K_{B}/m_{B} is in a range of 1.4×10⁻⁸ rad/in to 2.60×10⁻⁸ rad/in. K_{C}/m_{C} is the stiffness to mass ratio of the third section 4024, where K_{C} is the bending stiffness of the third section 4024 and m_{C} is the mass of the third section 4024. K_{C}/m_{C} is in a range of 4.85×10⁻⁹ rad/in to 2.00×10⁻⁸ rad/in. K_{D}/m_{D} is the stiffness to mass ratio of the fourth section 4026, where K_{D} is the bending stiffness of the fourth section 4026 and m_{D} is the mass of the fourth section 4026. K_{D}/m_{D} is in a range of 1.42×10⁻⁹ rad/in to 2.00×10⁻⁸ rad/in. K_{E}/m_{E} is the stiffness to mass ratio of the fifth section 4028, where K_{E} is the bending stiffness of the fifth section 4028 and m_{E} is the mass of the fifth section 4028. K_{E}/m_{E} is in a range of 1.37×10⁻⁹ rad/in to 2.00×10⁻⁸ rad/in. K_{F}/m_{F} is the stiffness to mass ratio of the sixth section 4030, where K_{F} is the bending stiffness of the sixth section 4030 and m_{F} is the mass of the sixth section 4030. K_{F}/m_{F} is in a range of 7.30×10⁻¹⁰ rad/in to 2.00×10⁻⁸ rad/in.

K is the bending stiffness of each of the sections 4020 to 4030. K is represented by relationship (19) for each section:

$$K = \frac{EI}{{L}^{3}} \qquad ( 19 )$$

Relationship (19) assumes a constant section thickness (or average wall thickness) and disregards tapering within a particular section. In relationship (19), E is the modulus of elasticity, or Young's modulus, for the material of the respective section of the LP shaft 238, L is the length of the respective section, and I is the area moment of inertia of the respective section. I is given by relationship (20):

$$I = \frac{π ( {D}_{o}^{4} - {D}_{i}^{4} )}{64} \qquad ( 20 )$$

Dₒ is an outer diameter of the respective shaft section and Dᵢ is an inner diameter of the respective shaft section. The outer diameter Dₒ is the diameter of the respective shaft section at the outer surface of the respective shaft section. The inner diameter Dᵢ is the diameter of the respective shaft section at the inner surface of the respective shaft section.

The area moment of inertia (I_{A}) of the first section 4020 is in a range of 2.0 in⁴ to 7.15 in⁴. In some embodiments, the area moment of inertia (I_{A}) of the first section 4020 is in a range of 2.9 in⁴ to 5.5 in⁴. The area moment of inertia (I_{B}) of the second section 4022 is in a range of 2.0 in⁴ to 7.8 in⁴. In some embodiments, the area moment of inertia (I_{B}) of the second section 4022 is in a range of 2.9 in⁴ to 6.0 in⁴. The area moment of inertia (I_{C}) of the third section 4024 is in a range of 2.0 in⁴ to 7.15 in⁴. In some embodiments, the area moment of inertia (I_{C}) of the third section 4024 is in a range of 2.9 in⁴ to 5.5 in⁴. The area moment of inertia (I_{D}) of the fourth section 4026 is in a range of 2.0 in⁴ to 19.0 in⁴. In some embodiments, the area moment of inertia (I_{D}) of the fourth section 4026 is in a range of 2.9 in⁴ to 14.6 in⁴. The area moment of inertia (I_{E}) of the fifth section 4028 is in a range of 2.0 in⁴ to 15.0 in⁴. In some embodiments, the area moment of inertia (I_{E}) of the fifth section 4028 is in a range of 2.9 in⁴ to 11.5 in⁴. The area moment of inertia (I_{F}) of the sixth section 4030 is in a range of 2.0 in⁴ to 81.4 in⁴. In some embodiments, the area moment of inertia (I_{F}) of the sixth section 4030 is in a range of 2.9 in⁴ to 62.6 in⁴.

A ratio of the area moment of inertia of the second section 4022 to the area moment of inertia of the first section 4020 (I_{B}/I_{A}) is in a range of 0.53 to 1. A ratio of the area moment of inertia of the second section 4022 to the area moment of inertia of the third section 4024 (I_{B}/I_{C}) is in a range of 0.53 to 1. A ratio of the area moment of inertia of the second section 4022 to the area moment of inertia of the fourth section 4026 (I_{B}/I_{D}) is in a range of 0.19 to 1. A ratio of the area moment of inertia of the second section 4022 to the area moment of inertia of the fifth section 4028 (I_{B}/I_{E}) is in a range of 0.25 to 1. A ratio of the area moment of inertia of the second section 4022 to the area moment of inertia of the sixth section 4030 (I_{B}/I_{F}) is in a range of 0.04 to 1.

The mass of each of the shaft sections 4020 to 4030 is given by relationship (21):

$$m = ρπ ( {D}_{o}^{2} - {D}_{i}^{2} ) * L \qquad ( 21 )$$

The symbol p is the density of the respective shaft section. The mass m_{A} of the first section 4020 is in a range of 4.8 lbf to 20.8 lbf. In some embodiments, the mass m_{A} of the first section 4020 is in a range of 7.1 lbf to 16.0 lbf. The mass m_{B} of the second section 4022 is in a range of 6.0 lbf to 31.2 lbf. In some embodiments, the mass m_{B} of the second section 4022 is in a range of 8.6 lbf to 24.0 lbf. The mass m_{C} of the third section 4024 is in a range of 4.8 lbf to 20.8 lbf. In some embodiments, the mass m_{C} of the third section 4024 is in a range of 7.1 lbf to 16.0 lbf. The mass m_{D} of the fourth section 4026 is in a range of 6.0 lbf to 31.2 lbf. In some embodiments, the mass m_{D} of the fourth section 4026 is in a range of 8.6 lbf to 24.0 lbf. The mass m_{E} of the fifth section 4028 is in a range of 3.2 lbf to 22.5 lbf. In some embodiments, the mass m_{E} of the fifth section 4028 is in a range of 4.6 lbf to 17.3 lbf. The mass m_{F} of the sixth section 4030 is in a range of 5.9 lbf to 65.2 lbf. In some embodiments, the mass m_{F} of the sixth section 4030 is in a range of 8.5 lbf to 50.1 lbf. The total mass mₜₒₜₐₗ of the LP shaft 238 is in a range of 42.0 lbf to 192.0 lbf. In some embodiments, the total mass mₜₒₜₐₗ of the LP shaft 238 is in a range of 60.0 lbf to 147.6 lbf.

Accordingly, the stiffness ratios for each section are given by relationships (22) to (26):

$$\frac{[ \frac{{K}_{A}}{{m}_{A}} ]}{[ \frac{{K}_{B}}{{m}_{B}} ]} = \frac{( {D}_{oA}^{4} - {D}_{iB}^{4} ) {L}_{B}^{4} ( {D}_{oB}^{2} - {D}_{iB}^{2} )}{( {D}_{oA}^{2} - {D}_{iA}^{2} ) {L}_{A}^{4} ( {D}_{oB}^{4} - {D}_{iB}^{4} )} \qquad ( 22 )$$

$$\frac{[ \frac{{K}_{C}}{{m}_{C}} ]}{[ \frac{{K}_{B}}{{m}_{B}} ]} = \frac{( {D}_{oC}^{4} - {D}_{iB}^{4} ) {L}_{B}^{4} ( {D}_{oB}^{2} - {D}_{iB}^{2} )}{( {D}_{oC}^{2} - {D}_{iC}^{2} ) {L}_{C}^{4} ( {D}_{oB}^{4} - {D}_{iB}^{4} )} \qquad ( 23 )$$

$$\frac{[ \frac{{K}_{D}}{{m}_{D}} ]}{[ \frac{{K}_{B}}{{m}_{B}} ]} = \frac{( {D}_{oD}^{4} - {D}_{iB}^{4} ) {L}_{B}^{4} ( {D}_{oB}^{2} - {D}_{iB}^{2} )}{( {D}_{oD}^{2} - {D}_{iD}^{2} ) {L}_{D}^{4} ( {D}_{oB}^{4} - {D}_{iB}^{4} )} \qquad ( 24 )$$

$$\frac{[ \frac{{K}_{E}}{{m}_{E}} ]}{[ \frac{{K}_{B}}{{m}_{B}} ]} = \frac{( {D}_{oE}^{4} - {D}_{iB}^{4} ) {L}_{B}^{4} ( {D}_{oB}^{2} - {D}_{iB}^{2} )}{( {D}_{oE}^{2} - {D}_{iE}^{2} ) {L}_{E}^{4} ( {D}_{oB}^{4} - {D}_{iB}^{4} )} \qquad ( 25 )$$

$$\frac{[ \frac{{K}_{F}}{{m}_{F}} ]}{[ \frac{{K}_{B}}{{m}_{B}} ]} = \frac{( {D}_{oE}^{4} - {D}_{iB}^{4} ) {L}_{B}^{4} ( {D}_{oB}^{2} - {D}_{iB}^{2} )}{( {D}_{oF}^{2} - {D}_{iF}^{2} ) {L}_{F}^{4} ( {D}_{oB}^{4} - {D}_{iB}^{4} )} \qquad ( 26 )$$

In relationships (22) to (26), L is the section length of the respective section, Dₒ is the outer diameter of the respective section, and Dᵢ is the inner diameter of the respective section.

The outer diameter Dₒ of each section is in a range of 2.9 in to 9.1 in. In some embodiments, the outer diameter Dₒ of each section is in a range of 3.0 in to 7.0 in. In some embodiments, the outer diameter Dₒ of each section is the same. In some embodiments, the outer diameter Dₒ varies among the various sections. In particular, in some embodiments, at least one of the outer diameter D_{oD} of the fourth section 4026, the outer diameter D_{oE} of the fifth section 4028, or the outer diameter D_{oF} of the sixth section 4030 is different than the outer diameter Dₒ of the first section 4020, the second section 4022, and the third section 4024. A ratio of the outer diameter D_{oB} of the second section 4022 to the outer diameter D_{oA} of the first section 4020 is in a range of 1.0 to 1.5. A ratio of the outer diameter D_{oB} of the second section 4022 to the outer diameter D_{oC} of the third section 4024 is in a range of 1.0 to 1.5. A ratio of the outer diameter D_{oB} of the second section 4022 to the outer diameter D_{oD} of the fourth section 4026 is in a range of 0.7 to 1.5. A ratio of the outer diameter D_{oB} of the second section 4022 to the outer diameter D_{oE} of the fifth section 4028 is in a range of 0.8 to 1.5. A ratio of the outer diameter D_{oB} of the second section 4022 to the outer diameter D_{oF} of the sixth section 4030 is in a range of 0.5 to 1.5.

The inner diameter Dᵢ of each section varies among the various sections. In general, the inner diameter Dᵢ of each section is in a range of 1.4 in to 3.9 in. In some embodiments, the inner diameter Dᵢ of each section is in a range of 2.1 in to 3.0 in. In some embodiments, the inner diameter D_{iB} of the second section 4022 is equal to or greater than the inner diameter Dₒ of the first section 4020, the third section 4024, the fifth section 4028, and the sixth section 4030. A ratio of the inner diameter D_{iB} of the second section 4022 to the inner diameter D_{iA} of the first section 4020 is in a range of 1.0 to 1.5. A ratio of the inner diameter D_{iB} of the second section 4022 to the inner diameter D_{iC} of the third section 4024 is in a range of 1.0 to 1.5. A ratio of the inner diameter D_{iB} of the second section 4022 to the inner diameter D_{iD} of the fourth section 4026 is in a range of 0.7 to 1.5. A ratio of the inner diameter D_{iB} of the second section 4022 to the inner diameter D_{iE} of the fifth section 4028 is in a range of 1.0 to 1.5. A ratio of the inner diameter D_{iB} of the second section 4022 to the inner diameter D_{iF} of the sixth section 4030 is in a range of 1.0 to 1.5.

The total bending stiffness Kₜₒₜₐₗ of the low-pressure shaft 136 is given by relationship (27):

$${K}_{total} = {K}_{A} + {K}_{B} + {K}_{C} + {K}_{D} + {K}_{E} + {K}_{F} \qquad ( 27 )$$

In relationship (27), K_{A} is the bending stiffness of the first section 4020, K_{B} is the bending stiffness of the second section 4022, K_{C} is the bending stiffness of the third section 4024, K_{D} is the bending stiffness of the fourth section 4026, K_{E} is the bending stiffness of the fifth section 4028, and K_{F} is the bending stiffness of the sixth section 4030. The bending stiffness K of each section is given by relationship (19) above.

K_{A} is in a range of 5.43×10⁻⁸ rad/lbf×in to 1.85×10⁻⁷ rad/lbf×in. In some embodiments, K_{A} is in a range of 7.76×10⁻⁸ rad/lbf×in to 1.42×10⁻⁷ rad/lbf×in. K_{B} is in a range of 3.36×10⁻⁷ rad/lbf×in to 6.24×10⁻⁷ rad/lbf×in. K_{C} is in a range of 5.43×10⁻⁸ rad/lbf×in to 1.85×10⁻⁷ rad/lbf×in. In some embodiments, K_{C} is in a range of 7.76×10⁻⁸ rad/lbf×in to 1.42×10⁻⁷ rad/lbf×in. K_{D} is in a range of 2.4×10⁻⁸ rad/lbf×in to 2.24×10⁻⁷ rad/lbf×in. In some embodiments, K_{D} is in a range of 3.43×10⁻⁸ rad/lbf×in to 1.72×10⁻⁷ rad/lbf×in. K_{E} is in a range of 1.65×10⁻⁸ rad/lbf×in to 11.98×10⁻⁸ rad/lbf×in. In some embodiments, K_{E} is in a range of 2.36×10⁻⁸ rad/lbf×in to 9.21×10⁻⁸ rad/lbf×in. K_{F} is in a range of 2.56×10⁻⁸ rad/lbf×in to 2.20×10⁻⁷ rad/lbf×in. In some embodiments, K_{F} is in a range of 3.66×10⁻⁸ rad/lbf×in to 1.69×10⁻⁷ rad/lbf×in. Kₜₒₜₐₗ is in a range of 5.11×10⁻⁷ rad/lbf×in to 1.56×10⁻⁶ rad/lbf×in. In some embodiments, Kₜₒₜₐₗ is in a range of 7.30×10⁻⁷ rad/lbf×in to 1.2×10⁻⁶ rad/lbf×in.

A ratio of the stiffness K_{A} of the first section 4020 to the stiffness K_{B} of the second section 4022 (K_{A}/K_{B}) is in a range of 0.16 to 0.3. A ratio of the stiffness K_{C} of the third section 4024 to the stiffness K_{B} of the second section 4022 (K_{C}/K_{B}) is in a range of 0.16 to 0.3. A ratio of the stiffness K_{D} of the fourth section 4026 to the stiffness K_{B} of the second section 4022 (K_{D}/K_{B}) is in a range of 0.07 to 0.36. A ratio of the stiffness K_{E} of the fifth section 4028 to the stiffness K_{B} of the second section 4022 (K_{E}/K_{B}) is in a range of 0.05 to 0.19. A ratio of the stiffness K_{F} of the sixth section 4030 to the stiffness K_{B} of the second section 4022 (K_{F}/K_{B}) is in a range of 0.08 to 0.35.

A ratio of the stiffness K_{B} of the second section 4022 to the total stiffness Kₜₒₜₐₗ is greater than or equal to 0.4. In particular, K_{B}/Kₜₒₜₐₗ is in a range of 0.4 to 0.7. A ratio of the stiffness to mass ratio of the second section 4022 to the total stiffness to mass ratio ((K_{B}/m_{B})/(Kₜₒₜₐₗ/mₜₒₜₐₗ) is greater than one. In some embodiments, the ratio of the stiffness to mass ratio of the second section 4022 to the total stiffness to mass ratio ((K_{B}/m_{B})/(Kₜₒₜₐₗ/mₜₒₜₐₗ) is 1.2 to 5. In some embodiments, the ratio of the stiffness to mass ratio of the second section 4022 to the total stiffness to mass ratio ((K_{B}/m_{B})/(Kₜₒₜₐₗ/mₜₒₜₐₗ) is 1.3 to 5. Such a configuration of the stiffness of the low-pressure shaft 136 provides for the bending modes (e.g., the first order bending mode, the second order bending mode, or the third order bending mode) of the low-pressure shaft 238 to be greater than the redline speed of the low-pressure shaft 238. In particular, the bending modes (e.g., the first order bending mode, the second order bending mode, or the third order bending mode) are at least 5% greater than the redline speed.

The embodiments of shaft length changes as effected by changes in the core size was previously expressed in relationship (9). With respect to FIG. 51 embodiments, the relationship among HPC and HPT stages to core length, core exit radius the core inlet radius, and the compressor stages and the turbine stages is expressed by relationship (28), which was found to characterize the embodiments that provided desired results in terms of core properties:

$${L}_{CORE} = {[ {m}^{( 20 + m )} \times {n}^{( 10 + n )} ]}^{( \frac{1}{100} )} \times {( \frac{Core Exit Radius}{Core Inlet Radius} )}^{\frac{\sqrt{{M}^{2} + {N}^{2}}}{10}} + C \qquad ( 28 )$$

Due to relationship (28), the influence of core length changes impacted by adding additional HPC or HPT stages from the embodiments evaluated, are more directly related to engine dynamics associated with a higher power density core. The symbol m is the number of stages in the high-pressure compressor and n is the number of stages in the high-pressure turbine. The symbol C is a constant that represents an axial distance from the IGV 2206 (FIG. 39) of the HPC 228 to a leading edge of the HP compressor rotor blade 2208 (FIG. 39) of the first stage of the HPC 228. C is in a range of 11.9 in to 23.5 in. The relation in (28) for L_{CORE} is valid only for m being eight, nine, ten, or eleven, and n being one or two. The core exit radius is a radius of the HP turbine 232 at an exit stage (last stage) of the HP turbine 232. In particular, the core exit radius is an average radius of the exit stage and is given by relationship (29):

$$\frac{{R}_{exit \_ blade \_ tip} + {R}_{exit \_ blade \_ hub}}{2} \qquad ( 29 )$$

In relationship (29), R_{exit_blade_tip} is the radius from the longitudinal centerline axis 212 to the tip of the HP turbine rotor blade 2212 of the exit stage at the leading edge of the HP turbine rotor blade 2212 and R_{exit_blade_hub} is the radius from the longitudinal centerline axis 212 to the hub (e.g., the root) of the HP turbine rotor blade 2212 of the last stage 2211 at the leading edge of the HP turbine rotor blade 2212.

The core inlet radius is a radius of the HP compressor 228 at inlet stage (e.g., the first stage) of the HP compressor 228. In particular, the core inlet radius is an average radius of the inlet stage and is given by relationship (30):

$$\frac{{R}_{inlet \_ blade \_ tip} + {R}_{inlet \_ blade \_ hub}}{2} \qquad ( 30 )$$

In relationship (30), R_{inlet_blade_tip} is the radius from the longitudinal centerline axis 212 to the tip of the HP compressor rotor blade 2208 of the first stage at the leading edge of the HP compressor rotor blade 2208 and R_{inlet_blade_hub} is the radius from the longitudinal centerline axis 212 to the hub (e.g., the root) of the HP compressor rotor blade 2208 of the first stage at the leading edge of the HP compressor rotor blade 2208.

The embodiments evaluated and tested for varying shaft distances and bearing placements to produce an effective fixed-fixed midshaft support (FIG. 51) are disclosed in TABLE 12, below. The problem addressed was both accommodating a stiffer shaft within a reduced space associated with a more compact core and raising the critical frequency of the midshaft section. Certain dimensions and placement of bearings, wall thicknesses, and shaft lengths, as described earlier, produced the unexpected result of higher mid-shaft critical frequencies needed for a high speed LP turbine associated with next generation, geared engines. By way of testing various engine architectures, the present disclosure provides for different configurations of the low-pressure shaft, bearing placement and type, including different thicknesses, moments of inertia, and lengths, and different bearing configurations for the bearings that support the low-pressure shaft.

During the course of evaluating the different embodiments set forth herein, with the goal of providing a low-pressure shaft that rotates at higher speeds while remaining sub-critical during normal operation of the turbofan engine, varying the thickness of the low-pressure shaft along the length of the low-pressure shaft, and arranging the bearings axially forward of the low-pressure compressor mounting point and aft of the low-pressure turbine mounting point, provided for an increased natural frequency of the low-pressure shaft without overly increasing the diameter of the low-pressure shaft to fit within the bore of the high-pressure shaft and without exciting a bending mode of the high-pressure shaft.

After evaluating the set of novel embodiments including several different architectures of the low-pressure shaft and the bearings, the present disclosure provides favorable results that provided a favorable balance among limited space (including limited space under the fan and limited space between the HP shaft and the LP shaft), higher mass-stiffness properties, and avoided cross-coupling with the HP shaft. The embodiments, provided below, were found to be capable of characterization by specifying a combination of the area moment of inertia, the average wall thickness of the second section 4022, the average wall thickness of the fourth section 4026 and the fifth section 4028, the length (L_{MIDSHAFT}) of the low-pressure shaft from the forward low-pressure shaft bearing (e.g., the bearing 4002a) to the aft low-pressure shaft bearing (e.g., the bearing 4008a), the length of the second section 4022, and the modulus of elasticity (E) of the material of the second section 4022. With this characterization, the architectures that satisfy operational requirements (e.g., low-pressure shafts have a natural frequency that is at least 10% greater than the redline speed) and the packaging requirements (e.g., low-pressure shafts having a length and a diameter that fit within the limited space of the turbofan engine) could be distinguished from architectures that do not satisfy these requirements. As such, a finite and readily ascertainable number of embodiments that accounts of the operational requirement and the packaging requirements without exciting the first-order bending mode of the low-pressure shaft. The present disclosure provides a set of novel designs that meet these requirements. The novel designs can be characterized by a Midshaft Effective Flexural Rigidity (MEFR), as set forth in relationship (31):

$$MEFR = E \times {I}_{B} \times ( \frac{( 1.3 \times {T}_{E} ) + {T}_{D}}{2 \times {T}_{B}} ) \times ( \frac{{L}_{B}}{{L}_{Total}} ) \times {10}^{- 6} \qquad ( 31 )$$

In MEFR, E is the modulus of elasticity of the material of the second section 4022, I_{B} is the average area moment of inertia of the second section 4022 of the low-pressure shaft, T_{D} is the thickness of the fourth section 4026, T_{E} the thickness of the fifth section 4028, T_{B} is the thickness of the second section 4022 (also referred to as the midshaft), L_{B} is the length of the second section 4022 (the midshaft), and L_{Total} is the total length of the low-pressure shaft 136 (L_{Total}=L_{E}+L_{A}+L_{B}+L_{C}+L_{F}+L_{D}).

As discussed further below and mentioned above, the present disclosure provides low-pressure shaft designs for different turbofan engine architectures that account for the higher rotational speeds, while increasing the natural frequency of the low-pressure shaft to avoid exciting the first-order bending mode of the shaft, and also fitting within the limited space within such turbofan engines. These improved low-pressure shaft designs can be characterized according to a defined range for the MEFR. Table 12 below represents exemplary embodiments 156 to 171 and their corresponding MEFR values for various low-pressure shafts.

FIG. 52 is a schematic view of a bearing damper assembly 4100 for the turbofan engine 3100 (FIG. 38), taken along the longitudinal centerline axis 212 (FIG. 38) of the turbofan engine 3100, according to the present disclosure. The bearing damper assembly 4100 can be utilized in any of the engines disclosed herein, provided, in the case of a squeeze film damper housing for the bearing, the oil sump and circuit is suitable for the bearing load requirements and accommodated in engine's thermal management system for the oil. The bearing damper assembly 4100 can be utilized to engage and to support a rotating component 4120 of the turbofan engine 3100. The bearing damper assembly 4100, however, can be used to support any rotating component of the turbofan engine 3100, or between any rotating component of other turbofan engines. Particularly, the rotating component 4120 may be any rotating component of the turbofan engine 3100 (e.g., the LP shaft 238 or the HP shaft 236). For example, the bearing damper assembly 4100 of the present disclosure may be associated with any of the bearings discussed herein. In some embodiments, the turbofan engine 3100 may include one or more bearing damper assemblies 4100 at various bearing locations. For example, one or more of the bearings 3102 to 3108 can include a respective bearing damper assembly 4100.

As shown in FIG. 52, the bearing damper assembly 4100 includes a damper frame 4102, a bearing housing 4104, end seals 4106, and one or more bearings 4108. In the illustrated embodiment, an outer surface (e.g., an outer rim) of the bearing housing 4104 is coupled to an inner surface of the damper frame 4102. In some embodiments, the bearing housing 4104 may be fixedly coupled to the damper frame 4102 (e.g., via screws, nuts, or other suitable fastening mechanisms). In such embodiments, movement of the outer rim of the bearing housing 4104 relative to the damper frame 4102 may be limited.

The bearings 4108 are coupled to an inner surface of the bearing housing 4104 and define an annular region 4112, that supports the rotating component 4120. As described above, the bearings 4108 may facilitate rotation of the rotating component 4120, for example, by reducing friction that resists rotation. In the illustrated embodiment, the bearings 4108 are ball bearings. The bearings 4108 may be, any type of bearings, such as, for example, ball bearings, roller bearings, or the like. The bearings 4108 are coupled between the bearing housing 4104 and the rotating component 4120. As such, the rotating component 4120 may exert a force through the bearings 4108 onto the bearing housing 4104. For example, gravity may pull downward on the rotating component 4120, thus causing the rotating component 4120 to exert a radial force on the bearing housing 4104. Additionally, thrust from movement of the turbofan engine 3100 (FIG. 38) may cause the rotating component 4120 to exert an axial force on the bearing housing 4104.

Furthermore, during operation of the turbofan engine 3100 (FIG. 38), vibrations may be produced on the rotating component 4120 (e.g., due to mass imbalance or operation of the turbofan engine 3100 (FIG. 38)) that may propagate into the bearing housing 4104. In some instances, vibrations of the rotating component 4120 may affect operation of the turbofan engine 3100 (FIG. 38), for example, by disturbing or displacing other components. In particular, the vibrations can excite the first order bending mode of the low-pressure shaft 238, as detailed above. As such, the bearing housing 4104 may be used to damp (e.g., dissipate) vibrations of the rotating component 4120, thus, reducing likelihood of vibrations affecting operation of the turbofan engine 3100.

Various types of dampers may be utilized in the bearing damper assembly 4100 to damp vibrations of the rotating component 4120. In the illustrated embodiment of FIG. 52, the bearing housing 4104 of the bearing damper assembly 4100 is a squeeze film damper that utilizes fluid (e.g., oil) in one or more annular gaps formed between an inner diameter and an outer diameter of the bearing housing 4104. In some embodiments, the damper may be a segmented damper, although other types of bearings or rotational supports are contemplated in this way, damping characteristics (e.g., targeted frequencies or a targeted damping value) of the bearing housing 4104 may be dependent at least in part on the fluid in the one or more annular gaps. The bearing damper assembly 4100 depicted in FIG. 52 is by way of example only. In other embodiments, the bearing damper assembly 4100 may have any other suitable configuration.

In operation, oil is supplied to the bearing housing 4104 between the end seals 4106 to damp the vibrations. The oil is supplied within an operating temperature range to achieve a particular viscosity of the oil that corresponds to a particular damping coefficient to damp the vibrations in the rotating component 4120. In one embodiment, the operating temperature range of the oil is between one hundred eighty degrees Fahrenheit (180° F.) and two hundred twenty degrees Fahrenheit (220° F.).

The present disclosure provides the following relationships that represent evaluation of several different core designs (designs that provide higher power densities, as discussed earlier) from the perspective of maintaining dynamic stability between and among the HP shaft and LP shaft. These relationships take into account the trade-offs that need to be made, so that the design accounts not only for features of the core length, size and weight, and representative of a higher overall pressure ratio and increased operating temperatures (including use of CMC material), but also the effects that these changes in the core can have on both the HP shaft and the LP shaft.

A first relationship concerns the high-pressure shaft redline speed, or high speed shaft rating HSR given by (32):

$$HSR = {10}^{- 6} * N {2}_{r / l} * {D}_{CORE} * {( \frac{{L}_{CORE}}{{D}_{CORE}} )}^{2} \qquad ( 32 )$$

L_{CORE} and D_{CORE} are defined as described previously. N2_{r/1} is the redline speed for the HP shaft. The redline speed N2_{r/1} is from 11000 RPM to 25000 RPM. L_{CORE} is from forty-three inches to eighty inches. D_{CORE} is from 13.8 inches to 30.6 inches. HSR is from 1.9 to 4.3.

For stable operating conditions the high-pressure shaft third order bending mode should be placed above the redline speed of the HP shaft and satisfying (33):

$$- 0.1822 * HSR + HST > 0 \qquad ( 33 )$$

HST accounts for the effects that the HPC pressure ratio and the HPC exit temperature can have on the third order bending mode. T25 is the temperature in Rankine (R) at the high-pressure compressor (HPC) inlet. A good approximation for HST can be made in terms of only the T25, using (34):

$$HST = - 0.0014 * T 25 + 1.61 \qquad ( 34 )$$

where T25 is from 615 R to 855 R and HST is from 0.46 to 0.78.

For stable operating conditions the high-pressure shaft second order bending mode should be placed 20% below the redline speed of the HP shaft satisfying (35):

$$- 0.1215 * HSR + ( \frac{2 * HST - 1}{3} ) < - 0.2 \qquad ( 35 )$$

A second relationship concerns the low-pressure shaft redline speed, or high-speed shaft rating HSR_{LP} given by (36):

$${HSR}_{LP} = {10}^{- 6} * N {1}_{r / l} * {D}_{CORE} * {( \frac{{L}_{CORE}}{{D}_{CORE}} )}^{2} \qquad ( 36 )$$

L_{CORE} and D_{CORE} are defined as described previously. N1_{r/1} is the redline speed for the LP shaft. For stable operating conditions the high-pressure shaft first mode should be placed either 20% below or above the redline speed of the LP shaft satisfying (37):

$$\frac{0.55}{{( {HSR}_{LP} )}^{2}} + LST < - 0.2 OR \frac{0.55}{{( {HSR}_{LP} )}^{2}} + LST > 0 \qquad ( 37 )$$

LST accounts for the effects that the HPC pressure ratio and the HPC exit temperature can have on the first mode. T25 is the temperature in Rankine (R) at the high-pressure compressor (HPC) inlet. A good approximation for LST can be made in terms of only the T25, using (38):

$$LST = - 0.0023 * T 25 + 1.18 \qquad ( 38 )$$

where T25 is from 615 R to 855 R and LST is from −0.2 to −0.74.

Relationships (32) through (38) when used together individually or together (depending on application or changes made to a design) can identify an improved core accounting for characteristics associated with a higher power density (use of CMC material, increased number of HPC and/or HPT stages, increased bore height or length of the LP shaft) and bounding those features within constraints to avoid dynamic instability by interaction between one or more vibration modes of the LP shaft and HP shaft.

The foregoing indicates that employing CMC in the high-pressure turbine and/or the high-pressure compressor can benefit both the low-pressure shaft critical speed and the high-pressure shaft dynamics (e.g., the third order bending mode of the high-pressure shaft), or it can introduce unanticipated dynamic instability such as at a cruise condition. As explained earlier, CMC material used in the high-pressure turbine can provide favorable reductions in disk width (e.g., FIG. 45, width w) and increased disk bore radius (e.g., FIG. 45, radius r) which may both reduce L_{MSR} and increase D_{MSR}. The changes in core length can also benefit the third order bending mode of the high-pressure shaft.

Additionally, CMC material used in high-pressure compressor (particularly the aft-most stages) can produce a noticeable increase in the natural frequency of the HP shaft first and third order bending mode because this location corresponds to the maximum deflection points for the first mode and the third order bending mode (FIGS. 50A, 50C). Finally, as discussed earlier, CMC material used for the HPT rotor blades (first stage) can result in a width reduction of the HPT disk (e.g., FIG. 45, width w), as well as an increased bore radius for the HPT first stage disk bore (e.g., FIG. 45, radius r). These later changes to the HPT can improve the dynamics of the high-pressure shaft, including the third order bending mode of the high-pressure shaft and the MSR because of the weight reduction and reduced L_{MSR} (reduces length of HP shaft correspondingly, thereby moving the third order bending mode to a higher frequency), and D_{MSR} increase, respectively. Accordingly, the use of CMC material in the HPC, LPC, HPT, and/or the LPT provides for higher critical speeds and lower weights, thereby increasing the MSR, and, thus, providing a higher power density engine.

Furthermore, the inventors considered the effects that gearbox dynamics have on LP shaft dynamics. Based on the studies done, it was found unexpectedly that there are certain relationships between gearbox dynamics and LP shaft dynamics that influence the design of the coupling between the gearbox and the LP shaft. Embodiments taking into account gearbox dynamics in combination with CMC are found in FIGS. 53A to 53I (e.g., embodiments 93 to 100, 112, and 113).

TABLE 7 lists the bearing layout, the strength-to-weight ratio E/rho in inches−1, the effective thickness T_{eff} in inches, the critical speed corresponding to the shaft's fundamental mode in RPM, the OD linear speed at redline in ft/sec, the length-to-diameter ratio L_{MSR}/D_{MSR} (dimensionless), and MSR in (ft/sec)^{1/2} for all the embodiments (28 to 40) of Tables 3 to 5, as well as a number of additional embodiments (41 to 59). As noted above, L_{MSR}/D_{MSR} represents the ratio of the length over the outer diameter of the low-pressure/low-speed shaft. When the shaft has a variable diameter over its length, the outer diameter may be the diameter at the midshaft. E/rho represents the material composition of the shaft, and T_{eff} represents an effective wall thickness of the shaft. For shafts with variable thickness over their length, the wall thickness may be the thickness at the midshaft.

TABLE 7

| | | | | | L_{MSR}/ | Redline | |
|---|---|---|---|---|---|---|---|
| Embod- | | E/rho | T_{eff} | Mode | D_{MSR} | OD Speed | MSR |
| iment | Bearing Layout | in⁻¹ | in | RPM | in/in | ft/sec | (ft/sec)^{1/2} |
| 28 | 2-bearing outbound | 1.00E+8 | 0.35 | 4181 | 30 | 50 | 214 |
| 29 | inbound OTM | 1.27E+8 | 0.35 | 10263 | 22 | 123 | 247 |
| 30 | outbound OTM | 1.27E+8 | 0.35 | 6915 | 30 | 83 | 275 |
| 31 | inbound OTM | 1.00E+8 | 0.35 | 9001 | 22 | 108 | 231 |
| 32 | outbound OTM | 1.00E+8 | 0.35 | 6065 | 30 | 73 | 257 |
| 33 | inbound OTM | 1.00E+8 | 0.32 | 10039 | 22 | 121 | 242 |
| 34 | outbound OTM | 1.00E+8 | 0.32 | 6942 | 30 | 83 | 272 |
| 35 | 4-bearing straddle | 1.00E+8 | 0.35 | 7746 | 22 | 93 | 214 |
| 36 | 4-bearing straddle | 1.00E+8 | 0.32 | 8555 | 22 | 103 | 223 |
| 37 | 4-bearing straddle | 1.27E+8 | 0.35 | 8832 | 22 | 106 | 229 |
| 38 | 4-bearing straddle | 1.27E+8 | 0.32 | 9703 | 30 | 116 | 322 |
| 39 | inbound OTM | 1.27E+8 | 0.32 | 11386 | 22 | 137 | 257 |
| 40 | outbound OTM | 1.27E+8 | 0.32 | 7873 | 30 | 94 | 290 |
| 41 | 4-bearing outbound | 1.00E+8 | 0.35 | 6262 | 26 | 72 | 219 |
| 42 | 2-bearing aft | 1.27E+8 | 0.29 | 8255 | 21 | 109 | 215 |
| 43 | 2-bearing aft | 1.27E+8 | 0.31 | 13323 | 14 | 233 | 216 |
| 44 | 2-bearing aft | 1.27E+8 | 0.47 | 5667 | 23 | 83 | 210 |
| 45 | 2-bearing aft | 1.27E+8 | 0.29 | 6380 | 24 | 83 | 215 |
| 46 | 2-bearing aft | 1.27E+8 | 0.31 | 9821 | 17 | 154 | 216 |
| 47 | 2-bearing aft | 1.27E+8 | 0.47 | 4586 | 26 | 67 | 211 |
| 48 | 2-bearing aft | 1.00E+8 | 0.23 | 6380 | 24 | 84 | 217 |
| 49 | 2-bearing aft | 1.00E+8 | 0.25 | 13493 | 14 | 235 | 218 |
| 50 | 2-bearing aft | 1.00E+8 | 0.38 | 4586 | 27 | 62 | 210 |
| 51 | 2-bearing aft | 1.27E+8 | 0.29 | 6619 | 25 | 87 | 231 |
| 52 | 2-bearing aft | 1.27E+8 | 0.31 | 11065 | 17 | 176 | 232 |
| 53 | 2-bearing aft | 1.27E+8 | 0.47 | 4852 | 28 | 64 | 224 |
| 54 | 4-bearing straddle | 1.00E+8 | 0.29 | 6380 | 28 | 75 | 245 |
| 55 | inbound OTM | 1.00E+8 | 0.31 | 10666 | 19 | 165 | 247 |
| 56 | outbound OTM | 1.00E+8 | 0.47 | 4586 | 31 | 59 | 239 |
| 57 | 4-bearing straddle | 1.27E+8 | 0.23 | 6380 | 35 | 70 | 289 |
| 58 | inbound OTM | 1.27E+8 | 0.25 | 11410 | 22 | 181 | 294 |
| 59 | outbound OTM | 1.27E+8 | 0.38 | 5293 | 33 | 70 | 276 |

Embodiments 42 to 53 use a two-bearing aft layout. These embodiments differ in using composite materials, different shaft geometries, and variable thickness profiles.

Embodiments 42 to 44 use a composite material instead of steel alloy. These embodiments differ in shaft geometry, with different L_{MSR}/D_{MSR} ratios ranging from 41 to 50.

Embodiments 45 to 47 use a composite material instead of a steel alloy. These embodiments also differ from each other in shaft geometry (e.g., L_{MSR}/D_{MSR} ratio). These also differ from Embodiments 42 to 44, in being longer and thinner, resulting in a higher range of L_{MSR}/D_{MSR} ratio, from 17 to 26.

Embodiments 48 to 50 use a steel alloy, vary the shaft geometry (length and/or diameter), and have a concave thickness profile. These differ from each other in terms of their effective thickness. These embodiments may be compared to Embodiments 51 to 53, which use composite materials, vary the shaft geometry (length and/or diameter), and have a concave thickness profile.

Embodiments 54 to 59 use different bearing layouts. Embodiments 54 to 56 use steel alloy and have varying geometry. Embodiments 57 to 59 use composite material and a concave thickness profile, in addition to varying geometry.

FIGS. 53A to 53I, illustrate additional embodiments 60 to 113 taking into account the effects of the change in core dimensions (e.g., stages, lengths, diameters, etc.) and use of CMC described previously. The comparisons described below are in relation to the embodiments 28 to 59 described in TABLE 7.

Embodiments 60 to 63 use CMC for various components in the low-pressure turbine to help reduce the weight. These embodiments differ from each other in terms of bearing arrangements, and maintain the same stiffness as comparable embodiments 28, 29, and 35 (described above in TABLE 7) without CMC components. The use of CMC provides a reduced overhung weight, which has the effect of increasing the allowable OD speed at redline and/or enabling a higher MSR.

Embodiments 64 to 67 use CMC for various components in both the low-pressure turbine and the core (e.g., the high-pressure turbine). The use of CMC in the low-pressure turbine reduces the weight. The use of CMC in the core increases the bore radius of the core, thus allowing for an increase in diameter of the low-pressure shaft. That is, embodiments 64 to 67, have a larger radius for the low-speed shaft (3 inches) relative to embodiments without CMC in the core, for example, embodiments 28, 29, 35, and 60 to 63, which employ CMC only in the LPT (having a low-speed shaft diameter of 2.7 inches). Embodiment 66 further includes the addition of using bottle boring for a variable low-speed shaft thickness. The increased bore radius generally provides a lower L_{MSR}/D_{MSR} ratio (see for example, a comparison with embodiments 28, 29, 35, and 60 to 63) and/or enabling an increased MSR.

Embodiments 68 to 72 use different combinations of bottle boring and CMC for various components in both the LPT and the HPT. These embodiments have an even larger radius (4 inches) for the low-speed shaft, as well as a lower effective thickness (see, for example, a comparison with embodiments 28, 31, 35, and 64 to 67) generally resulting in a higher redline speeds and/or higher MSR. Embodiments 70 and 71 further including bottle boring. Embodiment 71 includes a 2+1 bearing system arrangement, such as described with respect to FIG. 39.

Embodiments 73 to 78 use different combinations of bottle boring and CMC for various components in both the LPT and the HPT. These embodiments have an even larger radius (4 inches) for the low-speed shaft, as well as a lower effective thickness (see, for example, a comparison with embodiments 28, 31, 35, and 64 to 67). Embodiments 73 to 78 further include a composite material shaft. Embodiments 73 to 78 include CMC in the HPT a manner that increases the bore radius (e.g., as described with respect to FIG. 45). Embodiment 75 further includes CMC in the HPT in a manner that decreases the core length (e.g., as described with respect to FIG. 34). This results in increased strength to weight ratio (1.3E+8 in). The combination of CMC in the LPT, CMC in the HPT, and a composite material shaft facilitates higher redline speeds and/or higher MSR.

Embodiment 79 used a three-bearing system, including bottling boring. Embodiments 80 to 86 begin with this as a baseline and adjust various factors. Each additional embodiment from embodiments 80 to 86 builds on the prior embodiment. Embodiment 80 adds CMC in the LPT to embodiment 79. Embodiment 81 adds CMC in another stage of the LPT to embodiment 80. Embodiment 82 includes a composite material in the low-speed shaft added to the embodiment 81. Embodiment 83 adds the core increase benefits of CMC in the HPT to embodiment 82. Embodiment 84 is based on embodiment 83 but with a 9 stage core. Embodiment 85 is based on embodiment 84, but with two bearings in the forward position and one bearing in the aft position on the LPT (e.g., the arrangement described with respect to FIG. 28B). Embodiment 86 adds another core stage to embodiment 85. These variations resulted in increased redline speed and/or higher MSR.

Embodiment 87 used a three-bearing system, including bottling boring. Embodiments 88 to 92 begin with this as a baseline and adjust various factors. Each additional embodiment from embodiments 88 to 92 builds on the prior embodiment. Embodiment 88 adds CMC in the LPT to embodiment 87. Embodiment 89 includes a composite material in the low-speed shaft added to the embodiment 88. Embodiment 90 adds the core increase benefits of CMC in the HPT to embodiment 89. Embodiment 91 is based on embodiment 90 but with a 9-stage core. Embodiment 92 is based on embodiment 91, but with two bearings in the forward position and one bearing in the aft position on the LPT (e.g., the arrangement described with respect to FIG. 39). These variations resulted in increased redline speed and/or higher MSR.

Embodiments 93 to 96 all use CMC in the LPT and CMC in the HPT to take advantage of the core increase benefits. Embodiments 93 and 94 use a four-bearing system and include bottle boring. Embodiments 95 and 96 include a two-bearing system having a forward inbound bearing and an aft outbound bearing and include bottle boring. The embodiments of 93 to 96 further have differences in terms of stiffness (e.g., decoupler shear stiffness and/or decoupler moment stiffness). As shown, embodiments 94 and 96 achieve a greater shear stiffness than embodiments 93 and 95, respectively, generally resulting in substantially higher redline speeds and/or higher MSR.

Embodiments 97 to 100 all use CMC in the LPT and CMC in the HPT to take advantage of the core increase benefits. Embodiments 97 and 98 use a four-bearing system and include bottle boring. Embodiments 99 and 100 include a two-bearing system having a forward inbound bearing and an aft outbound bearing and include bottle boring. The embodiments of 97 to 100 further have differences in terms of stiffness (e.g., decoupler shear stiffness). As shown, embodiments 98 and 100 achieve a greater shear stiffness than embodiments 97 and 99, respectively, generally resulting in substantially higher redline speeds and/or higher MSR. Embodiments 97 to 100 differ from embodiments 93 to 96 in that the embodiments have a smaller LP shaft diameter.

In each of the embodiments 101 to 111, L_{MSR} is determined based on the relationship (6) described previously. In embodiments 101 to 104 CMC is not used. In embodiments 105 to 111, CMC is used in the LPT and the HPT. In embodiments 105 to 107, the CMC is used in the HPT to increase the core radius. In the embodiments 108 to 111 the CMC is used in the HPT to decrease the core length and increase the core radius. As shown in embodiments 101 to 111, this allows increase in redline speeds and/or MSR.

Embodiments 112 and 113 both use CMC in the LPT and CMC in the HPT to take advantage of the core increase benefits. Embodiments 112 and 113 both include a two-bearing system having a forward inbound bearing and an aft outbound bearing and include bottle boring. The embodiments differ in terms of stiffness (e.g., decoupler shear stiffness and/or decoupler moment stiffness). As shown, embodiment 113 achieves a greater shear stiffness and greater moment stiffness than embodiment 112, generally resulting in a substantially higher redline speed and/or higher MSR.

Based on the experimentation described above, the inventors identified embodiments with MSR between two hundred and three thirty hundred (ft/sec)⁻¹ and OD redline speeds ranging from fifty to two hundred sixty ft/sec and with L_{MSR}/D_{MSR} ratio ranging from twelve to thirty-seven were possible and indicated noticeable improvements in subcritical range when the power turbine shaft incorporates the various aspects of the disclosure.

TABLE 8 summarizes examples of different operating ranges for embodiments, such as the embodiments listed in TABLE 7. For example, an embodiment can be configured with a L_{MSR}/D_{MSR} ranging between twelve and twenty may have an OD speed between one hundred and fifty and two hundred and fifty ft/sec, and a corresponding range of MSR between one hundred ninety and two hundred forty-five (ft/sec)^{1/2}. As another example, an embodiment can be configured with a L_{MSR}/D_{MSR} ranging between sixteen and thirty may have an OD speed between seventy-five and one hundred seventy-five ft/sec, and a corresponding range of MSR between two hundred twelve and two hundred sixty (ft/sec)^{1/2}. As still another example, an embodiment can be configured with a L_{MSR}/D_{MSR} ranging between twenty-six and thirty-seven may have an OD speed between sixty and ninety ft/sec, and a corresponding range of MSR between two hundred forty-seven and two hundred eighty-seven ft/sec)^{1/2}. These low, nominal, and high ranges as summarized in TABLE 8 are general examples, and individual embodiments may exceed these values.

TABLE 8

| | L_{MSR}/ | Redline OD | |
|---|---|---|---|
| Example Limits | D_{MSR} | Speed | MSR |
| and Ranges | (in/in) | (ft/sec) | (ft/sec)^{1/2} |
| Low limit | 12 | 250 | 190 |
| | 20 | 150 | 245 |
| Nominal limit | 16 | 175 | 212 |
| | 30 | 75 | 260 |
| High Limit | 26 | 90 | 247 |
| | 37 | 60 | 287 |

According to additional embodiments, CMCs were evaluated in the low-pressure turbine and high-pressure turbine, in combination with different bearing configurations, different effective shaft thicknesses, different shaft diameters, different shaft materials (e.g., composites), and a variety of combinations thereof, in order to determine which combinations would work best for a given architecture and need, as well as taking the competing engineering requirements into account. Some of these embodiments are summarized in FIGS. 53A to 53I.

FIGS. 53A to 53I list the bearing layout, the strength-to-weight ratio E/rho in inches⁻¹, the effective thickness T_{eff} in inches, the critical speed corresponding to the shaft's fundamental mode in RPM, the OD linear speed at redline in ft/sec, the length-to-diameter ratio L_{MSR}/D_{MSR} (dimensionless), and MSR in (ft/sec)^{1/2} for a number of additional embodiments (60 to 86). As noted above, L_{MSR}/D_{MSR} represents the ratio of the length over the outer diameter. When the shaft has a variable diameter over its length, the outer diameter may be the diameter at the midshaft. E/rho represents the material composition of the shaft, and T_{eff} represents an effective wall thickness of the shaft. For shafts with variable thickness over their length, the wall thickness may be the thickness at the midshaft.

Additional embodiments of engine architectures utilizing CMC are detailed in Table 9. As discussed above, CMC materials are currently being considered for use various in higher temperature sections of turbofan engines, such as airfoils (e.g., turbines, and vanes), combustors, shrouds and other like components, that would benefit from the lighter-weight and higher temperature capability these materials can offer. The additional embodiments summarized in Table 9 include CMC materials in certain components of a turbofan engine. For example, and referring to FIG. 24 above, embodiment 114 includes the combustor 2262 with the outer combustion chamber liner 2264 and the inner combustion chamber liner 2266 both formed from CMC materials and defining the combustion chamber 2268. In some embodiments, at least one of the outer combustion chamber liner 2264 or the inner combustion chamber liner 2266 is formed from the CMC material. In some embodiments (e.g., embodiments 115 to 119), CMC components are static components of the HPT, such as the HP turbine stator vanes 2216 (FIG. 24), the shroud 2218 (FIG. 24), or both the HP turbine stator vane 2216 and the shroud 2218. In some embodiments (e.g., embodiments 120 to 124), CMC components are static components of the LPT, such as the LP turbine stator vanes 2224 (FIG. 29), the shroud 2226 (FIG. 29), or both the LP turbine stator vane 2224 and the shroud 2226. In some embodiments (e.g., embodiments 119, 124, 125, 126, 127, and 128), CMC components are rotating components, such as the HP turbine rotor blades 2212 (FIGS. 24 and 29), the shroud 2214 (FIG. 29), the LP turbine rotor blades 2220 (FIG. 29), or the shroud 2222 (FIG. 29). In embodiments (e.g., embodiments 115, 117, 119, and 125), the CMC materials are used in the first stage of the HPT, with the downstream stages being formed from non-CMC materials such as metal alloys. In other embodiments (e.g., embodiments 116, 118, and 126), the CMC materials are used in the first stage of the HPT and downstream stages, such as the second stage of the HPT. Similarly, in embodiments (e.g., embodiments 120, 122, 124, and 127), the CMC materials are used in the first stage of the LPT, with the downstream stages being formed from non-CMC materials such as metal alloys. In other embodiments (e.g., embodiments 121, 123, and 128), the CMC materials are used in the first stage of the LPT and one or more downstream stages, such as the second stage of the LPT.

Each of the embodiments in Table 9 are based on embodiment 79 in FIG. 53C and discussed above but include components that are formed from CMC materials as indicated in the description of the embodiment in Table 9. In the embodiments below, the other components can be made from non-ceramic matrix composite materials, such as a metal alloys, including but not limited to titanium, nickel, and/or cobalt based superalloys (e.g., those available under the name Inconel® available from Special Metals Corporation).

TABLE 9

| Embodiment | Description |
|---|---|
| 114 | Combustor with CMC inner combustion |
| | chamber liner and CMC outer combustion |
| | chamber liner |
| 115 | HPT with the stage 1 nozzle having a CMC |
| | stator vanes |
| 116 | HPT with the stage 1 nozzle having CMC stator |
| | vanes and the stage 2 nozzle having CMC stator |
| | vanes |
| 117 | HPT with the stage 1 nozzle having a CMC |
| | shroud |
| 118 | HPT with the stage 1 nozzle having a CMC |
| | shroud and the stage 2 nozzle having a CMC |
| | shroud |
| 119 | HPT with the stage 1 nozzle having a CMC |
| | shroud and CMC stator vanes and with the stage |
| | 1 turbine having CMC rotor blades |
| 120 | LPT with the stage 1 nozzle having a CMC |
| | stator vanes |
| 121 | HPT with the stage 1 nozzle having CMC stator |
| | vanes and the stage 2 nozzle having CMC stator |
| | vanes |
| 122 | LPT with the stage 1 nozzle having a CMC |
| | shroud |
| 123 | LPT with the stage 1 nozzle having a CMC |
| | shroud and the stage 2 nozzle having a CMC |
| | shroud |
| 124 | LPT with the stage 1 nozzle having a CMC |
| | shroud and CMC stator vanes and with the stage |
| | 1 turbine having CMC rotor blades |
| 125 | HPT with stage 1 turbine blades having CMC |
| | shroud |
| 126 | HPT with the stage 1 turbine blades having |
| | CMC shroud and the stage 2 turbine blades |
| | having CMC shroud |
| 127 | LPT with stage 1 turbine blades having CMC |
| | shroud |
| 128 | LPT with the stage 1 turbine blades having |
| | CMC shroud and the stage 2 turbine blades |
| | having CMC shroud |

As mentioned above, during normal operation of an engine, the shaft can become critical or supercritical due to conditions in which the shaft operates at speeds greater than the maximum operating speed and less than the redline speed (e.g., 5% to 10% less than the redline speed) and the bearing damper assembly 4100 (FIG. 52) loses oil or the oil becomes too hot (e.g., the oil temperature is greater than the operating temperature range). In such instances, the shaft mode, and, thus, the margin to redline and the MSR for a particular shaft configuration changes as compared to the shaft mode and the MSR during normal conditions for that particular shaft configuration. Table 10 lists embodiments in which the shaft may become critical or supercritical and the shaft mode is within 5% to 10% of the redline speed.

TABLE 10

| | | | | | L_{MSR}/ | Redline | |
|---|---|---|---|---|---|---|---|
| Embod- | | E/rho | T_{eff} | Mode | D_{MSR} | OD Speed | MSR |
| iment | Bearing Layout | in⁻¹ | in | RPM | in/in | ft/sec | (ft/sec)^{1/2} |
| 129 | 2-bearing outbound | 1.00E+8 | 0.29 | 6619 | 25 | 87 | 231 |
| 130 | 2-bearing outbound | 1.27E+8 | 0.31 | 11065 | 16 | 176 | 207 |
| 131 | 2-bearing outbound | 1.27E+8 | 0.47 | 4852 | 28 | 64 | 224 |
| 132 | 4-bearing straddle | 1.27E+8 | 0.23 | 6380 | 35 | 70 | 289 |
| 133 | inbound OTM | 1.27E+8 | 0.25 | 10666 | 22 | 169 | 284 |
| 134 | inbound OTM | 1.27E+8 | 0.38 | 4586 | 33 | 61 | 257 |
| 135 | 2-bearing outbound | 1.00E+8 | 0.29 | 7083 | 25 | 93 | 238 |
| 136 | 2-bearing outbound | 1.27E+8 | 0.31 | 11839 | 16 | 188 | 214 |
| 137 | 2-bearing outbound | 1.27E+8 | 0.47 | 5191 | 28 | 69 | 232 |
| 138 | 4-bearing straddle | 1.27E+8 | 0.23 | 6827 | 35 | 75 | 299 |
| 139 | inbound OTM | 1.27E+8 | 0.25 | 11412 | 22 | 181 | 294 |
| 140 | inbound OTM | 1.27E+8 | 0.38 | 4907 | 33 | 65 | 266 |
| 141 | 2-bearing outbound | 1.00E+8 | 0.29 | 6255 | 25 | 83 | 224 |
| 142 | 2-bearing outbound | 1.27E+8 | 0.31 | 10456 | 16 | 166 | 201 |
| 143 | 2-bearing outbound | 1.27E+8 | 0.47 | 4585 | 28 | 61 | 218 |
| 144 | 4-bearing straddle | 1.27E+8 | 0.23 | 6029 | 35 | 66 | 281 |
| 145 | inbound OTM | 1.27E+8 | 0.25 | 10079 | 22 | 160 | 276 |
| 146 | inbound OTM | 1.27E+8 | 0.38 | 4334 | 33 | 58 | 250 |

Embodiments 129 to 134 show embodiments in which the oil to the bearing dampers has an oil temperature within the operating temperature range (e.g., within 180° F. to 220° F.).

Embodiments 135 to 140 correspond to embodiments 129 to 134, respectively, and show embodiments in which the oil to the bearing dampers is cold, particularly, in which the oil temperature is between ninety degrees Fahrenheit (90°) and one hundred fifty degrees Fahrenheit (150° F.). The oil can fall into this range, for example, at locations with low ambient temperatures (e.g., less than 32° F.) such that the oil temperature does not increase into the operating temperature range during high power (e.g., takeoff) conditions. In particular, such a condition can occur if there is an insufficient amount of time between the turbofan engine powering on and takeoff such that the oil does not warm up into the operating temperature range prior to takeoff. As shown in Table 10, the shaft mode and the MSR increase for embodiments 135 to 140 as compared to the shaft mode and the MSR of the respective embodiments 129 to 134. Thus, the cold oil increases the shaft mode and the MSR, while MSR remains within the acceptable range of two hundred (ft/sec)^{1/2} to three hundred (ft/sec)^{1/2}.

Embodiments 141 to 146 correspond to embodiments 129 to 134, respectively, and show embodiments in which the oil to the bearing dampers is hot, particularly, in which the oil temperature is greater than three hundred degrees Fahrenheit (300°). The oil can increase greater than the operating temperature range (e.g., greater than 300° F.), for example, at locations with relatively high ambient temperatures. In particular, such a condition can occur if there is insufficient cooling for the oil (e.g., an insufficient amount of oil, an insufficient amount of fuel, or an insufficient amount of air is routed through the heat exchanger to cool the oil to the operating temperature range). As shown in Table 10, the shaft mode and the MSR decrease for embodiments 141 to 146 as compared to the shaft mode and the MSR of the respective embodiments 129 to 134. Thus, the hot oil decreases the shaft mode and the MSR, while MSR remains within the acceptable range of two hundred (ft/sec)^{1/2} to three hundred (ft/sec)^{1/2}.

Accordingly, the ranges disclosed herein for the MSR relationship accounts for such instances when the shaft becomes critical or supercritical during operation of the engine by placing the shaft mode in a range of 5% to 10% less than the redline speed of the shaft.

Table 11 lists embodiments showing the effects of particular ratios of the length L_{FAN BRG} to the length L_{MSR} and the ratio of the length L_{AFT BRG} to the length L_{MSR} (FIGS. 39, 40, and 42).

TABLE 11

| | | | | L_{MSR}/ | Redline | | L_{FAN BRG}/ | L_{AFT BRG}/ |
|---|---|---|---|---|---|---|---|---|
| Embod- | L_{MSR} | D_{MSR} | Mode | D_{MSR} | OD Speed | MSR | L_{MSR} | L_{MSR} |
| iment | in | in | RPM | in/in | ft/sec | (ft/sec)^{1/2} | in/in | in/in |
| 147 | 74.6 | 3.03 | 6619 | 25 | 87 | 231 | 0.15 | 0 |
| 148 | 56.8 | 3.64 | 11065 | 16 | 176 | 207 | 0.2 | 0 |
| 149 | 84.9 | 3.04 | 4852 | 28 | 64 | 224 | 0.25 | 0 |
| 150 | 75.9 | 3.03 | 6380 | 25 | 84 | 230 | 0.35 | 0.1 |
| 151 | 62.2 | 3.03 | 10380 | 21 | 137 | 241 | 0.4 | 0.1 |
| 152 | 87.0 | 2.52 | 4586 | 35 | 50 | 245 | 0.5 | 0.2 |
| 153 | 75.9 | 3.03 | 6780 | 25 | 89 | 237 | 0.35 | 0.2 |
| 154 | 62.2 | 3.03 | 10840 | 21 | 143 | 246 | 0.4 | 0.2 |
| 155 | 87.0 | 2.52 | 5293 | 35 | 58 | 263 | 0.5 | 0.3 |

In Table 11, embodiments 147 to 155 correspond to a direct drive engine (e.g., no power gearbox). In particular, embodiments 147 to 149 correspond to embodiments 51 to 53 in Table 7. In embodiments 147 to 149, the engine is a three bearing configuration that includes a fan bearing (e.g., the fifth bearing 3210 in FIG. 39), a forward LP shaft bearing (e.g., the first bearing 3202 in FIG. 39), and an aft LP shaft bearing (e.g., the fourth bearing 3208 in FIG. 39). In this way, there is no aft bearing (e.g., the fifth bearing 3310 in FIG. 40) aft of the aft LP shaft bearing such that L_{AFT} BRG/L_{MSR} is zero. In embodiments 147 to 149, L_{FAN BRG}/L_{MSR} is in a range of 0.15 to 0.30 and L_{MSR}/D_{MSR} in a range of fifteen (15) to twenty-eight (28).

Embodiments 150 to 152 correspond to embodiments 147 to 149, but include a gearbox assembly (e.g., the gearbox assembly 255) and an aft bearing (e.g., the fifth bearing 3310 in FIG. 40) in addition to the fan bearing. In embodiments 150 to 152, L_{MSR}/D_{MSR} is in a range of fifteen (15) to thirty-five (35) such that the LP shaft is more slender than the LP shaft of embodiments 147 to 149. Further, in embodiments 150 to 152, L_{FAN BRG}/L_{MSR} is in a range of 0.35 to 0.50. In this way, the section of the LP shaft from the fan bearing to the forward LP shaft bearing has little effect on the shaft mode. L_{AFT} BRG/L_{MSR} is in a range of 0.10 to 0.20.

Embodiments 153 to 155 also correspond to embodiments 147 to 149, and include a gearbox assembly (e.g., the gearbox assembly 255) and an aft bearing (e.g., the fifth bearing 3310 in FIG. 40) in addition to the fan bearing. In embodiments 153 to 155, L_{MSR}/D_{MSR} is in a range of fifteen (15) to thirty-five (35) such that the LP shaft is more slender than the LP shaft of embodiments 147 to 149. Further, in embodiments 153 to 155, L_{FAN BRG}/L_{MSR} is in a range of 0.35 to 0.50. In this way, the section of the LP shaft from the fan bearing to the forward LP shaft bearing has little effect on the shaft mode. L_{AFT} BRG/L_{MSR} is in a range of 0.20 to 0.30.

As shown in Table 11, increasing L_{AFT BRG} increases the shaft mode, and, thus, increases the MSR (e.g., in embodiments 150 to 152 and 153 to 155), as compared to embodiments (e.g., embodiments 147 to 149) without a gearbox assembly (e.g., such that the fan bearing is closer to the forward LP shaft bearing) and without an aft bearing.

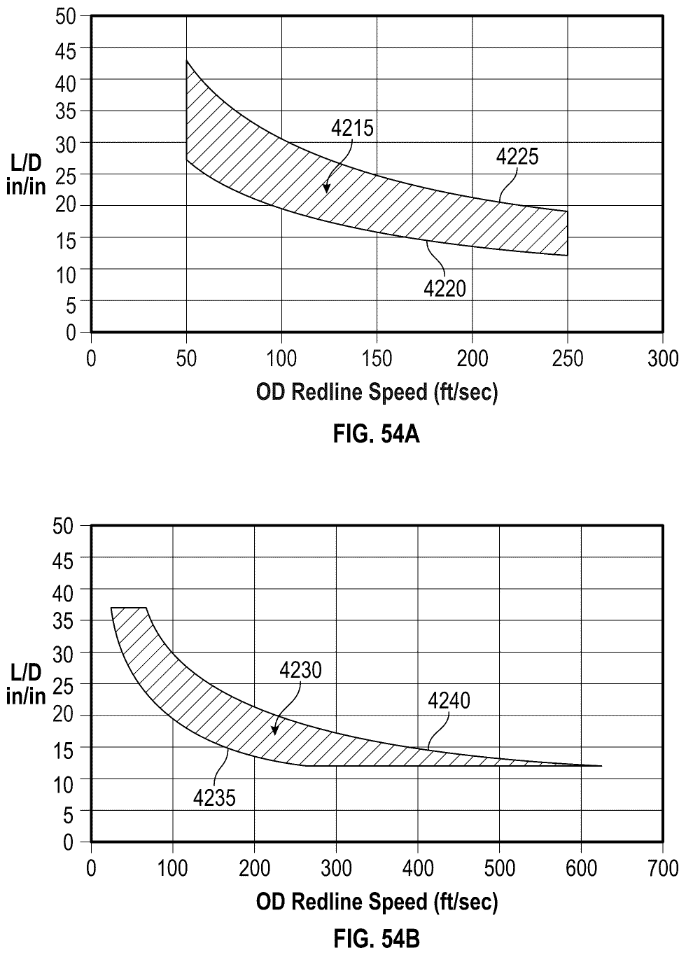

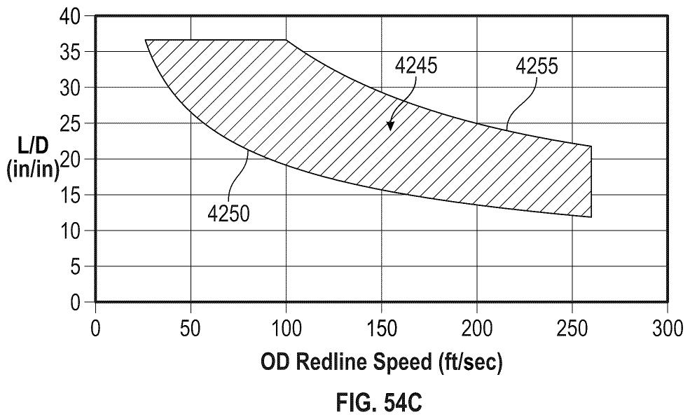

FIG. 54A illustrates acceptable ranges for LP shaft redline speeds for a MSR region 4215, ranging from 200 (ft/sec)⁻¹ (curve 4220) to 300 (ft/sec)⁻¹ (curve 4225), for redline speeds from fifty to two hundred and fifty feet per second and shafts having an L_{MSR}/D_{MSR} from twelve to forty-three.

FIG. 54B illustrates acceptable ranges for LP shaft redline speeds for a MSR region 4230, ranging from 200 (ft/sec)⁻¹ (curve 4235) to 300 (ft/sec)⁻¹ (curve 4240), for L_{MSR}/D_{MSR} ratios from twelve to thirty-seven and redline speeds from thirty to six hundred thirty feet per second.

FIG. 54C illustrates acceptable ranges for LP shaft redline speeds for a MSR region 4245, ranging from one hundred ninety (ft/sec)⁻¹ (curve 4250) to three hundred thirty (ft/sec)⁻¹ (curve 4255), for L_{MSR}/D_{MSR} between twelve and thirty-seven. Examples are provided in TABLE 7 and FIGS. 53A to 53I. FIG. 54C shows an MSR ranging from one hundred ninety (ft/sec)⁻¹ (curve 4250) to three hundred thirty (ft/sec)⁻¹ (curve 4255), for L_{MSR}/D_{MSR} ratios from twelve to thirty-seven and redline speeds from fifty to two hundred and sixty feet per second.

In view of the foregoing objectives, in at least certain embodiments, a propulsion system is configured to define an MSR greater than one hundred ninety (ft/sec)^{1/2}, such as greater than two hundred (ft/sec)^{1/2}, such as at least two hundred thirty-five (ft/sec)^{1/2}, up to at least three hundred thirty (ft/sec)^{1/2}.

In view of the foregoing objectives, in at least certain embodiments, a propulsion system is configured to define an L_{MSR}/D_{MSR} ratio greater than twelve, such as greater than sixteen, such as at least twenty-six, up to at least thirty-seven.

In view of the foregoing objectives, in at least certain embodiments, a propulsion system is configured to define an OD redline speed greater than sixty ft/se, such as greater than seventy-five ft/sec, such as at least one hundred and fifty ft/sec, up to at least two hundred and sixty ft/sec.

Based on the teachings in this disclosure, and without limiting the disclosure to only those embodiments explicitly shown, it will be understood how both the manner and the degree to which a modification of shaft length, diameter, material composition, bearings configuration, and thickness profile affects the MSR, and, additionally, the competing requirements, or requirements for a turbofan engine architecture (e.g., available spacing/packaging, clearance, sump location, lubrication, etc.) for a given MSR.

Referring to Table 12, embodiments 156 to 171 may represent any of the turbofan engines detailed herein. In Table 12, the MEFR values were determined on relationship (31) described above and using units of inches for the lengths and thicknesses, inches to the fourth power for the area moment of inertia, and pounds per square inch (psi) for the modulus of elasticity.

TABLE 12

| | I_{B} | T_{D} | T_{E} | T_{B} | L_{B} | L_{Total} | E | MEFR |
|---|---|---|---|---|---|---|---|---|
| Emb. | (in⁴) | (in) | (in) | (in) | (in) | (in) | (psi) | (lbf-in²) |
| 156 | 2.91 | 0.48 | 0.90 | 0.23 | 37.20 | 92.74 | 2.9E+07 | 121.42 |
| 157 | 6.00 | 0.83 | 1.17 | 0.83 | 44.70 | 111.30 | 3.1E+07 | 104.09 |
| 158 | 3.49 | 0.83 | 0.90 | 0.53 | 37.20 | 92.74 | 1.5E+07 | 39.64 |
| 159 | 2.33 | 0.48 | 1.17 | 0.16 | 44.70 | 111.30 | 3.6E+07 | 210.47 |
| 160 | 2.91 | 0.58 | 1.08 | 0.28 | 44.64 | 111.29 | 3.1E+07 | 127.70 |
| 161 | 4.46 | 0.38 | 0.72 | 0.18 | 29.76 | 74.19 | 2.9E+07 | 185.89 |
| 162 | 2.91 | 0.48 | 0.90 | 0.23 | 37.20 | 92.74 | 3.0E+07 | 124.35 |
| 163 | 5.44 | 0.61 | 0.90 | 0.61 | 40.00 | 95.00 | 2.9E+07 | 97.25 |
| 164 | 3.49 | 0.83 | 0.90 | 0.42 | 37.20 | 92.74 | 3.1E+07 | 102.21 |
| 165 | 6.00 | 0.83 | 1.17 | 0.83 | 44.70 | 101.20 | 3.6E+07 | 135.12 |
| 166 | 2.91 | 0.48 | 0.90 | 0.23 | 37.20 | 92.74 | 1.5E+07 | 62.80 |
| 167 | 2.91 | 0.23 | 0.90 | 0.23 | 37.2 | 92.74 | 2.9E+07 | 103.02 |
| 168 | 2.91 | 0.37 | 1.50 | 0.23 | 41.00 | 94.00 | 3.0E+07 | 192.04 |
| 169 | 1.53 | 0.34 | 0.97 | 0.15 | 39.3 | 86.00 | 3.0E+07 | 111.94 |
| 170 | 2.00 | 0.36 | 1.37 | 0.17 | 40.03 | 92.50 | 3.0E+07 | 163.51 |
| 171 | 2.25 | 0.37 | 1.46 | 0.19 | 39.79 | 94.00 | 3.0E+07 | 170.53 |

The designs herein provide the aforementioned benefits including achieving an increased natural frequency of the low-pressure shaft. During the course of creating those designs, the present disclosure provides the ranges that would be suitable to achieve the desired results, while taking into account the operational requirements and the packaging requirements for the low-pressure shaft. The values for terms used to compute the MEFR value are strictly limited to certain ranges based on the various designs evaluated where those values had varied. Otherwise, the engine made may not produce favorable results.

The shaft redline speeds provided herein are in a range of 5,000 RPM to 13,000 RPM. In particular, the shaft redline speeds are in a range of 10,000 RPM to 13,000 RPM for a three-stage low-pressure turbine. The shaft redline speeds are in a range of 9,000 RPM to 10,200 RPM for a four-stage low-pressure turbine.

The MEFR is only valid for an area moment of inertia of the second section 4022 (I_{B}) in a range of 1.5 in⁴ to 6.0 in⁴. Values of I_{B} that fall within this range provide for a shaft that has a balance between reducing the overall weight of the shaft by having less material and increasing the stiffness and the resistance to bending of the shaft. Values of I_{B} less than 1.5 in⁴ account for the second section 4022 having less material, and therefore, less weight, but a lesser resistance to bending. Values of I_{B} greater than 6.0 in⁴ account for the second section 4022 having a greater stiffness and resistance to bending, but more material and a greater weight.

The MEFR is only valid for a thickness of the fourth section 4026 (T_{D}) in a range of 0.23 in to 0.83 in. Values of T_{D} that fall within this range provide for a fourth section 4026 that reduces overall weight of the shaft and increases stiffness and resistance to bending such that the shaft, in combination with the bearing configuration, acts as a fixed-fixed beam. Values of T_{D} less than 0.23 in reduce material and weight but also have a lesser stiffness. Value of T_{D} greater than 0.83 have a greater stiffness, but increased material and weight.

The MEFR is only valid for a thickness of the fifth section 4028 (T_{E}) in a range of 0.72 in to 1.17 in. Values of T_{E} that fall within this range provide for a fifth section 4028 that reduces overall weight of the shaft and increases stiffness and resistance to bending such that the shaft, in combination with the bearing configuration, acts as a fixed-fixed beam. Values of T_{E} less than 0.72 in reduce material and weight but also have a lesser stiffness. Value of T_{E} greater than 1.17 in have a greater stiffness, but increased material and weight.

The MEFR is only valid for a thickness of the second section 4022 (T_{B}) in a range of 0.15 in to 0.83 in. Values of T_{B} that fall within this range provide for a second section 4022 that reduces overall weight of the shaft and increases stiffness and resistance to bending such that the shaft has an increased natural frequency (e.g., the first order bending mode). Values of T_{B} less than 0.15 in reduce material and weight but also have a lesser stiffness. Value of T_{B} greater than 0.83 have a greater stiffness, but increased material and weight.

The MEFR is only valid for a length of the second section 4022 (L_{B}) in a range of 29.7 in to 44.7 in. Values of L_{B} that fall within this range provide for a balance between increasing the natural frequency, having a shaft length that accommodates the LPT stages, and reduces material and weight. Values of L_{B} less than 29.7 in provide for an increased natural frequency, but require other, thicker sections of the shaft to be longer, and, therefore, increases the overall weight of the shaft. Value of L_{B} greater than 44.7 in have less overall shaft weight but reduced natural frequency.

The MEFR is only valid for a total length of the low-pressure shaft (L_{Total}) in a range of 74.1 in to 111.3 in. Values of L_{Total} that fall within this range provide for a balance between increasing the natural frequency, having a shaft length that accommodates the LPT stages, and reduces material and weight. Values of L_{Total} less than 74.1 in provide for an increased natural frequency, but cannot accommodate the LPT stages. Value of L_{Total} greater than 111.3 in have less overall shaft weight but reduced natural frequency.

The MEFR is only valid for a modulus of elasticity (E) in a range of 1.5E+07 psi to 3.6E+07 psi. The modulus of elasticity (E) is given based on the material of the low-pressure shaft. Materials considered herein include steel, nickel, titanium, cobalt, and metal alloys, as detailed above.

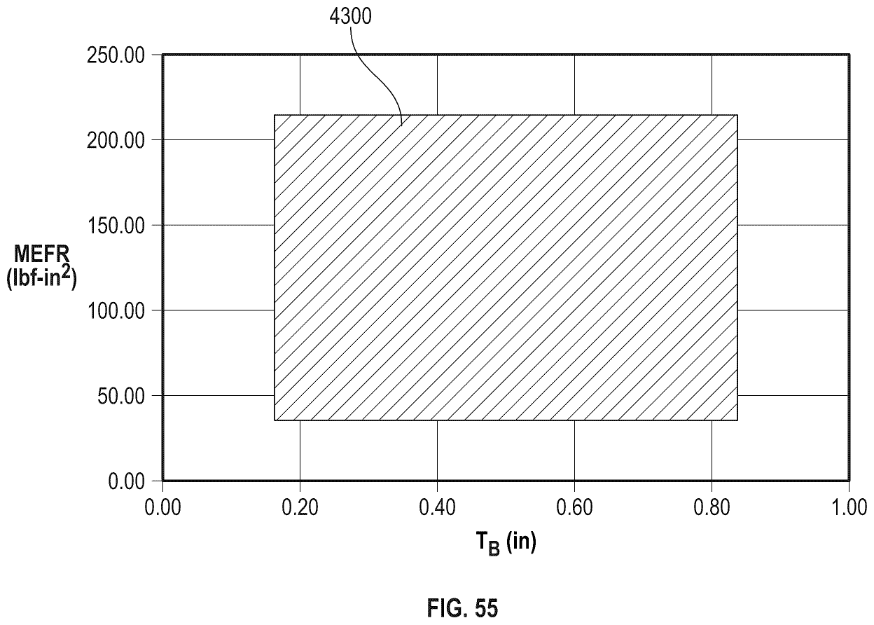

FIG. 55 represents, in graph form, MEFR as a function of T_{B}, according to the present disclosure. An area 4300 represents the boundaries of the MEFR. The MEFR is in a range of 39 lbf-in² to 211 lbf-in² for a second section thickness T_{B} of the second section 4022 in a range of 0.15 in to 0.83 in. The range of the MEFR identifies the specific architectures (section thicknesses and bearing configuration) that avoid exciting the first-order bending mode of the low-pressure shaft, while accounting for higher shaft speeds and fitting the low-pressure shaft within the limited space of smaller core engines. In particular, if the MEFR is within the area 4300, then the low-pressure shaft satisfies the operational requirements (e.g., the low-pressure shaft has a natural frequency that is at least 10% greater than the redline speed) and the packaging requirements (e.g., the low-pressure shaft has a length and a diameter that fit within the limited space of the turbofan engine) could be distinguished from architectures that do not satisfy these requirements. As such, low-pressure shafts having a MEFR that falls within the area 4300 account for the operational requirements and the packaging requirements without exciting the first-order bending mode of the low-pressure shaft. If the MEFR is outside of the area 4300, then the low-pressure shaft either will not rotate at the required speed, will not fit within the limited space within the HP shaft without exciting the HP shaft dynamics, or will have a natural frequency that is less than 10% greater than the redline speed such that the first-order bending mode will be excited during operation. Thus, the low-pressure shaft having a MEFR within the area 4300 provides for an improved low-pressure shaft architecture that is capable of rotating at the greater speeds of next generation engines, while accounting for the limited space of such engines and without exciting the first-order bending mode of the low-pressure shaft during operation.

Further aspects are provided by the subject matter of the following clauses.

A turbofan engine for an aircraft, the turbofan engine including a fan having a plurality of fan blades, each of the plurality of fan blades being rotatable about a pitch axis, and a fan actuation system including one or more actuators for rotating the plurality of fan blades about the pitch axis and one or more radial thrust bearings, wherein the fan actuation system is characterized by a fan actuation system envelope in a range from 300 to 1860, the fan actuation system envelope being given by:

$$\frac{{N}_{FB} \times {D}_{FT} \times {M}_{cruise}}{( \frac{{R}_{TB}}{{N}_{FB}} )}$$

wherein N_{FB} is a number of the plurality of fan blades, D_{FT} is a fan tip diameter of the plurality of fan blades, M_{cruise} is a Mach number of the aircraft at cruise operating conditions, and R_{TB} is a thrust bearing radius of the one or more radial thrust bearings.

A turbofan engine for an aircraft, the turbofan engine including a fan having a plurality of fan blades, each of the plurality of fan blades being rotatable about a pitch axis, a nacelle that circumferentially surrounds the fan, and a fan actuation system including one or more actuators for rotating the plurality of fan blades about the pitch axis and one or more radial thrust bearings, wherein the fan actuation system is characterized by a fan actuation system envelope in a range from 300 to 660, the fan actuation system envelope being given by:

$$\frac{{N}_{FB} \times {D}_{FT} \times {M}_{cruise}}{( \frac{{R}_{TB}}{{N}_{FB}} )}$$

wherein N_{FB} is a number of the plurality of fan blades, D_{FT} is a fan tip diameter of the plurality of fan blades, M_{cruise} is a Mach number of the aircraft at cruise operating conditions, and R_{TB} is a thrust bearing radius of the one or more thrust bearings.

A turbofan engine for an aircraft, the turbofan engine including a fan having a plurality of fan blades, the fan being an open fan, and each of the plurality of fan blades being rotatable about a pitch axis, and a fan actuation system including one or more actuators for rotating the plurality of fan blades about the pitch axis and one or more radial thrust bearings, wherein the fan actuation system is characterized by a fan actuation system envelope in a range from 660 to 1860, the fan actuation system envelope being given by:

$$\frac{{N}_{FB} \times {D}_{FT} \times {M}_{cruise}}{( \frac{{R}_{TB}}{{N}_{FB}} )}$$

wherein N_{FB} is a number of the plurality of fan blades, D_{FT} is a fan tip diameter of the plurality of fan blades, M_{cruise} is a Mach number of the aircraft at cruise operating conditions, and R_{TB} is a thrust bearing radius of the one or more radial thrust bearings.

The turbofan engine of any preceding clause, wherein the fan actuation system includes a hydraulic system that supplies hydraulic fluid for rotating the plurality of fan blades about the pitch axis.

The turbofan engine of any preceding clause, wherein the cruise operating conditions occur at a mid-level power range of the turbofan engine.

The turbofan engine of the preceding clause, wherein the mid-level power range is 30% to 85% of a sea level static maximum engine rated thrust for the turbofan engine.

The turbofan engine of any preceding clause, wherein the turbofan engine is rated for use on a regional aircraft having a maximum takeoff thrust of 10,000 lbf to 20,000 lbf.

The turbofan engine of any preceding clause, wherein the turbofan engine is rated for use on a narrow body aircraft having a maximum takeoff thrust of 15,000 lbf to 30,000 lbf.

The turbofan engine of any preceding clause, wherein the turbofan engine is rated for use on a wide body aircraft having a maximum takeoff thrust of 40,000 lbf to 110,000 lbf.

The turbofan engine of any preceding clause, wherein N_{FB} is in a range from ten to eighteen.

The turbofan engine of any preceding clause, wherein N_{FB} is in a range from ten to fourteen.

The turbofan engine of any preceding clause, wherein D_{FT} is in a range from 84.0 inches to 180.0 inches.

The turbofan engine of any preceding clause, wherein D_{FT} is in a range from 84.0 inches to 120.0 inches.

The turbofan engine of any preceding clause, wherein D_{FT} is in a range from 120.0 inches to 168.0 inches.

The turbofan engine of any preceding clause, wherein R_{TB} is in a range from 14 inches to 27 inches.

The turbofan engine of any preceding clause, wherein R_{TB} is in a range from 14 inches to 19 inches.

The turbofan engine of any preceding clause, wherein R_{TB} is in a range from 19 inches to 27 inches.

The turbofan engine of any preceding clause, wherein M_{cruise} is in a range from 0.7 to 0.92.

The turbofan engine of any preceding clause, wherein M_{cruise} is in a range from 0.75 to 0.9.

The turbofan engine of any preceding clause, wherein M_{cruise} is in a range from 0.8 to 0.88.

The turbofan engine of any preceding clause, wherein the fan actuation system includes a pressurized pneumatic chamber that is filled with a pressurized gas that biases the plurality of fan blades to a feather position.

The turbofan engine of any preceding clause, wherein the fan actuation system is devoid of counterweights for reducing inertial loading associated with rotation of fan blades.

The turbofan engine of any preceding clause, further including a core cowl, wherein the turbofan engine has a longitudinal centerline axis, and the core cowl is annular about the longitudinal centerline axis.

The turbofan engine of the preceding clause, further including a core inlet that is annular about the longitudinal centerline axis.

The turbofan engine of any preceding clause, further including a gearbox assembly, wherein the turbine section includes a low-pressure shaft, and the fan has a fan shaft that is coupled to the low-pressure shaft through the gearbox assembly.

The turbofan engine of the preceding clause, wherein the gearbox assembly has a gear ratio in a range 3.5:1 to 5:1 for a ducted engine.

The turbofan engine of any preceding clause, wherein the gearbox assembly has a gear ratio in a range from 4:1 and 10:1 for an unducted fan engine.

The turbofan engine of any preceding clause, wherein the low-pressure shaft, the gearbox assembly, and the fan shaft are coaxial along the longitudinal centerline axis.

The turbofan engine of any preceding clause, wherein the fan actuation system envelope is in a range from 660 to 1020.

The turbofan engine of any preceding clause, the fan actuation system envelope being in a range from 300 to 660.

The turbofan engine of any preceding clause, the fan actuation system envelope being in a range from 660 to 1860.

The turbofan engine of any preceding clause, the fan actuation system envelope being in a range from 660 to 1020.

The turbofan engine of any preceding clause, further including a nacelle that circumferentially surrounds the fan.

The turbofan engine of any preceding clause, wherein the turbofan engine is an open fan engine.

The turbofan engine of any preceding clause, further including a fan hub, the plurality of fan blades extending radially from the fan hub.

The turbofan engine of any preceding clause, the fan actuation system being disposed within the fan hub.

The turbofan engine of any preceding clause, further including a compressor section, a combustor, and a turbine section.

The turbofan engine of any preceding clause, the compressor section including a low-pressure compressor and a high-pressure compressor, and the turbine section including a high-pressure turbine and a low-pressure turbine.

The turbofan engine of any preceding clause, further including a high-pressure shaft that couples the high-pressure compressor and the high-pressure turbine.

The turbofan engine of any preceding clause, further including a low-pressure shaft that couples the low-pressure compressor and the low-pressure turbine.

The turbofan engine of any preceding clause, the low-pressure shaft being disposed through the high-pressure shaft.

The turbofan engine of any preceding clause, the gearbox assembly including a gear assembly including a plurality of gears.

The turbofan engine of any preceding clause, the gearbox assembly including one or more gear bearings.

The turbofan engine of any preceding clause, each of the plurality of fan blades extending from a fan root to a fan tip.

The turbofan engine of any preceding clause, the fan tip diameter DFT being defined from the longitudinal centerline axis to the fan tip of each of the plurality of fan blades.

The turbofan engine of any preceding clause, the fan actuation system including a trunnion mechanism that includes a plurality of trunnions, each fan blade being disposed in a respective trunnion.

The turbofan engine of any preceding clause, the fan blades extending from a disk.

The turbofan engine of any preceding clause, the disk including a plurality of disk segments.

The turbofan engine of any preceding clause, each fan blade being coupled to a respective disk segment at the trunnion mechanism.

The turbofan engine of any preceding clause, the plurality of trunnions being rotatable to rotate the plurality of fan blades about the pitch axis.

The turbofan engine of any preceding clause, the fan actuation system including one or more actuators coupled to the plurality of trunnions.

The turbofan engine of any preceding clause, the fan actuation system including a plurality of trunnion links and a unison ring, the plurality of trunnion links being coupled to the plurality of trunnions and to the unison ring.

The turbofan engine of any preceding clause, the plurality of trunnion links including a plurality of forward trunnion links and a plurality of aft trunnion links.

The turbofan engine of any preceding clause, the unison ring including a plurality of unison rings including a forward unison ring that is positioned forward of the plurality of trunnions and an aft unison ring that is disposed aft of the plurality of trunnions.

The turbofan engine of any preceding clause, the plurality of forward trunnion links being coupled to the forward unison ring.

The turbofan engine of any preceding clause, the plurality of aft trunnion links being coupled to the aft unison ring.

The turbofan engine of any preceding clause, further including a plurality of pins that couple the plurality of trunnion links to the unison ring.

The turbofan engine of any preceding clause, the plurality of forward trunnion links being coupled to the forward unison ring by a plurality of forward pins.

The turbofan engine of any preceding clause, the plurality of aft trunnion links being coupled to the aft unison ring by a plurality of aft pins.

The turbofan engine of any preceding clause, the one or more actuators including a hydraulic cylinder and a piston disposed within the hydraulic cylinder.

The turbofan engine of the preceding clause, the hydraulic cylinder and the piston being movable along an axial direction.

The turbofan engine of any preceding clause, the forward unison ring being coupled to the hydraulic cylinder such that the forward unison ring moves when the hydraulic cylinder moves.

The turbofan engine of any preceding clause, the aft unison ring being coupled to the piston such that the aft unison ring moves as the piston moves.

The turbofan engine of any preceding clause, the fan actuation system rotating the plurality of fan blades between a first end position and a second end position.

The turbofan engine of any preceding clause, the first end position being a feather position in which the plurality of fan blades is substantially aligned with a flow of a volume of air across the plurality of fan blades.

The turbofan engine of the preceding clause, the fan actuation system rotating the plurality of fan blades to any position between the first end position and the second end position.

The turbofan engine of any preceding clause, the second end positioned being a reverse position in which the plurality of fan blades exceeds a plane that is transverse to the longitudinal centerline axis by at least 30° to assist with braking the aircraft.

The turbofan engine of any preceding clause, the fan actuation system moving the hydraulic cylinder in a first direction and moving the piston in a second direction.

The turbofan engine of any preceding clause, movement of the hydraulic cylinder and the piston causing the plurality of fan blades to rotate about the pitch axis.

The turbofan engine of any preceding clause, the one or more actuators including a piston retainer.

The turbofan engine of the preceding clause, the piston retainer being coupled to the fan shaft such that the piston retainer rotates with the fan shaft.

The turbofan engine of any preceding clause, the piston being coupled to the piston retainer such that the piston rotates with the piston retainer.

The turbofan engine of any preceding clause, the hydraulic cylinder being axially slidable with respect to the piston and the piston retainer.

The turbofan engine of any preceding clause, the piston retainer including a first portion, a second portion that extends radially outward from the first portion, and a third portion that extends axially from the second portion.

The turbofan engine of any preceding clause, the third portion of the piston retainer being coupled to the fan shaft.

The turbofan engine of any preceding clause, the piston being coupled to, and extending forward from, the first portion of the piston retainer.

The turbofan engine of any preceding clause, the hydraulic cylinder being disposed radially outward of the piston retainer and the piston.

The turbofan engine of any preceding clause, the hydraulic cylinder being coupled to the unison ring at a joint such that movement of the hydraulic cylinder in the axial direction causes the plurality of fan blades to pitch about the pitch axis.

The turbofan engine of any preceding clause, the hydraulic cylinder having a first portion, a second portion, a third portion, and a fourth portion.

The turbofan engine of the preceding clause, the first portion of the hydraulic cylinder extending generally in the axial direction and being coupled to the unison ring at the joint.

The turbofan engine of any preceding clause, the second portion of the hydraulic cylinder being disposed radially inward of the first portion and being coupled to the first portion and to the unison ring at the joint.

The turbofan engine of any preceding clause, the third portion of the hydraulic cylinder extending forward from the joint.

The turbofan engine of any preceding clause, the fourth portion of the hydraulic cylinder being coupled to, and extending axially within, the third portion of the hydraulic cylinder.

The turbofan engine of any preceding clause, the first portion of the hydraulic cylinder being sealingly engaged with the third portion of the piston retainer.

The turbofan engine of any preceding clause, the second portion of the piston retainer being sealingly engaged with the first portion of the hydraulic cylinder.

The turbofan engine of any preceding clause, the piston being sealingly engaged with the second portion and the fourth portion of the hydraulic cylinder.

The turbofan engine of any preceding clause, the fan actuation system including one or more hydraulic chambers defined between the hydraulic cylinder, the piston, and the piston retainer.

The turbofan engine of the preceding clause, the one or more hydraulic chambers including a first hydraulic chamber, a second hydraulic chamber, and a third hydraulic chamber.

The turbofan engine of any preceding clause, the first hydraulic chamber being defined between first portion of the hydraulic cylinder, the second portion of the piston retainer, and the third portion of the piston retainer.

The turbofan engine of any preceding clause, the second hydraulic chamber being defined between the first portion of the hydraulic cylinder, the second portion of the hydraulic cylinder, the first portion of the piston retainer, and the second portion of the piston retainer.

The turbofan engine of any preceding clause, the third hydraulic chamber being defined between the second portion of the hydraulic cylinder, an aft end of the piston, and the first portion of the piston retainer,

The turbofan engine of any preceding clause, the first hydraulic chamber and the third hydraulic chamber being supplied with a hydraulic fluid at a first pressure, and the second hydraulic chamber being supplied with the hydraulic fluid at a second pressure.

The turbofan engine of any preceding clause, the first pressure and the second pressure being increased or decreased to cause the hydraulic cylinder to move axially forward or axially rearward to rotate the plurality of fan blades about the pitch axis.

The turbofan engine of any preceding clause, the fan actuation system including a hydraulic system that supplies the hydraulic fluid to the one or more hydraulic chambers.

The turbofan engine of any preceding clause, the hydraulic system including a pump to supply the hydraulic fluid to the one or more hydraulic chambers.

The turbofan engine of the preceding clause, the hydraulic system including an oil transfer bearing including a fixed portion with a plurality of fluid lines coupled to the pump.

The turbofan engine of the preceding clause, the oil transfer bearing including a sleeve that is rotatable about the fixed portion.

The turbofan engine of any preceding clause, the plurality of fluid lines including a first fluid line in fluid communication with the first hydraulic chamber, a second fluid line in fluid communication with the second hydraulic chamber, and a third fluid line in fluid communication the third hydraulic chamber.

The turbofan engine of any preceding clause, the plurality of fluid lines being coupled to the sleeve.

The turbofan engine of any preceding clause, the first hydraulic chamber and the third hydraulic chamber being provided with the hydraulic fluid at the same first pressure.

The turbofan engine of any preceding clause, the pump supplying the hydraulic fluid to the first hydraulic chamber and the third hydraulic chamber to increase the first pressure P1 and supplying the hydraulic fluid to the second hydraulic chamber to decrease the second pressure P2, to move the hydraulic cylinder in the rearward direction to rotate the plurality of fan blades towards the reverse position.

The turbofan engine of any preceding clause, the pump supplying the hydraulic fluid to the second hydraulic chamber to increase the second pressure P2 and supplying the hydraulic fluid to the first hydraulic chamber and the third hydraulic chamber to decrease the first pressure P1, to move the hydraulic cylinder in the forward direction to rotate the plurality of fan blades towards the feather position.

The turbofan engine of any preceding clause, the one or more actuators further including a pressurized pneumatic chamber filled with a pressurized gas to bias the hydraulic cylinder to move the plurality of fan blades to the feather position.

The turbofan engine of any preceding clause, a pressure of the pressurized gas in the pressurized pneumatic chamber being in a range from 720 psi to 920 psi.

The turbofan engine of any preceding clause, the pressurized gas in the pressurized pneumatic chamber causing the hydraulic cylinder to move rearward when the hydraulic system or the turbofan engine fails or is shut down.

The turbofan engine of any preceding clause, the fan actuation system not including a pitch lock device.

The turbofan engine of any preceding clause, the one or more radial thrust bearings being disposed between the plurality of trunnions and the disk such that the plurality of trunnions rotates with respect to the disk to rotate the plurality of fan blades about the pitch axis.

The turbofan engine of any preceding clause, the one or more radial thrust bearings transmitting a load from the plurality of fan blades to a static structure of the turbofan engine.

A turbofan engine for an aircraft, the turbofan engine including a fan having a plurality of fan blades coupled to a fan shaft having one or more fan bearings, each of the plurality of fan blades being rotatable about a pitch axis and extending from a fan hub, and a fan actuation system disposed within the fan hub and including one or more actuators for rotating the plurality of fan blades about the pitch axis and one or more radial thrust bearings, wherein the fan actuation system is characterized by a fan actuation system length envelope in a range from 8.5 to 24, the fan actuation system length envelope being given by

$$\frac{{N}_{FB} \times {D}_{FT}}{{L}_{AXIAL} \times ( \frac{{R}_{TB}}{{N}_{FB}} )} ,$$

wherein N_{FB} is a number of the plurality of fan blades, D_{FT} is a fan tip diameter of the plurality of fan blades, R_{TB} is a thrust bearing radius of the one or more radial thrust bearings, and L_{AXIAL} is an axial length from a fan hub tip of the fan hub to the one or more fan bearings.

The turbofan engine of the preceding clause, wherein the fan actuation system includes a pressurized pneumatic chamber that is filled with a pressurized gas that biases the plurality of fan blades to a feather position.

The turbofan engine of any preceding clause, wherein the fan actuation system includes one or more counterweights for reducing inertial loading associated with rotation of the plurality of fan blades.

The turbofan engine of any preceding clause, further including a core cowl, wherein the turbofan engine has a longitudinal centerline axis, and the core cowl is annular about the longitudinal centerline axis wherein the core cowl includes a core inlet that is annular about the longitudinal centerline axis.

The turbofan engine of any preceding clause, wherein the fan actuation system includes a hydraulic system that supplies hydraulic fluid for rotating the plurality of fan blades about the pitch axis.

The turbofan engine of any preceding clause, wherein N_{FB} is in a range from ten to eighteen.

The turbofan engine of any preceding clause, wherein N_{FB} is in a range from ten to fourteen.

The turbofan engine of any preceding clause, wherein D_{FT} is in a range from 84.0 inches to 180.0 inches.

The turbofan engine of any preceding clause, wherein D_{FT} is in a range from 84.0 inches to 120.0 inches.

The turbofan engine of any preceding clause, wherein D_{FT} is in a range from 120.0 inches to 180.0 inches.

The turbofan engine of any preceding clause, wherein R_{TB} is in a range from 12 inches to 27 inches.

The turbofan engine of any preceding clause, wherein R_{TB} is in a range from 12 inches to 19 inches.

The turbofan engine of any preceding clause, wherein R_{TB} is in a range from 19 inches to 27 inches.

The turbofan engine of any preceding clause, wherein L_{AXIAL} is given by A_{FH}+A_{FB}, A_{FH} being a fan hub axial length from the fan hub tip to the pitch axis of the plurality of fan blades and A_{FB} being a fan bearing axial length from the pitch axis of the plurality of fan blades to the one or more fan bearings.

The turbofan engine of any preceding clause, wherein A_{FH} is in a range from 25 inches to 75 inches.

The turbofan engine of any preceding clause, wherein A_{FB} is in a range from 16 inches to 23 inches.

The turbofan engine of any preceding clause, wherein the fan actuation system has a fan actuation system axial length (A_{FAS}) defined from an axially forward-most surface of the fan actuation system to the pitch axis of the plurality of fan blades, A_{FAS} being a maximum of 80% A_{FH}.

A turbofan engine for an aircraft, the turbofan engine including a fan having a plurality of fan blades coupled to a fan shaft having one or more fan bearings, each of the plurality of fan blades being rotatable about a pitch axis and extending from a fan hub, a nacelle that circumferentially surrounds the fan, and a fan actuation system disposed within the fan hub and including one or more actuators for rotating the plurality of fan blades about the pitch axis and one or more radial thrust bearings, wherein the fan actuation system is characterized by a fan actuation system length envelope in a range from 8.5 to 13, the fan actuation system length envelope being given by

$$\frac{{N}_{FB} \times {D}_{FT}}{{L}_{AXIAL} \times ( \frac{{R}_{TB}}{{N}_{FB}} )} ,$$

wherein N_{FB} IS a number of the plurality of fan blades, D_{FT} is a fan tip diameter of the plurality of fan blades, R_{TB} is a thrust bearing radius of the one or more radial thrust bearings, and L_{AXIAL} is an axial length from a fan hub tip of the fan hub to the one or more fan bearings, wherein L_{AXIAL} is given by A_{FH}+A_{FB}, A_{FH} being a fan hub axial length from the fan hub tip to the pitch axis of the plurality of fan blades and A_{FB} being a fan bearing axial length from the pitch axis of the plurality of fan blades to the one or more fan bearings, A_{FH} is in a range from 25 inches to 40 inches, and A_{FB} is in a range from 17 inches to 20 inches.

A turbofan engine for an aircraft, the turbofan engine including a fan having a plurality of fan blades coupled to a fan shaft having one or more fan bearings, the fan being an open fan, and each of the plurality of fan blades being rotatable about a pitch axis and extending from a fan hub, and a fan actuation system disposed within the fan hub and including one or more actuators for rotating the plurality of fan blades about the pitch axis and one or more radial thrust bearings, wherein the fan actuation system is characterized by a fan actuation system length envelope in a range from 8.5 to 24, the fan actuation system length envelope being given by

$$\frac{{N}_{FB} \times {D}_{FT}}{{L}_{AXIAL} \times ( \frac{{R}_{TB}}{{N}_{FB}} )} ,$$

wherein N_{FB} is a number of the plurality of fan blades, D_{FT} is a fan tip diameter of the plurality of fan blades, R_{TB} is a thrust bearing radius of the one or more radial thrust bearings, and L_{AXIAL} is an axial length from a fan hub tip of the fan hub to the one or more fan bearings, and R_{TB} is a thrust bearing radius of the one or more radial thrust bearings, wherein L_{AXIAL} is given by A_{FH}+A_{FB}, A_{FH} being a fan hub axial length from the fan hub tip to the pitch axis of the plurality of fan blades and A_{FB} being a fan bearing axial length from the pitch axis of the plurality of fan blades to the one or more fan bearings, A_{FH} is in a range from 25 inches to 75 inches, and A_{FB} is in a range from 16 inches to 23 inches, and D_{FT} is in a range from 120.0 inches to 180.0 inches.

The turbofan engine of the preceding clause, wherein R_{TB} is in a range from 12 inches to 27 inches.

A turbofan engine for an aircraft, the turbofan engine including a fan having a plurality of fan blades coupled to a fan disk that is drivingly coupled to a fan shaft, the fan disk defining a disk bore, a fan hub that directs an airflow through the plurality of fan blades, each of the plurality of fan blades being rotatable about a pitch axis and extending from the fan hub, one or more fan bearings that support rotation of the fan shaft, the one or more fan bearings being positioned radially outward of the disk bore, wherein a fan bearing radius ratio is in a range from 1.0 to 2.75, and a fan actuation system disposed within the fan hub and including one or more actuators for rotating the plurality of fan blades about the pitch axis and one or more radial thrust bearings, wherein the fan actuation system is characterized by a fan actuation system length envelope in a range from 8.5 to 24, the fan actuation system length envelope being given by:

$$\frac{{N}_{FB} \times {D}_{FT}}{{L}_{AXIAL} \times ( \frac{{R}_{TB}}{{N}_{FB}} )} ,$$

wherein N_{FB} is a number of the plurality of fan blades, D_{FT} is a fan tip diameter of the plurality of fan blades, R_{TB} is a thrust bearing radius of the one or more radial thrust bearings, and L_{AXIAL} is an axial length from a fan hub tip of the fan hub to the one or more fan bearings.

The turbofan engine of the preceding clause, wherein the turbofan engine has a fan hub radius ratio in a range from 0.1 to 0.4.

The turbofan engine of any preceding clause, wherein the one or more radial thrust bearings are tapered roller bearings.

The turbofan engine of any preceding clause, wherein the one or more fan bearings are positioned axially aft of the fan disk.

The turbofan engine of any preceding clause, wherein the fan disk extends between an inner surface and an outer surface, the one or more fan bearings being positioned radially outward of the outer surface.

The turbofan engine of any preceding clause, wherein the one or more fan bearings include at least one of roller bearings or ball bearings.

The turbofan engine of any preceding clause, wherein the ball bearings include four-point contact ball bearings.

The turbofan engine of any preceding clause, further including a compressor section, a combustion section, and a turbine section downstream of the fan, the turbine section having an input shaft that couples the compressor section to the turbine section, and a gearbox assembly, the fan shaft being drivingly coupled to the input shaft through the gearbox assembly.

The turbofan engine of any preceding clause, wherein the one or more fan bearings are positioned axially between the fan disk and the gearbox assembly.

The turbofan engine of any preceding clause, wherein the one or more fan bearings are positioned radially outward of the gearbox assembly.

A turbofan engine for an aircraft, the turbofan engine including a fan having a plurality of fan blades coupled to a fan disk that is drivingly coupled to a fan shaft, the fan disk defining a disk bore, and the fan being an open fan, a fan hub that directs an airflow through the plurality of fan blades, each of the plurality of fan blades being rotatable about a pitch axis and extending from the fan hub, one or more fan bearings that support rotation of the fan shaft, the one or more fan bearings being positioned radially outward of the disk bore, wherein a fan bearing radius ratio is in a range from 1.0 to 2.75, and a fan actuation system disposed within the fan hub and including one or more actuators for rotating the plurality of fan blades about the pitch axis and one or more radial thrust bearings, wherein the fan actuation system is characterized by a fan actuation system length envelope in a range of 8.5 to 24, the fan actuation system length envelope being given by

$$\frac{{N}_{FB} \times {D}_{FT}}{{L}_{AXIAL} \times ( \frac{{R}_{TB}}{{N}_{FB}} )} ,$$

wherein N_{FB} is a number of the plurality of fan blades, D_{FT} is a fan tip diameter of the plurality of fan blades, R_{TB} is a thrust bearing radius of the one or more radial thrust bearings, and L_{AXIAL} is an axial length from a fan hub tip of the fan hub to the one or more fan bearings, and R_{TB} is a thrust bearing radius of the one or more radial thrust bearings, wherein L_{AXIAL} is given by A_{FH}+A_{FB}, A_{FH} being a fan hub axial length from the fan hub tip to the pitch axis of the plurality of fan blades and A_{FB} being a fan bearing axial length from the pitch axis of the plurality of fan blades to the one or more fan bearings, A_{FH} is in a range of 25 inches to 85 inches, and A_{FB} is in a range of 10 inches to 23 inches, and D_{FT} is in a range of 120.0 inches to 192.0 inches.

The turbofan engine of the preceding clause, wherein the turbofan engine has a fan hub radius ratio in a range from 0.1 to 0.4.

The turbofan engine of any preceding clause, wherein the one or more radial thrust bearings are tapered roller bearings.

The turbofan engine of any preceding clause, wherein the one or more fan bearings are positioned axially aft of the fan disk.

The turbofan engine of any preceding clause, wherein the fan disk extends between an inner surface and an outer surface, the one or more fan bearings being positioned radially outward of the outer surface.

The turbofan engine of any preceding clause, wherein the one or more fan bearings include at least one of roller bearings or ball bearings.

The turbofan engine of any preceding clause, wherein the ball bearings include four-point contact ball bearings.

The turbofan engine of any preceding clause, further including a compressor section, a combustion section, and a turbine section downstream of the fan, the turbine section having an input shaft that couples the compressor section to the turbine section, and a gearbox assembly, the fan shaft being drivingly coupled to the input shaft through the gearbox assembly.

The turbofan engine of any preceding clause, wherein the one or more fan bearings are positioned axially between the fan disk and the gearbox assembly.

The turbofan engine of any preceding clause, wherein the one or more fan bearings are positioned radially outward of the gearbox assembly.

A turbofan engine for an aircraft, the turbofan engine including a fan having a plurality of fan blades coupled to a fan shaft having one or more fan bearings, each of the plurality of fan blades being rotatable about a pitch axis and extending from a fan hub, a compressor section, a combustion section, and a turbine section, the compressor section having a high-pressure compressor defining a high-pressure compressor exit area (A_{HPCExit}), and a fan actuation system disposed within the fan hub and including one or more actuators for rotating the plurality of fan blades about the pitch axis and one or more radial thrust bearings, wherein the fan actuation system is characterized by a fan actuation system length envelope in a range of 8.5 to 24, the fan actuation system length envelope being given by:

$$\frac{{N}_{FB} \times {D}_{FT}}{{L}_{AXIAL} \times ( \frac{{R}_{TB}}{{N}_{FB}} )}$$

wherein N_{FB} is a number of the plurality of fan blades, D_{FT} is a fan tip diameter of the plurality of fan blades, R_{TB} is a thrust bearing radius of the one or more radial thrust bearings, and L_{AXIAL} is an axial length from a fan hub tip of the fan hub to the one or more fan bearings, wherein the turbofan engine defines a redline exhaust gas temperature (EGT), a total sea level static thrust output (Fn_{Total}), and a corrected specific thrust, wherein the corrected specific thrust is greater than or equal to 42 and less than or equal to 90, the corrected specific thrust being given by: Fn_{Total}×EGT/(A_{HPCExit}²×1000).

The turbofan engine of the preceding clause, wherein the EGT is greater than 1000 degrees Celsius and less than 1300 degrees Celsius.

The turbofan engine of any preceding clause, wherein the EGT is greater than 1100 degree Celsius and less than 1250 degrees Celsius.

The turbofan engine of any preceding clause, wherein the EGT is greater than 1150 degree Celsius and less than 1250 degrees Celsius.

The turbofan engine of any preceding clause, wherein the EGT is greater than 1000 degree Celsius and less than 1300 degrees Celsius, and wherein the corrected specific thrust is greater than or equal to 45.

The turbofan engine of any preceding clause, wherein the EGT is greater than 1000 degree Celsius and less than 1300 degrees Celsius, and wherein the corrected specific thrust is greater than or equal to 50.

The turbofan engine of any preceding clause, wherein the turbine section includes a high-pressure turbine having a first stage of high-pressure turbine rotor blades, and wherein the turbofan engine further includes a cooled cooling air system in fluid communication with the first stage of high-pressure turbine rotor blades.

The turbofan of any preceding clause, wherein the cooled cooling air system is further in fluid communication with the high-pressure compressor for receiving an airflow from the high-pressure compressor, and wherein the cooled cooling air system further includes a heat exchanger in thermal communication with the airflow for cooling the airflow.

The turbofan engine of any preceding clause, wherein when the turbofan engine is operated at a takeoff power level, the cooled cooling air system is configured to provide a temperature reduction of a cooling airflow equal to at least 15% of the EGT and up to 45% of the EGT.

The turbofan of any preceding clause, wherein when the turbofan engine is operated at a takeoff power level, the cooled cooling air system is configured to receive between 2.5% and 35% of an airflow through a core duct of the turbofan engine at an inlet to the compressor section.

The turbofan engine of any preceding clause, wherein the fan is a primary fan, and the turbofan engine further including an inlet duct downstream of the primary fan and upstream of the compressor section, and a secondary fan located within the inlet duct.

The turbofan engine of any preceding clause, further including a bypass passage, wherein the turbofan engine defines a third stream extending from a location downstream of the secondary fan to the bypass passage.

The turbofan engine of any preceding clause, wherein the secondary fan is a single stage secondary fan.

A turbofan engine for an aircraft, the turbofan engine including a fan having a plurality of fan blades coupled to a fan shaft having one or more fan bearings, each of the plurality of fan blades being rotatable about a pitch axis and extending from a fan hub, a nacelle that circumferentially surrounds the fan; a compressor section, a combustion section, and a turbine section, the compressor section having a high-pressure compressor defining a high-pressure compressor exit area (A_{HPCExit}), and a fan actuation system disposed within the fan hub and including one or more actuators for rotating the plurality of fan blades about the pitch axis and one or more radial thrust bearings, wherein the fan actuation system is characterized by a fan actuation system length envelope in a range of 8.5 to 13, the fan actuation system length envelope being given by:

$$\frac{{N}_{FB} \times {D}_{FT}}{{L}_{AXIAL} \times ( \frac{{R}_{TB}}{{N}_{FB}} )}$$

wherein N_{FB} is a number of the plurality of fan blades, D_{FT} is a fan tip diameter of the plurality of fan blades, R_{TB} is a thrust bearing radius of the one or more radial thrust bearings, and L_{AXIAL} is an axial length from a fan hub tip of the fan hub to the one or more fan bearings, wherein L_{AXIAL} is given by A_{FH}+A_{FB}, A_{FH} being a fan hub axial length from the fan hub tip to the pitch axis of the plurality of fan blades and A_{FB} being a fan bearing axial length from the pitch axis of the plurality of fan blades to the one or more fan bearings, A_{FH} is in a range of 25 inches to 40 inches, and A_{FB} is in a range of 17 inches to 20 inches, wherein the turbofan engine defines a redline exhaust gas temperature (EGT), a total sea level static thrust output (Fn_{Total}), and a corrected specific thrust, wherein the corrected specific thrust is greater than or equal to 42 and less than or equal to 90, the corrected specific thrust being given by: Fn_{Total}×EGT/(A_{HPCExit}²×1000).

A turbofan engine for an aircraft, the turbofan engine including a fan having a plurality of fan blades coupled to a fan shaft having one or more fan bearings, the fan being an open fan, and each of the plurality of fan blades being rotatable about a pitch axis and extending from a fan hub, a compressor section, a combustion section, and a turbine section, the compressor section having a high-pressure compressor defining a high-pressure compressor exit area (A_{HPCExit}), and a fan actuation system disposed within the fan hub and including one or more actuators for rotating the plurality of fan blades about the pitch axis and one or more radial thrust bearings, wherein the fan actuation system is characterized by a fan actuation system length envelope in a range of 8.5 to 24, the fan actuation system length envelope being given by:

$$\frac{{N}_{FB} \times {D}_{FT}}{{L}_{AXIAL} \times ( \frac{{R}_{TB}}{{N}_{FB}} )} ,$$

wherein N_{FB} is a number of the plurality of fan blades, D_{FT} is a fan tip diameter of the plurality of fan blades, R_{TB} is a thrust bearing radius of the one or more radial thrust bearings, and L_{AXIAL} is an axial length from a fan hub tip of the fan hub to the one or more fan bearings, and R_{TB} is a thrust bearing radius of the one or more radial thrust bearings, wherein L_{AXIAL} is given by A_{FH}+A_{FB}, A_{FH} being a fan hub axial length from the fan hub tip to the pitch axis of the plurality of fan blades and A_{FB} being a fan bearing axial length from the pitch axis of the plurality of fan blades to the one or more fan bearings, A_{FH} is in a range of 25 inches to 75 inches, and A_{FB} is in a range of 16 inches to 23 inches, and D_{FT} is in a range of 120.0 inches to 180.0 inches, wherein the turbofan engine defines a redline exhaust gas temperature (EGT), a total sea level static thrust output (Fn_{Total}), and a corrected specific thrust, wherein the corrected specific thrust is greater than or equal to 42 and less than or equal to 90, the corrected specific thrust being given by: Fn_{Total}×EGT/(A_{HPCExit}²×1000).

The turbofan engine of the preceding clause, wherein the fan is a primary fan, and the turbofan engine further includes an inlet duct downstream of the primary fan and upstream of the compressor section, and a secondary fan located within the inlet duct.

The turbofan engine of any preceding clause, wherein the EGT is greater than 1000 degrees Celsius and less than 1300 degrees Celsius.

The turbofan engine of any preceding clause, wherein the turbine section includes a high-pressure turbine having a first stage of high-pressure turbine rotor blades, and wherein the turbofan engine further includes a cooled cooling air system in fluid communication with the first stage of high-pressure turbine rotor blades.

The turbofan of any preceding clause, wherein the cooled cooling air system is further in fluid communication with the high-pressure compressor for receiving an airflow from the high-pressure compressor, and wherein the cooled cooling air system further includes a heat exchanger in thermal communication with the airflow for cooling the airflow.

The turbofan engine of any preceding clause, wherein when the turbofan engine is operated at a takeoff power level, the cooled cooling air system is configured to provide a temperature reduction of a cooling airflow equal to at least 15% of the EGT and up to 45% of the EGT.

A turbofan engine for an aircraft, the turbofan engine including a fan having a plurality of fan blades coupled to a fan shaft having one or more fan bearings, each of the plurality of fan blades being rotatable about a pitch axis and extending from a fan hub, a compressor section, a combustion section, and a turbine section, the turbine section having a low-pressure shaft that drivingly couples the fan to the turbine section, and a fan actuation system disposed within the fan hub and including one or more actuators for rotating the plurality of fan blades about the pitch axis and one or more radial thrust bearings, wherein the fan actuation system is characterized by a fan actuation system length envelope in a range of 8.5 to 24, the fan actuation system length envelope being given by:

$$\frac{{N}_{FB} \times {D}_{FT}}{{L}_{AXIAL} \times ( \frac{{R}_{TB}}{{N}_{FB}} )} ,$$

wherein N_{FB} is a number of the plurality of fan blades, D_{FT} is a fan tip diameter of the plurality of fan blades, R_{TB} is a thrust bearing radius of the one or more radial thrust bearings, and L_{AXIAL} is an axial length from a fan hub tip of the fan hub to the one or more fan bearings, wherein the low-pressure shaft is characterized by a midshaft rating (MSR) between two hundred (ft/sec)^{1/2} and three hundred thirty (ft/sec)^{1/2}.

The turbofan engine of the preceding clause, wherein the low-pressure shaft has a redline speed between fifty and two hundred fifty-five feet per second (ft/sec).

The turbofan engine of any preceding clause, wherein a first order bending mode of the low-pressure shaft is greater than a redline speed of the low-pressure shaft.

The turbofan engine of any preceding clause, wherein the low-pressure shaft has a length L, an outer diameter D, and a ratio of L/D between twelve and thirty-seven.

The turbofan engine of any preceding clause, wherein the low-pressure shaft is a composite shaft made of at least two different materials.

The turbofan engine of any preceding clause, further including a power gearbox, wherein the low-pressure shaft is coupled to the fan shaft across the power gearbox.

The turbofan engine of any preceding clause, wherein a first order bending mode of the low-pressure shaft is less than a redline speed of the low-pressure shaft and within 5% to 10% of the redline speed.

The turbofan engine of any preceding clause, further including one or more bearings that support the low-pressure shaft.

The turbofan engine of any preceding clause, further including a bearing damper assembly including the one or more bearings and a bearing housing that receives oil to damp vibrations of the one or more bearings from the low-pressure shaft.

The turbofan engine of any preceding clause, wherein the MSR is greater when the oil has an oil temperature greater than an operating temperature range as compared to the MSR when the oil has an oil temperature within the operating temperature range.

The turbofan engine of any preceding clause, wherein the MSR is less when the oil has an oil temperature less than an operating temperature range as compared to the MSR when the oil has an oil temperature within the operating temperature range.

The turbofan engine of any preceding clause, wherein a first order bending mode of the low-pressure shaft is greater when the oil has an oil temperature greater than an operating temperature range as compared to the first order bending mode of the low-pressure shaft when the oil has an oil temperature within the operating temperature range.

The turbofan engine of any preceding clause, wherein a first order bending mode of the low-pressure shaft is less when the oil has an oil temperature less than an operating temperature range as compared to the first order bending mode of the low-pressure shaft when the oil has an oil temperature within the operating temperature range.

A turbofan engine for an aircraft, the turbofan engine including a fan having a plurality of fan blades coupled to a fan shaft having one or more fan bearings, each of the plurality of fan blades being rotatable about a pitch axis and extending from a fan hub, a nacelle that circumferentially surrounds the fan; a compressor section, a combustion section, and a turbine section, the turbine section having a low-pressure shaft that drivingly couples the fan to the turbine section, and a fan actuation system disposed within the fan hub and including one or more actuators for rotating the plurality of fan blades about the pitch axis and one or more radial thrust bearings, wherein the fan actuation system is characterized by a fan actuation system length envelope in a range of 8.5 to 13, the fan actuation system length envelope being given by:

$$\frac{{N}_{FB} \times {D}_{FT}}{{L}_{AXIAL} \times ( \frac{{R}_{TB}}{{N}_{FB}} )} ,$$

wherein N_{FB} is a number of the plurality of fan blades, D_{FT} is a fan tip diameter of the plurality of fan blades, R_{TB} is a thrust bearing radius of the one or more radial thrust bearings, and L_{AXIAL} is an axial length from a fan hub tip of the fan hub to the one or more fan bearings, wherein L_{AXIAL} is given by A_{FH}+A_{FB}, A_{FH} being a fan hub axial length from the fan hub tip to the pitch axis of the plurality of fan blades and A_{FB} being a fan bearing axial length from the pitch axis of the plurality of fan blades to the one or more fan bearings, A_{FH} is in a range of 25 inches to 40 inches, and A_{FB} is in a range of 17 inches to 20 inches, wherein the low-pressure shaft is characterized by a midshaft rating (MSR) between two hundred (ft/sec)^{1/2} and three hundred thirty (ft/sec)^{1/2}.

A turbofan engine for an aircraft, the turbofan engine including a fan having a plurality of fan blades coupled to a fan shaft having one or more fan bearings, the fan being an open fan, and each of the plurality of fan blades being rotatable about a pitch axis and extending from a fan hub, a compressor section, a combustion section, and a turbine section, the turbine section having a low-pressure shaft that drivingly couples the fan to the turbine section, and a fan actuation system disposed within the fan hub and including one or more actuators for rotating the plurality of fan blades about the pitch axis and one or more radial thrust bearings, wherein the fan actuation system is characterized by a fan actuation system length envelope in a range of 8.5 to 24, the fan actuation system length envelope being given by:

$$\frac{{N}_{FB} \times {D}_{FT}}{{L}_{AXIAL} \times ( \frac{{R}_{TB}}{{N}_{FB}} )} ,$$

wherein N_{FB} is a number of the plurality of fan blades, D_{FT} is a fan tip diameter of the plurality of fan blades, R_{TB} is a thrust bearing radius of the one or more radial thrust bearings, and L_{AXIAL} is an axial length from a fan hub tip of the fan hub to the one or more fan bearings, and R_{TB} is a thrust bearing radius of the one or more radial thrust bearings, wherein L_{AXIAL} is given by A_{FH}+A_{FB}, A_{FH} being a fan hub axial length from the fan hub tip to the pitch axis of the plurality of fan blades and A_{FB} being a fan bearing axial length from the pitch axis of the plurality of fan blades to the one or more fan bearings, A_{FH} is in a range of 25 inches to 75 inches, and A_{FB} is in a range of 16 inches to 23 inches, and D_{FT} is in a range of 120.0 inches to 180.0 inches, wherein the low-pressure shaft is characterized by a midshaft rating (MSR) between two hundred (ft/sec)^{1/2} and three hundred thirty (ft/sec)^{1/2}.

The turbofan engine of the preceding clause, wherein a first order bending mode of the low-pressure shaft is greater than a redline speed of the low-pressure shaft.

The turbofan engine of any preceding clause, wherein a first order bending mode of the low-pressure shaft is less than a redline speed of the low-pressure shaft and within 5% to 10% of the redline speed.

The turbofan engine of any preceding clause, further including one or more bearings that support the low-pressure shaft, and a bearing damper assembly including the one or more bearings and a bearing housing that receives oil to damp vibrations of the one or more bearings from the low-pressure shaft.

The turbofan engine of any preceding clause, wherein the MSR is greater when the oil has an oil temperature greater than an operating temperature range as compared to the MSR when the oil has an oil temperature within the operating temperature range, and the MSR is less when the oil has an oil temperature less than an operating temperature range as compared to the MSR when the oil has an oil temperature within the operating temperature range.

The turbofan engine of any preceding clause, wherein a first order bending mode of the low-pressure shaft is greater when the oil has an oil temperature greater than an operating temperature range as compared to the first order bending mode of the low-pressure shaft when the oil has an oil temperature within the operating temperature range, and a first order bending mode of the low-pressure shaft is less when the oil has an oil temperature less than an operating temperature range as compared to the first order bending mode of the low-pressure shaft when the oil has an oil temperature within the operating temperature range.

A turbofan engine for an aircraft, the turbofan engine including a fan having a plurality of fan blades coupled to a fan shaft having one or more fan bearings, each of the plurality of fan blades being rotatable about a pitch axis and extending from a fan hub, a compressor section, a combustion section, and a turbine section arranged in serial flow order, the turbine section having a low-pressure turbine including a low-pressure shaft, and a fan actuation system disposed within the fan hub and including one or more actuators for rotating the plurality of fan blades about the pitch axis and one or more radial thrust bearings, wherein the fan actuation system is characterized by a fan actuation system length envelope in a range of 8.5 to 24, the fan actuation system length envelope being given by:

$$\frac{{N}_{FB} \times {D}_{FT}}{{L}_{AXIAL} \times ( \frac{{R}_{TB}}{{N}_{FB}} )} ,$$

wherein N_{FB} is a number of the plurality of fan blades, D_{FT} is a fan tip diameter of the plurality of fan blades, R_{TB} is a thrust bearing radius of the one or more radial thrust bearings, and L_{AXIAL} is an axial length from a fan hub tip of the fan hub to the one or more fan bearings, and wherein the low-pressure shaft is characterized by a midshaft effective flexural rigidity (MEFR) in a range of 39 lbf-in² to 211 lbf-in² and given by:

$$E \times {I}_{B} \times ( \frac{( 1.3 \times {T}_{E} ) + {T}_{D}}{2 \times {T}_{B}} ) \times ( \frac{{L}_{B}}{{L}_{Total}} ) \times {10}^{- 6} ,$$

where E is a modulus of elasticity of the low-pressure shaft, I_{B} is an area moment of inertia of a midshaft section of the low-pressure shaft, T_{E} is an average thickness of an axially forward-most section of the low-pressure shaft, T_{D} is an average thickness of an axially aft-most section of the low-pressure shaft, T_{B} is an average thickness of the midshaft section, L_{B} is an axial length of the midshaft section, and L_{Total} is a total length of the low-pressure shaft.

The turbofan engine of the preceding clause, wherein E is in a range of 1.5E+07 psi to 3.6E+07 psi.

The turbofan engine of any preceding clause, wherein I_{B} is in a range of 1.5 in⁴ to 6.0 in⁴.

The turbofan engine of any preceding clause, wherein T_{D} is in a range of 0.23 in to 0.83 in.

The turbofan engine of any preceding clause, wherein T_{E} is in a range of 0.72 in to 1.50 in.

The turbofan engine of any preceding clause, wherein T_{B} is in a range of 0.15 in to 0.83 in.

The turbofan engine of any preceding clause, wherein L_{B} is in a range of 29.7 in to 44.7 in.

The turbofan engine of any preceding clause, wherein L_{Total} is in a range of 74.1 inches to 111.3 in.

The turbofan engine of any preceding clause, wherein the low-pressure shaft has a redline speed in a range of 10,000 RPM to 13,000 RPM for a three-stage low-pressure turbine.

The turbofan engine of any preceding clause, wherein the low-pressure shaft has a redline speed in a range of 9,000 RPM to 10,200 RPM for a four-stage low-pressure turbine.

A turbofan engine for an aircraft, the turbofan engine including a fan having a plurality of fan blades coupled to a fan shaft having one or more fan bearings, each of the plurality of fan blades being rotatable about a pitch axis and extending from a fan hub, a nacelle that circumferentially surrounds the fan; a compressor section, a combustion section, and a turbine section arranged in serial flow order, the turbine section having a low-pressure turbine including a low-pressure shaft, and a fan actuation system disposed within the fan hub and including one or more actuators for rotating the plurality of fan blades about the pitch axis and one or more radial thrust bearings, wherein the fan actuation system is characterized by a fan actuation system length envelope in a range of 8.5 to 13, the fan actuation system length envelope being given by:

$$\frac{{N}_{FB} \times {D}_{FT}}{{L}_{AXIAL} \times ( \frac{{R}_{TB}}{{N}_{FB}} )} ,$$

wherein N_{FB} is a number of the plurality of fan blades, D_{FT} is a fan tip diameter of the plurality of fan blades, R_{TB} is a thrust bearing radius of the one or more radial thrust bearings, and L_{AXIAL} is an axial length from a fan hub tip of the fan hub to the one or more fan bearings, wherein L_{AXIAL} is given by A_{FH}+A_{FB}, A_{FH} being a fan hub axial length from the fan hub tip to the pitch axis of the plurality of fan blades and A_{FB} being a fan bearing axial length from the pitch axis of the plurality of fan blades to the one or more fan bearings, A_{FH} is in a range of 25 inches to 40 inches, and A_{FB} is in a range of 17 inches to 20 inches, and wherein the low-pressure shaft is characterized by a midshaft effective flexural rigidity (MEFR) in a range of 39 lbf-in² to 211 lbf-in² and given by:

$$E \times {I}_{B} \times ( \frac{( 1.3 \times {T}_{E} ) + {T}_{D}}{2 \times {T}_{B}} ) \times ( \frac{{L}_{B}}{{L}_{Total}} ) \times {10}^{- 6} ,$$

where E is a modulus of elasticity of the low-pressure shaft, I_{B} is an area moment of inertia of a midshaft section of the low-pressure shaft, T_{E} is an average thickness of an axially forward-most section of the low-pressure shaft, T_{D} is an average thickness of an axially aft-most section of the low-pressure shaft, T_{B} is an average thickness of the midshaft section, L_{B} is an axial length of the midshaft section, and L_{Total} is a total length of the low-pressure shaft.

A turbofan engine for an aircraft, the turbofan engine including a fan having a plurality of fan blades coupled to a fan shaft having one or more fan bearings, the fan being an open fan, and each of the plurality of fan blades being rotatable about a pitch axis and extending from a fan hub, a compressor section, a combustion section, and a turbine section arranged in serial flow order, the turbine section having a low-pressure turbine including a low-pressure shaft, and a fan actuation system disposed within the fan hub and including one or more actuators for rotating the plurality of fan blades about the pitch axis and one or more radial thrust bearings, wherein the fan actuation system is characterized by a fan actuation system length envelope in a range of 8.5 to 24, the fan actuation system length envelope being given by:

$$\frac{{N}_{FB} \times {D}_{FT}}{{L}_{AXIAL} \times ( \frac{{R}_{TB}}{{N}_{FB}} )} ,$$

wherein N_{FB} is a number of the plurality of fan blades, D_{FT} is a fan tip diameter of the plurality of fan blades, R_{TB} is a thrust bearing radius of the one or more radial thrust bearings, and L_{AXIAL} is an axial length from a fan hub tip of the fan hub to the one or more fan bearings, and R_{TB} is a thrust bearing radius of the one or more radial thrust bearings, wherein L_{AXIAL} is given by A_{FH}+A_{FB}, A_{FH} being a fan hub axial length from the fan hub tip to the pitch axis of the plurality of fan blades and A_{FB} being a fan bearing axial length from the pitch axis of the plurality of fan blades to the one or more fan bearings, A_{FH} is in a range of 25 inches to 75 inches, and A_{FB} is in a range of 16 inches to 23 inches, and D_{FT} is in a range of 120.0 inches to 180.0 inches, and wherein the low-pressure shaft is characterized by a midshaft effective flexural rigidity (MEFR) in a range of 39 lbf-in² to 211 lbf-in² and given by:

$$E \times {I}_{B} \times ( \frac{( 1.3 \times {T}_{E} ) + {T}_{D}}{2 \times {T}_{B}} ) \times ( \frac{{L}_{B}}{{L}_{Total}} ) \times {10}^{- 6} ,$$

where E is a modulus of elasticity of the low-pressure shaft, I_{B} is an area moment of inertia of a midshaft section of the low-pressure shaft, T_{E} is an average thickness of an axially forward-most section of the low-pressure shaft, T_{D} is an average thickness of an axially aft-most section of the low-pressure shaft, T_{B} is an average thickness of the midshaft section, L_{B} is an axial length of the midshaft section, and L_{Total} is a total length of the low-pressure shaft.

The turbofan engine of the preceding clause, wherein E is in a range of 1.5E+07 psi to 3.6E+07 psi.

The turbofan engine of any preceding clause, wherein I_{B} is in a range of 1.5 in⁴ to 6.0 in⁴.

The turbofan engine of any preceding clause, wherein T_{D} is in a range of 0.23 in to 0.83 in.

The turbofan engine of any preceding clause, wherein T_{E} is in a range of 0.72 in to 1.50 in.

The turbofan engine of any preceding clause, wherein T_{B} is in a range of 0.15 in to 0.83 in.

The turbofan engine of any preceding clause, wherein L_{B} is in a range of 29.7 in to 44.7 in.

The turbofan engine of any preceding clause, wherein L_{Total} is in a range of 74.1 inches to 111.3 in.

The turbofan engine of any preceding clause, wherein the low-pressure shaft has a redline speed in a range of 10,000 RPM to 13,000 RPM for a three-stage low-pressure turbine or the low-pressure shaft has a redline speed in a range of 9,000 RPM to 10,200 RPM for a four-stage low-pressure turbine.

Although the foregoing description is directed to the preferred embodiments of the present disclosure, other variations and modifications will be apparent to those skilled in the art and may be made without departing from the disclosure. Moreover, features described in connection with one embodiment of the present disclosure may be used in conjunction with other embodiments, even if not explicitly stated above.

1. A turbofan engine for an aircraft, the turbofan engine comprising:
a fan having a plurality of fan blades coupled to a fan shaft having one or more fan bearings, each of the plurality of fan blades being rotatable about a pitch axis and extending from a fan hub;
a compressor section, a combustion section, and a turbine section, the compressor section having a high-pressure compressor defining a high-pressure compressor exit area (A_{HPCExit}); and
a fan actuation system disposed within the fan hub and including one or more actuators for rotating the plurality of fan blades about the pitch axis and one or more radial thrust bearings, wherein the fan actuation system is characterized by a fan actuation system length envelope in a range of 8.5 to 24, the fan actuation system length envelope being given by:
$$\frac{{N}_{FB} \times {D}_{FT}}{{L}_{AXIAL} \times ( \frac{{R}_{TB}}{{N}_{FB}} )}$$
wherein N_{FB} is a number of the plurality of fan blades, D_{FT} is a fan tip diameter of the plurality of fan blades, R_{TB} is a thrust bearing radius of the one or more radial thrust bearings, and L_{AXIAL} is an axial length from a fan hub tip of the fan hub to the one or more fan bearings,
wherein the turbofan engine defines a redline exhaust gas temperature (EGT), a total sea level static thrust output (Fn_{Total}), and a corrected specific thrust, wherein the corrected specific thrust is greater than or equal to 42 and less than or equal to 90, the corrected specific thrust being given by: Fn_{Total}×EGT/(A_{HPCExit}²×1000).

2. The turbofan engine of claim 1, wherein the EGT is greater than 1000 degrees Celsius and less than 1300 degrees Celsius.

3. The turbofan engine of claim 1, wherein the EGT is greater than 1100 degree Celsius and less than 1250 degrees Celsius.

4. The turbofan engine of claim 1, wherein the EGT is greater than 1150 degree Celsius and less than 1250 degrees Celsius.

5. The turbofan engine of claim 1, wherein the EGT is greater than 1000 degree Celsius and less than 1300 degrees Celsius, and wherein the corrected specific thrust is greater than or equal to 45.

6. The turbofan engine of claim 1, wherein the EGT is greater than 1000 degree Celsius and less than 1300 degrees Celsius, and wherein the corrected specific thrust is greater than or equal to 50.

7. The turbofan engine of claim 1, wherein the turbine section comprises a high-pressure turbine having a first stage of high-pressure turbine rotor blades, and wherein the turbofan engine further comprises:
a cooled cooling air system in fluid communication with the first stage of high-pressure turbine rotor blades.

8. The turbofan of claim 7, wherein the cooled cooling air system is further in fluid communication with the high-pressure compressor for receiving an airflow from the high-pressure compressor, and wherein the cooled cooling air system further comprises a heat exchanger in thermal communication with the airflow for cooling the airflow.

9. The turbofan engine of claim 7, wherein when the turbofan engine is operated at a takeoff power level, the cooled cooling air system is configured to provide a temperature reduction of a cooling airflow equal to at least 15% of the EGT and up to 45% of the EGT.

10. The turbofan of claim 7, wherein when the turbofan engine is operated at a takeoff power level, the cooled cooling air system is configured to receive between 2.5% and 35% of an airflow through a core duct of the turbofan engine at an inlet to the compressor section.

11. The turbofan engine of claim 1, wherein the fan is a primary fan, and the turbofan engine further comprises:
an inlet duct downstream of the primary fan and upstream of the compressor section; and
a secondary fan located within the inlet duct.

12. The turbofan engine of claim 11, further comprising a bypass passage, wherein the turbofan engine defines a third stream extending from a location downstream of the secondary fan to the bypass passage.

13. The turbofan engine of claim 11, wherein the secondary fan is a single stage secondary fan.

14. A turbofan engine for an aircraft, the turbofan engine comprising:
a fan having a plurality of fan blades coupled to a fan shaft having one or more fan bearings, each of the plurality of fan blades being rotatable about a pitch axis and extending from a fan hub;
a nacelle that circumferentially surrounds the fan;
a compressor section, a combustion section, and a turbine section, the compressor section having a high-pressure compressor defining a high-pressure compressor exit area (A_{HPCExit}); and
a fan actuation system disposed within the fan hub and including one or more actuators for rotating the plurality of fan blades about the pitch axis and one or more radial thrust bearings, wherein the fan actuation system is characterized by a fan actuation system length envelope in a range of 8.5 to 13, the fan actuation system length envelope being given by:
$$\frac{{N}_{FB} \times {D}_{FT}}{{L}_{AXIAL} \times ( \frac{{R}_{TB}}{{N}_{FB}} )}$$
wherein N_{FB} is a number of the plurality of fan blades, D_{FT} is a fan tip diameter of the plurality of fan blades, R_{TB} is a thrust bearing radius of the one or more radial thrust bearings, and L_{AXIAL} is an axial length from a fan hub tip of the fan hub to the one or more fan bearings, wherein L_{AXIAL} is given by A_{FH}+A_{FB}, A_{FH} being a fan hub axial length from the fan hub tip to the pitch axis of the plurality of fan blades and A_{FB} being a fan bearing axial length from the pitch axis of the plurality of fan blades to the one or more fan bearings, A_{FH} is in a range of 25 inches to 40 inches, and A_{FB} is in a range of 17 inches to 20 inches,
wherein the turbofan engine defines a redline exhaust gas temperature (EGT), a total sea level static thrust output (Fn_{Total}), and a corrected specific thrust, wherein the corrected specific thrust is greater than or equal to 42 and less than or equal to 90, the corrected specific thrust being given by: Fn_{Total}×EGT/(A_{HPCExit}²×1000).

15. A turbofan engine for an aircraft, the turbofan engine comprising:
a fan having a plurality of fan blades coupled to a fan shaft having one or more fan bearings, the fan being an open fan, and each of the plurality of fan blades being rotatable about a pitch axis and extending from a fan hub;
a compressor section, a combustion section, and a turbine section, the compressor section having a high-pressure compressor defining a high-pressure compressor exit area (A_{HPCExit}); and
a fan actuation system disposed within the fan hub and including one or more actuators for rotating the plurality of fan blades about the pitch axis and one or more radial thrust bearings, wherein the fan actuation system is characterized by a fan actuation system length envelope in a range of 8.5 to 24, the fan actuation system length envelope being given by:
$$\frac{{N}_{FB} \times {D}_{FT}}{{L}_{AXIAL} \times ( \frac{{R}_{TB}}{{N}_{FB}} )}$$
wherein N_{FB} is a number of the plurality of fan blades, D_{FT} is a fan tip diameter of the plurality of fan blades, R_{TB} is a thrust bearing radius of the one or more radial thrust bearings, and L_{AXIAL} is an axial length from a fan hub tip of the fan hub to the one or more fan bearings, and R_{TB} is a thrust bearing radius of the one or more radial thrust bearings, wherein L_{AXIAL} IS given by A_{FH}+A_{FB}, A_{FH} being a fan hub axial length from the fan hub tip to the pitch axis of the plurality of fan blades and A_{FB} being a fan bearing axial length from the pitch axis of the plurality of fan blades to the one or more fan bearings, A_{FH} is in a range of 25 inches to 75 inches, and A_{FB} is in a range of 16 inches to 23 inches, and D_{FT} is in a range of 120.0 inches to 180.0 inches,
wherein the turbofan engine defines a redline exhaust gas temperature (EGT), a total sea level static thrust output (Fn_{Total}), and a corrected specific thrust, wherein the corrected specific thrust is greater than or equal to 42 and less than or equal to 90, the corrected specific thrust being given by: Fn_{Total}×EGT/(A_{HPCExit}²×1000).

16. The turbofan engine of claim 15, wherein the fan is a primary fan, and the turbofan engine further comprises:
an inlet duct downstream of the primary fan and upstream of the compressor section; and
a secondary fan located within the inlet duct.

17. The turbofan engine of claim 15, wherein the EGT is greater than 1000 degrees Celsius and less than 1300 degrees Celsius.

18. The turbofan engine of claim 15, wherein the turbine section comprises a high-pressure turbine having a first stage of high-pressure turbine rotor blades, and wherein the turbofan engine further comprises:
a cooled cooling air system in fluid communication with the first stage of high-pressure turbine rotor blades.

19. The turbofan of claim 18, wherein the cooled cooling air system is further in fluid communication with the high-pressure compressor for receiving an airflow from the high-pressure compressor, and wherein the cooled cooling air system further comprises a heat exchanger in thermal communication with the airflow for cooling the airflow.

20. The turbofan engine of claim 18, wherein when the turbofan engine is operated at a takeoff power level, the cooled cooling air system is configured to provide a temperature reduction of a cooling airflow equal to at least 15% of the EGT and up to 45% of the EGT.
